(19) United States
(12) Patent Application Publication
(10) Pub. No.: US 2025/0356064 A1
(43) Pub. Date: Nov. 20, 2025

(54) DEVICES, METHODS, AND GRAPHICAL USER INTERFACES FOR TRANSITIONING BETWEEN MULTIPLE MODES OF OPERATION

(71) Applicant: Apple Inc., Cupertino, CA (US)

(72) Inventors: Karen EL ASMAR, San Francisco, CA (US); Walden J. DAVIS, San Francisco, CA (US); Jonathan R. DASCOLA, San Francisco, CA (US); Amy E. DEDONATO, San Francisco, CA (US); Kaely COON, San Francisco, CA (US); Stephen O. LEMAY, Palo Alto, CA (US); Lynn I. STREJA, San Francisco, CA (US)

(21) Appl. No.: 19/185,080

(22) Filed: Apr. 21, 2025

Related U.S. Application Data
(60) Provisional application No. 63/648,129, filed on May 15, 2024.
(60) Provisional application No. 63/657,761, filed on Jun. 7, 2024.
(60) Provisional application No. 63/715,625, filed on Nov. 3, 2024.
(60) Provisional application No. 63/762,629, filed on Feb. 24, 2025.
(60) Provisional application No. 63/765,451, filed on Feb. 28, 2025.
(60) Provisional application No. 63/784,885, filed on Apr. 7, 2025.

(51) Int. Cl. G06F 21/83; G06F 21/32

(52) U.S. Cl. CPC G06F 21/83; G06F 21/32; G06F 2221/2117

(57) ABSTRACT

The present disclosure generally relates to interacting with computer systems that are operable in multiple modes of operation and/or can be transitioned between multiple modes of operation.

### CROSS-REFERENCE TO RELATED APPLICATIONS

This application claims priority to U.S. Provisional Patent Application No. 63/784,885, entitled “DEVICES, METHODS, AND GRAPHICAL USER INTERFACES FOR TRANSITIONING BETWEEN MULTIPLE MODES OF OPERATION,” filed Apr. 7, 2025; to U.S. Provisional Patent Application No. 63/765,451, entitled “DEVICES, METHODS, AND GRAPHICAL USER INTERFACES FOR TRANSITIONING BETWEEN MULTIPLE MODES OF OPERATION,” filed Feb. 28, 2025; to U.S. Provisional Patent Application No. 63/762,629, entitled “DEVICES, METHODS, AND GRAPHICAL USER INTERFACES FOR TRANSITIONING BETWEEN MULTIPLE MODES OF OPERATION,” filed Feb. 24, 2025; to U.S. Provisional Patent Application No. 63/715,625, entitled “DEVICES, METHODS, AND GRAPHICAL USER INTERFACES FOR TRANSITIONING BETWEEN MULTIPLE MODES OF OPERATION,” filed Nov. 3, 2024; to U.S. Provisional Patent Application No. 63/657,761, entitled “DEVICES, METHODS, AND GRAPHICAL USER INTERFACES FOR TRANSITIONING BETWEEN MULTIPLE MODES OF OPERATION,” filed Jun. 7, 2024; and to U.S. Provisional Patent Application No. 63/648,129, entitled “DEVICES, METHODS, AND GRAPHICAL USER INTERFACES FOR TRANSITIONING BETWEEN MULTIPLE MODES OF OPERATION,” filed May 15, 2024. The content of each of these applications is hereby incorporated by reference in their entirety.

### TECHNICAL FIELD

The present disclosure relates generally to computer systems that are in communication with one or more display generation components and, optionally, one or more input devices that provide computer-generated experiences, including, but not limited to, electronic devices that provide virtual reality and mixed reality experiences via one or more display generation components.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touchscreen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with and/or utilizing computer systems are cumbersome, inefficient, and limited. For example, systems that make it difficult and/or tedious to transition between multiple modes of operations, and/or systems that make it difficult to share computer systems between multiple users, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted display (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges. Such methods and user interfaces also improve device security, data security, and data privacy.

In accordance with some embodiments, a method is described. The method comprises: at a computer system that is in communication with one or more display generation components and one or more input devices: detecting, via the one or more input devices, a first user using the computer system; and in response to detecting the first user using the computer system: in accordance with a determination that one or more guest user criteria are satisfied and there is saved guest enrollment information available to the computer system, initiating a processing for using the saved guest enrollment information to process user inputs by the first user; and in accordance with a determination that the one or more guest user criteria are satisfied and there is not saved guest enrollment information available to the computer system, initiating a process for performing input enrollment of the first user.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: detecting, via the one or more input devices, a first user using the computer system; and in response to detecting the first user using the computer system: in accordance with a determination that one or more guest user criteria are satisfied and there is saved guest enrollment information available to the computer system, initiating a processing for using the saved guest enrollment information to process user inputs by the first user; and in accordance with a determination that the one or more guest user criteria are satisfied and there is not saved guest enrollment information available to the computer system, initiating a process for performing input enrollment of the first user.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: detecting, via the one or more input devices, a first user using the computer system; and in response to detecting the first user using the computer system: in accordance with a determination that one or more guest user criteria are satisfied and there is saved guest enrollment information available to the computer system, initiating a processing for using the saved guest enrollment information to process user inputs by the first user; and in accordance with a determination that the one or more guest user criteria are satisfied and there is not saved guest enrollment information available to the computer system, initiating a process for performing input enrollment of the first user.

In accordance with some embodiments, a computer system is described. The computer system is configured to communicate with one or more display generation components and one or more input devices. The computer system comprises: one or more processors; and memory storing one or more programs configured to be executed by the one or more processors, the one or more programs including instructions for: detecting, via the one or more input devices, a first user using the computer system; and in response to detecting the first user using the computer system: in accordance with a determination that one or more guest user criteria are satisfied and there is saved guest enrollment information available to the computer system, initiating a processing for using the saved guest enrollment information to process user inputs by the first user; and in accordance with a determination that the one or more guest user criteria are satisfied and there is not saved guest enrollment information available to the computer system, initiating a process for performing input enrollment of the first user.

In accordance with some embodiments, a computer system is described. The computer system is configured to communicate with one or more display generation components and one or more input devices, and comprises: means for detecting, via the one or more input devices, a first user using the computer system; means for, in response to detecting the first user using the computer system: in accordance with a determination that one or more guest user criteria are satisfied and there is saved guest enrollment information available to the computer system, initiating a processing for using the saved guest enrollment information to process user inputs by the first user; and in accordance with a determination that the one or more guest user criteria are satisfied and there is not saved guest enrollment information available to the computer system, initiating a process for performing input enrollment of the first user.

In accordance with some embodiments, a computer program product is described. The computer program product comprises one or more programs configured to be executed by one or more processors of a computer system that is in communication with one or more display generation components and one or more input devices, the one or more programs including instructions for: detecting, via the one or more input devices, a first user using the computer system; and in response to detecting the first user using the computer system: in accordance with a determination that one or more guest user criteria are satisfied and there is saved guest enrollment information available to the computer system, initiating a processing for using the saved guest enrollment information to process user inputs by the first user; and in accordance with a determination that the one or more guest user criteria are satisfied and there is not saved guest enrollment information available to the computer system, initiating a process for performing input enrollment of the first user.

In accordance with some embodiments, a method is described. The method comprises: at a first computer system that is in communication with one or more display generation components and one or more input devices: detecting, via the one or more input devices, an attempt to authenticate a first user at the first computer system, wherein a registered account is associated with a registered user for the first computer system; in response to detecting the attempt to authenticate the first user: in accordance with a determination that the attempt to authenticate the first user meets a first set of criteria, including a first criterion that is satisfied when the attempt to authenticate the first user fails, initiating a process to operate the first computer system in a guest mode of operation that has restricted access to one or more of a plurality of features of the first computer system, including causing a second computer system associated with the registered account to output a request for authorization for the first computer system to be operated in the guest mode of operation; and subsequent to initiating the process to operate the first computer system in the guest mode of operation and causing the second computer system associated with the registered account to output a request for authorization for the first computer system to be operated in the guest mode of operation: in accordance with a determination that operation of the first computer system in the guest mode of operation is authorized based on input received at the second computer system that is associated with the registered account, initiating the guest mode of operation; and in accordance with a determination that operation of the first computer system in the guest mode of operation is not authorized by the registered account of the first computer system, forgoing initiating the guest mode of operation.

In accordance with some embodiments, a non-transitory computer-readable storage medium is described. The non-transitory computer-readable storage medium stores one or more programs configured to be executed by one or more processors of a first computer system that is in communication with one or more display generation components and one or more input devices, the one or more programs including instructions for: detecting, via the one or more input devices, an attempt to authenticate a first user at the first computer system, wherein a registered account is associated with a registered user for the first computer system; in response to detecting the attempt to authenticate the first user: in accordance with a determination that the attempt to authenticate the first user meets a first set of criteria, including a first criterion that is satisfied when the attempt to authenticate the first user fails, initiating a process to operate the first computer system in a guest mode of operation that has restricted access to one or more of a plurality of features of the first computer system, including causing a second computer system associated with the registered account to output a request for authorization for the first computer system to be operated in the guest mode of operation; and subsequent to initiating the process to operate the first computer system in the guest mode of operation and causing the second computer system associated with the registered account to output a request for authorization for the first computer system to be operated in the guest mode of operation: in accordance with a determination that operation of the first computer system in the guest mode of operation is authorized based on input received at the second computer system that is associated with the registered account, initiating the guest mode of operation; and in accordance with a determination that operation of the first computer system in the guest mode of operation is not authorized by the registered account of the first computer system, forgoing initiating the guest mode of operation.

In accordance with some embodiments, a transitory computer-readable storage medium is described. The transitory computer-readable storage medium stores one or more programs configured to be executed by one or more processors of a first computer system that is in communication with one or more display generation components and one or more input devices, the one or more programs including instructions for: detecting, via the one or more input devices, an attempt to authenticate a first user at the first computer system, wherein a registered account is associated with a registered user for the first computer system; in response to detecting the attempt to authenticate the first user: in accordance with a determination that the attempt to authenticate the first user meets a first set of criteria, including a first criterion that is satisfied when the attempt to authenticate the first user fails, initiating a process to operate the first computer system in a guest mode of operation that has restricted access to one or more of a plurality of features of the first computer system, including causing a second computer system associated with the registered account to output a request for authorization for the first computer system to be operated in the guest mode of operation; and subsequent to initiating the process to operate the first computer system in the guest mode of operation and causing the second computer system associated with the registered account to output a request for authorization for the first computer system to be operated in the guest mode of operation: in accordance with a determination that operation of the first computer system in the guest mode of operation is authorized based on input received at the second computer system that is associated with the registered account, initiating the guest mode of operation; and in accordance with a determination that operation of the first computer system in the guest mode of operation is not authorized by the registered account of the first computer system, forgoing initiating the guest mode of operation.

In accordance with some embodiments, a first computer system is described. The first computer system is configured to communicate with one or more display generation components and one or more input devices, and comprises: one or more processors; and memory storing one or more programs configured to be executed by the one or more processors, the one or more programs including instructions for: detecting, via the one or more input devices, an attempt to authenticate a first user at the first computer system, wherein a registered account is associated with a registered user for the first computer system; in response to detecting the attempt to authenticate the first user: in accordance with a determination that the attempt to authenticate the first user meets a first set of criteria, including a first criterion that is satisfied when the attempt to authenticate the first user fails, initiating a process to operate the first computer system in a guest mode of operation that has restricted access to one or more of a plurality of features of the first computer system, including causing a second computer system associated with the registered account to output a request for authorization for the first computer system to be operated in the guest mode of operation; and subsequent to initiating the process to operate the first computer system in the guest mode of operation and causing the second computer system associated with the registered account to output a request for authorization for the first computer system to be operated in the guest mode of operation: in accordance with a determination that operation of the first computer system in the guest mode of operation is authorized based on input received at the second computer system that is associated with the registered account, initiating the guest mode of operation; and in accordance with a determination that operation of the first computer system in the guest mode of operation is not authorized by the registered account of the first computer system, forgoing initiating the guest mode of operation.

In accordance with some embodiments, a first computer system is described. The first computer system is configured to communicate with one or more display generation components and one or more input devices, and comprises: means for detecting, via the one or more input devices, an attempt to authenticate a first user at the first computer system, wherein a registered account is associated with a registered user for the first computer system; means for, in response to detecting the attempt to authenticate the first user: in accordance with a determination that the attempt to authenticate the first user meets a first set of criteria, including a first criterion that is satisfied when the attempt to authenticate the first user fails, initiating a process to operate the first computer system in a guest mode of operation that has restricted access to one or more of a plurality of features of the first computer system, including causing a second computer system associated with the registered account to output a request for authorization for the first computer system to be operated in the guest mode of operation; and means for, subsequent to initiating the process to operate the first computer system in the guest mode of operation and causing the second computer system associated with the registered account to output a request for authorization for the first computer system to be operated in the guest mode of operation: in accordance with a determination that operation of the first computer system in the guest mode of operation is authorized based on input received at the second computer system that is associated with the registered account, initiating the guest mode of operation; and in accordance with a determination that operation of the first computer system in the guest mode of operation is not authorized by the registered account of the first computer system, forgoing initiating the guest mode of operation.

In accordance with some embodiments, a computer program product is described. The computer program product comprises one or more programs configured to be executed by one or more processors of a first computer system that is in communication with one or more display generation components and one or more input devices, the one or more programs including instructions for: detecting, via the one or more input devices, an attempt to authenticate a first user at the first computer system, wherein a registered account is associated with a registered user for the first computer system; in response to detecting the attempt to authenticate the first user: in accordance with a determination that the attempt to authenticate the first user meets a first set of criteria, including a first criterion that is satisfied when the attempt to authenticate the first user fails, initiating a process to operate the first computer system in a guest mode of operation that has restricted access to one or more of a plurality of features of the first computer system, including causing a second computer system associated with the registered account to output a request for authorization for the first computer system to be operated in the guest mode of operation; and subsequent to initiating the process to operate the first computer system in the guest mode of operation and causing the second computer system associated with the registered account to output a request for authorization for the first computer system to be operated in the guest mode of operation: in accordance with a determination that operation of the first computer system in the guest mode of operation is authorized based on input received at the second computer system that is associated with the registered account, initiating the guest mode of operation; and in accordance with a determination that operation of the first computer system in the guest mode of operation is not authorized by the registered account of the first computer system, forgoing initiating the guest mode of operation.

In accordance with some embodiments, a method is described. The method comprises: at a computer system that is in communication with one or more display generation components: receiving an indication of a first event corresponding to a request to initiate a guest mode of operation on an external computer system, wherein: a registered user mode of operation of the external computer system provides access to a first plurality of features of the external computer system; and a guest mode of operation of the external computer system provides access to a subset of the first plurality of features and provides access to fewer features of the external computer system than the registered user mode of operation; and in response to receiving the indication of the first event corresponding to a request to initiate a guest mode of operation on the external computer system, displaying, via the one or more display generation components, a visual indication of the request to initiate the guest mode of operation on the external computer system.

In accordance with some embodiments, a non-transitory computer-readable storage medium is described. The non-transitory computer-readable storage medium stores one or more programs configured to be executed by one or more processors of a computer system that is in communication with one or more display generation components, the one or more programs including instructions for: receiving an indication of a first event corresponding to a request to initiate a guest mode of operation on an external computer system, wherein: a registered user mode of operation of the external computer system provides access to a first plurality of features of the external computer system; and a guest mode of operation of the external computer system provides access to a subset of the first plurality of features and provides access to fewer features of the external computer system than the registered user mode of operation; and in response to receiving the indication of the first event corresponding to a request to initiate a guest mode of operation on the external computer system, displaying, via the one or more display generation components, a visual indication of the request to initiate the guest mode of operation on the external computer system.

In accordance with some embodiments, a transitory computer-readable storage medium is described. The transitory computer-readable storage medium stores one or more programs configured to be executed by one or more processors of a computer system that is in communication with one or more display generation components, the one or more programs including instructions for: receiving an indication of a first event corresponding to a request to initiate a guest mode of operation on an external computer system, wherein: a registered user mode of operation of the external computer system provides access to a first plurality of features of the external computer system; and a guest mode of operation of the external computer system provides access to a subset of the first plurality of features and provides access to fewer features of the external computer system than the registered user mode of operation; and in response to receiving the indication of the first event corresponding to a request to initiate a guest mode of operation on the external computer system, displaying, via the one or more display generation components, a visual indication of the request to initiate the guest mode of operation on the external computer system.

In accordance with some embodiments, a computer system is described. The computer system is configured to communicate with one or more display generation components, and comprises: one or more processors; and memory storing one or more programs configured to be executed by the one or more processors, the one or more programs including instructions for: receiving an indication of a first event corresponding to a request to initiate a guest mode of operation on an external computer system, wherein: a registered user mode of operation of the external computer system provides access to a first plurality of features of the external computer system; and a guest mode of operation of the external computer system provides access to a subset of the first plurality of features and provides access to fewer features of the external computer system than the registered user mode of operation; and in response to receiving the indication of the first event corresponding to a request to initiate a guest mode of operation on the external computer system, displaying, via the one or more display generation components, a visual indication of the request to initiate the guest mode of operation on the external computer system.

In accordance with some embodiments, a computer system is described. The computer system is configured to communicate with one or more display generation components, and comprises: means for receiving an indication of a first event corresponding to a request to initiate a guest mode of operation on an external computer system, wherein: a registered user mode of operation of the external computer system provides access to a first plurality of features of the external computer system; and a guest mode of operation of the external computer system provides access to a subset of the first plurality of features and provides access to fewer features of the external computer system than the registered user mode of operation; and means for, in response to receiving the indication of the first event corresponding to a request to initiate a guest mode of operation on the external computer system, displaying, via the one or more display generation components, a visual indication of the request to initiate the guest mode of operation on the external computer system.

In accordance with some embodiments, a computer program product is described. The computer program product comprises one or more programs configured to be executed by one or more processors of a computer system that is in communication with one or more display generation components, the one or more programs including instructions for: receiving an indication of a first event corresponding to a request to initiate a guest mode of operation on an external computer system, wherein: a registered user mode of operation of the external computer system provides access to a first plurality of features of the external computer system; and a guest mode of operation of the external computer system provides access to a subset of the first plurality of features and provides access to fewer features of the external computer system than the registered user mode of operation; and in response to receiving the indication of the first event corresponding to a request to initiate a guest mode of operation on the external computer system, displaying, via the one or more display generation components, a visual indication of the request to initiate the guest mode of operation on the external computer system.

In accordance with some embodiments, a method is described. The method comprises: at a computer system that is in communication with one or more display generation components and one or more input devices: detecting, via the one or more input devices, a sequence of one or more inputs corresponding to a request to use the computer system in a guest mode of operation, wherein: the guest mode of operation requires user input enrollment information to calibrate the computer system to be controlled using detected inputs that are interpreted based on the user input enrollment information; and the guest mode of operation is not associated with a user of the computer system; in response to detecting the sequence of one or more inputs, initiating a process for operating the computer system in a guest mode of operation for the user of the computer system, wherein, the process for operating the computer system in the guest mode of operation includes outputting, via one or more output devices, a first prompt prompting the user of the computer system to use an external computer system that is separate from the computer system and that is associated with the user of the computer system to provide saved user input enrollment information corresponding to the user of the computer system to calibrate the computer system to be controlled using detected inputs that are interpreted based on the user input enrollment information; after the first prompt has been output, receiving first saved user input enrollment information corresponding to the user of the computer system from the external computer system; after receiving the first saved user input enrollment information corresponding to the user of the computer system from the external computer system, detecting, via the one or more input devices, input; and in response to detecting the input, performing an operation based on the input, where the operation is performed using the input as interpreted based on the first saved user input enrollment information for the user that was received from the external computer system.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: detecting, via the one or more input devices, a sequence of one or more inputs corresponding to a request to use the computer system in a guest mode of operation, wherein: the guest mode of operation requires user input enrollment information to calibrate the computer system to be controlled using detected inputs that are interpreted based on the user input enrollment information; and the guest mode of operation is not associated with the user of the computer system; in response to detecting the sequence of one or more inputs, initiating a process for operating the computer system in a guest mode of operation for the user of the computer system, wherein, the process for operating the computer system in the guest mode of operation includes outputting, via one or more output devices, a first prompt prompting the user of the computer system to use an external computer system that is separate from the computer system and that is associated with the user of the computer system to provide saved user input enrollment information corresponding to the user of the computer system to calibrate the computer system to be controlled using detected inputs that are interpreted based on the user input enrollment information; after the first prompt has been output, receiving first saved user input enrollment information corresponding to the user of the computer system from the external computer system; after receiving the first saved user input enrollment information corresponding to the user of the computer system from the external computer system, detecting, via the one or more input devices, input; and in response to detecting the input, performing an operation based on the input, where the operation is performed using the input as interpreted based on the first saved user input enrollment information for the user that was received from the external computer system.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: detecting, via the one or more input devices, a sequence of one or more inputs corresponding to a request to use the computer system in a guest mode of operation, wherein: the guest mode of operation requires user input enrollment information to calibrate the computer system to be controlled using detected inputs that are interpreted based on the user input enrollment information; and the guest mode of operation is not associated with the user of the computer system; in response to detecting the sequence of one or more inputs, initiating a process for operating the computer system in a guest mode of operation for the user of the computer system, wherein, the process for operating the computer system in the guest mode of operation includes outputting, via one or more output devices, a first prompt prompting the user of the computer system to use an external computer system that is separate from the computer system and that is associated with the user of the computer system to provide saved user input enrollment information corresponding to the user of the computer system to calibrate the computer system to be controlled using detected inputs that are interpreted based on the user input enrollment information; after the first prompt has been output, receiving first saved user input enrollment information corresponding to the user of the computer system from the external computer system; after receiving the first saved user input enrollment information corresponding to the user of the computer system from the external computer system, detecting, via the one or more input devices, input; and in response to detecting the input, performing an operation based on the input, where the operation is performed using the input as interpreted based on the first saved user input enrollment information for the user that was received from the external computer system.

In accordance with some embodiments, a computer system is described. The computer system is configured to communicate with one or more display generation components and one or more input devices, and comprises: one or more processors; and memory storing one or more programs configured to be executed by the one or more processors, the one or more programs including instructions for: detecting, via the one or more input devices, a sequence of one or more inputs corresponding to a request to use the computer system in a guest mode of operation, wherein: the guest mode of operation requires user input enrollment information to calibrate the computer system to be controlled using detected inputs that are interpreted based on the user input enrollment information; and the guest mode of operation is not associated with the user of the computer system; in response to detecting the sequence of one or more inputs, initiating a process for operating the computer system in a guest mode of operation for the user of the computer system, wherein, the process for operating the computer system in the guest mode of operation includes outputting, via one or more output devices, a first prompt prompting the user of the computer system to use an external computer system that is separate from the computer system and that is associated with the user of the computer system to provide saved user input enrollment information corresponding to the user of the computer system to calibrate the computer system to be controlled using detected inputs that are interpreted based on the user input enrollment information; after the first prompt has been output, receiving first saved user input enrollment information corresponding to the user of the computer system from the external computer system; after receiving the first saved user input enrollment information corresponding to the user of the computer system from the external computer system, detecting, via the one or more input devices, input; and in response to detecting the input, performing an operation based on the input, where the operation is performed using the input as interpreted based on the first saved user input enrollment information for the user that was received from the external computer system.

In accordance with some embodiments, a computer system is described. The computer system is configured to communicate with one or more display generation components and one or more input devices, and comprises: means for detecting, via the one or more input devices, a sequence of one or more inputs corresponding to a request to use the computer system in a guest mode of operation, wherein: the guest mode of operation requires user input enrollment information to calibrate the computer system to be controlled using detected inputs that are interpreted based on the user input enrollment information; and the guest mode of operation is not associated with the user of the computer system; means for, in response to detecting the sequence of one or more inputs, initiating a process for operating the computer system in a guest mode of operation for the user of the computer system, wherein, the process for operating the computer system in the guest mode of operation includes outputting, via one or more output devices, a first prompt prompting the user of the computer system to use an external computer system that is separate from the computer system and that is associated with the user of the computer system to provide saved user input enrollment information corresponding to the user of the computer system to calibrate the computer system to be controlled using detected inputs that are interpreted based on the user input enrollment information; means for, after the first prompt has been output, receiving first saved user input enrollment information corresponding to the user of the computer system from the external computer system; means for, after receiving the first saved user input enrollment information corresponding to the user of the computer system from the external computer system, detecting, via the one or more input devices, input; and means for, in response to detecting the input, performing an operation based on the input, where the operation is performed using the input as interpreted based on the first saved user input enrollment information for the user that was received from the external computer system.

In accordance with some embodiments, a computer program product is described. The computer program product comprises one or more programs configured to be executed by one or more processors of a computer system that is in communication with one or more display generation components and one or more input devices, the one or more programs including instructions for: detecting, via the one or more input devices, a sequence of one or more inputs corresponding to a request to use the computer system in a guest mode of operation, wherein: the guest mode of operation requires user input enrollment information to calibrate the computer system to be controlled using detected inputs that are interpreted based on the user input enrollment information; and the guest mode of operation is not associated with the user of the computer system; in response to detecting the sequence of one or more inputs, initiating a process for operating the computer system in a guest mode of operation for the user of the computer system, wherein, the process for operating the computer system in the guest mode of operation includes outputting, via one or more output devices, a first prompt prompting the user of the computer system to use an external computer system that is separate from the computer system and that is associated with the user of the computer system to provide saved user input enrollment information corresponding to the user of the computer system to calibrate the computer system to be controlled using detected inputs that are interpreted based on the user input enrollment information; after the first prompt has been output, receiving first saved user input enrollment information corresponding to the user of the computer system from the external computer system; after receiving the first saved user input enrollment information corresponding to the user of the computer system from the external computer system, detecting, via the one or more input devices, input; and in response to detecting the input, performing an operation based on the input, where the operation is performed using the input as interpreted based on the first saved user input enrollment information for the user that was received from the external computer system.

In accordance with some embodiments, a method is described. The method comprises: at a computer system that is in communication with one or more display generation components and one or more input devices: displaying, via the one or more display generation components, a first user interface that is part of a first application, wherein: the first application includes one or more options for managing a wearable device that is separate from the computer system, and displaying the first user interface includes displaying a first set of one or more options for managing input enrollment information corresponding to the wearable device, wherein the input enrollment information is used by the wearable device to process user inputs received by the wearable device; while displaying the first user interface, including displaying the first set of options, detecting, via the one or more input devices, a first set of one or more user inputs directed to one or more of the first set of options; and in response to detecting the first set of one or more user inputs directed to one or more of the first set of options, performing one or more actions with respect to the input enrollment information for the wearable device.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a first user interface that is part of a first application, wherein: the first application includes one or more options for managing a wearable device that is separate from the computer system, and displaying the first user interface includes displaying a first set of one or more options for managing input enrollment information corresponding to the wearable device, wherein the input enrollment information is used by the wearable device to process user inputs received by the wearable device; while displaying the first user interface, including displaying the first set of options, detecting, via the one or more input devices, a first set of one or more user inputs directed to one or more of the first set of options; and in response to detecting the first set of one or more user inputs directed to one or more of the first set of options, performing one or more actions with respect to the input enrollment information for the wearable device.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, a first user interface that is part of a first application, wherein: the first application includes one or more options for managing a wearable device that is separate from the computer system, and displaying the first user interface includes displaying a first set of one or more options for managing input enrollment information corresponding to the wearable device, wherein the input enrollment information is used by the wearable device to process user inputs received by the wearable device; while displaying the first user interface, including displaying the first set of options, detecting, via the one or more input devices, a first set of one or more user inputs directed to one or more of the first set of options; and in response to detecting the first set of one or more user inputs directed to one or more of the first set of options, performing one or more actions with respect to the input enrollment information for the wearable device.

In accordance with some embodiments, a computer system is described. The computer system is configured to communicate with one or more display generation components and one or more input devices. The computer system comprises: one or more processors; and memory storing one or more programs configured to be executed by the one or more processors, the one or more programs including instructions for: displaying, via the one or more display generation components, a first user interface that is part of a first application, wherein: the first application includes one or more options for managing a wearable device that is separate from the computer system, and displaying the first user interface includes displaying a first set of one or more options for managing input enrollment information corresponding to the wearable device, wherein the input enrollment information is used by the wearable device to process user inputs received by the wearable device; while displaying the first user interface, including displaying the first set of options, detecting, via the one or more input devices, a first set of one or more user inputs directed to one or more of the first set of options; and in response to detecting the first set of one or more user inputs directed to one or more of the first set of options, performing one or more actions with respect to the input enrollment information for the wearable device.

In accordance with some embodiments, a computer system is described. The computer system is configured to communicate with one or more display generation components and one or more input devices, and comprises: means displaying, via the one or more display generation components, a first user interface that is part of a first application, wherein: the first application includes one or more options for managing a wearable device that is separate from the computer system, and displaying the first user interface includes displaying a first set of one or more options for managing input enrollment information corresponding to the wearable device, wherein the input enrollment information is used by the wearable device to process user inputs received by the wearable device; means for, while displaying the first user interface, including displaying the first set of options, detecting, via the one or more input devices, a first set of one or more user inputs directed to one or more of the first set of options; and means for, in response to detecting the first set of one or more user inputs directed to one or more of the first set of options, performing one or more actions with respect to the input enrollment information for the wearable device.

In accordance with some embodiments, a computer program product is described. The computer program product comprises one or more programs configured to be executed by one or more processors of a computer system that is in communication with one or more display generation components and one or more input devices, the one or more programs including instructions for: displaying, via the one or more display generation components, a first user interface that is part of a first application, wherein: the first application includes one or more options for managing a wearable device that is separate from the computer system, and displaying the first user interface includes displaying a first set of one or more options for managing input enrollment information corresponding to the wearable device, wherein the input enrollment information is used by the wearable device to process user inputs received by the wearable device; while displaying the first user interface, including displaying the first set of options, detecting, via the one or more input devices, a first set of one or more user inputs directed to one or more of the first set of options; and in response to detecting the first set of one or more user inputs directed to one or more of the first set of options, performing one or more actions with respect to the input enrollment information for the wearable device.

In accordance with some embodiments, a method is described. The method comprises: at a computer system that is in communication with one or more display generation components and one or more input devices: displaying, via the one or more display generation components, a first user interface, wherein displaying the first user interface includes concurrently displaying: a first set of one or more options that correspond to logging into a first user account of the computer system, wherein the first user account corresponds to a first respective user; and instructions for initiating a process for resetting the computer system for use by a new user different from the first respective user; while displaying the first user interface, detecting, via the one or more input devices, a first set of one or more user inputs associated with the first user interface; and in response to detecting the first set of one or more user inputs: in accordance with a determination that the first set of one or more user inputs correspond to the instructions for initiating a process for resetting the computer system for use by a new user different from the first respective user, initiating a process for resetting the computer system for use by a new user.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a first user interface, wherein displaying the first user interface includes concurrently displaying: a first set of one or more options that correspond to logging into a first user account of the computer system, wherein the first user account corresponds to a first respective user; and instructions for initiating a process for resetting the computer system for use by a new user different from the first respective user; while displaying the first user interface, detecting, via the one or more input devices, a first set of one or more user inputs associated with the first user interface; and in response to detecting the first set of one or more user inputs: in accordance with a determination that the first set of one or more user inputs correspond to the instructions for initiating a process for resetting the computer system for use by a new user different from the first respective user, initiating a process for resetting the computer system for use by a new user.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, a first user interface, wherein displaying the first user interface includes concurrently displaying: a first set of one or more options that correspond to logging into a first user account of the computer system, wherein the first user account corresponds to a first respective user; and instructions for initiating a process for resetting the computer system for use by a new user different from the first respective user; while displaying the first user interface, detecting, via the one or more input devices, a first set of one or more user inputs associated with the first user interface; and in response to detecting the first set of one or more user inputs: in accordance with a determination that the first set of one or more user inputs correspond to the instructions for initiating a process for resetting the computer system for use by a new user different from the first respective user, initiating a process for resetting the computer system for use by a new user.

In accordance with some embodiments, a computer system is described. The computer system is configured to communicate with one or more display generation components and one or more input devices. The computer system comprises: one or more processors; and memory storing one or more programs configured to be executed by the one or more processors, the one or more programs including instructions for: displaying, via the one or more display generation components, a first user interface, wherein displaying the first user interface includes concurrently displaying: a first set of one or more options that correspond to logging into a first user account of the computer system, wherein the first user account corresponds to a first respective user; and instructions for initiating a process for resetting the computer system for use by a new user different from the first respective user; while displaying the first user interface, detecting, via the one or more input devices, a first set of one or more user inputs associated with the first user interface; and in response to detecting the first set of one or more user inputs: in accordance with a determination that the first set of one or more user inputs correspond to the instructions for initiating a process for resetting the computer system for use by a new user different from the first respective user, initiating a process for resetting the computer system for use by a new user.

In accordance with some embodiments, a computer system is described. The computer system is configured to communicate with one or more display generation components and one or more input devices, and comprises: means for displaying, via the one or more display generation components, a first user interface, wherein displaying the first user interface includes concurrently displaying: a first set of one or more options that correspond to logging into a first user account of the computer system, wherein the first user account corresponds to a first respective user; and instructions for initiating a process for resetting the computer system for use by a new user different from the first respective user; means for, while displaying the first user interface, detecting, via the one or more input devices, a first set of one or more user inputs associated with the first user interface; and means for, in response to detecting the first set of one or more user inputs: in accordance with a determination that the first set of one or more user inputs correspond to the instructions for initiating a process for resetting the computer system for use by a new user different from the first respective user, initiating a process for resetting the computer system for use by a new user.

In accordance with some embodiments, a computer program product is described. The computer program product comprises one or more programs configured to be executed by one or more processors of a computer system that is in communication with one or more display generation components and one or more input devices, the one or more programs including instructions for: displaying, via the one or more display generation components, a first user interface, wherein displaying the first user interface includes concurrently displaying: a first set of one or more options that correspond to logging into a first user account of the computer system, wherein the first user account corresponds to a first respective user; and instructions for initiating a process for resetting the computer system for use by a new user different from the first respective user; while displaying the first user interface, detecting, via the one or more input devices, a first set of one or more user inputs associated with the first user interface; and in response to detecting the first set of one or more user inputs: in accordance with a determination that the first set of one or more user inputs correspond to the instructions for initiating a process for resetting the computer system for use by a new user different from the first respective user, initiating a process for resetting the computer system for use by a new user.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6A is a flow diagram illustrating a glint-assisted gaze tracking pipeline in accordance with some embodiments.

FIG. 6B illustrates an exemplary diagram of a communication session between electronic devices in accordance with some embodiments.

FIGS. 7A-7AB illustrate example techniques for initiating a guest mode of operation of a computer system, in accordance with some embodiments.

FIG. 8 is a flow diagram of methods of initiating a guest mode of operation of a computer system, in accordance with some embodiments.

FIGS. 9A-9AA illustrate example techniques for initiating a guest mode of operation of a computer system, in accordance with some embodiments.

FIG. 10 is a flow diagram of methods of initiating a guest mode of operation of a computer system, in accordance with some embodiments.

FIG. 11 is a flow diagram of methods of responding to a request to initiate a guest mode of operation on an external computer system, in accordance with some embodiments.

FIGS. 12A-12AN illustrate example techniques for initiating a guest mode of operation of a computer system, in accordance with some embodiments.

FIG. 13 is a flow diagram of methods of initiating a guest mode of operation of a computer system, in accordance with some embodiments.

FIGS. 14A-14R illustrate example techniques for managing a wearable device using a computer system, in accordance with some embodiments.

FIG. 15 is a flow diagram of methods of managing a wearable device using a computer system, in accordance with some embodiments.

FIGS. 16A-16W illustrate example techniques for managing a computer system, in accordance with some embodiments.

FIG. 17 is a flow diagram of methods of managing a computer system, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system allows a guest user to use the computer system using guest enrollment information. When there is saved guest enrollment information available, the computer system allows the guest user to use the computer system using the saved guest enrollment information. When there is not saved guest enrollment information available, the computer system initiates a process for performing input enrollment of the guest user. Allowing a guest user to use saved guest enrollment information allows the guest user to use the computer system with fewer inputs by skipping input enrollment. Enrolling a user when there is not saved guest enrollment information available ensures that user inputs from the guest user are properly received and interpreted, thereby improving the user-device interface and allowing for more efficient use of the computer system.

In some embodiments, a computer system allows a guest user to use the computer system to use the computer system when authorization is received from an external computer system. When authentication of a user fails, the computer system causes a second computer system to output (e.g., display) a request for authorization for the computer system to be operated in a guest mode of operation. If the second computer system provides authorization for the computer system to be operated in the guest mode of operation (e.g., in response to user input and/or user authorization at the second computer system), the computer system is operated in the guest mode of operation. If the second computer system does not provide authorization for the computer system to be operated in the guest mode of operation, the computer system is not operated in the guest mode of operation. Such features improve device security by ensuring that unauthorized users do not use the computer system, and also improves efficiency by allowing an authorized user to authorize use of the computer system from an external computer system.

In some embodiments, a computer system receives an indication of a request to operate a second computer system in a guest mode of operation. The computer system displays a visual indication of the request to initiate the guest mode of operation on the external computer system. Such features improve device security by ensuring that unauthorized users do not use the second computer system, and also improves efficiency by allowing an authorized user to authorize use of the second computer system from a separate device, e.g., the computer system.

In some embodiments, a computer system detects one or more user inputs corresponding to a request to use the computer system in a guest mode of operation. The guest mode of operation requires user input enrollment information to calibrate the computer system to be controlled using detected inputs that are interpreted based on the user input enrollment information. The computer system initiates a process for operating the computer system in the guest mode of operation, including causing output of a first prompt prompting the user to use an external computer system to provide saved user input enrollment information. The computer system receives saved user input enrollment information from an external computer system, and processes inputs based on the saved user input enrollment information received from the external computer system. Allowing a guest user to import saved user input enrollment information from an external device allows the guest user to use the computer system with fewer inputs by skipping input enrollment.

In some embodiments, a computer system displays a first user interface that is part of a first application. In some embodiments, the first application includes one or more options for managing a wearable device that is separate from the computer system. In some embodiments, the first user interface includes a first set of one or more options for managing input enrollment information corresponding to the wearable device, wherein the input enrollment information is used by the wearable device to process user inputs received by the wearable device. While displaying the first user interface, the computer system detects a first set of one or more user inputs directed to the first set of one or more options. In response to detecting the first set of one or more user inputs, the computer system performs one or more actions with respect to the input enrollment information for the wearable device.

In some embodiments, a computer system displays a first user interface that includes one or more options for managing a wearable device that is separate from the computer system. In some embodiments, displaying the first user interface includes displaying a first set of one or more options for managing input enrollment information that is used by the wearable device to process user inputs received by the wearable device. While displaying the first user interface, the computer system detects one or more user inputs directed to the first set of one or more options, and in response to detecting the one or more user inputs, the computer system performs one or more actions with respect to the input enrollment information for the wearable device.

In some embodiments, a computer system displays a first user interface that includes concurrent display of a first set of one or more options that correspond to logging into a first user account of the computer system, wherein the first user account corresponds to a first respective user; and instructions for initiating a process for resetting the computer system for use by a new user different from the first respective user. In some embodiments, while displaying the first user interface, the computer system detects a first set of one or more user inputs associated with the first user interface. In some embodiments, in response to detecting the first set of one or more user inputs: in accordance with a determination that the first set of one or more user inputs correspond to the instructions for initiating a process for resetting the computer system for use by a new user different from the first respective user, the computer system initiates a process for resetting the computer system for use by a new user.

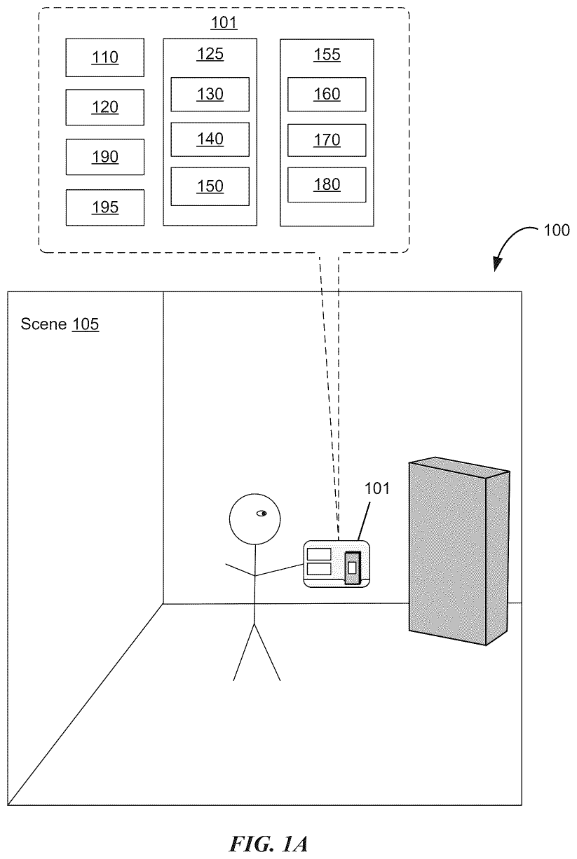

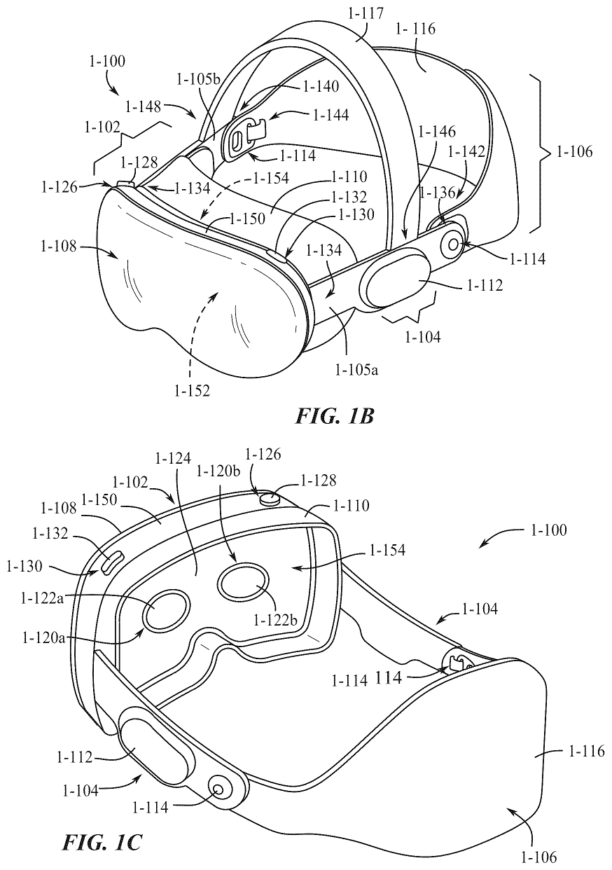

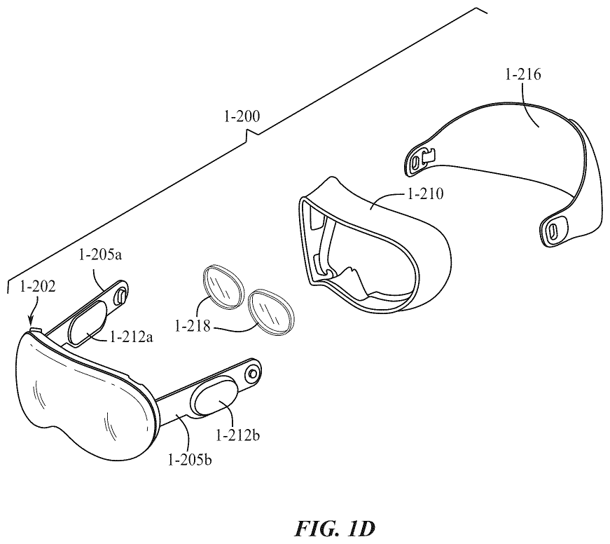

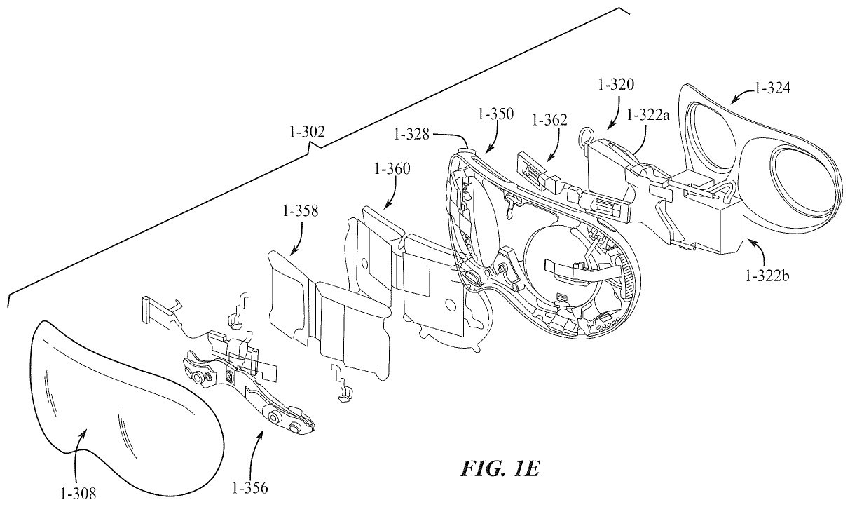

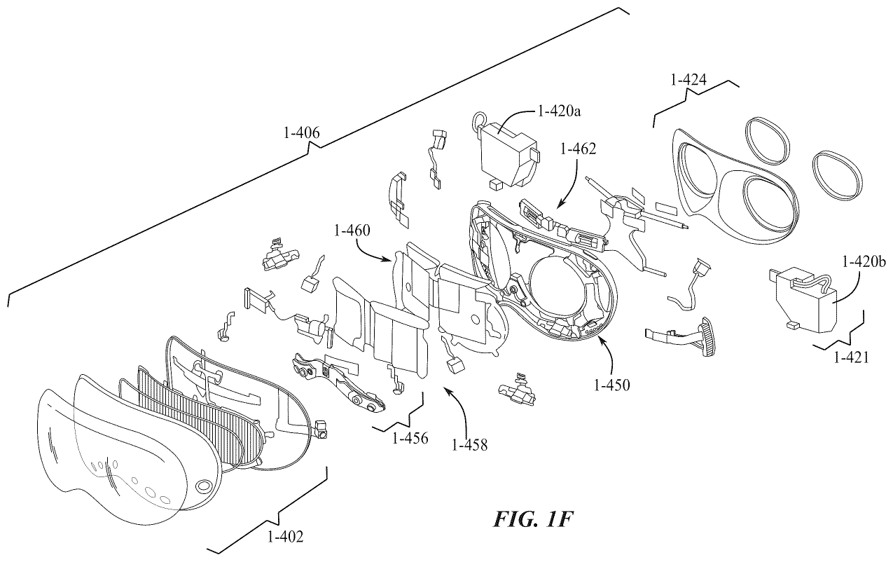

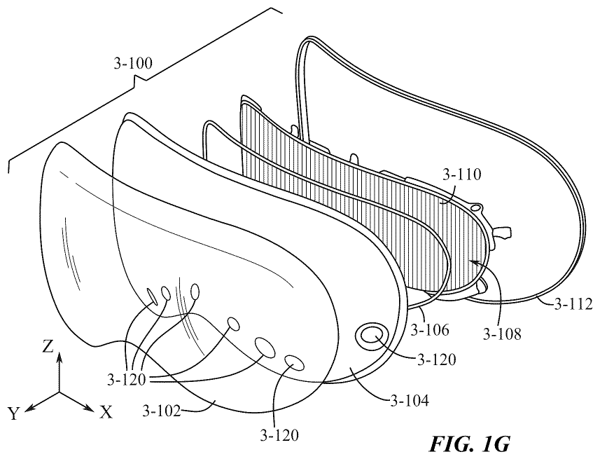

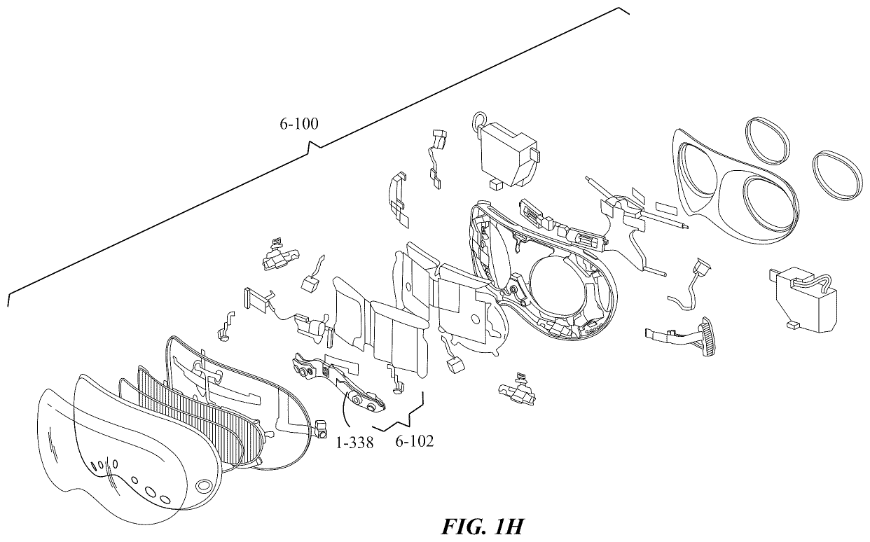

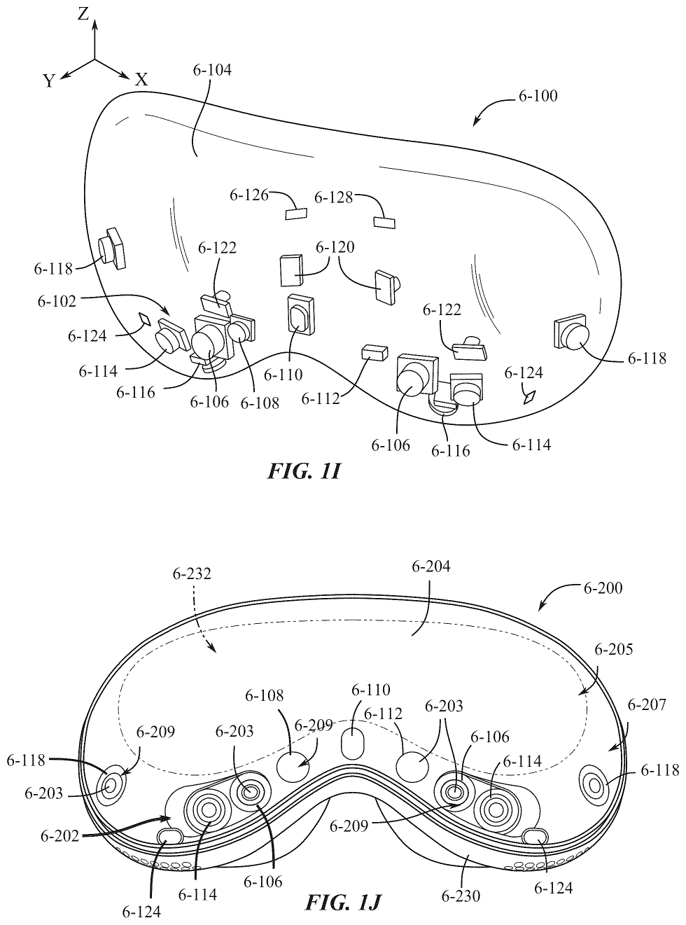

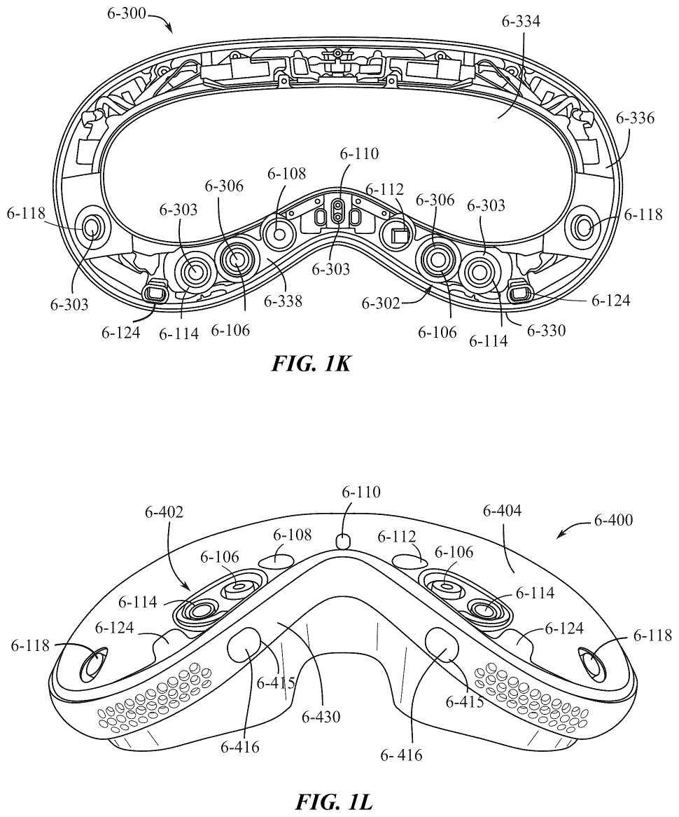

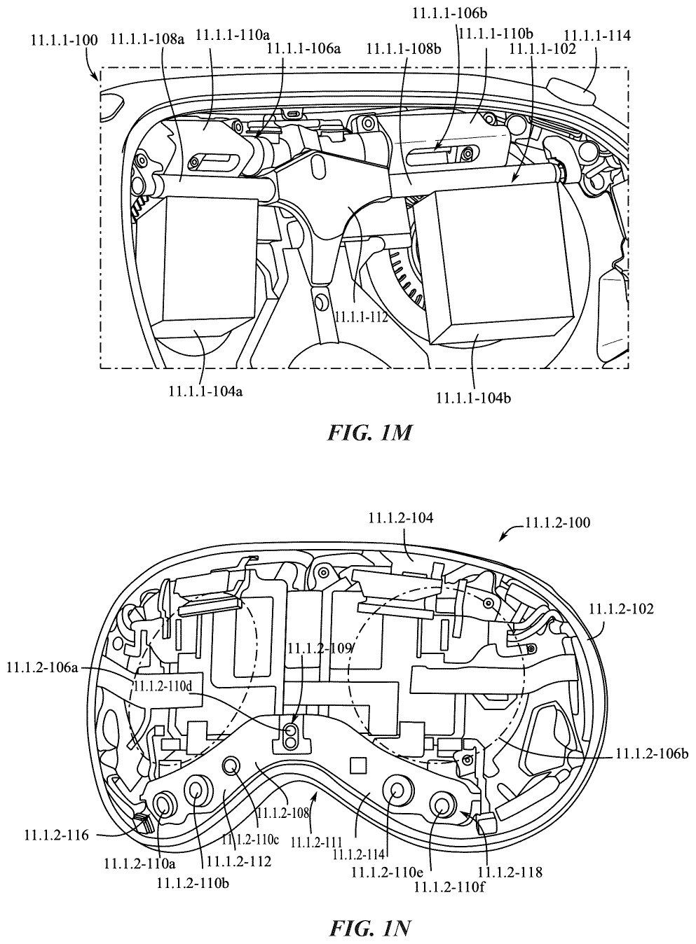

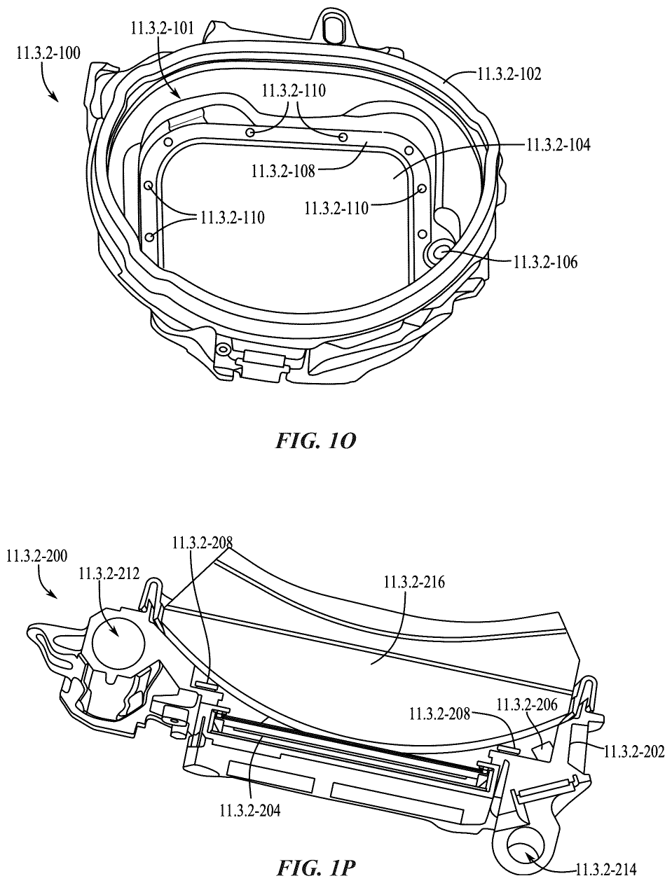

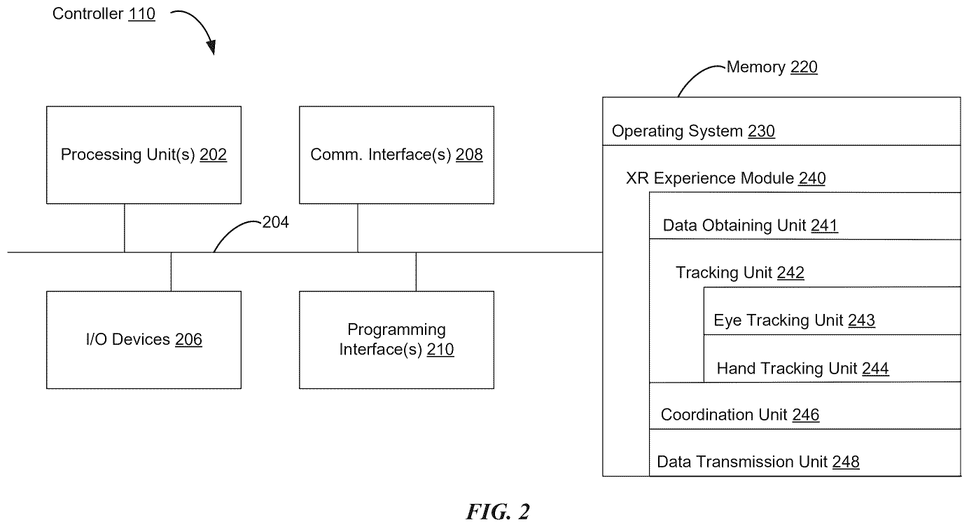

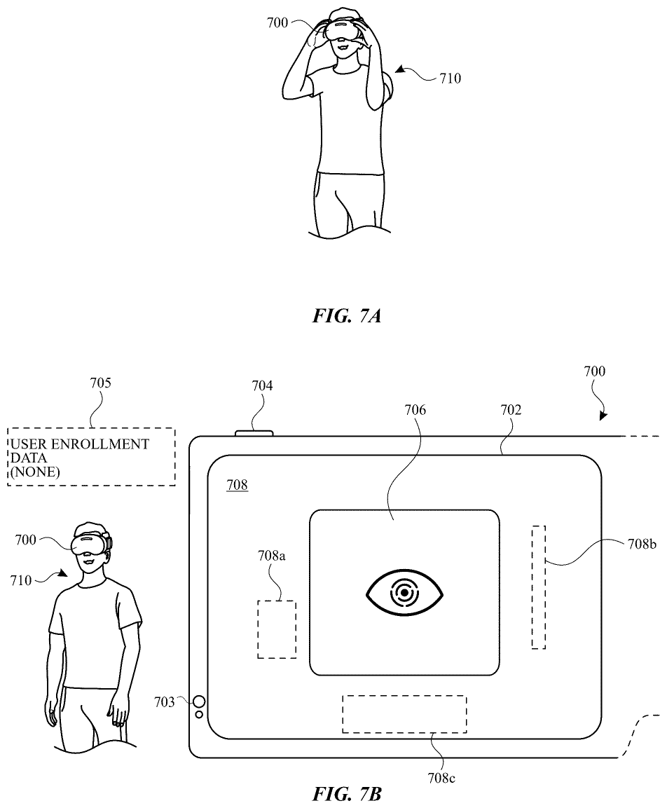

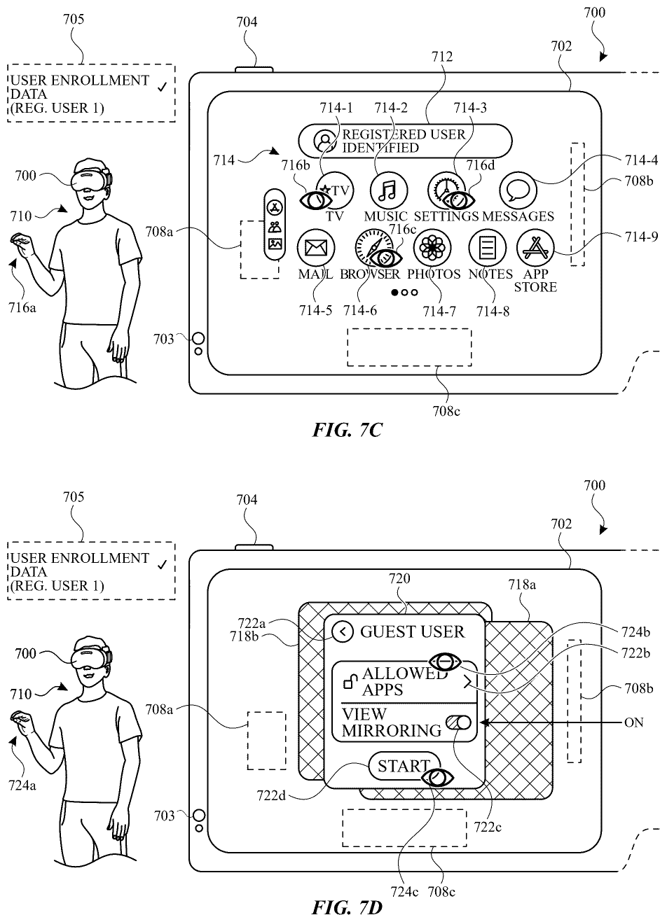

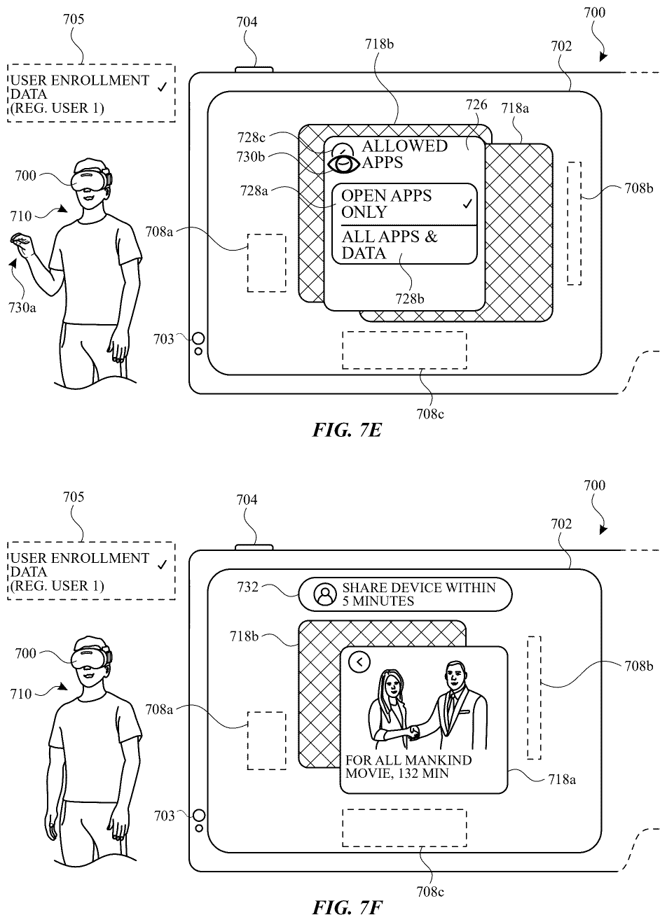

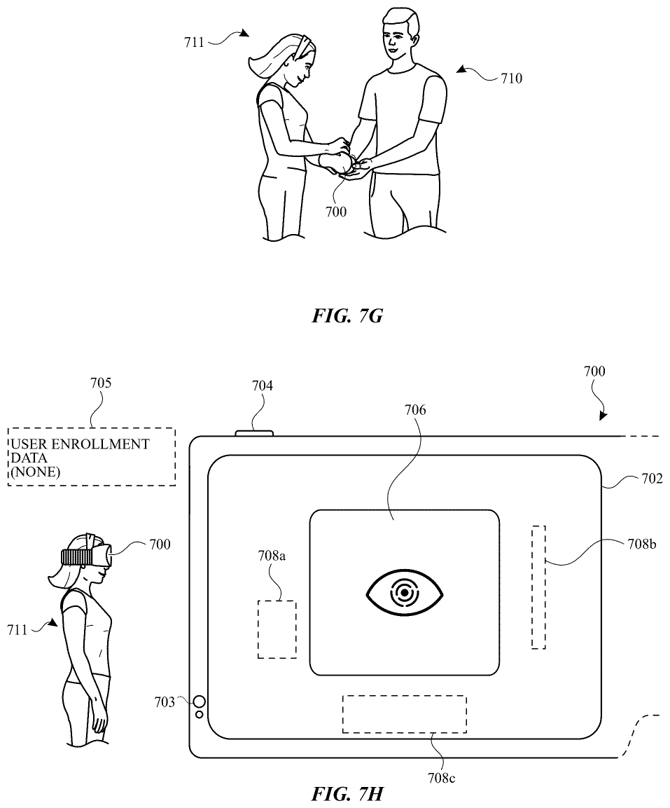

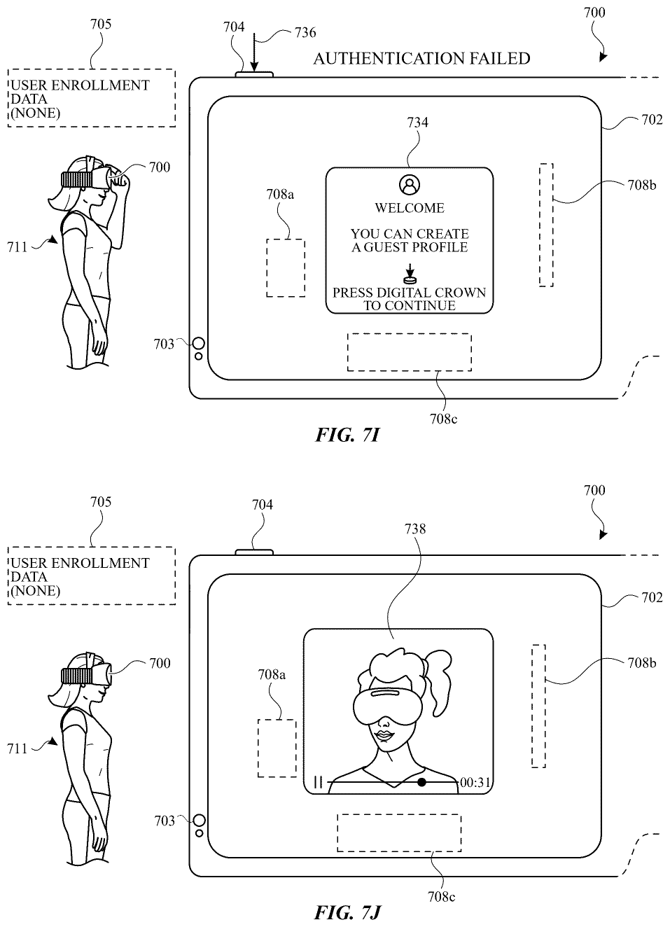

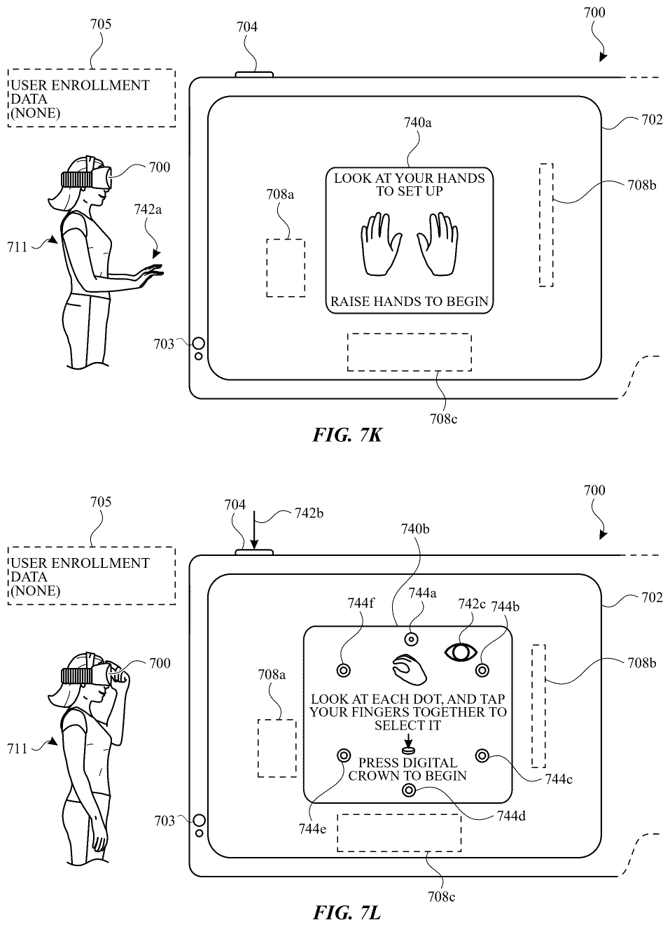

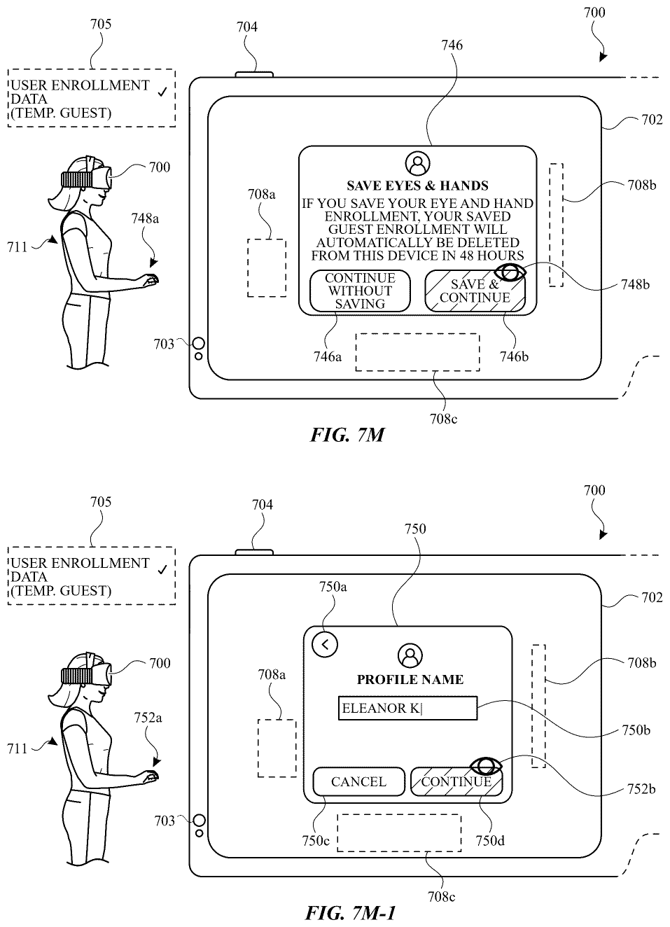

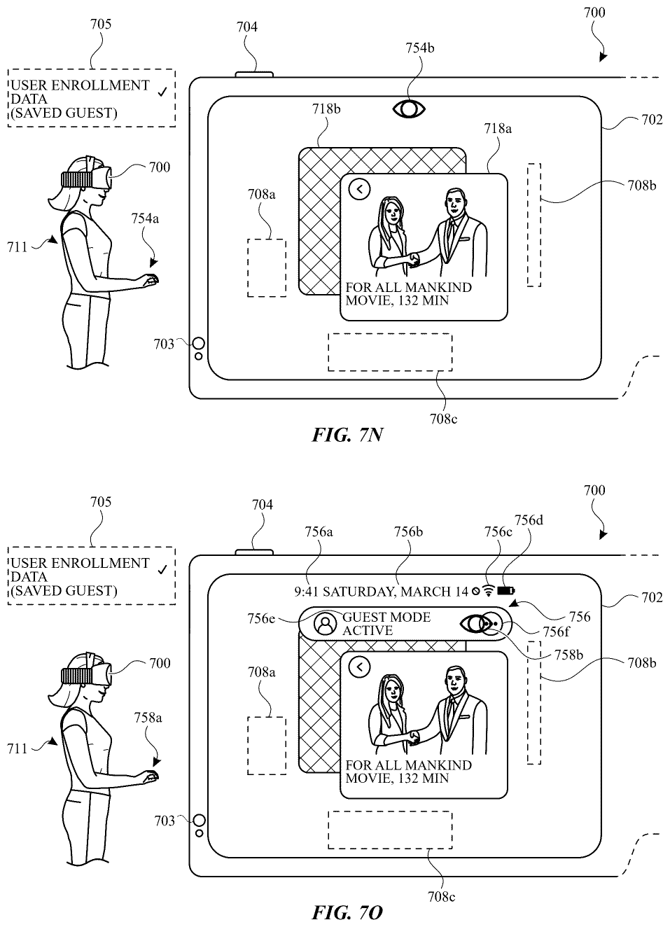

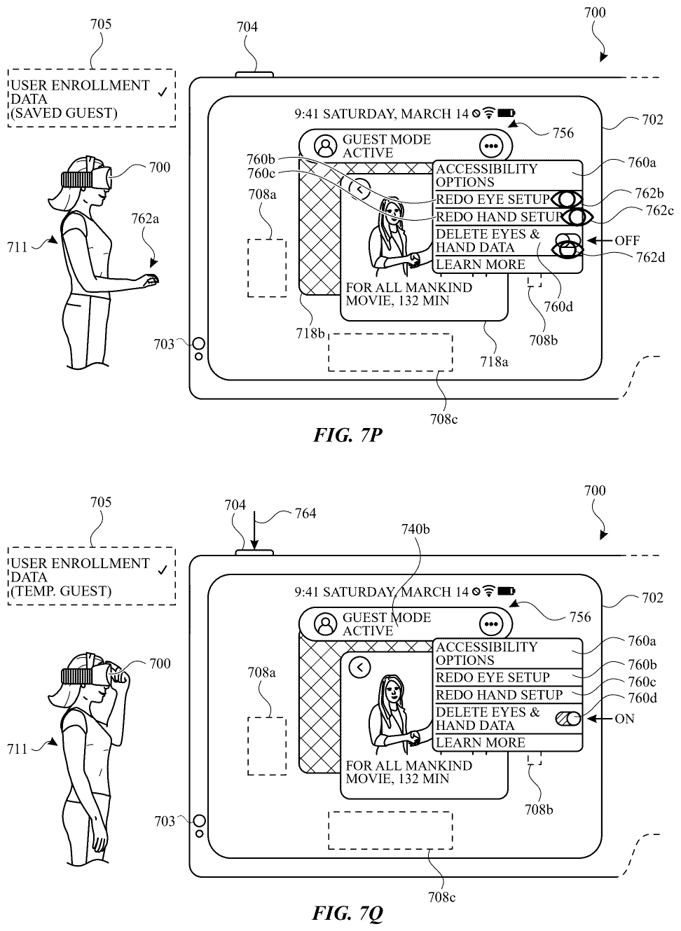

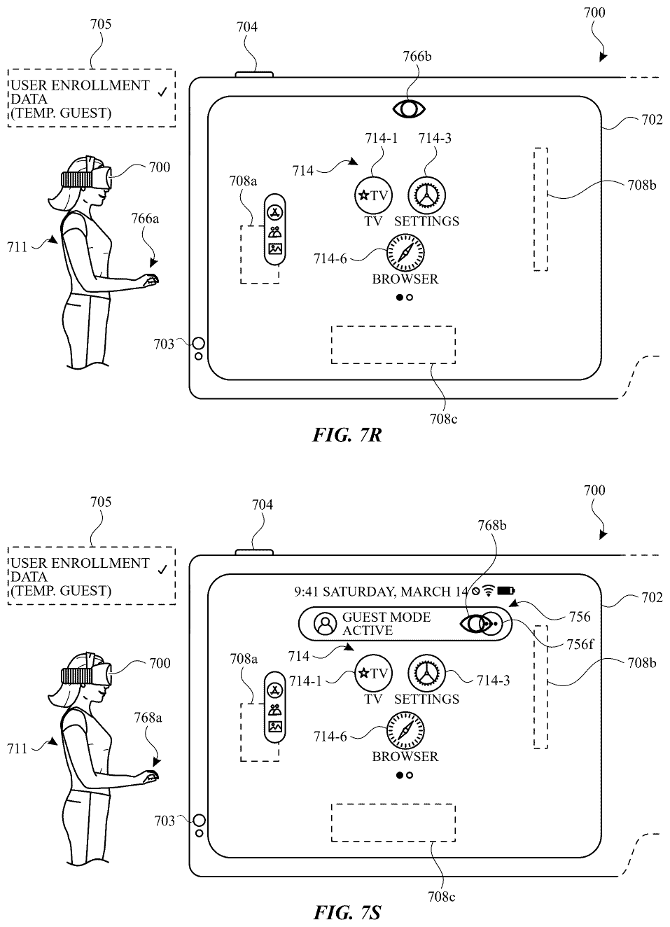

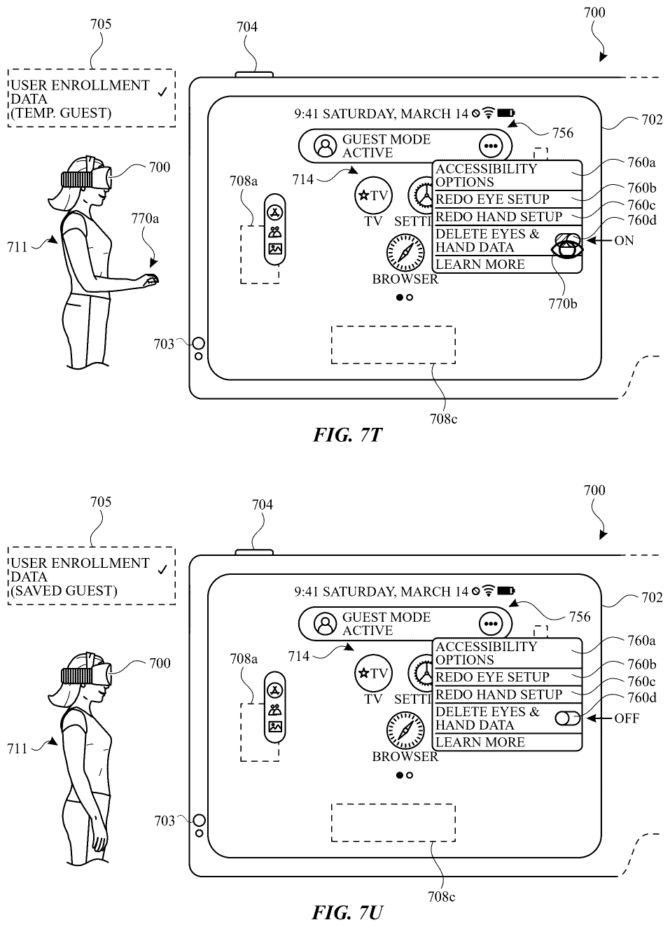

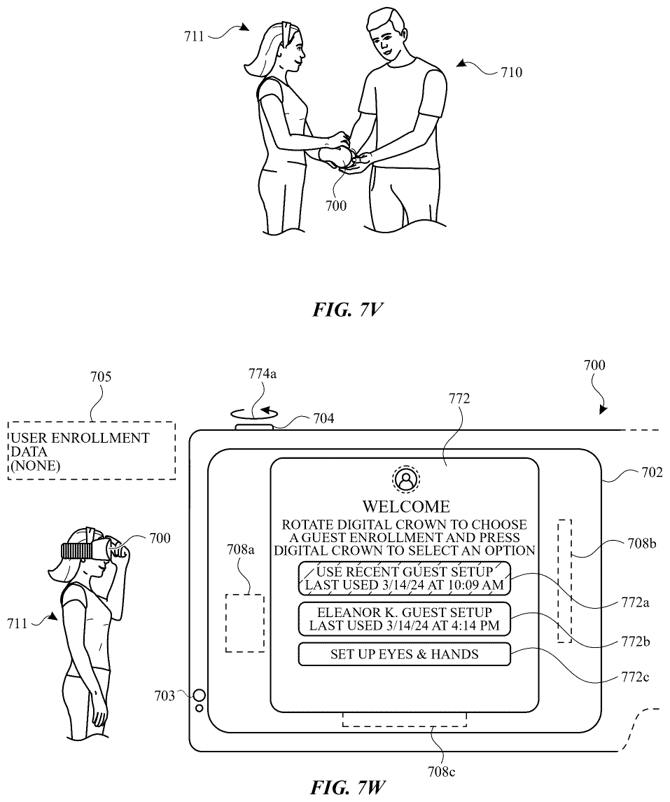

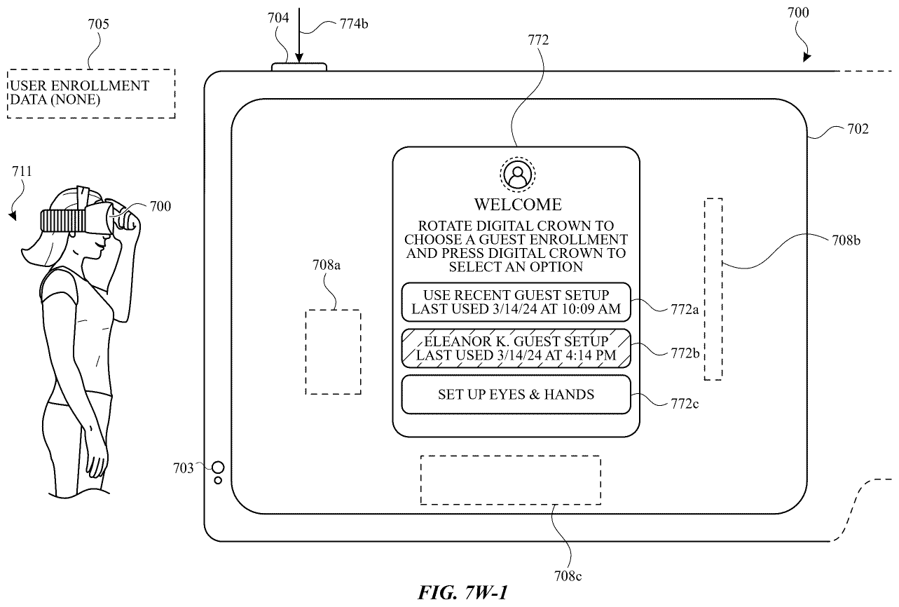

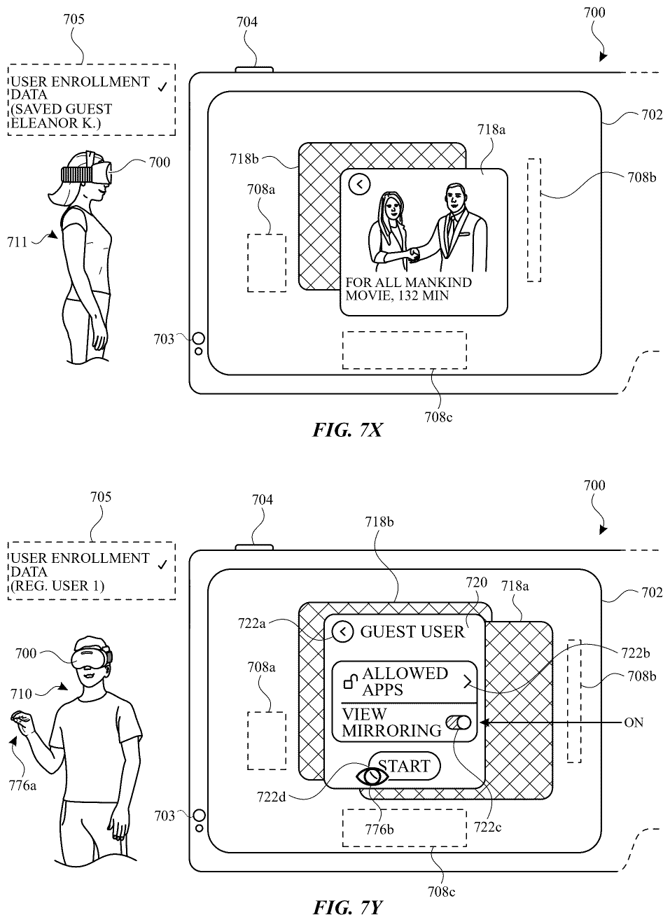

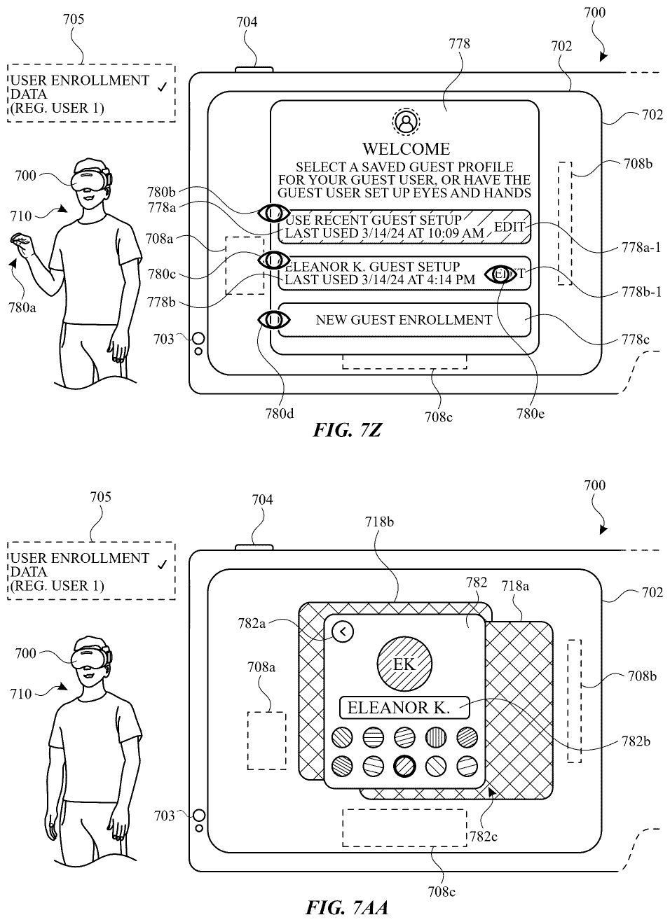

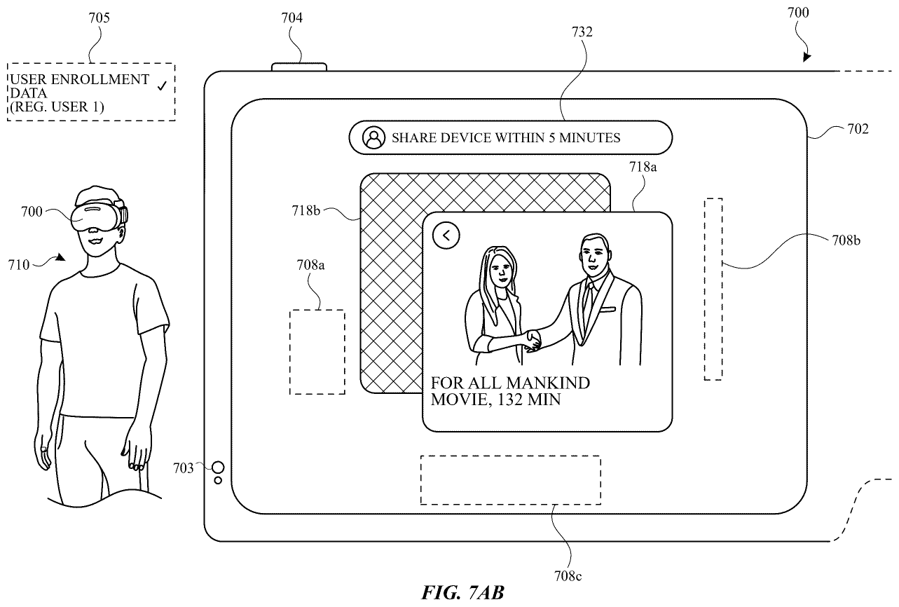

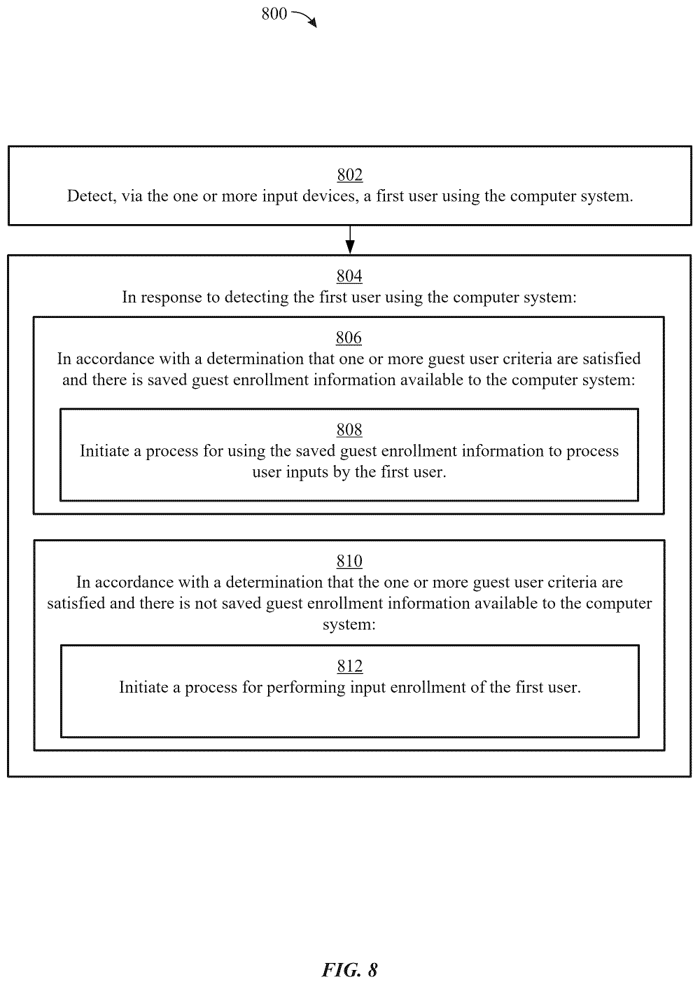

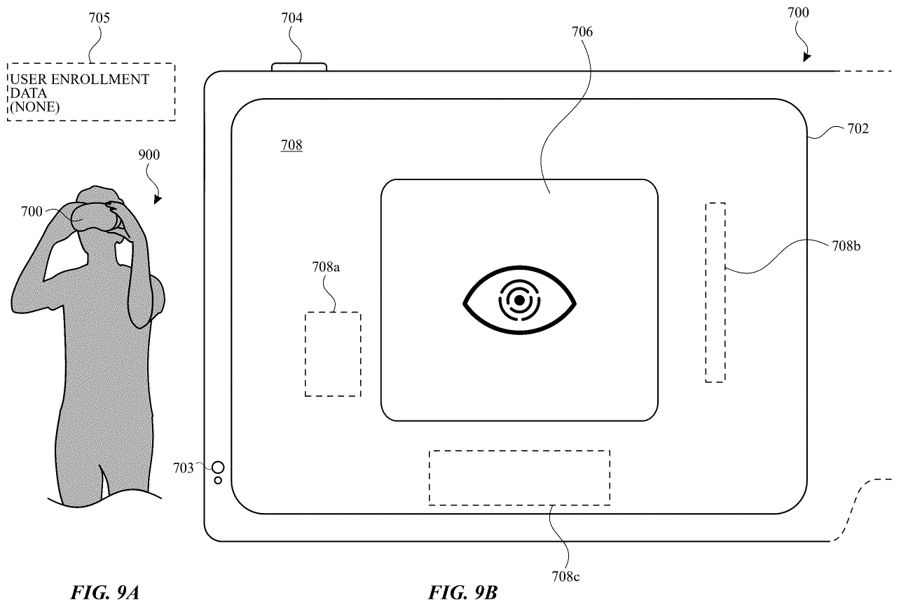

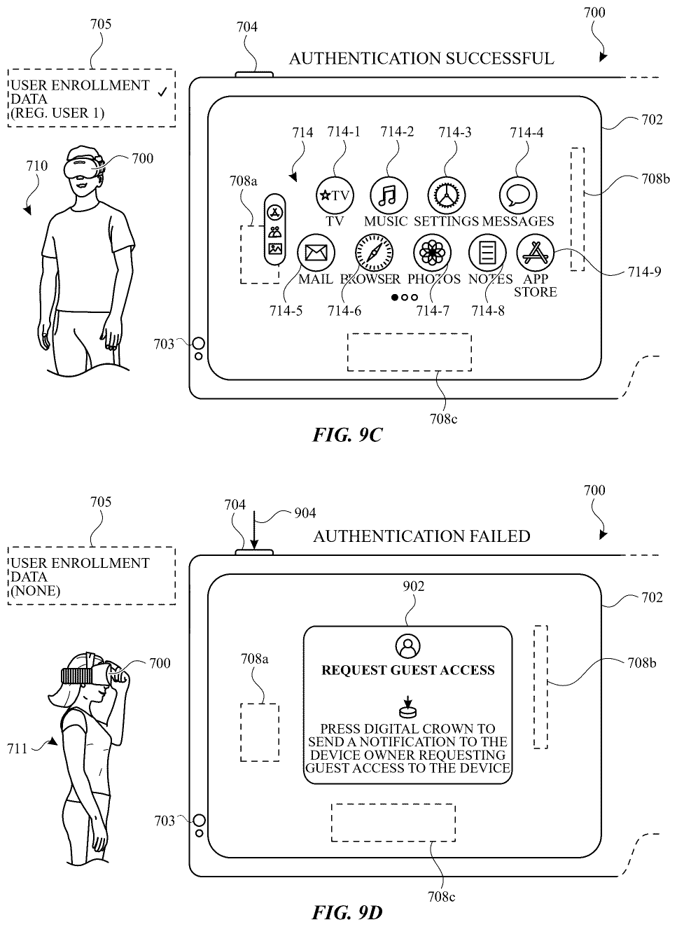

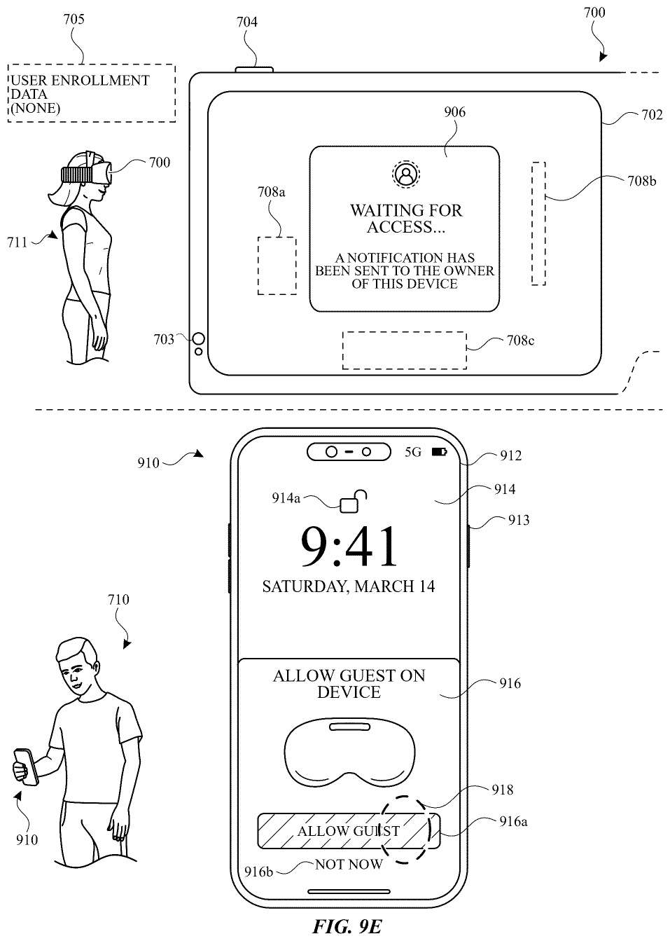

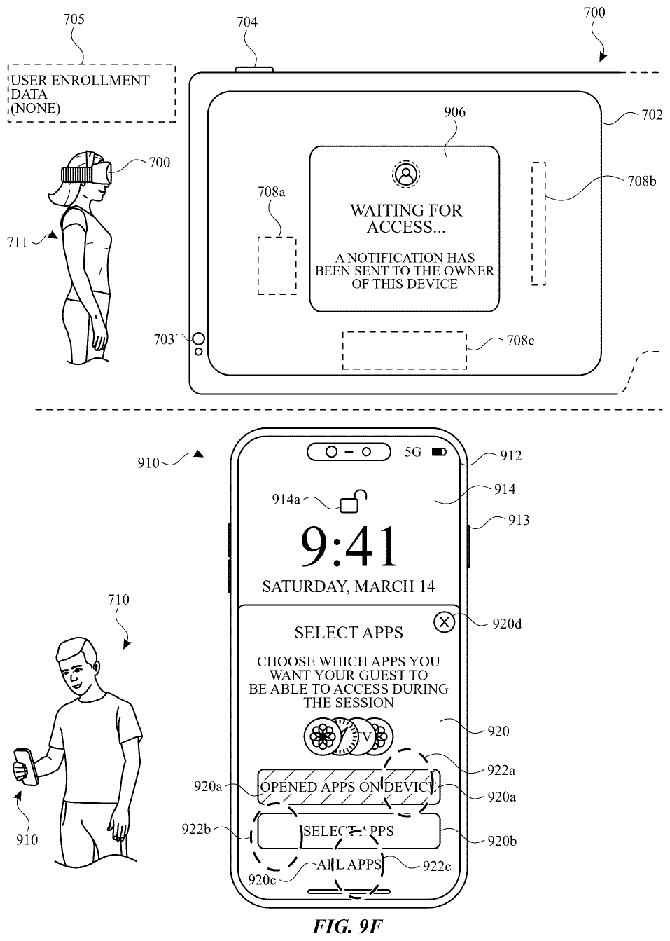

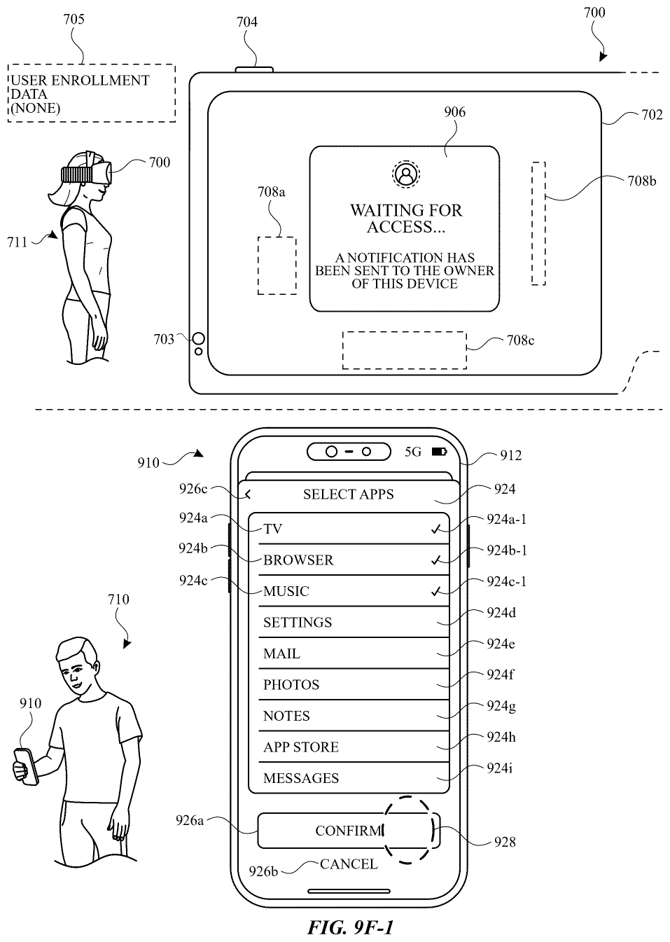

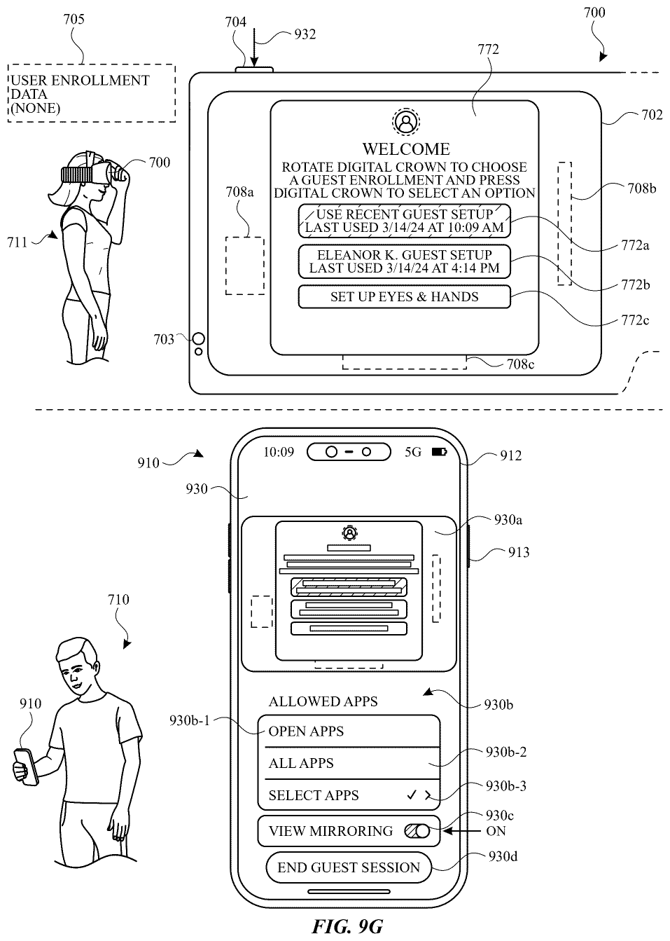

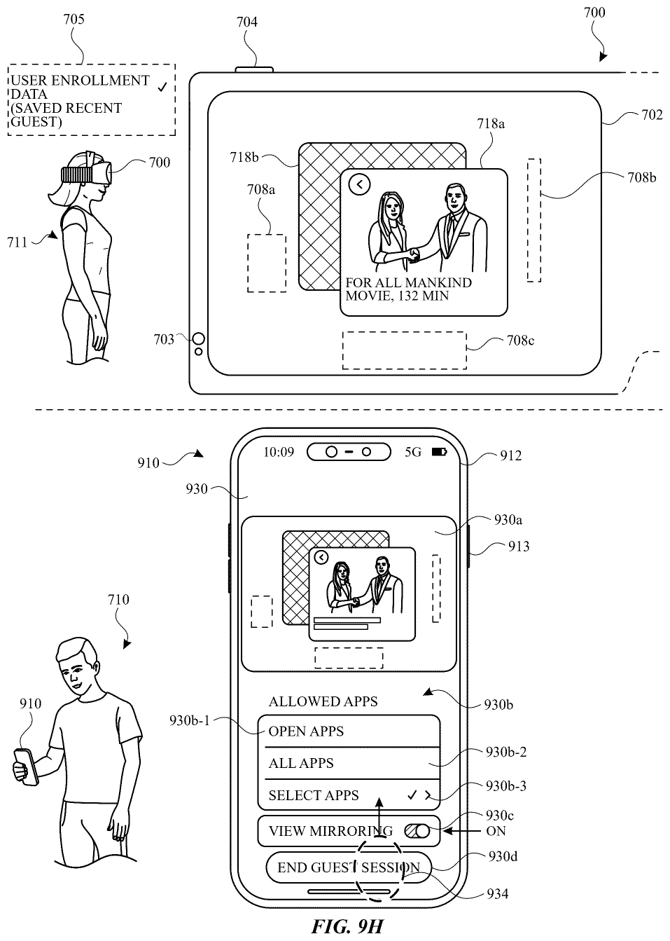

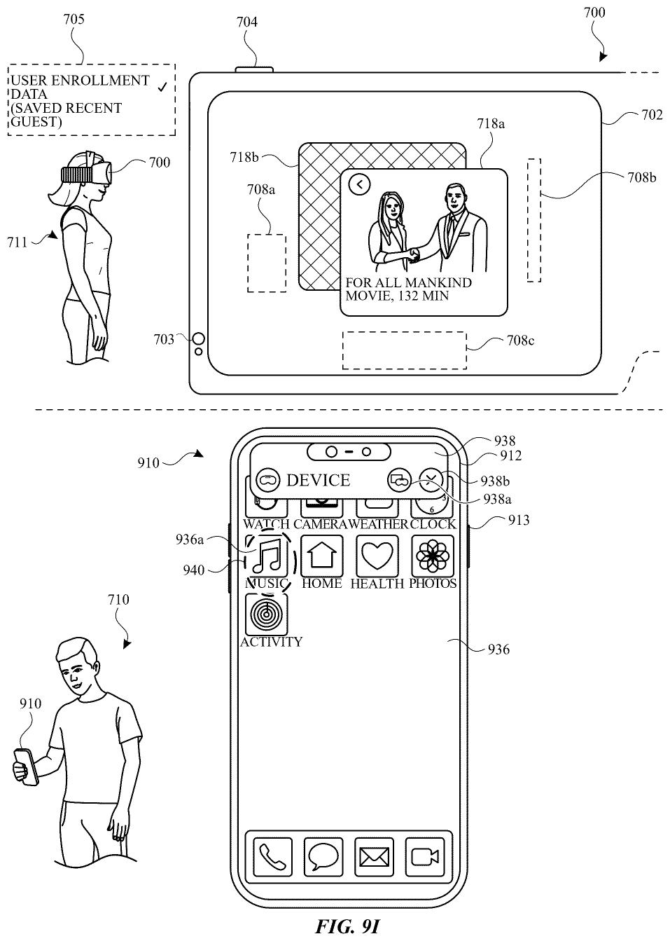

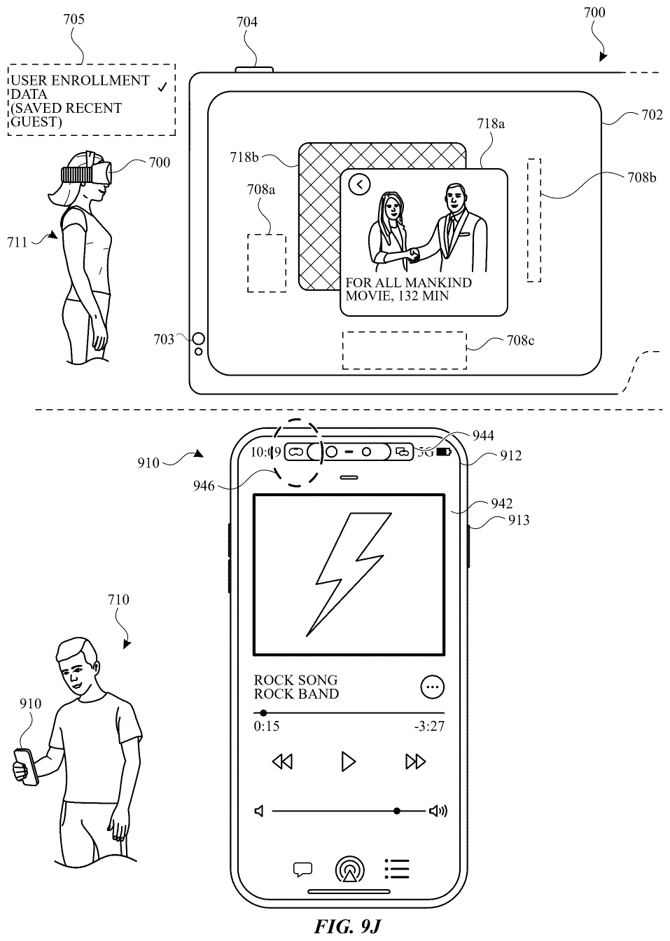

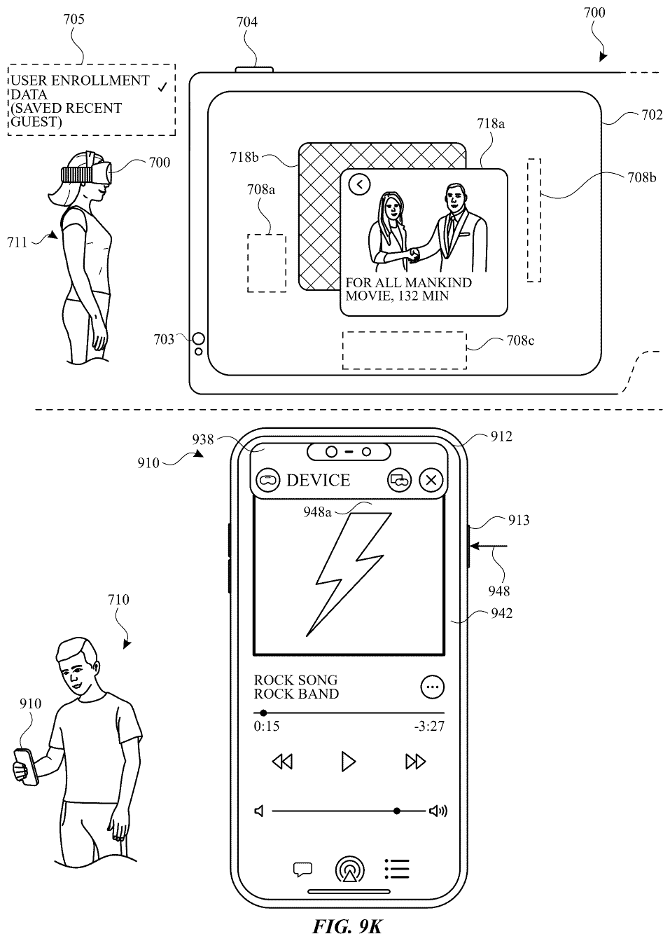

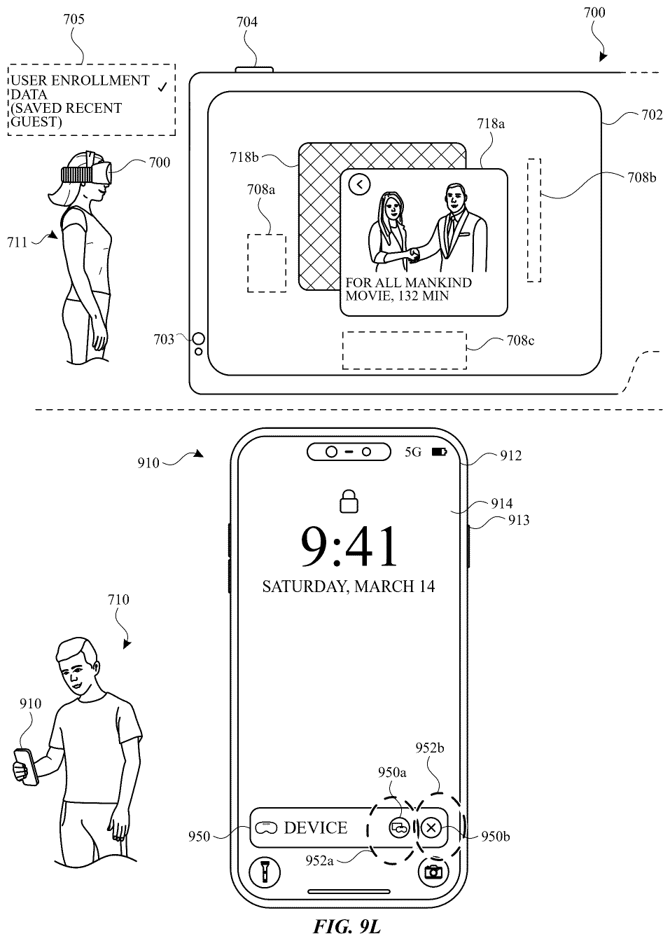

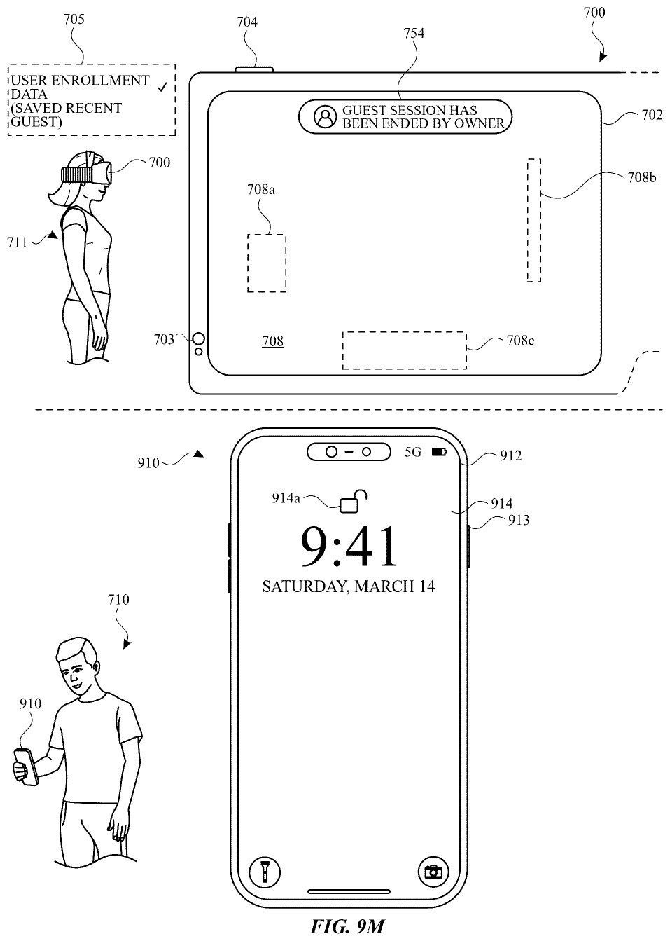

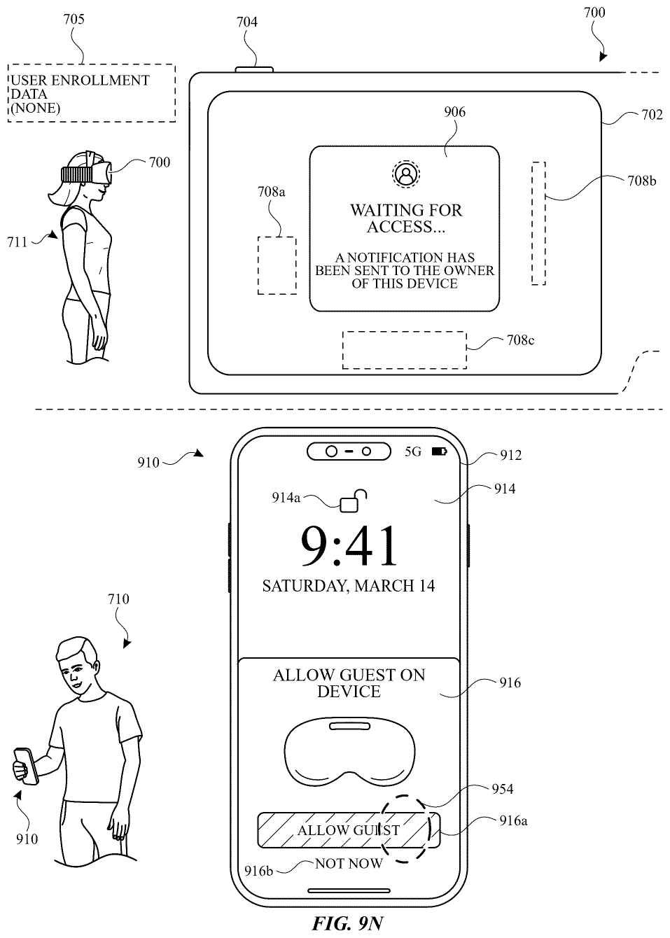

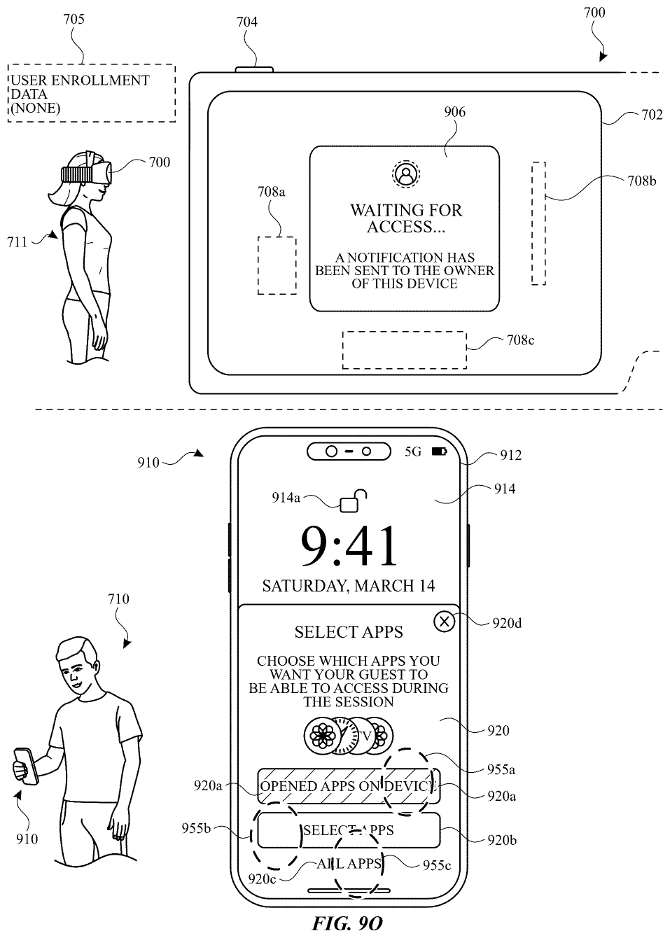

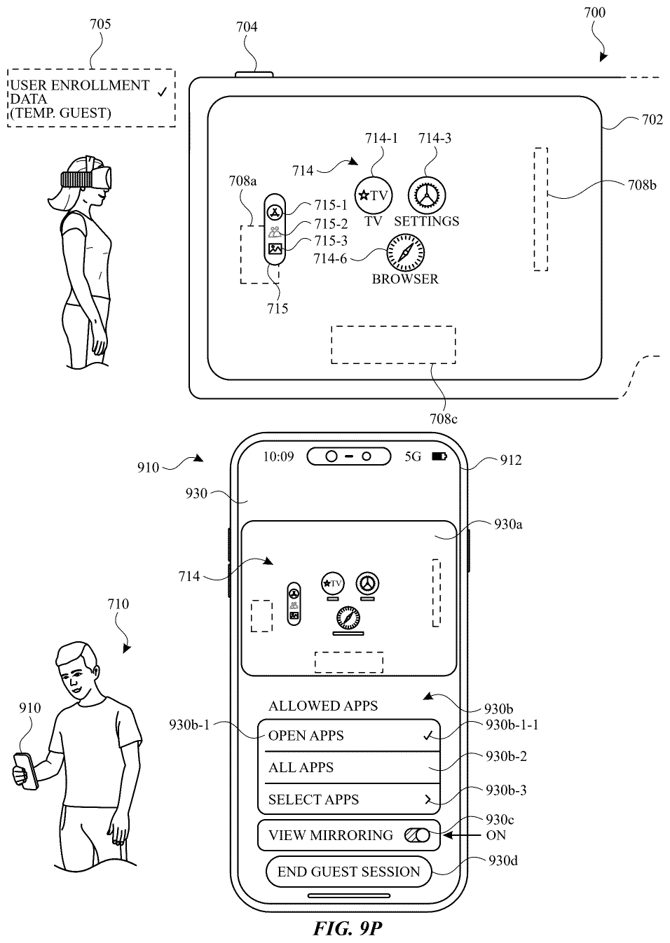

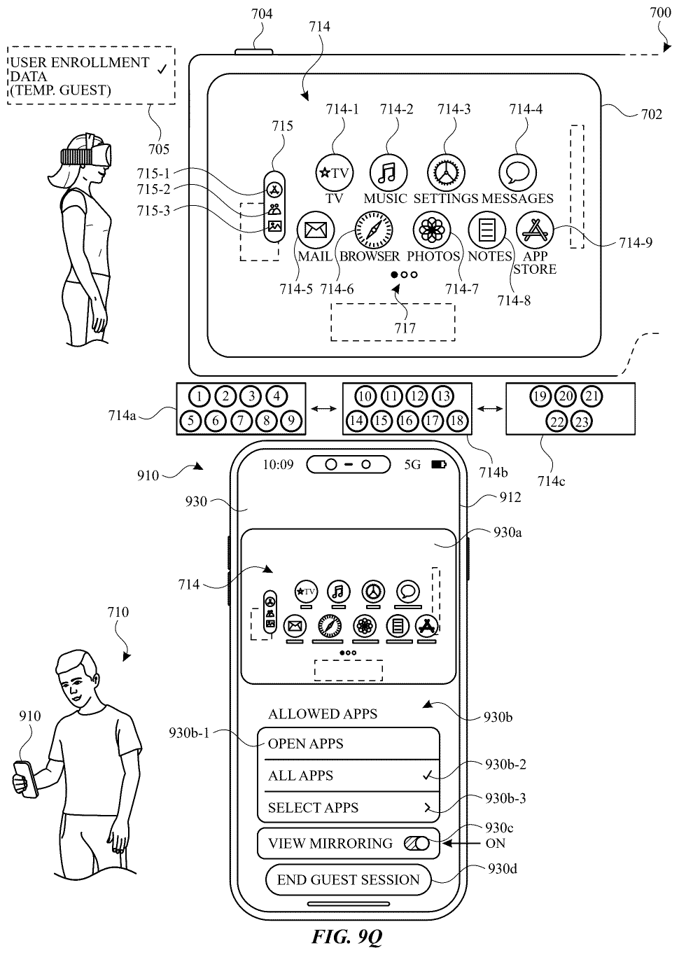

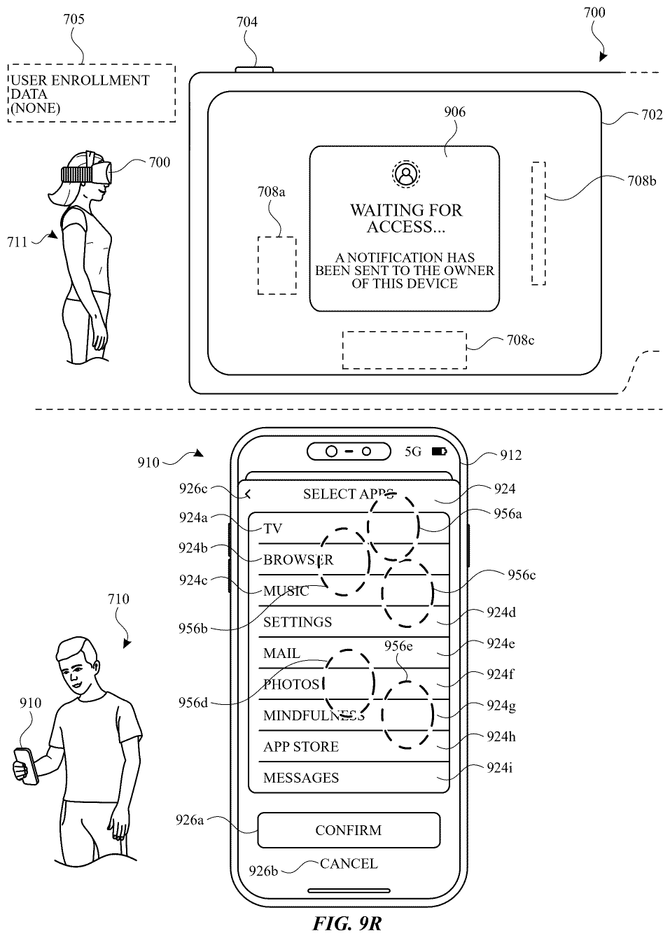

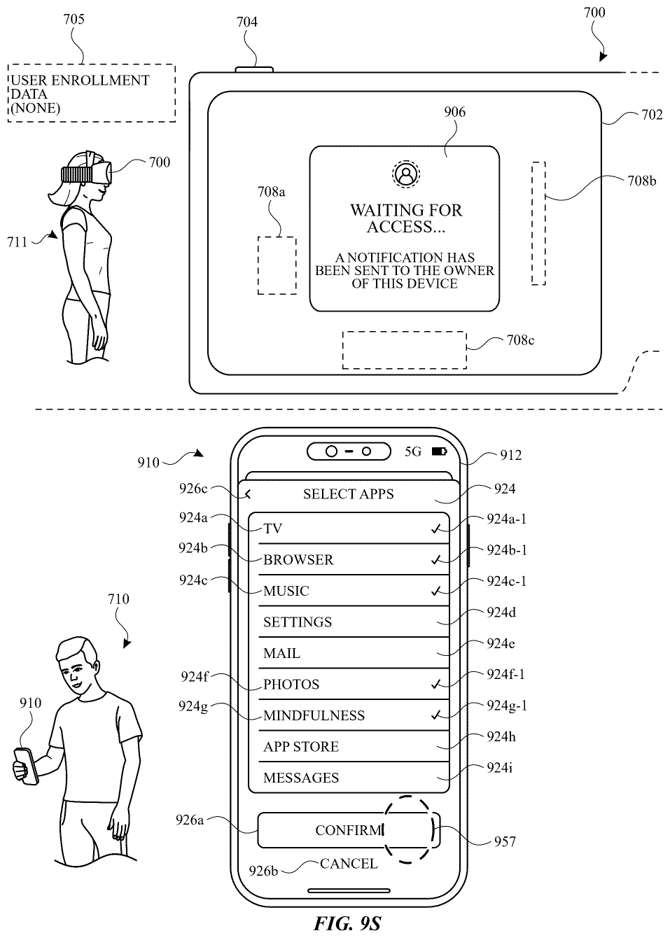

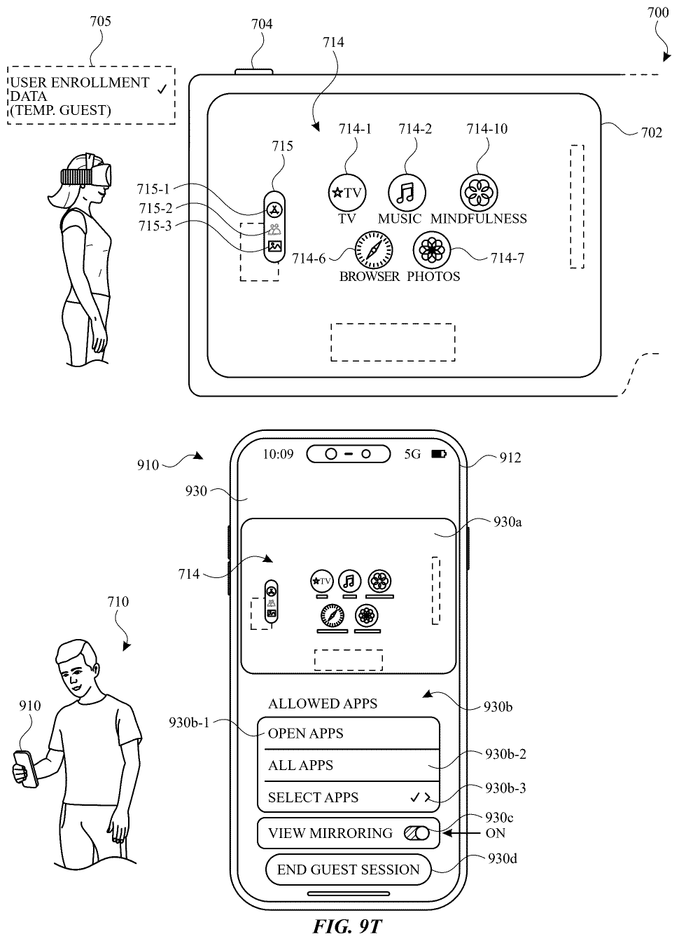

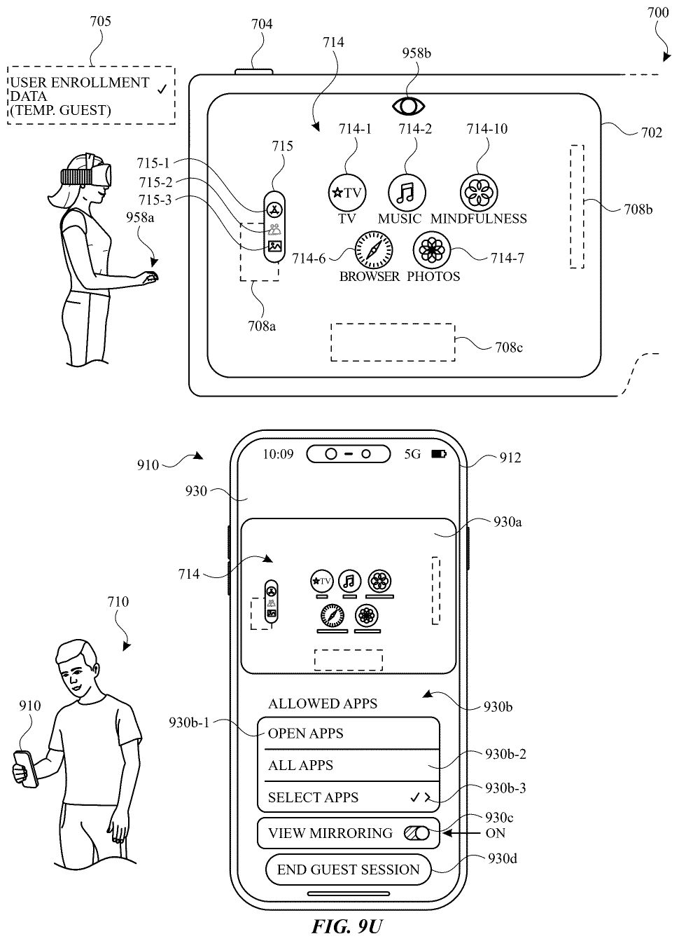

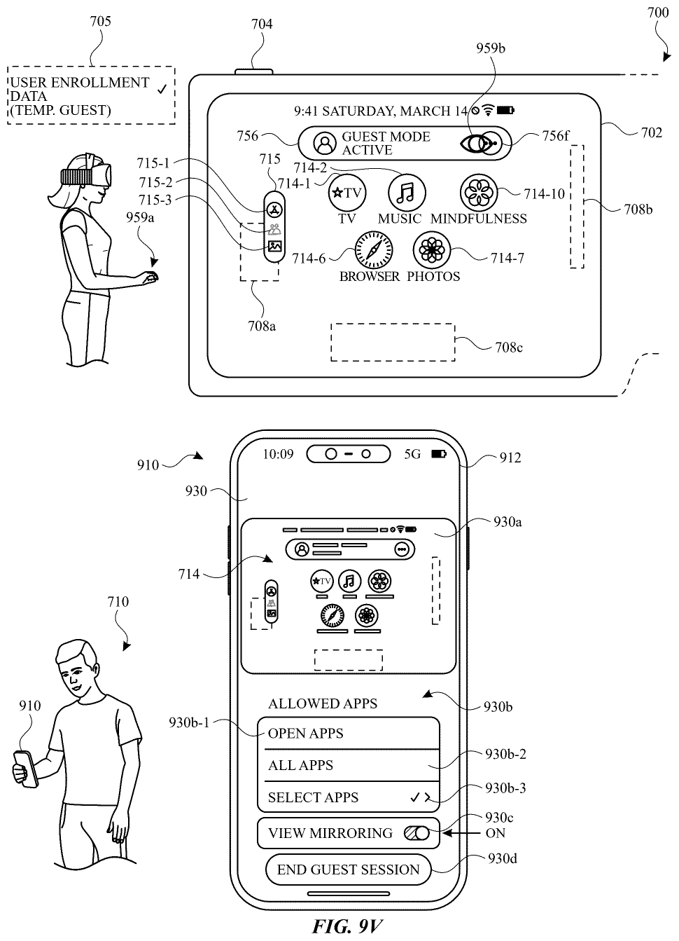

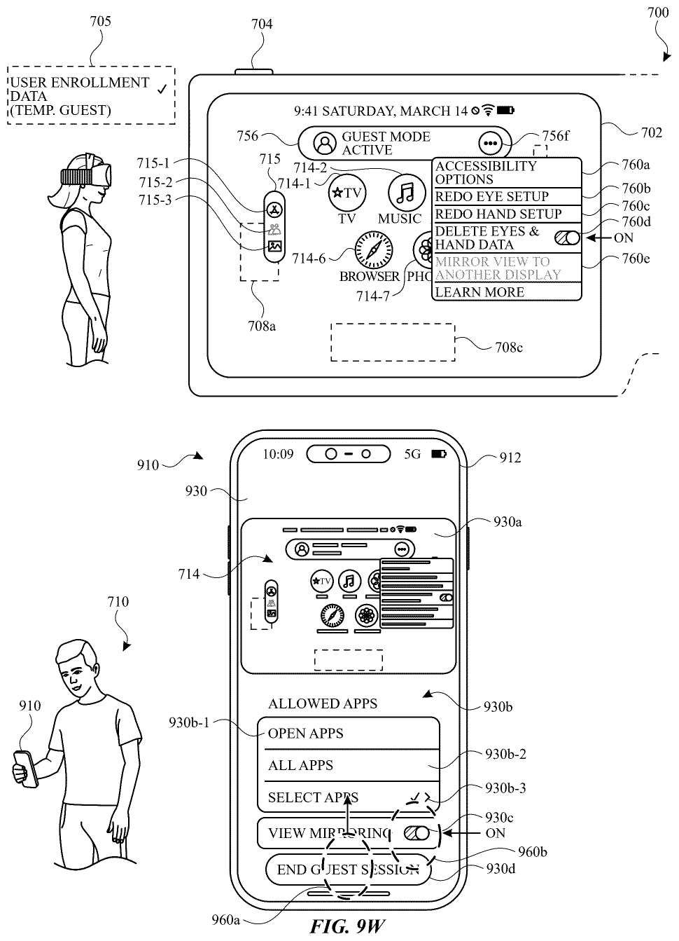

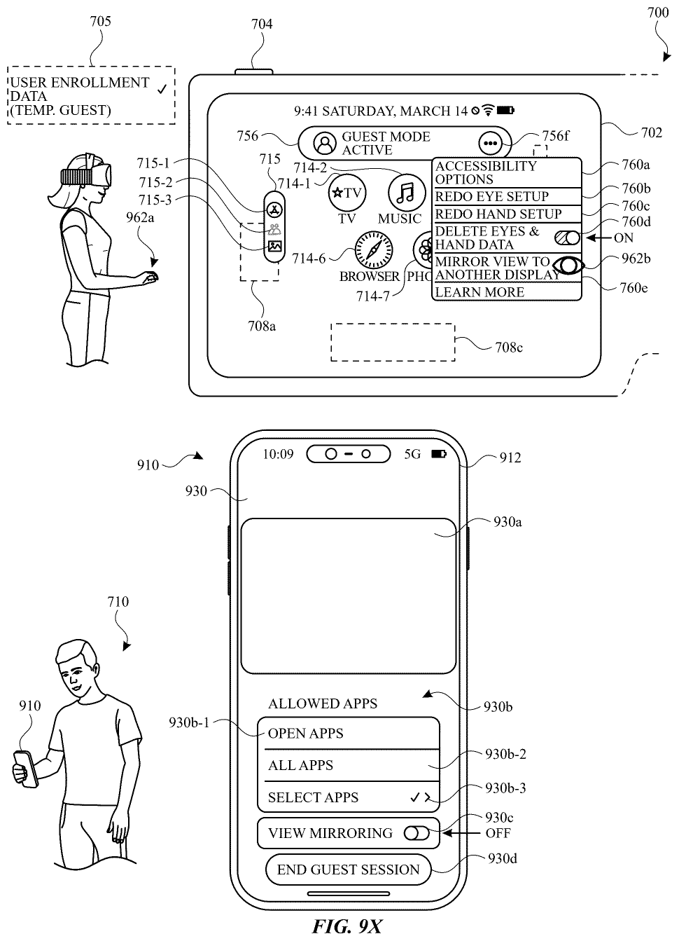

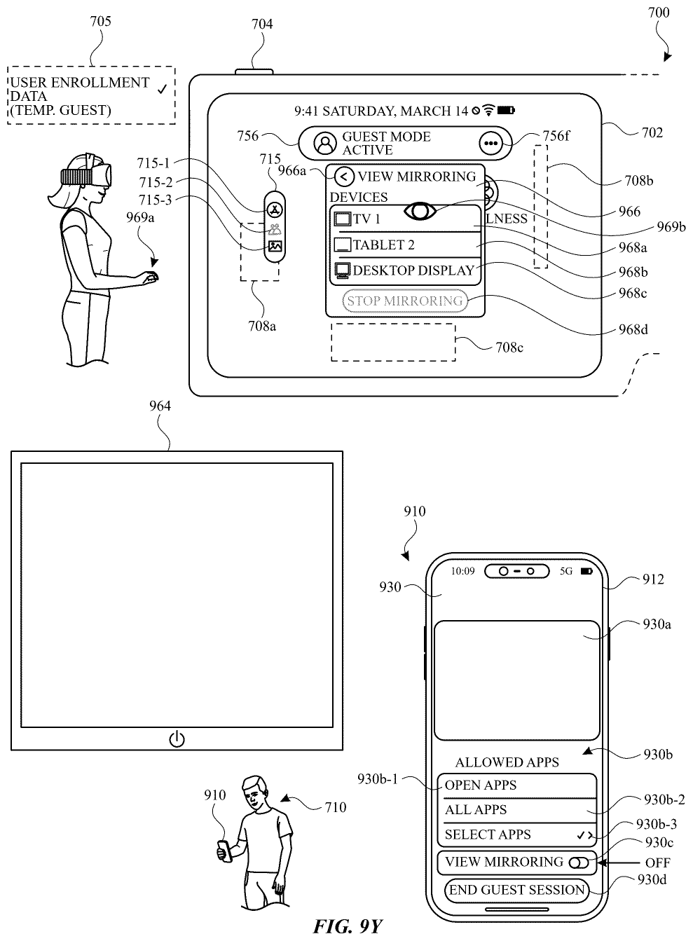

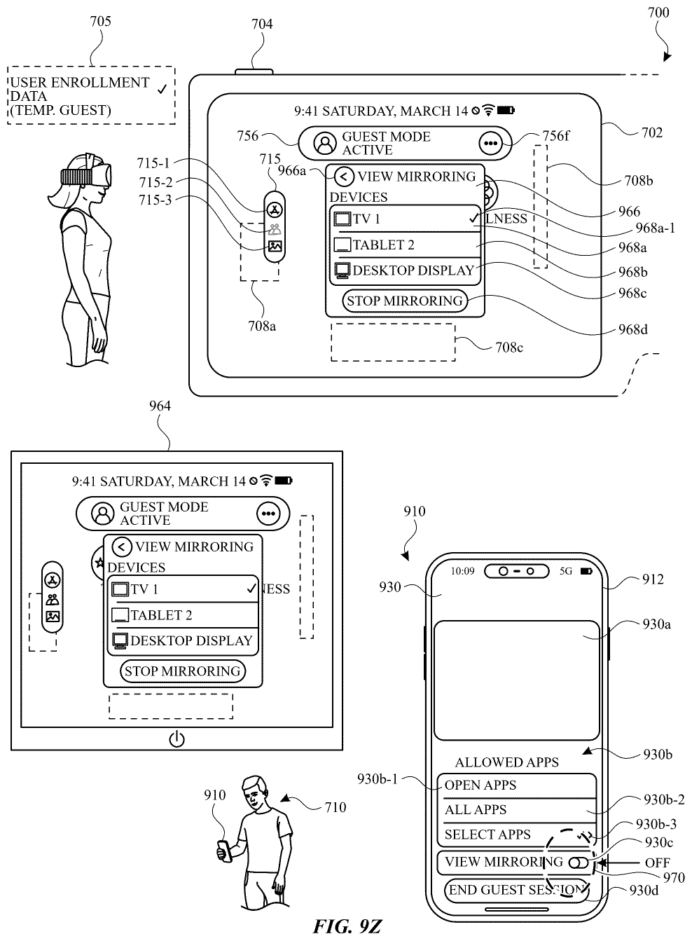

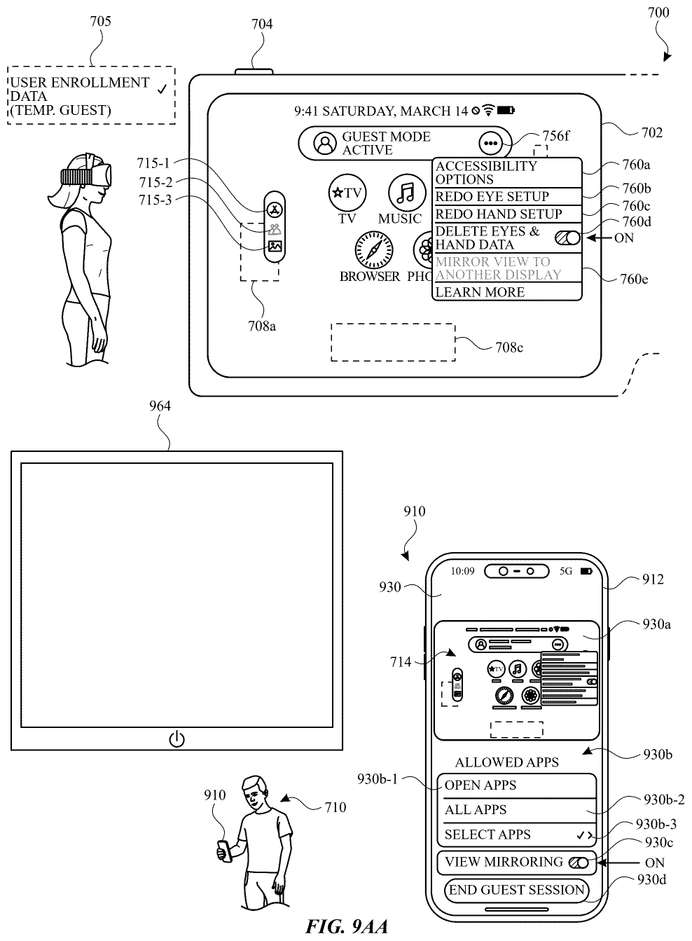

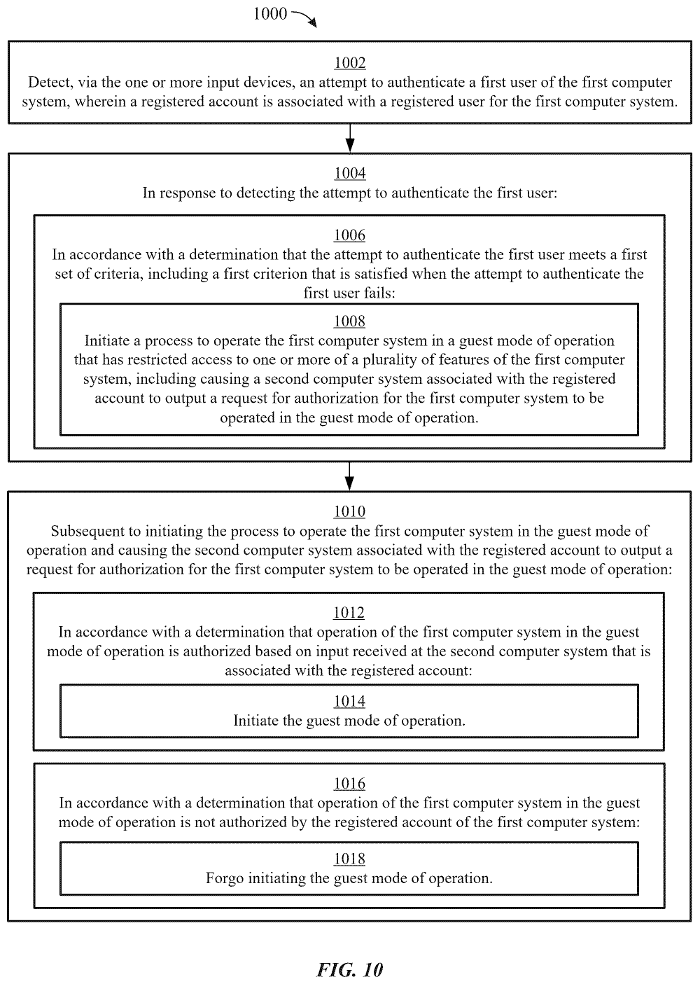

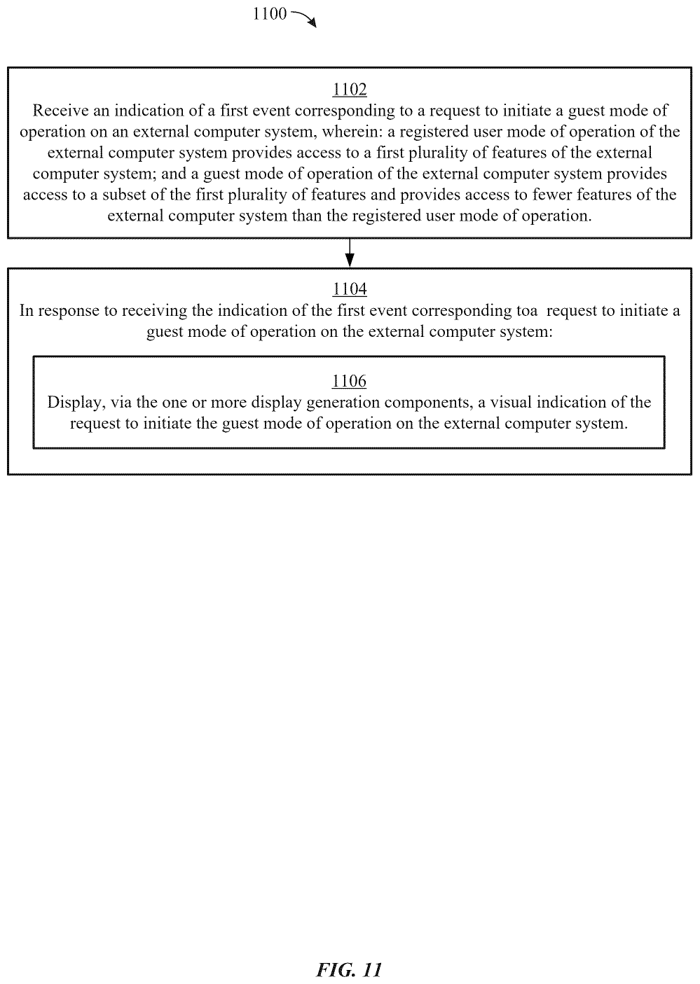

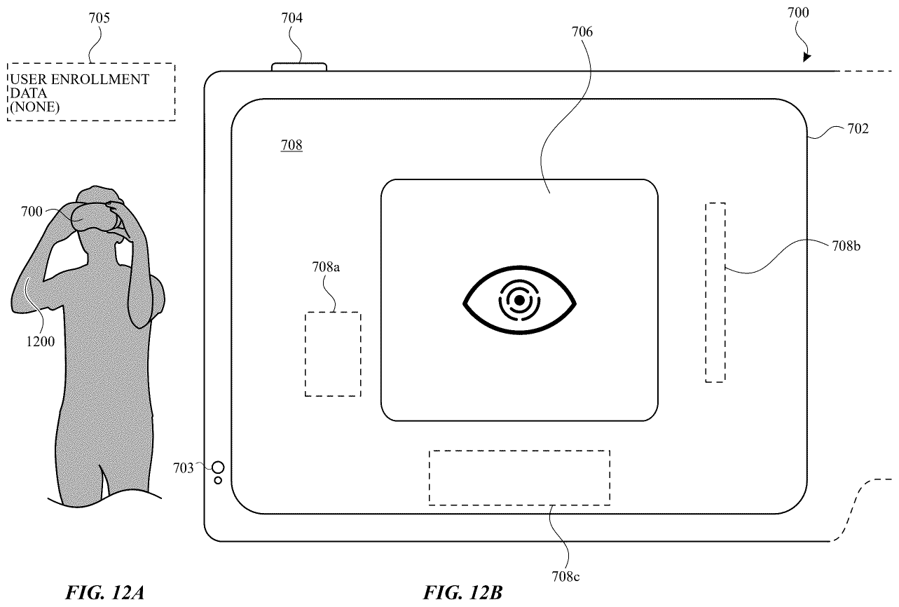

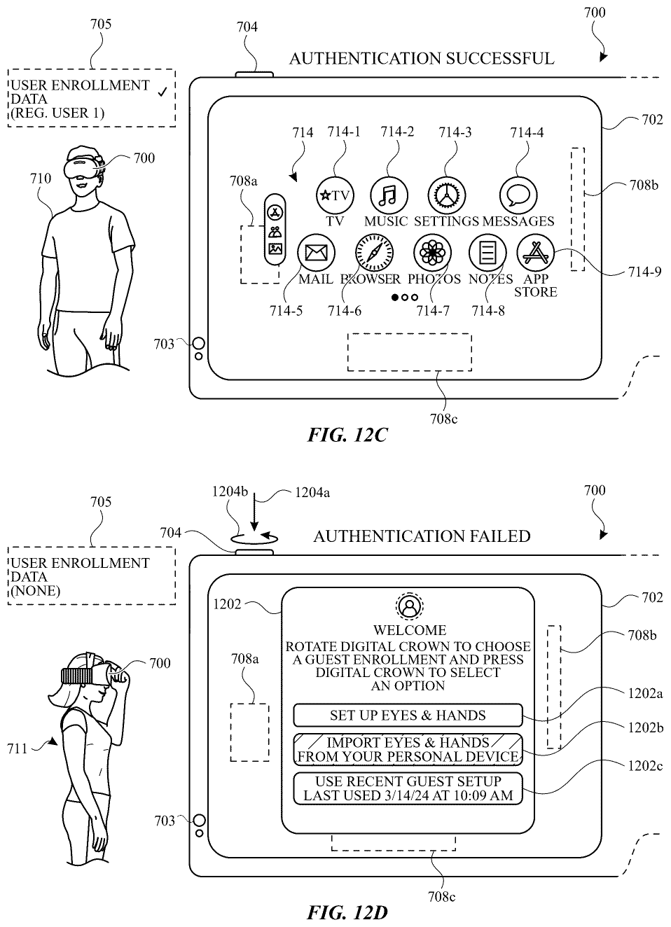

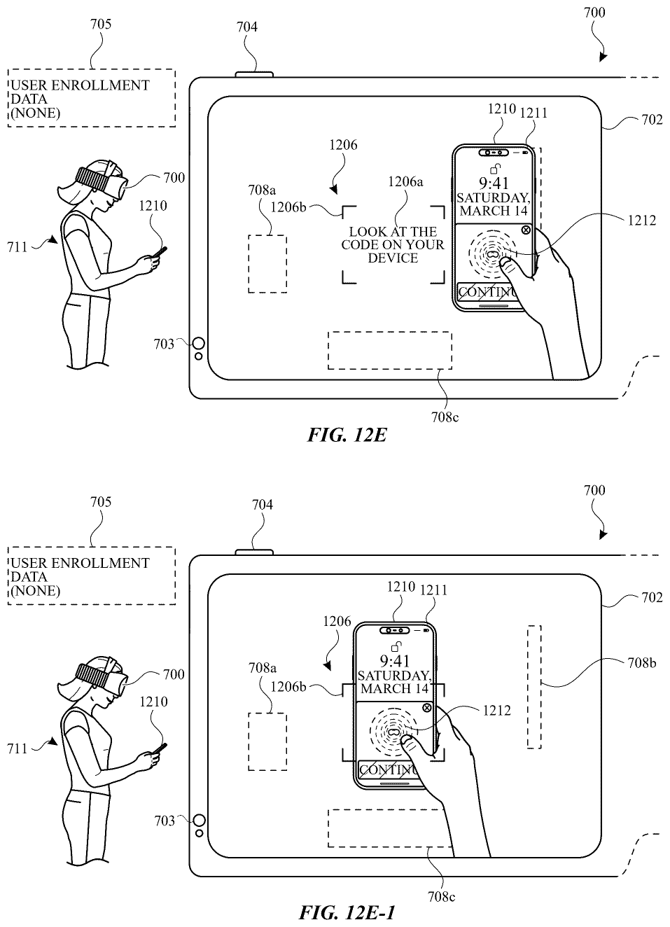

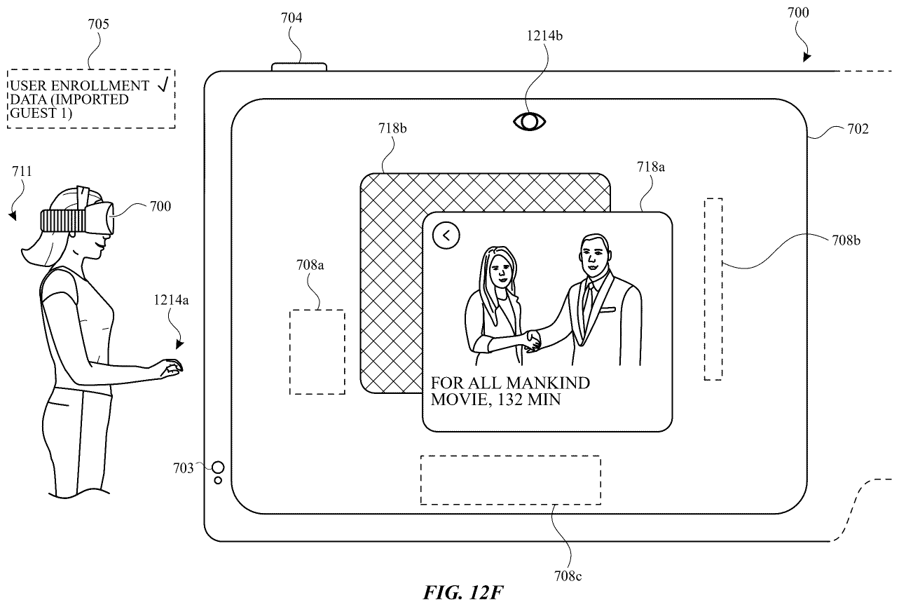

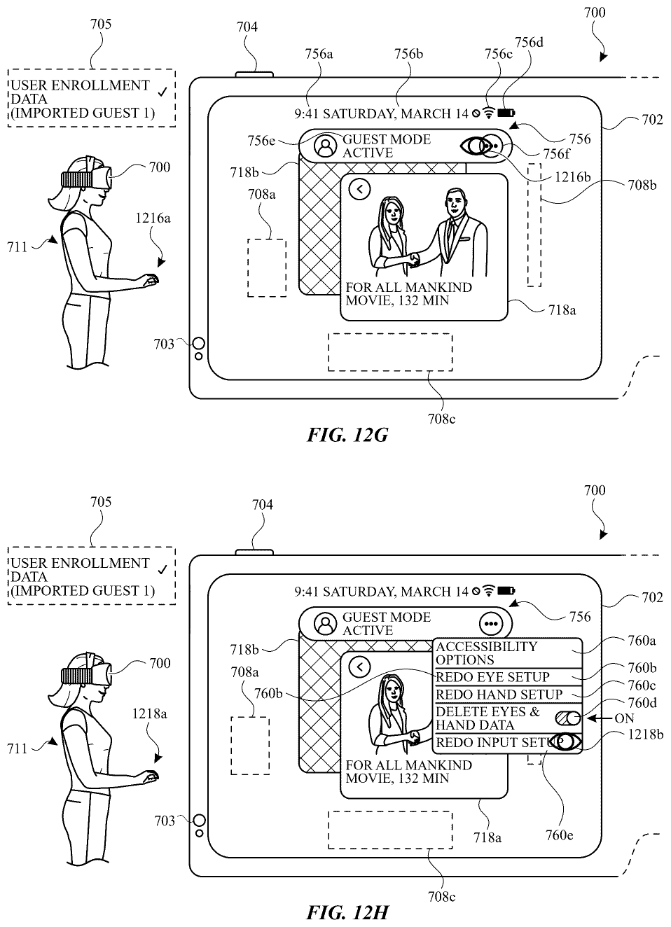

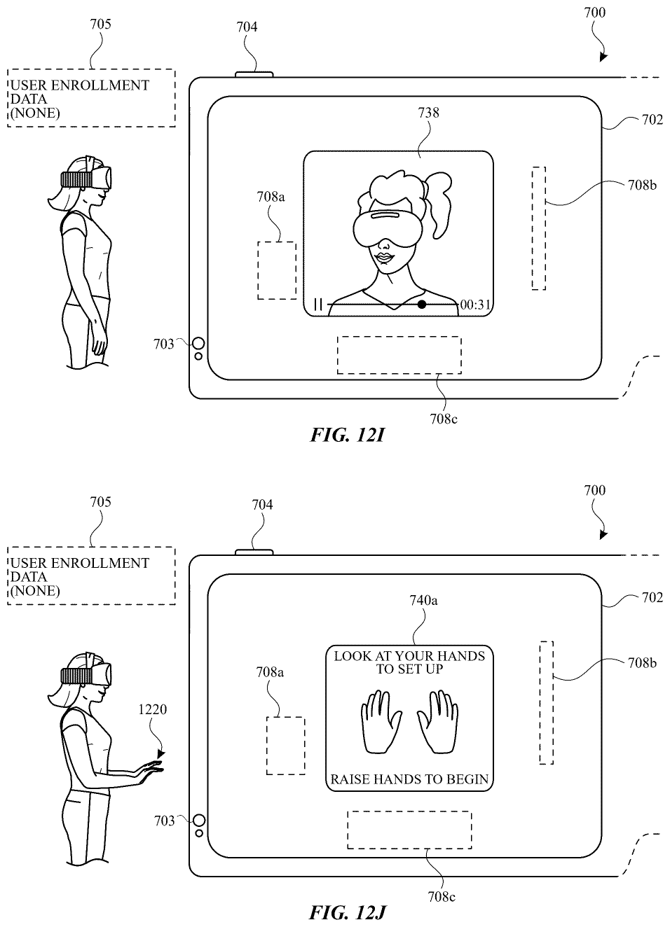

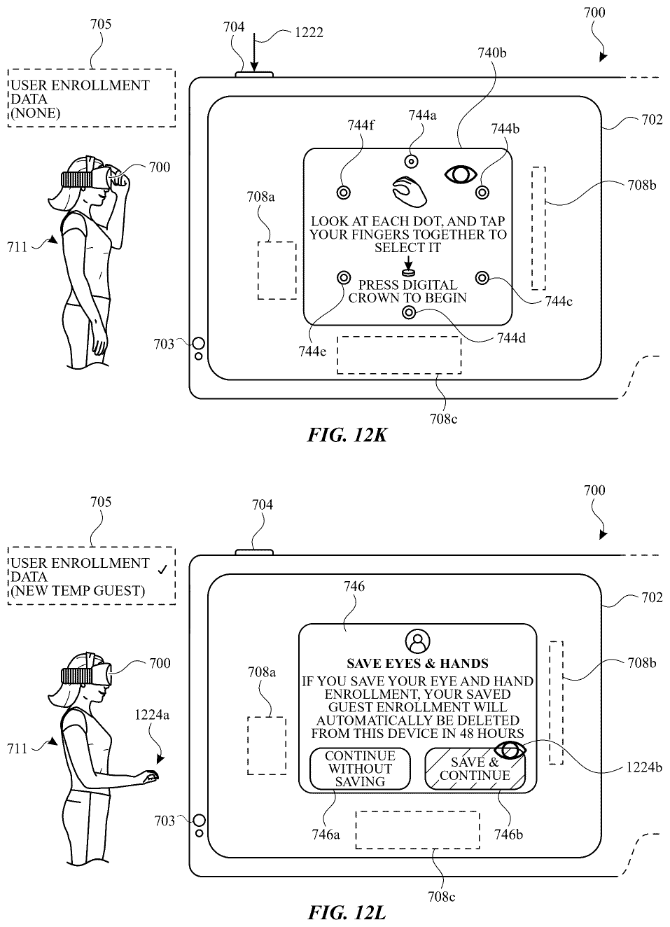

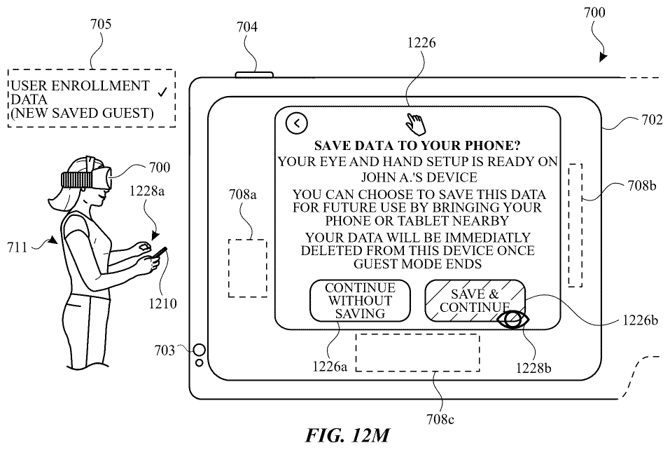

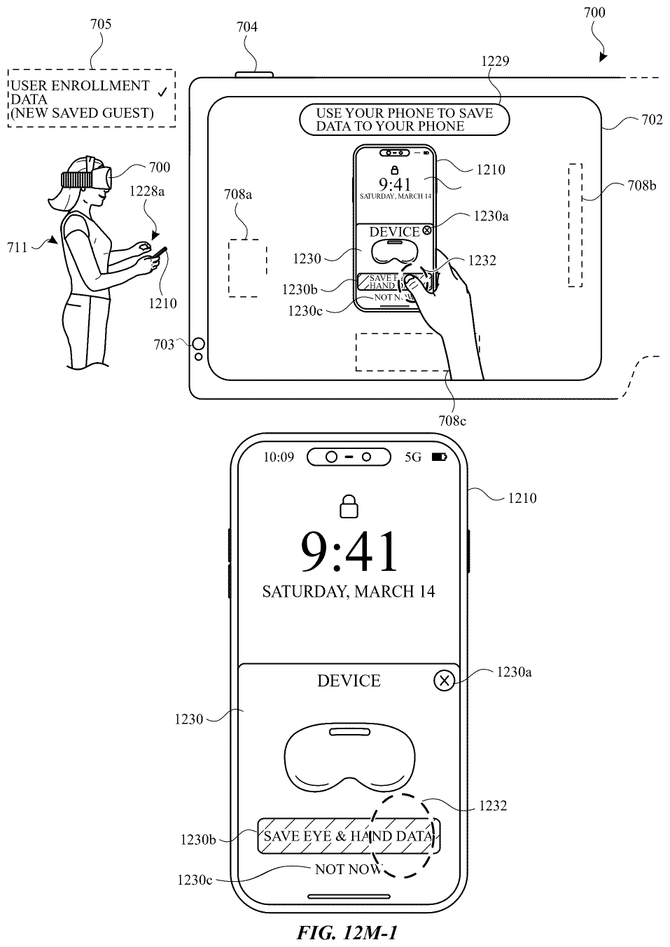

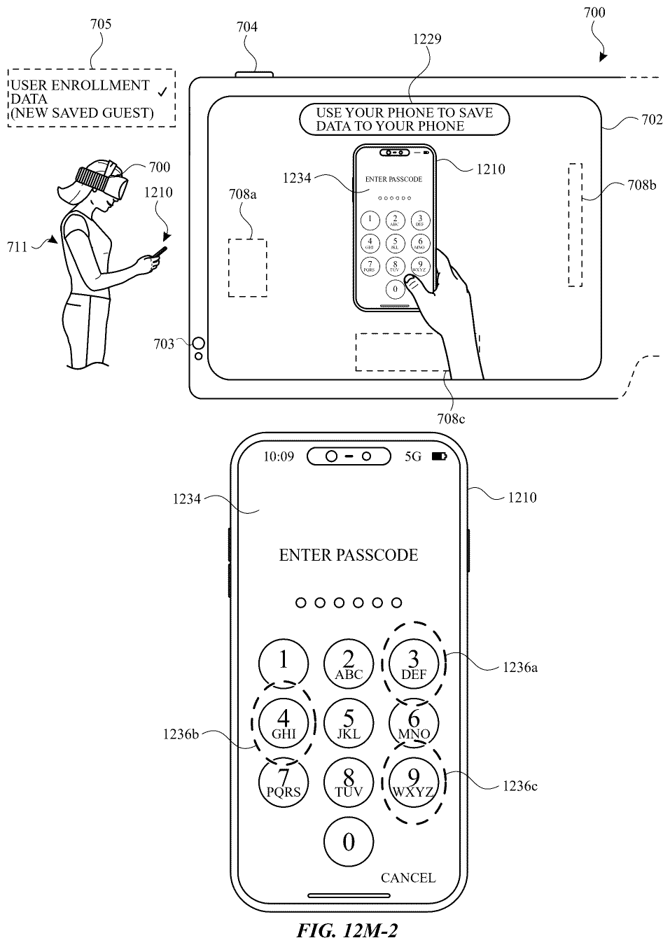

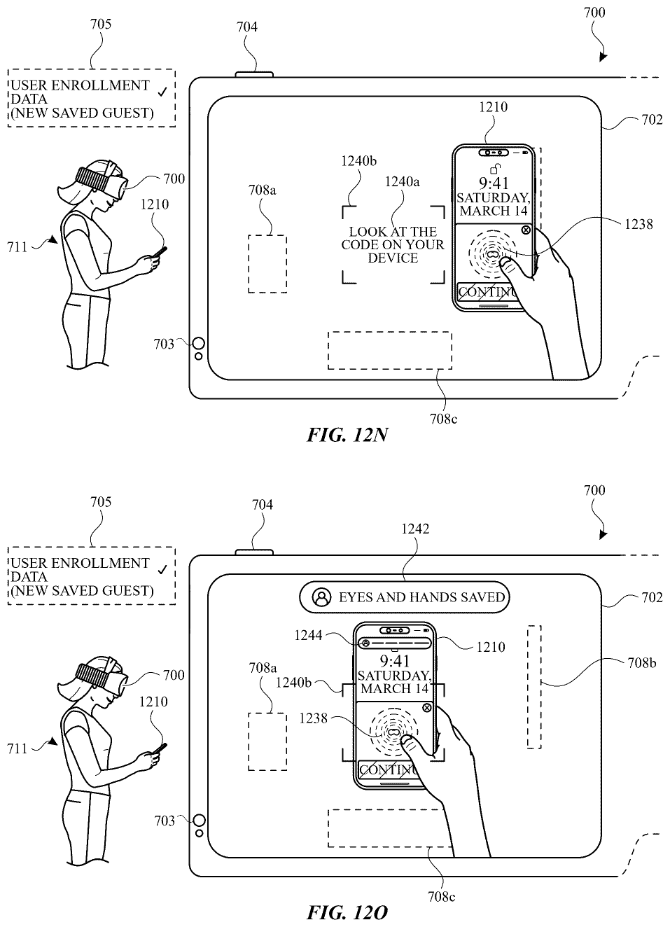

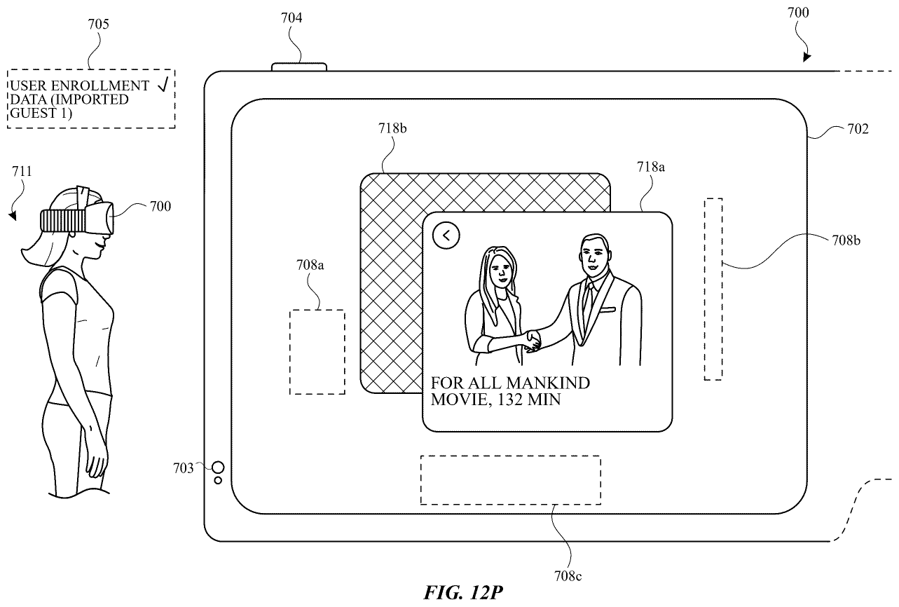

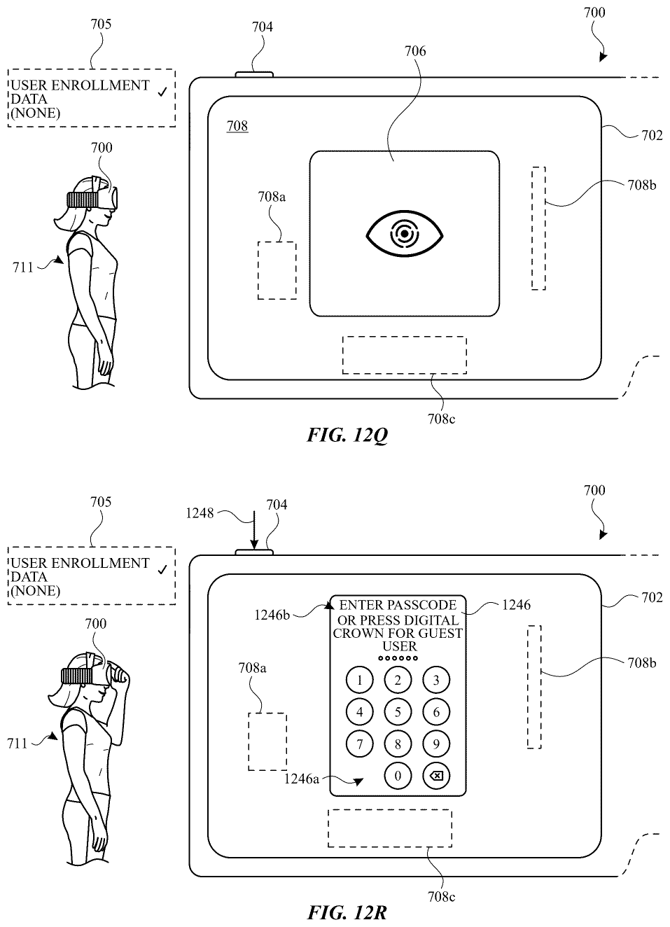

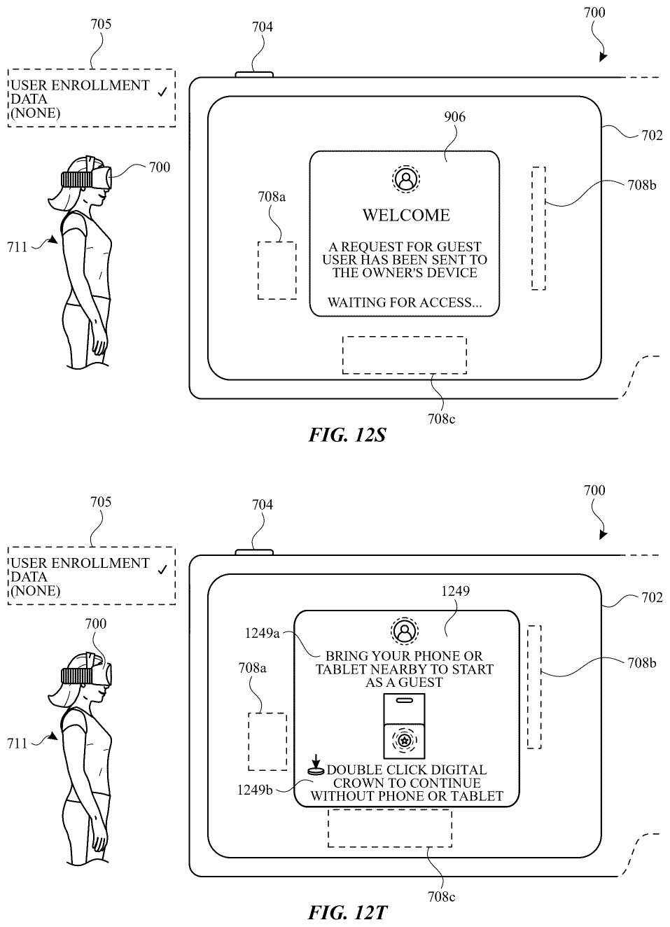

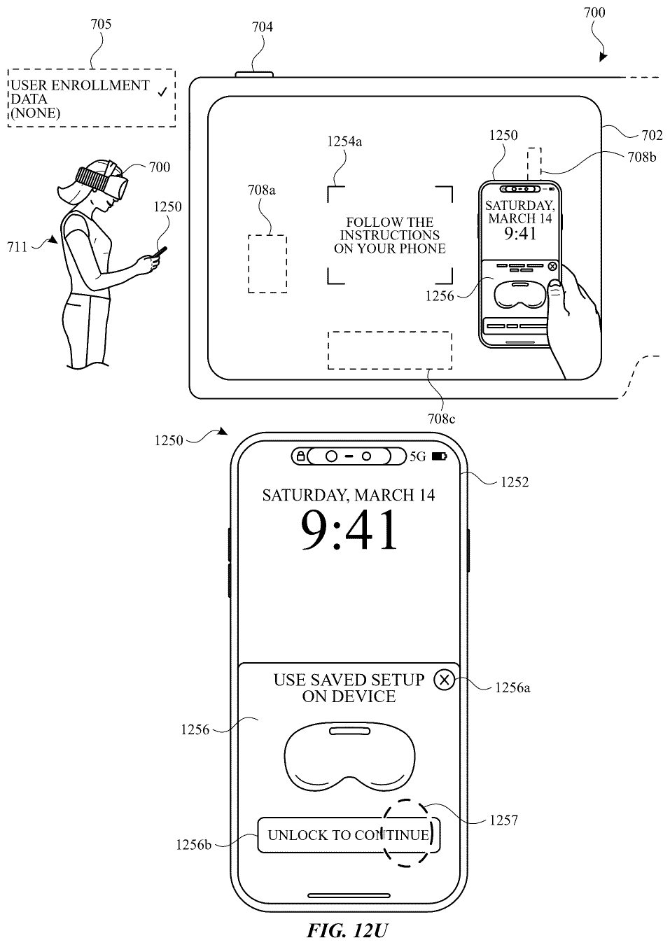

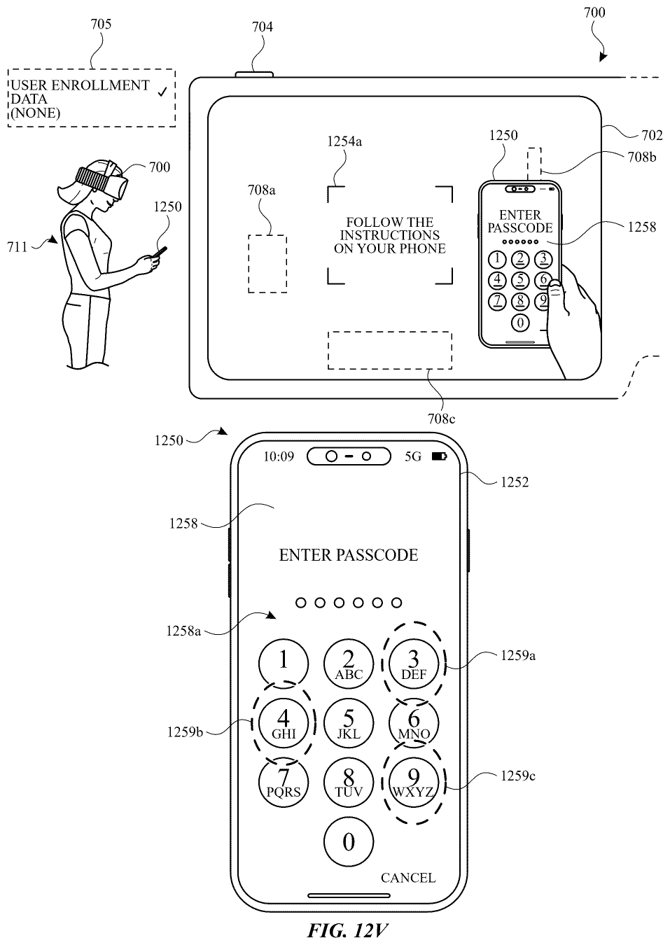

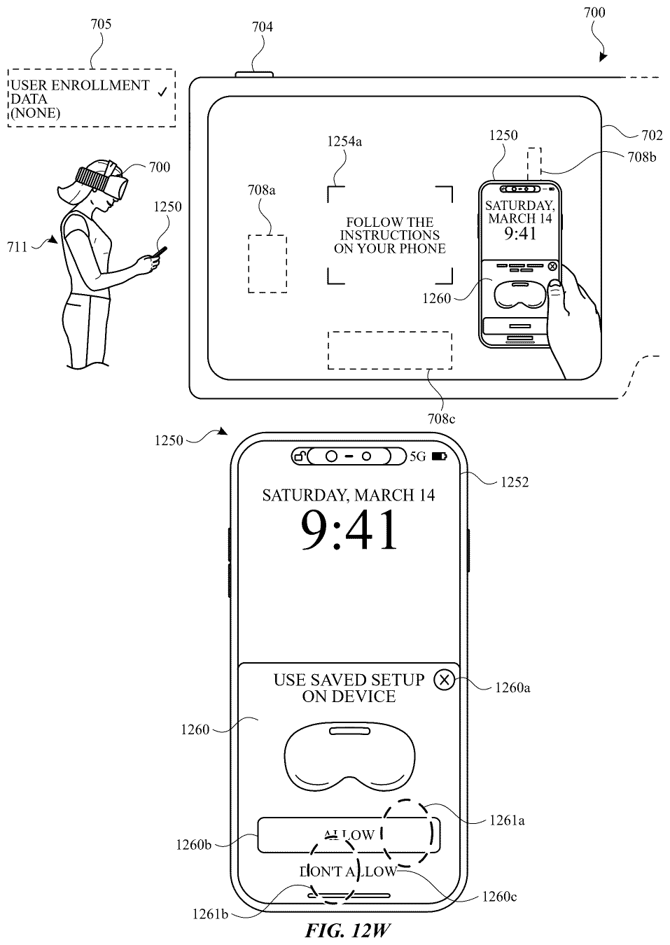

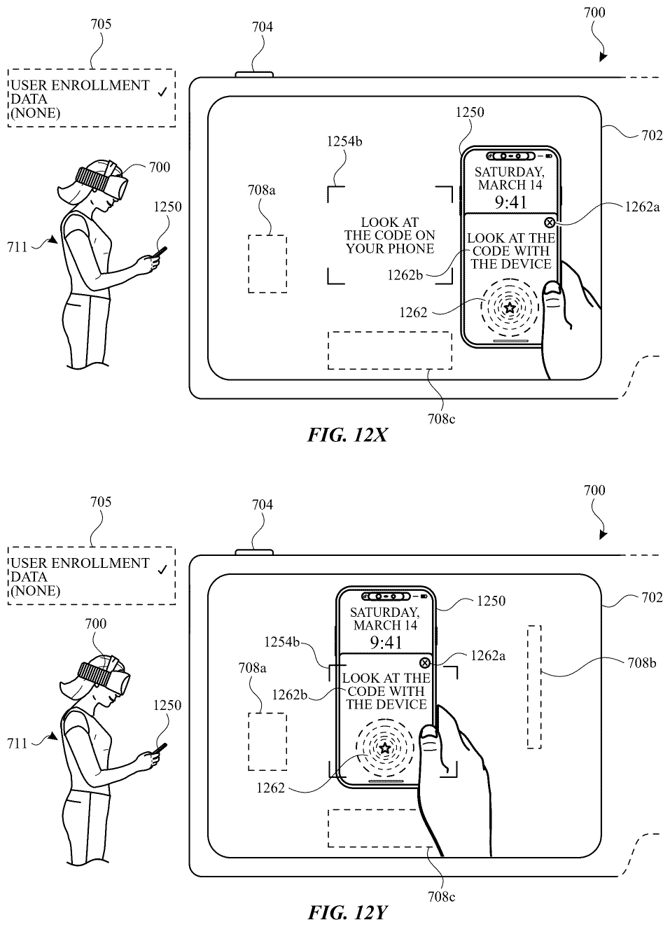

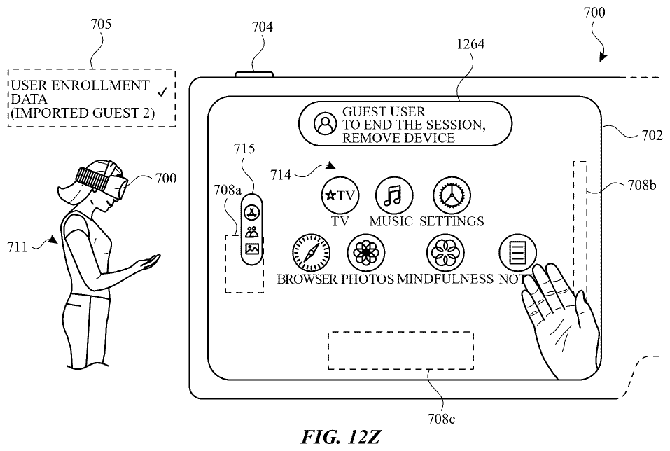

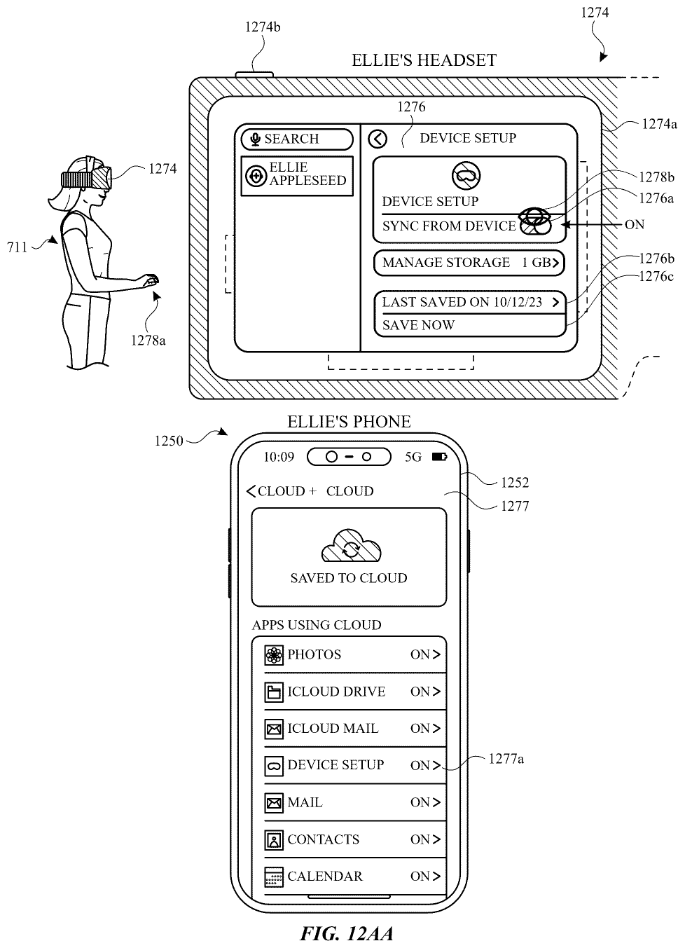

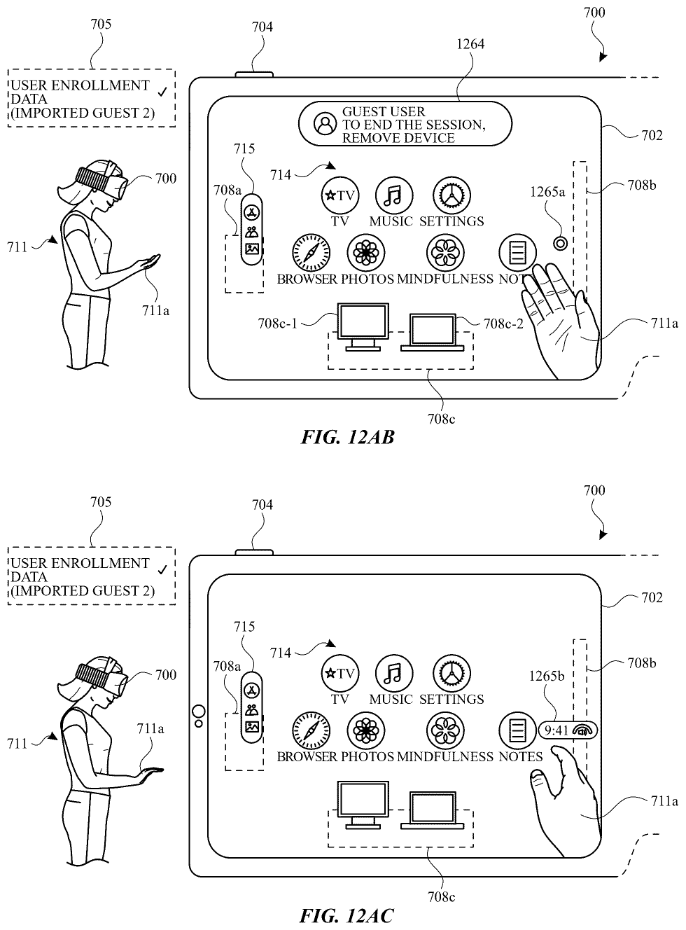

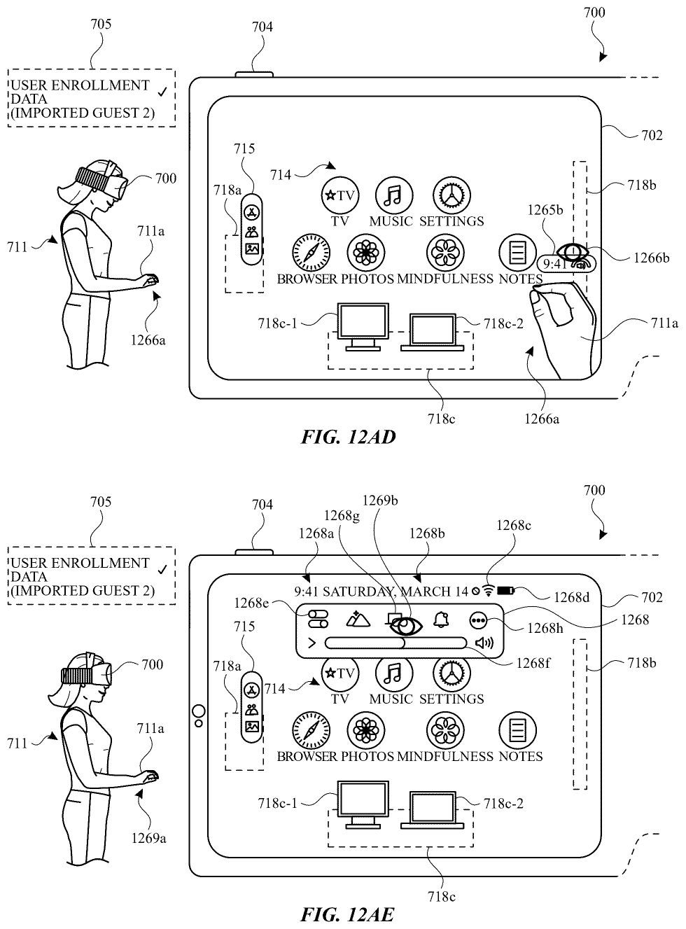

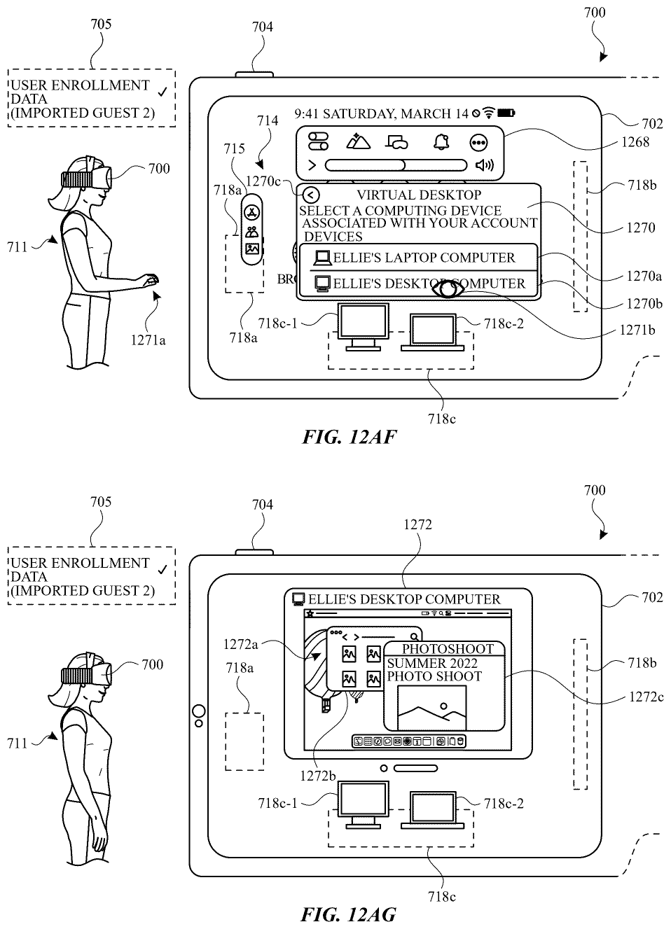

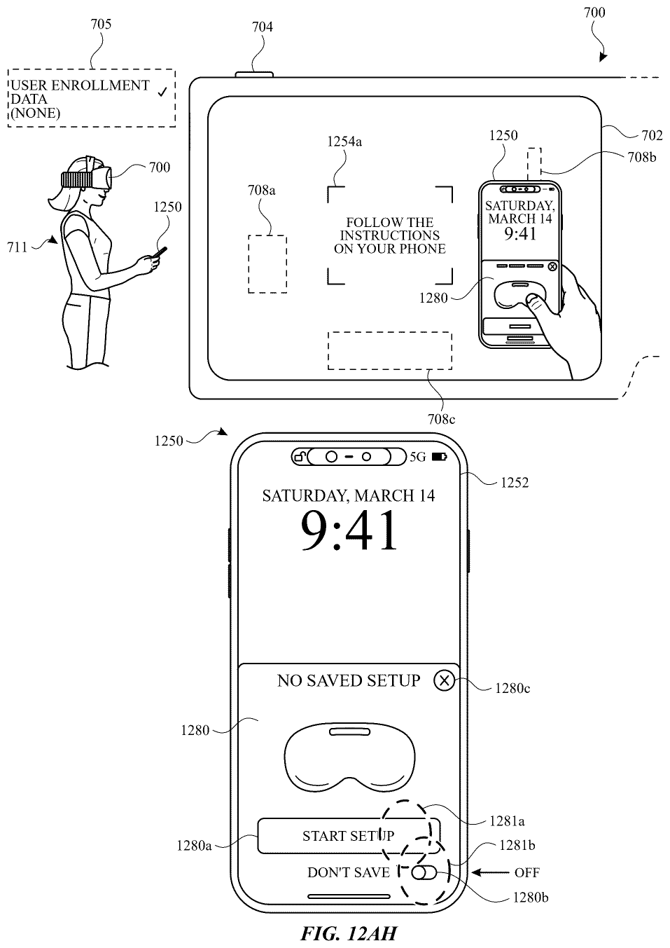

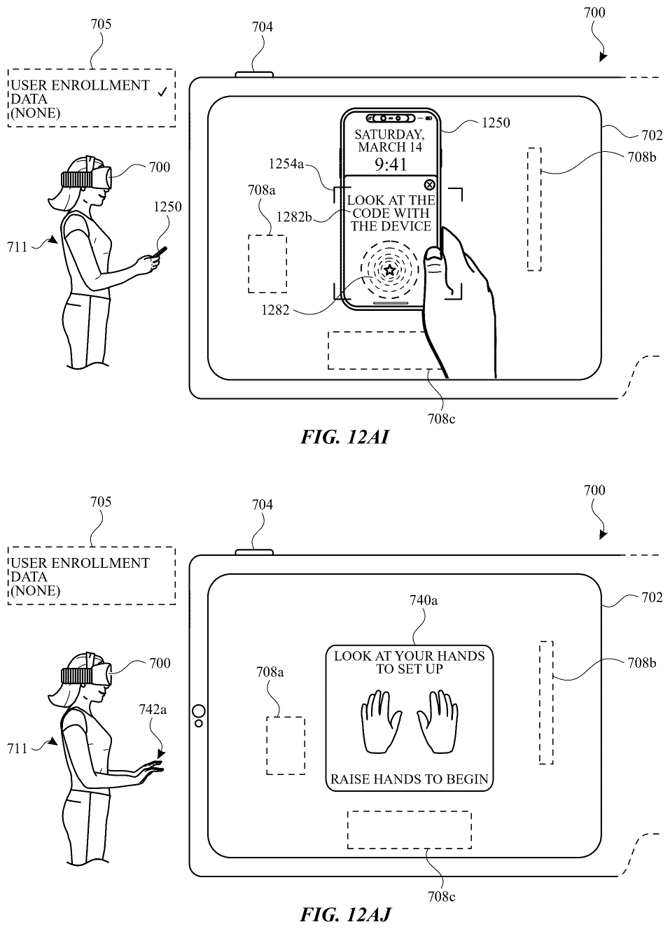

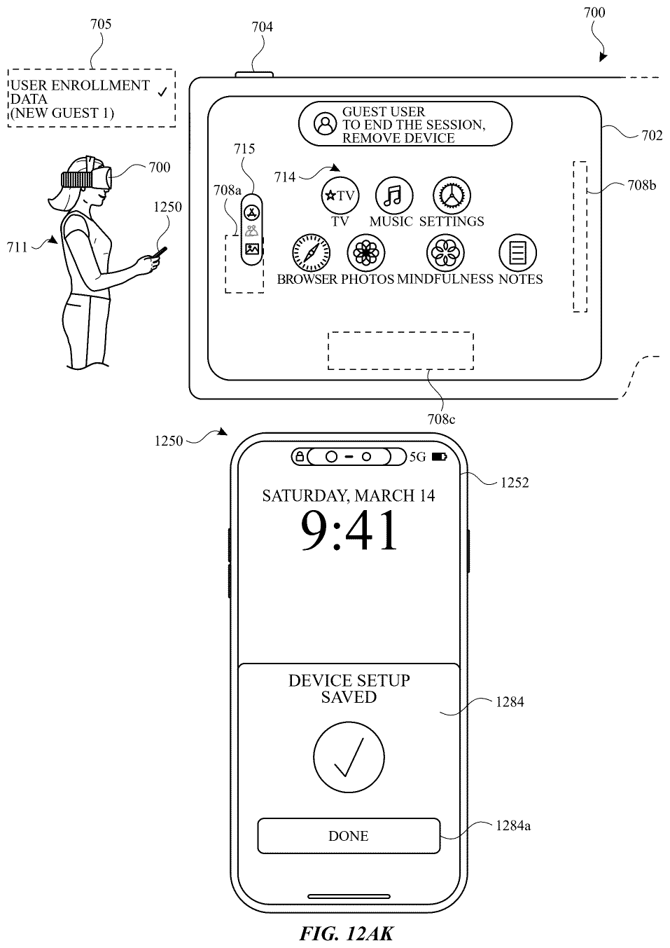

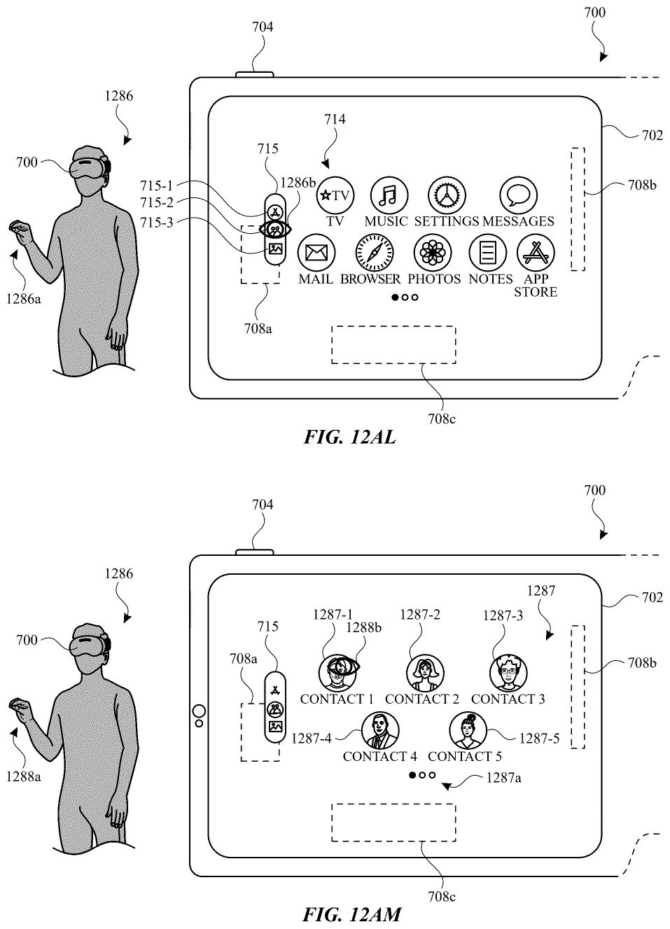

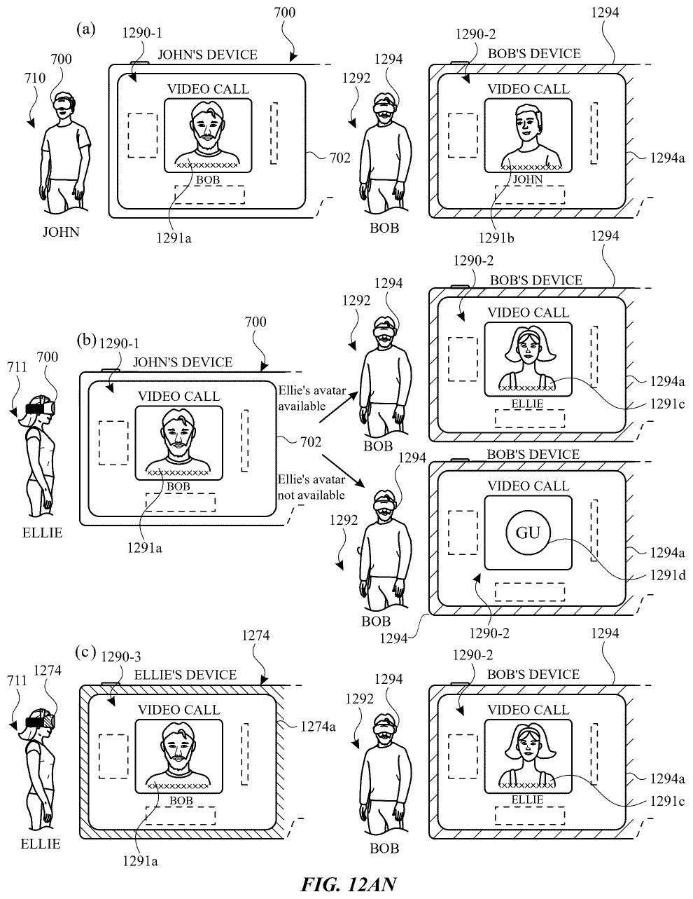

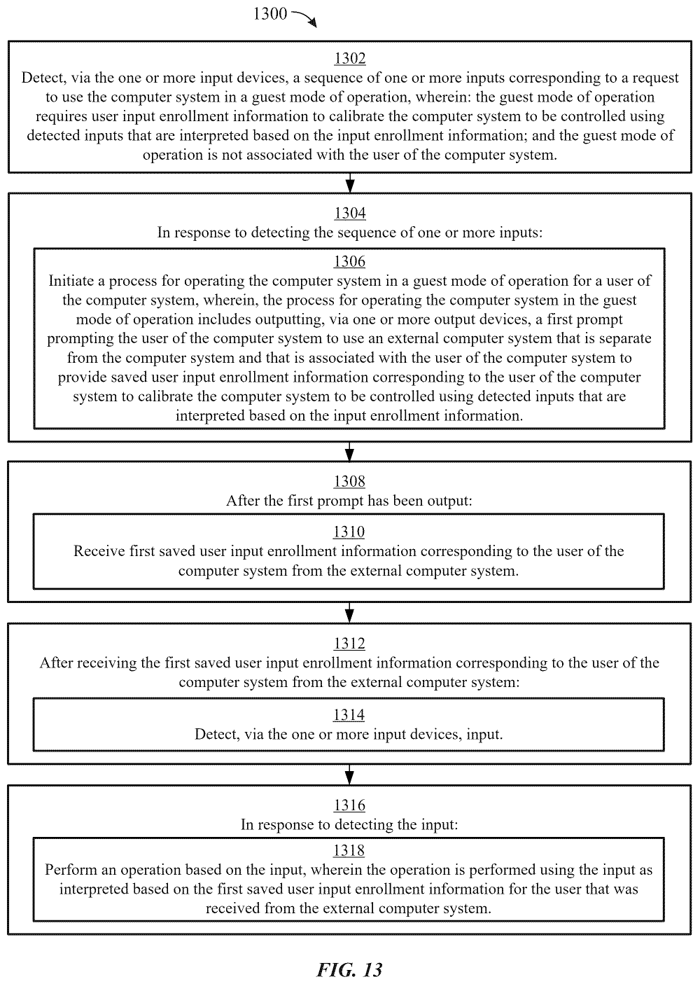

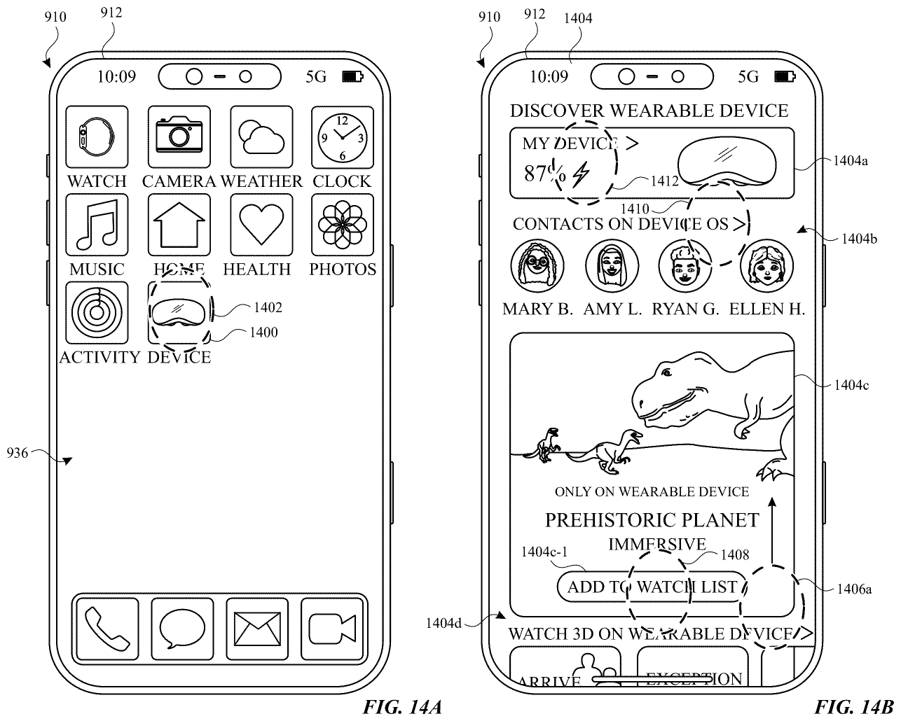

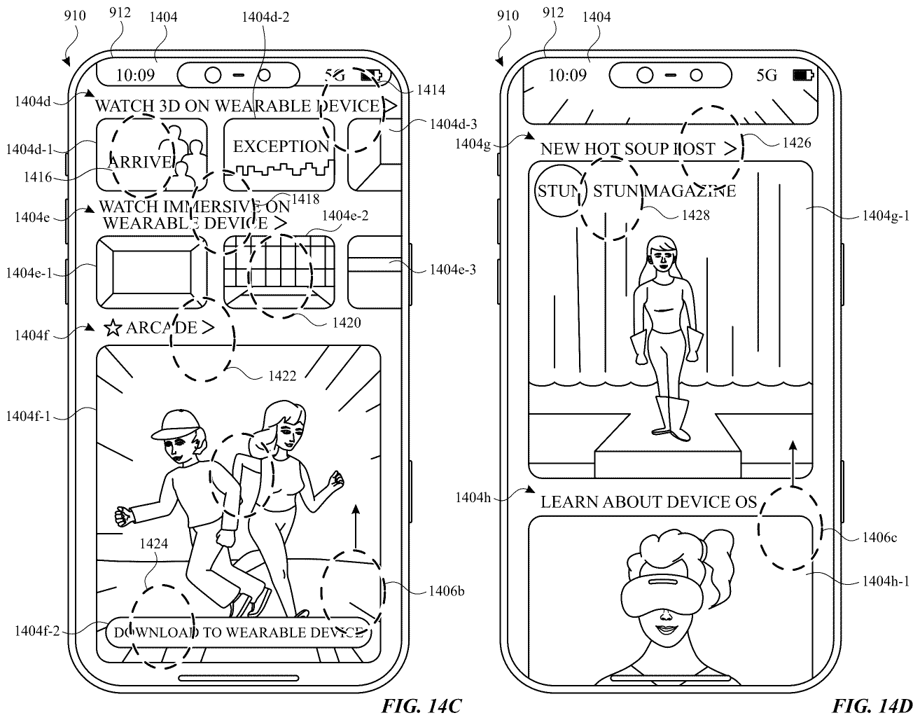

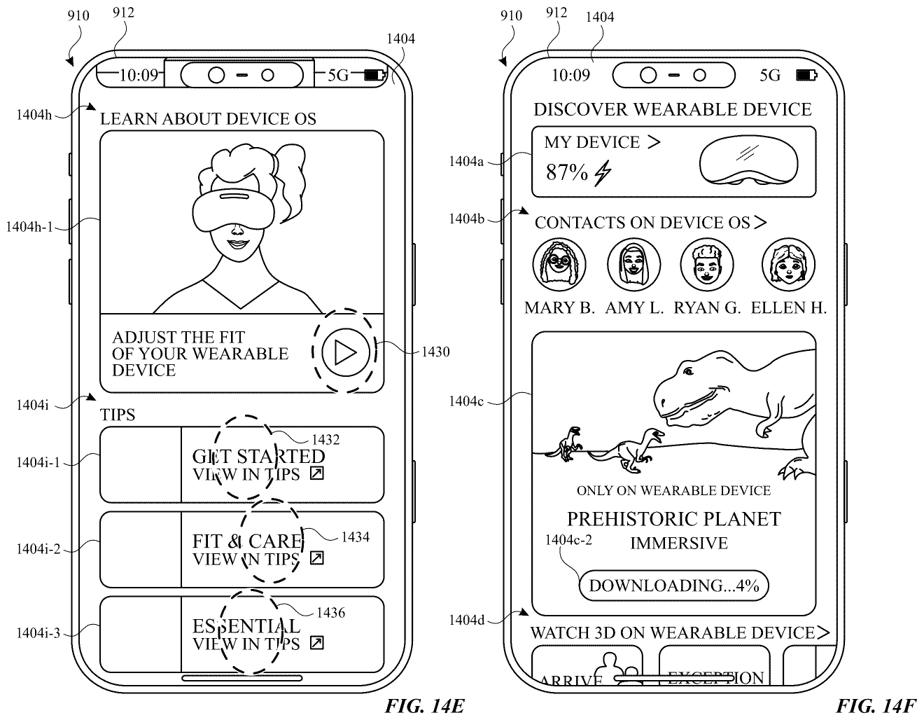

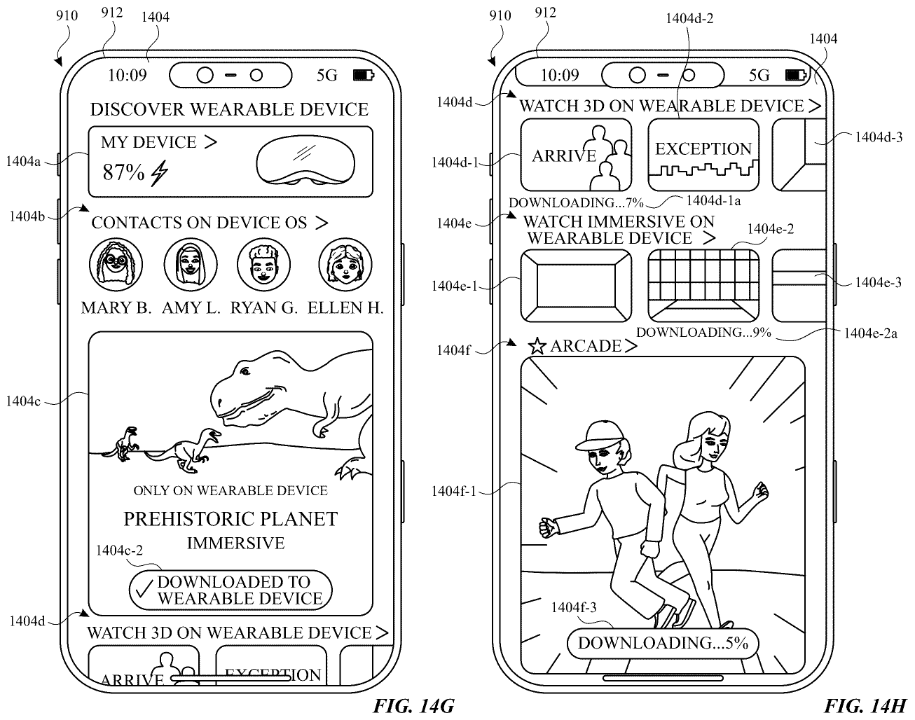

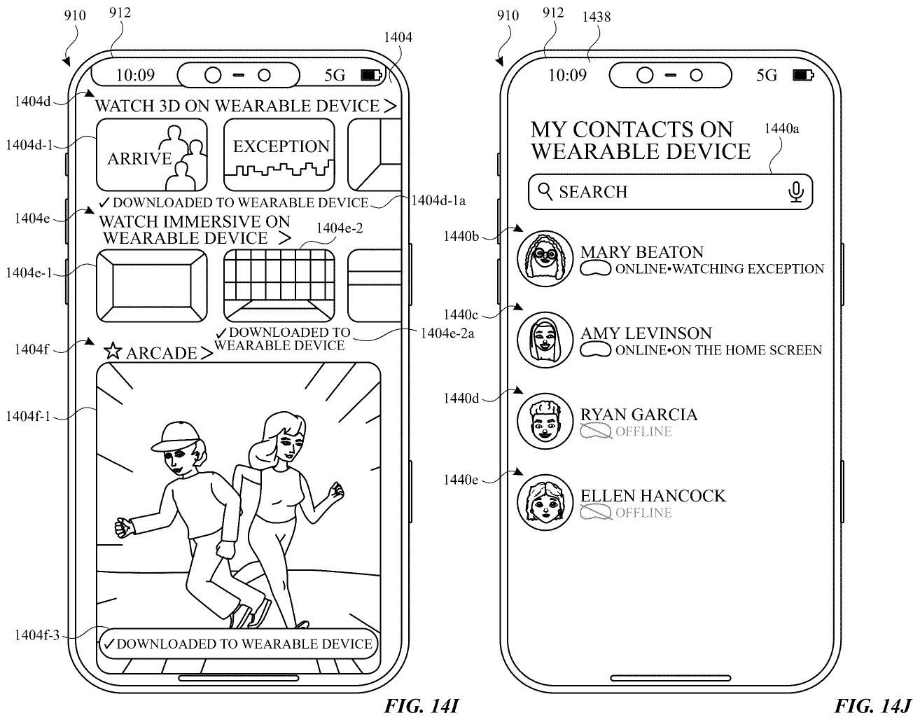

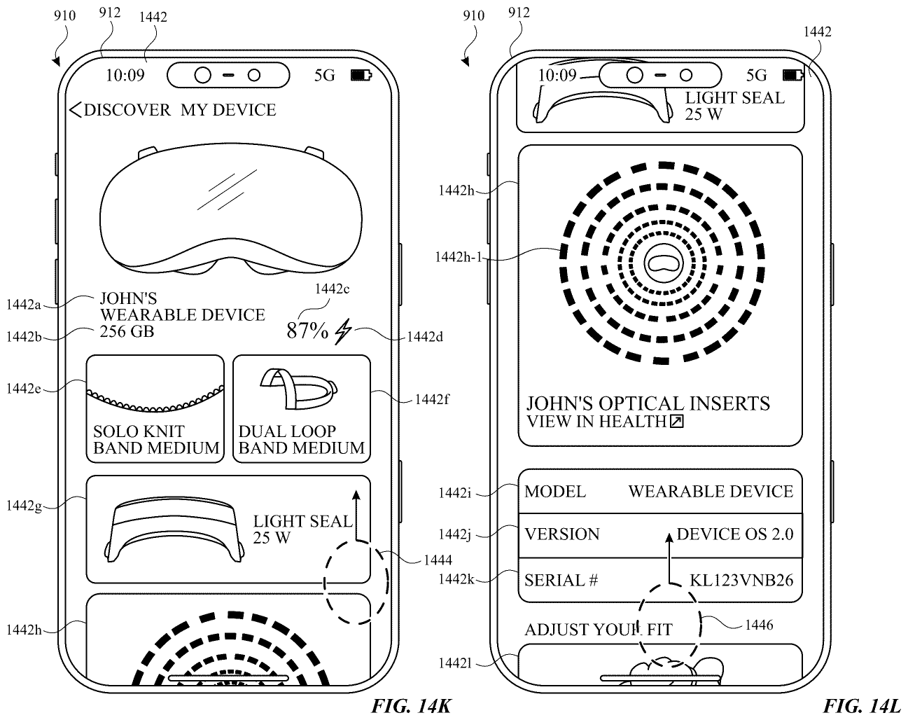

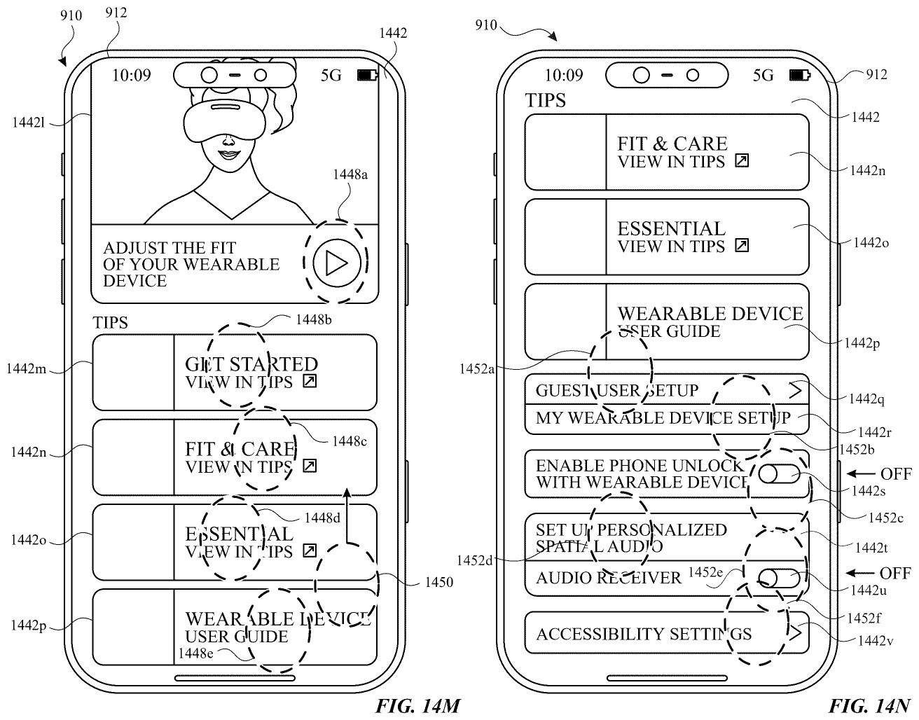

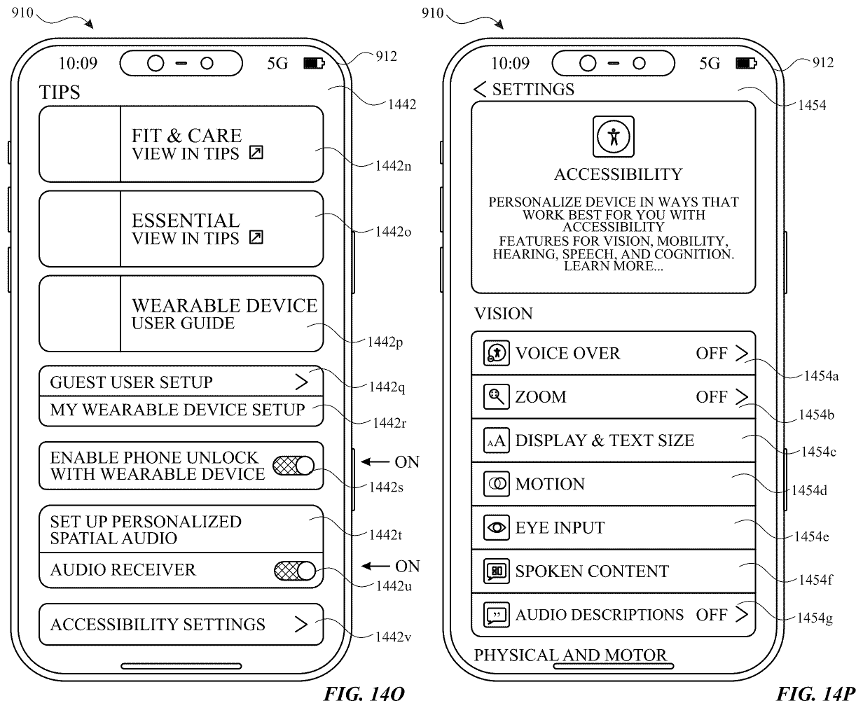

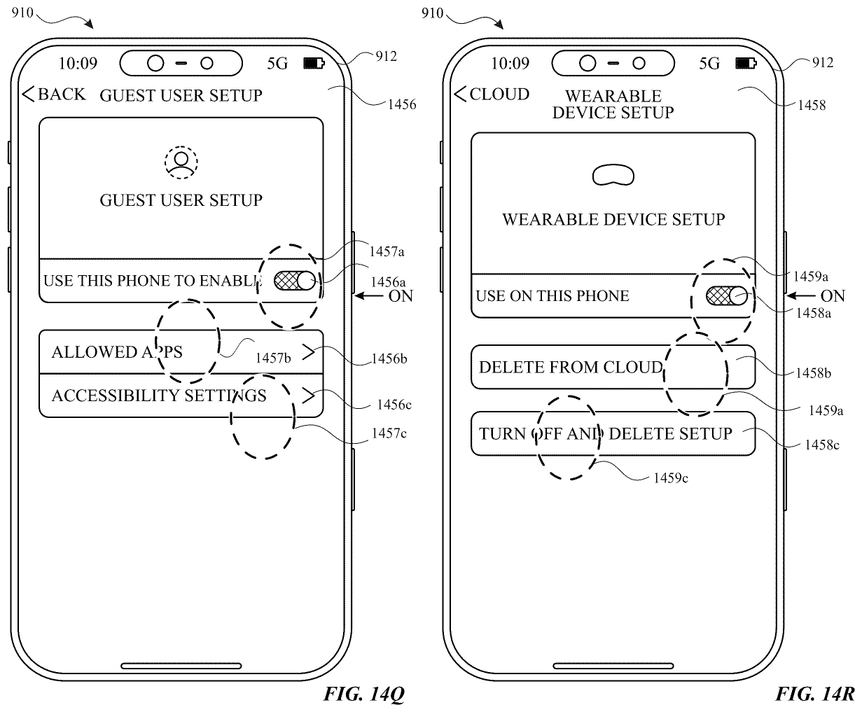

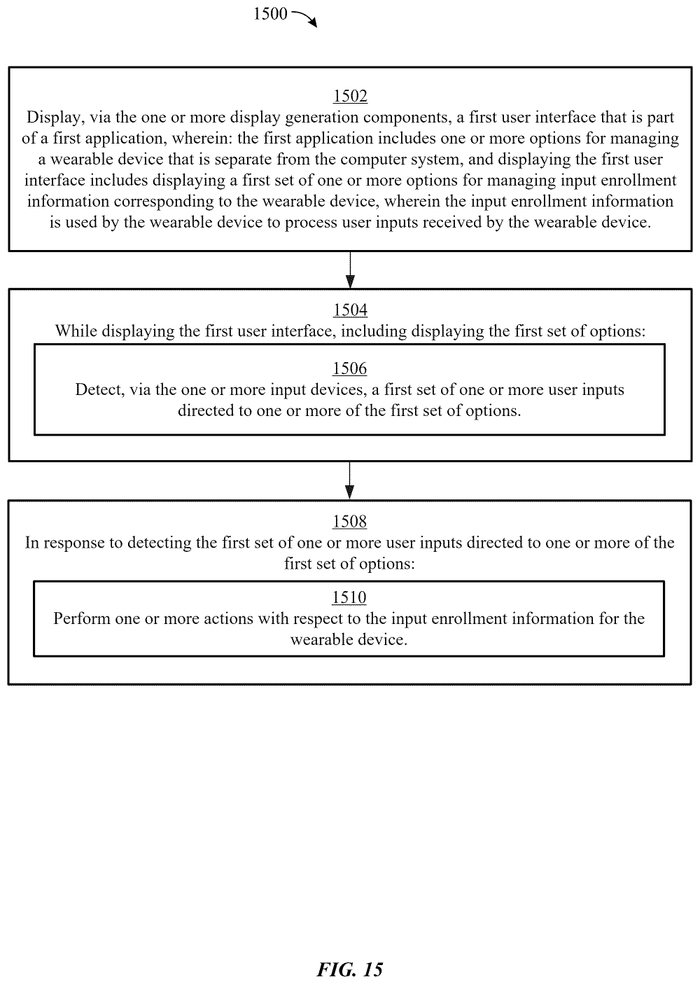

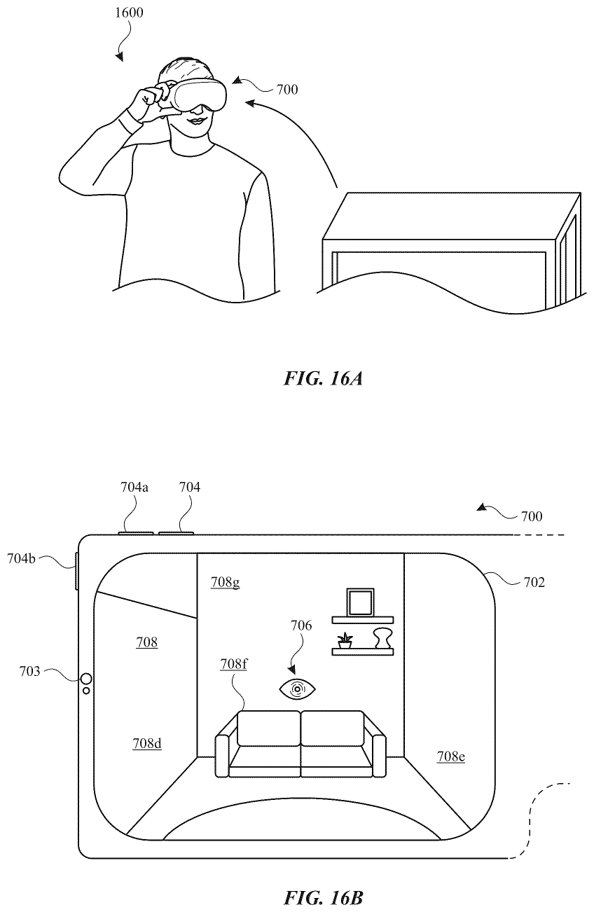

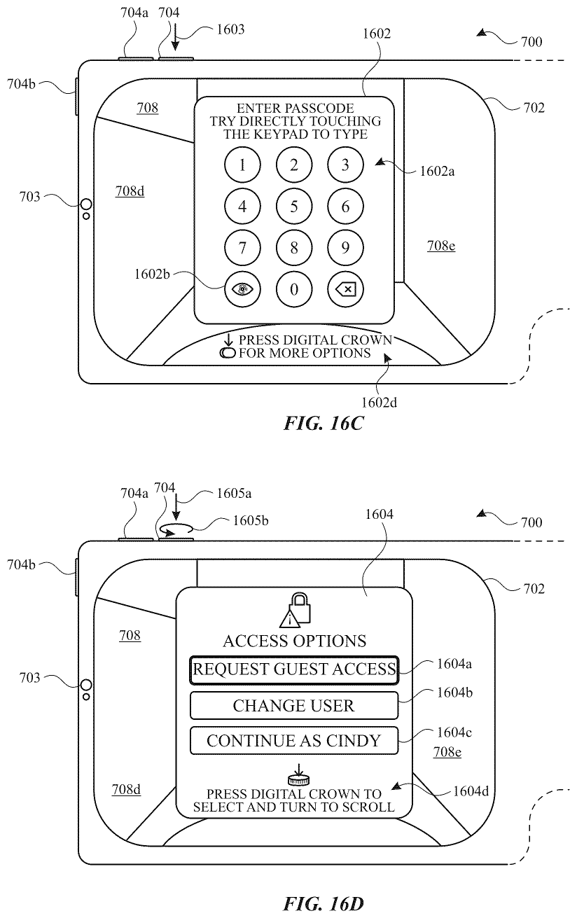

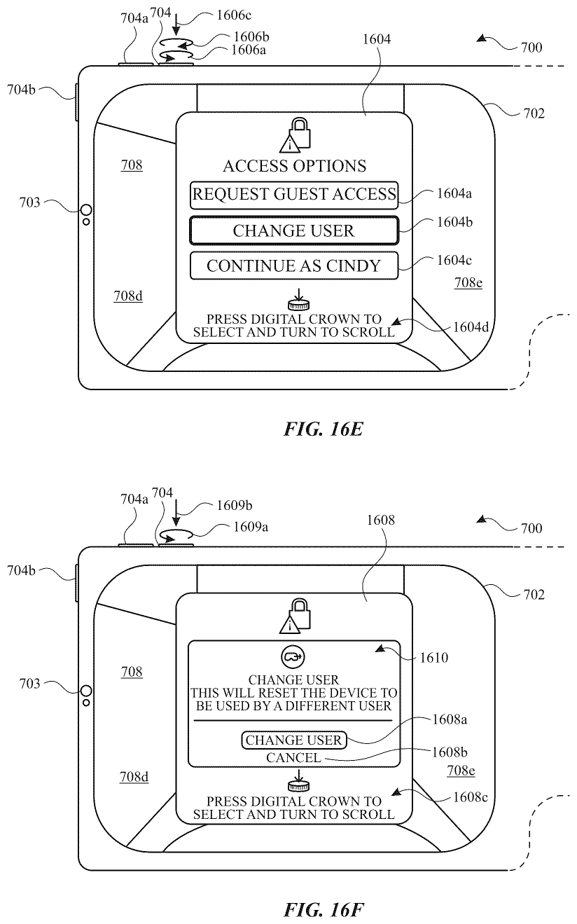

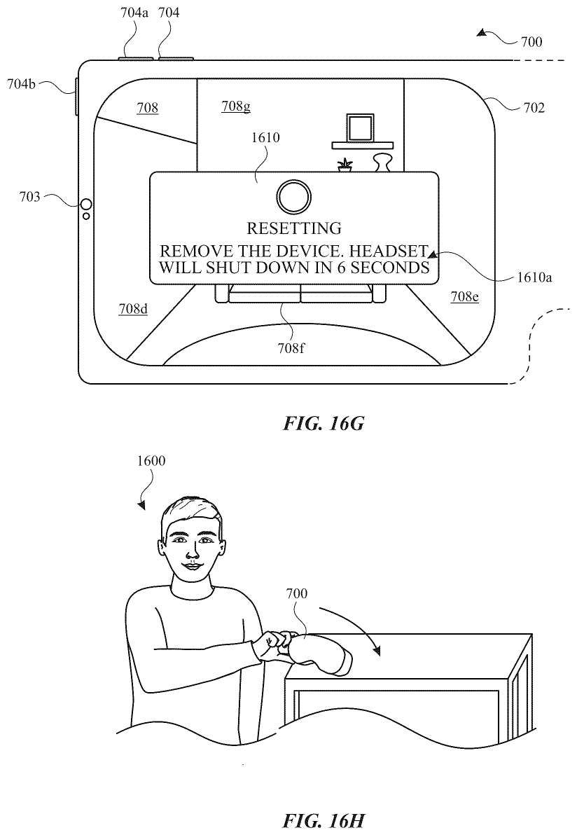

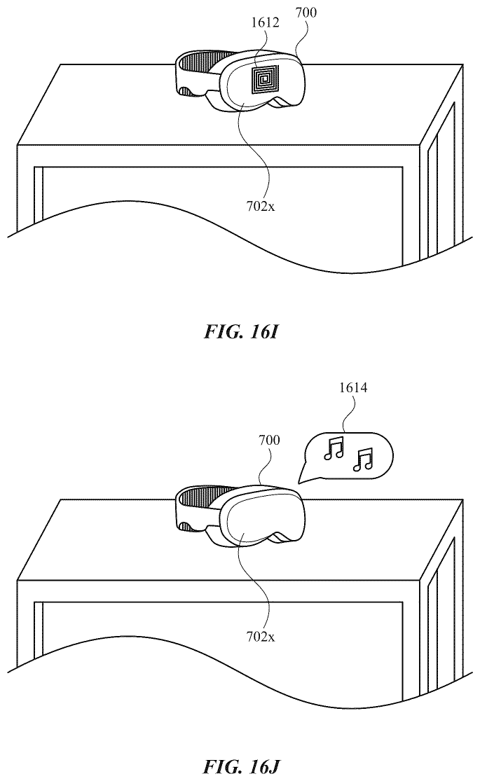

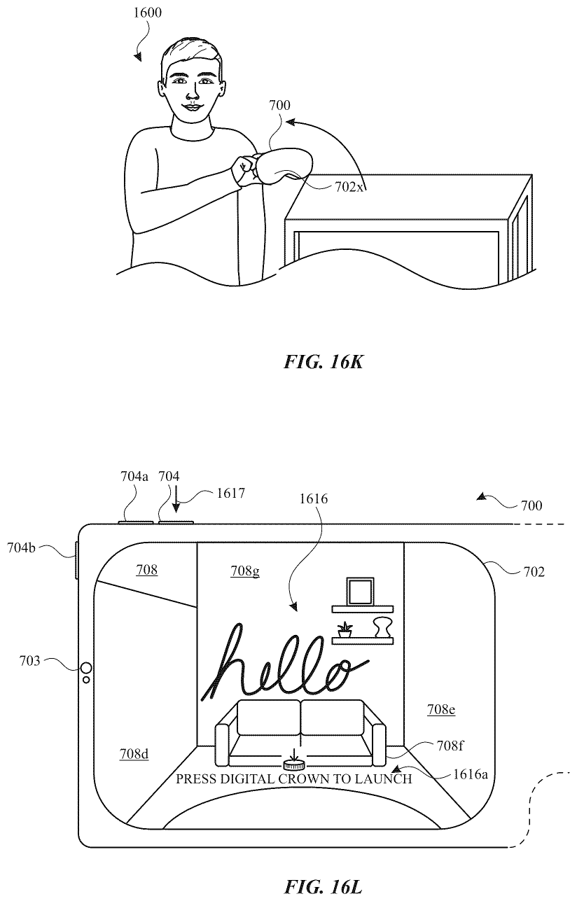

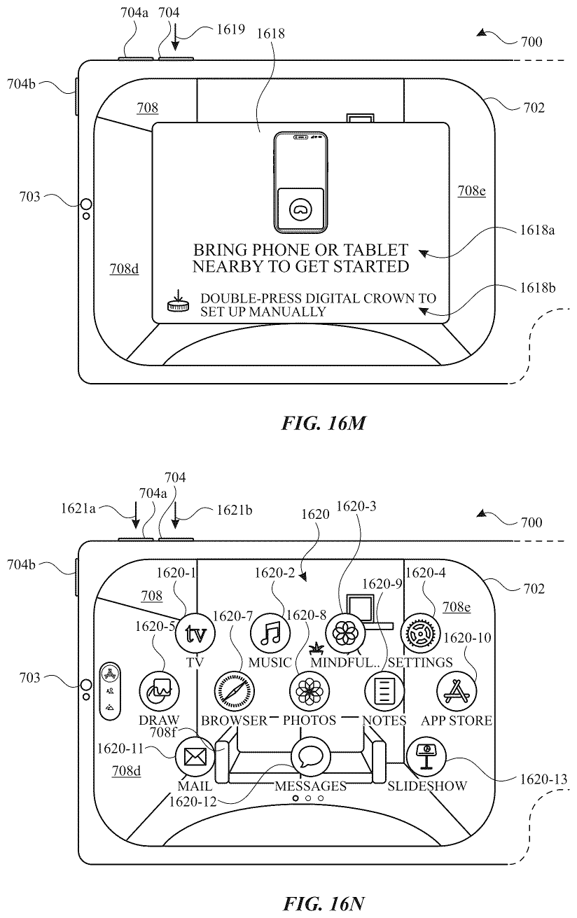

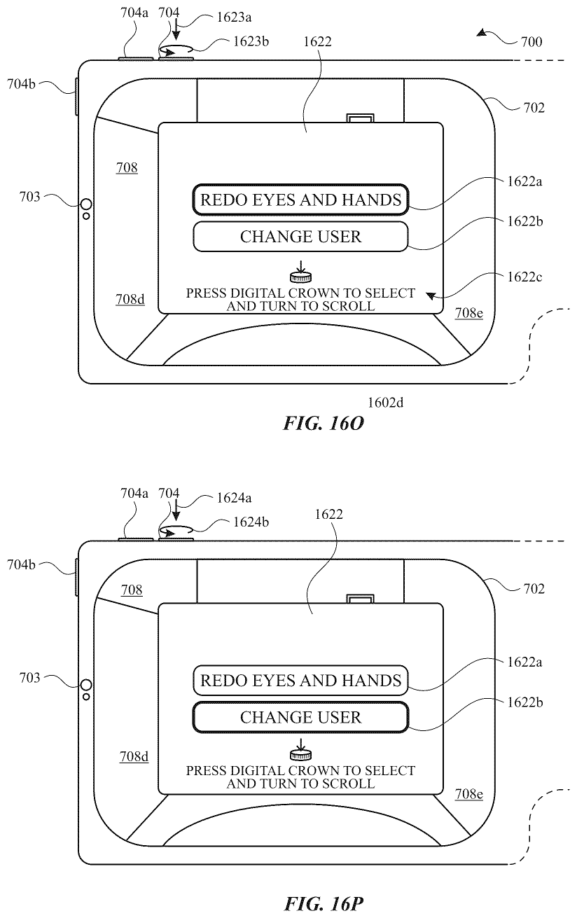

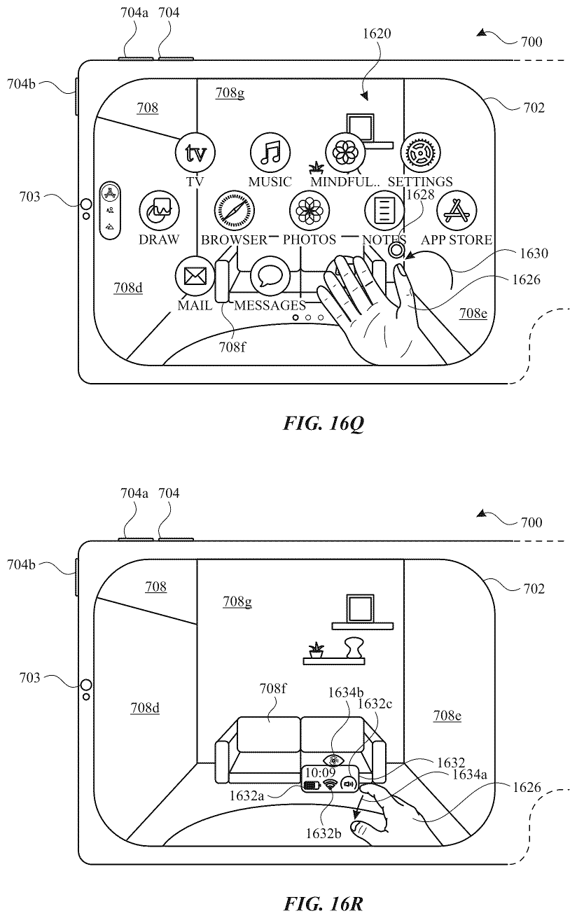

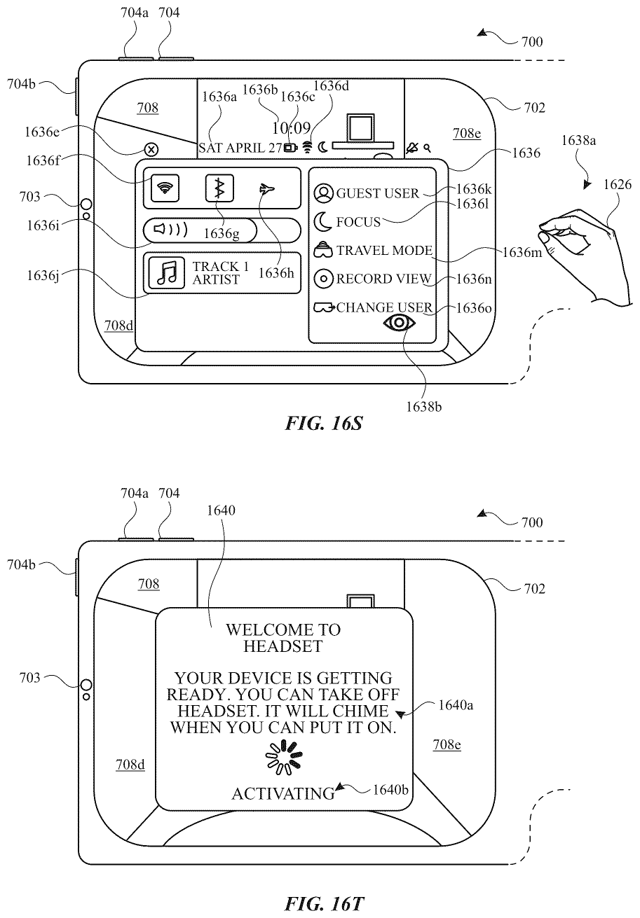

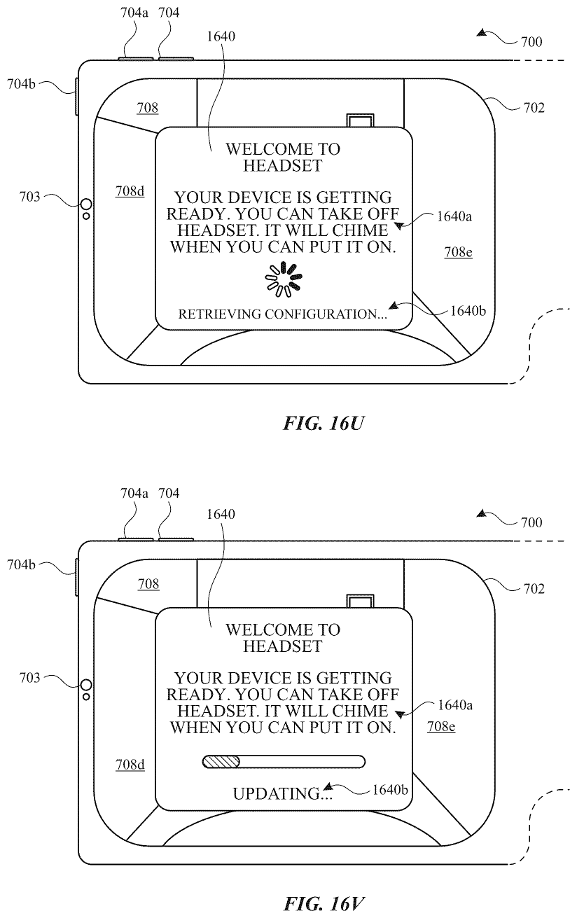

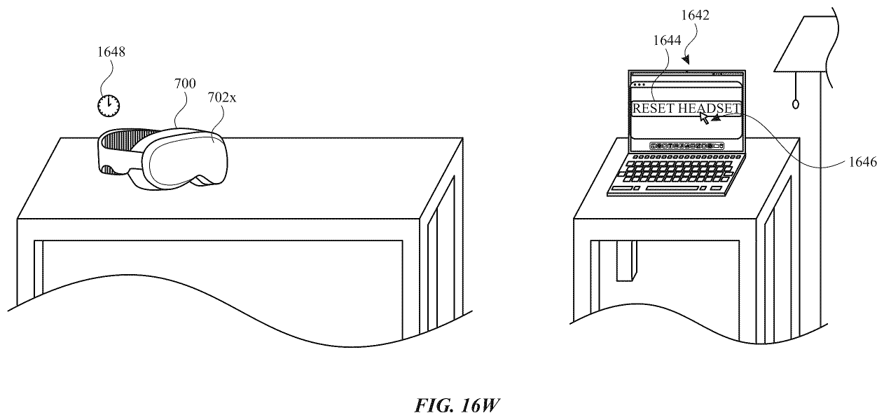

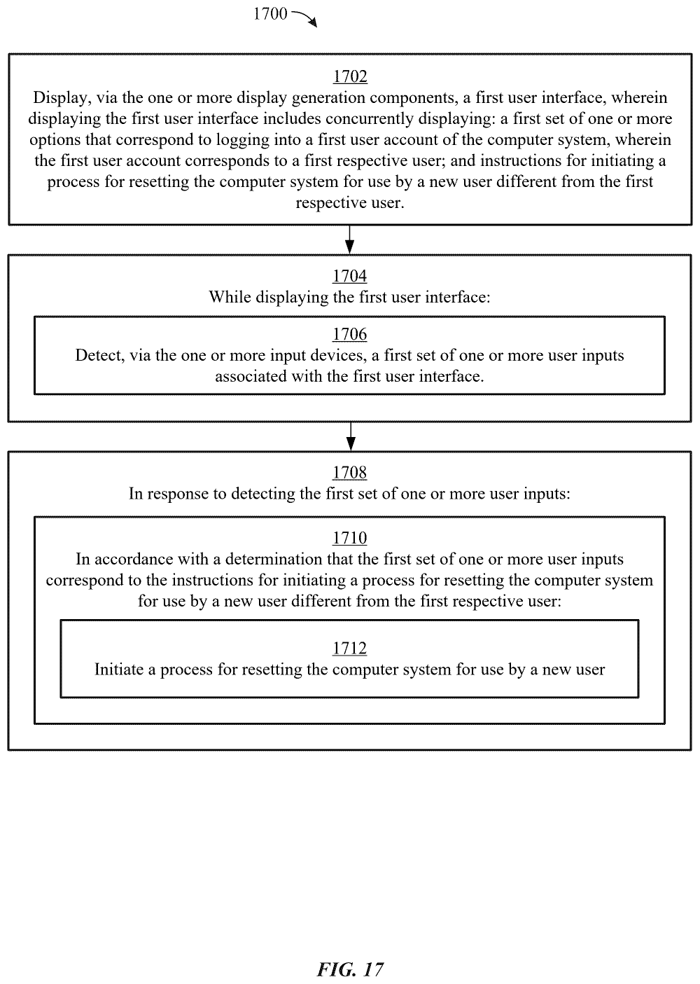

FIGS. 1A-6B provide a description of example computer systems for providing XR experiences to users. FIGS. 7A-7AB illustrate example techniques for initiating a guest mode of operation of a computer system, in some embodiments. FIG. 8 is a flow diagram of methods of initiating a guest mode of operation of a computer system, in some embodiments. The user interfaces in FIGS. 7A-7AB are used to illustrate the processes in FIG. 8. FIGS. 9A-9AA illustrate example techniques for initiating a guest mode of operation of a computer system, in some embodiments. FIG. 10 is a flow diagram of methods of initiating a guest mode of operation of a computer system, in some embodiments. FIG. 11 is a flow diagram of methods of responding to a request to initiate a guest mode of operation on an external computer system, in some embodiments. The user interfaces in FIGS. 9A-9AA are used to illustrate the processes in FIG. 10 and FIG. 11. FIGS. 12A-12AN illustrate example techniques for initiating a guest mode of operation of a computer system, in some embodiments. FIG. 13 is a flow diagram of methods of initiating a guest mode of operation of a computer system, in some embodiments. The user interfaces in FIGS. 12A-12AN are used to illustrate the processes in FIG. 13. FIGS. 14A-14R illustrate example techniques for managing a wearable device using a computer system, in accordance with some embodiments. FIG. 15 is a flow diagram of methods of managing a wearable device using a computer system, in accordance with some embodiments. The user interfaces in FIGS. 14A-14R are used to illustrate the processes in FIG. 15. FIGS. 16A-16W illustrate example techniques for managing a computer system, in accordance with some embodiments. FIG. 17 is a flow diagram of methods of managing a computer system, in accordance with some embodiments. The user interfaces in FIGS. 16A-16W are used to illustrate the processes in FIG. 17.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted display (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

### Examples of XR Include Virtual Reality and Mixed Reality

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

### Examples of Mixed Realities Include Augmented Reality and Augmented Virtuality

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head-mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head-mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head-mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, or 50 cm) of the point of reference in one or more dimensions (e.g., up/down, left/right, and/or forward/backward relative to the position of the point of reference).

In some embodiments, spatial media includes spatial visual media and/or spatial audio. In some embodiments, a spatial capture is a capture of spatial media. In some embodiments, spatial visual media (also referred to as stereoscopic media) (e.g., a spatial image and/or a spatial video) is media that includes two different images or sets of images, representing two perspectives of the same or overlapping fields-of-view, for concurrent display. A first image representing a first perspective is presented to a first eye of the viewer and a second image representing a second perspective, different from the first perspective, is concurrently presented to a second eye of the viewer. The first image and the second image have the same or overlapping fields-of-view. In some embodiments, a computer system displays the first image via a first display that is positioned for viewing by the first eye of the viewer and concurrently displays the second image via a second display, different from the first display, that is position for viewing by the second eye of the viewer. In some embodiments, the first image and the second image, when viewed together, create a depth effect and provide the viewer with depth perception for the contents of the images. In some embodiments, a first video representing a first perspective is presented to a first eye of the viewer and a second video representing a second perspective, different from the first perspective, is concurrently presented to a second eye of the viewer. The first video and the second video have the same or overlapping fields-of-view. In some embodiments, the first video and the second video, when viewed together, create a depth effect and provide the viewer with depth perception for the contents of the videos. In some embodiments, spatial audio experiences in headphones are produced by manipulating sounds in the headphone's two audio channels (e.g., left and right) so that they resemble directional sounds arriving in the ear-canal. For example, the headphones can reproduce a spatial audio signal that simulates a soundscape around the listener (also referred to as the user). An effective spatial sound reproduction can render sounds such that the listener perceives the sound as coming from a location within the soundscape external to the listener's head, just as the listener would experience the sound if encountered in the real world.

The geometry of the listener's ear, and in particular the outer ear (pinna), has a significant effect on the sound that arrives from a sound source to a listener's eardrum. The spatial audio sound experience is possible by taking into account the effect of the listener's pinna, the listener's head, and/or the listener's torso to the sound that enters to the listener's ear-canal. The geometry of the user's ear is optionally determined by using a three-dimensional scanning device that produces a three-dimensional model of at least a portion of the visible parts of the user's ear. This geometry is optionally used to produce a filter for producing the spatial audio experience. In some embodiments, spatial audio is audio that has been filtered such that a listener of the audio perceives the audio as coming from one or more directions and/or locations in three-dimensional space (e.g., from above, below, and/or in front of the listener).

An example of such a filter is a Head-Related Transfer Function (HRTF) filter. These filters are used to provide an effect that is similar to how a human ear, head, and torso filter sounds. When the geometry of the ears of a listener is known, a personalized filter (e.g., a personalized HRTF filter) can be produced so that the sound experienced by that listener through headphones (e.g., in-ear headphones, on-ear headphones, and/or over-ear headphones) is more realistic. In some embodiments, two filters are produced—one filter per ear—so that each ear of the listener has a corresponding personalized filter (e.g., personalized HRTF filter), as the ears of the listener may be of different geometry.

In some embodiments, a HRTF filter includes some (or all) acoustic information required to describe how sound reflects or diffracts around a listener's head before entering the listener's auditory system. In some embodiments, a personalized HRTF filter can be selected from a database of previously determined HRTFs for users having similar anatomical characteristics. In some embodiments, a personalized HRTF filter can be generated by numerical modeling based on the geometry of the listener's ear. One or more processors of the computer system optionally apply the personalized HRTF filter for the listener to an audio input signal to generate a spatial input signal for playback by headphones that are connected (e.g., wirelessly or by wire) to the computer system.

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touchscreen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

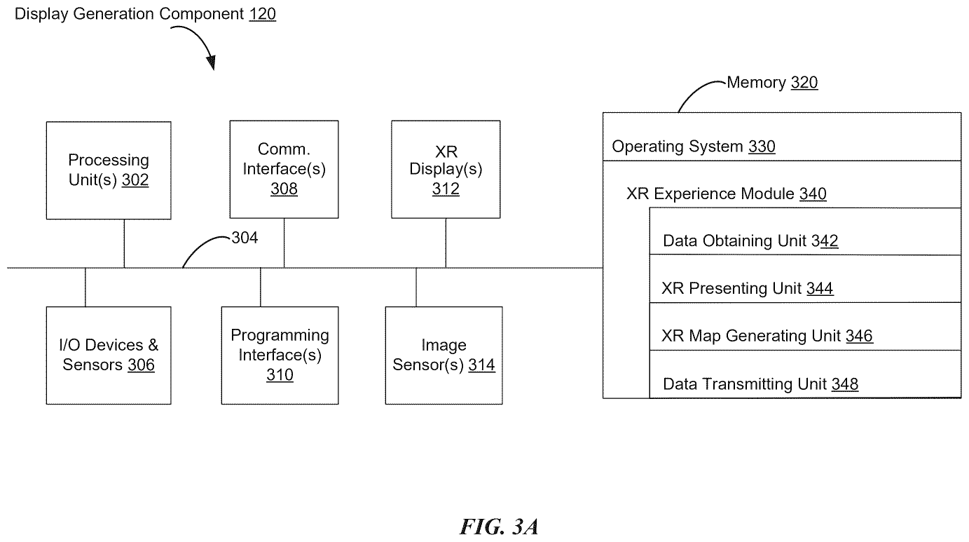

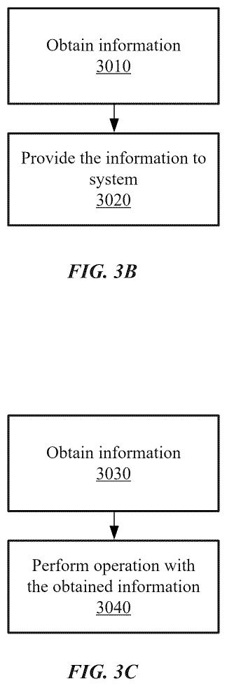

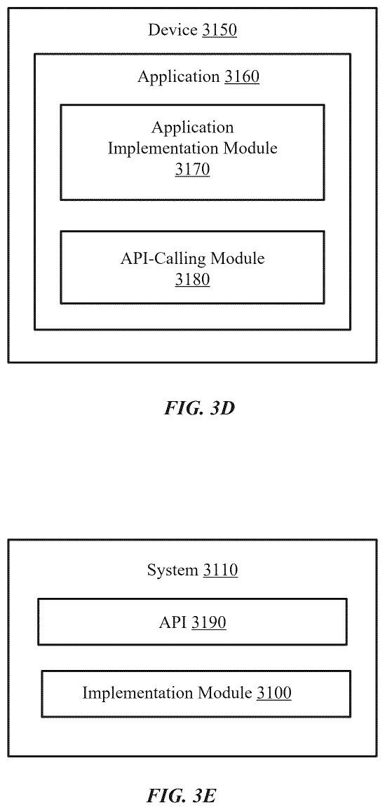

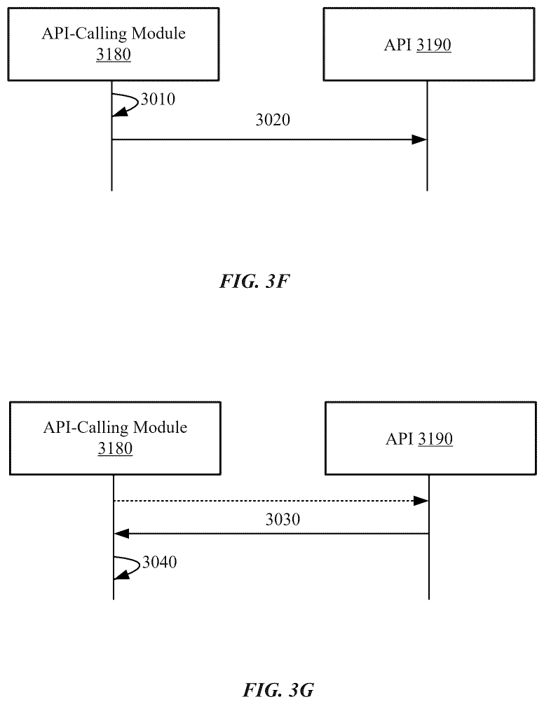

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user's head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward-facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-302 of an HMD. The display unit 1-302 can include a front display assembly 1-308, a frame/housing assembly 1-350, and a curtain assembly 1-324. The display unit 1-302 can also include a sensor assembly 1-356, logic board assembly 1-358, and cooling assembly 1-360 disposed between the frame assembly 1-350 and the front display assembly 1-308. In at least one example, the display unit 1-302 can also include a rear-facing display assembly 1-320 including first and second rear-facing display screens 1-322a, 1-322b disposed between the frame 1-350 and the curtain assembly 1-324.

In at least one example, the display unit 1-302 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-302 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of an HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-IE, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the display assembly 1-108 of the HMD 1-100 shown in FIG. 1B or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1I. Terms such as “vertical,” “up,” “down,” and similar terms refer to orientations or directions as indicated by the Z-axis shown in FIG. 1I. Terms such as “frontward,” “rearward,” “forward,” backward,” and similar terms refer to orientations or directions as indicated by the Y-axis shown in FIG. 1I.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward-facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward-facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin.

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

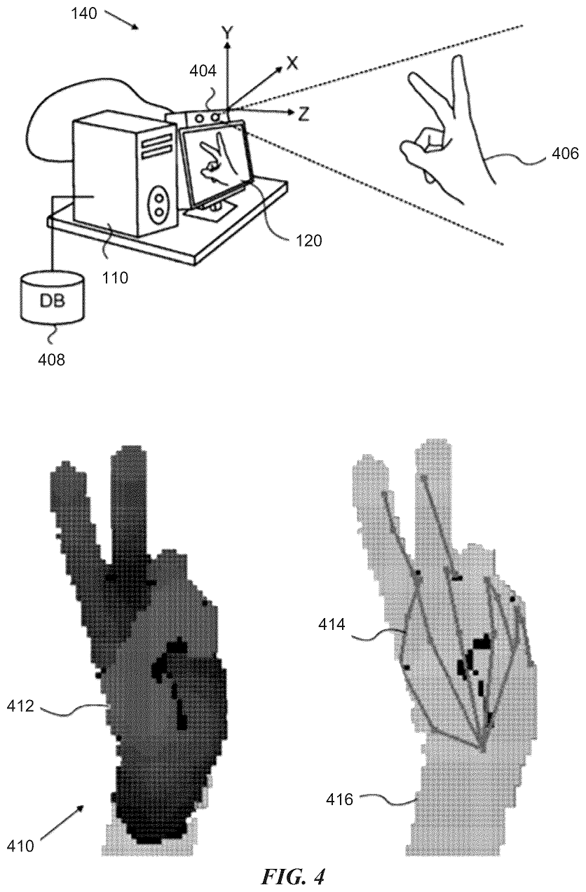

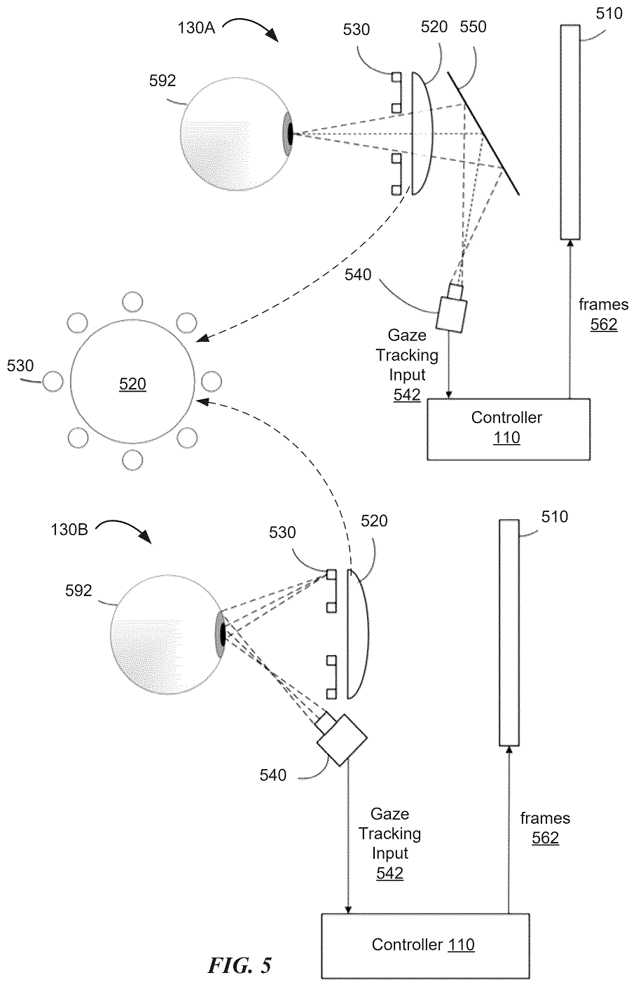

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 800, 1000, 1100, 1300, 1500, and/or 1700 (FIGS. 8, 10, 11, 13, 15, and/or 17) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand). In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105 or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, e.g., the measured z distance from the image sensors 404, with the shade of gray growing darker with increasing depth. The controller 110 processes these depth values in order to identify and segment a component of the image (e.g., a group of neighboring pixels) having characteristics of a human hand. These characteristics, may include, for example, overall size, shape, and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device and is optionally used in conjunction with a head-mounted display generation component. In some embodiments, the eye tracking device 130 is not a head-mounted device and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)) mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

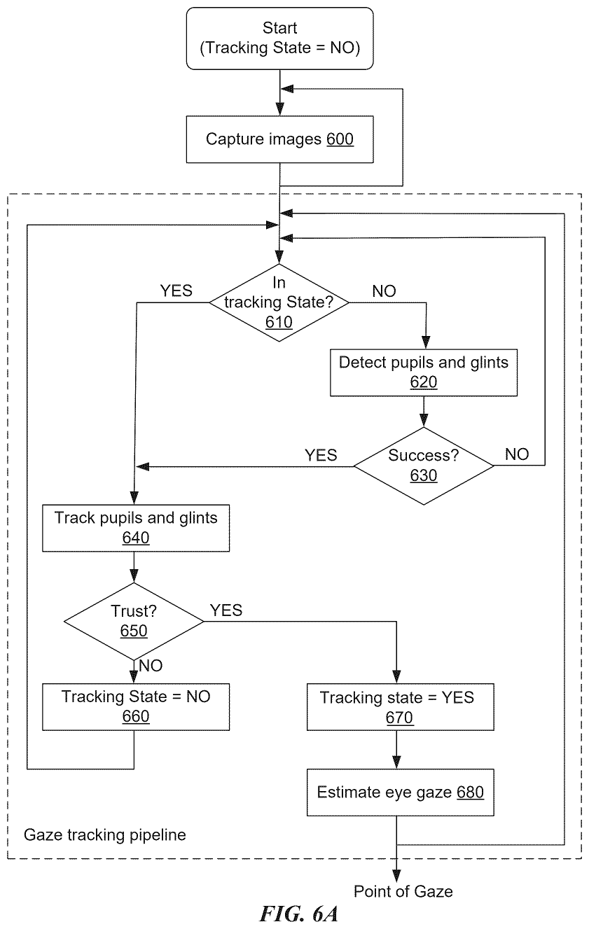

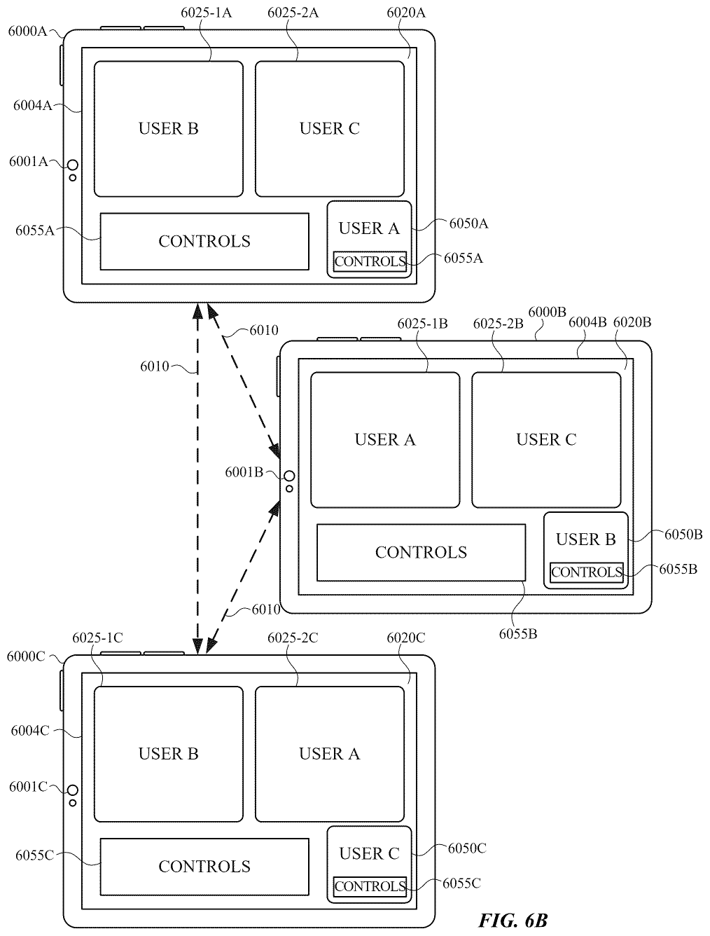

FIG. 6A illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6A, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6A is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head-mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

FIG. 6B depicts an exemplary diagram of a communication session between electronic devices 6000A, 6000B, and 6000C. In some embodiments, electronic devices 6000A, 6000B, and 6000C are computer systems, such as computer system 101. In some embodiments, one or more of electronic devices 6000A, 6000B, and/or 6000C are HMDs, such as, for example, HMD 1-100, 1-200, 3-100, 6-100, 6-200, 6-300, 6-400, 11.1.1-100, and/or 11.1.2-100. Devices 6000A, 6000B, and 6000C each share with each other one or more data connections 6010 such as an Internet connection, Wi-Fi connection, cellular connection, short-range communication connection, and/or any other such data connection or network so as to facilitate real time communication of audio and/or video data between the respective devices for a duration of time. In some embodiments, an exemplary communication session can include a shared-data session whereby data is communicated from one or more of the electronic devices to the other electronic devices to enable concurrent output of respective content at the electronic devices. In some embodiments, an exemplary communication session can include a video conference session whereby audio and/or video data is communicated between devices 6000A, 6000B, and 6000C such that users of the respective devices can engage in real time communication using the electronic devices.

In FIG. 6B, device 6000A represents an electronic device associated with User A. Device 6000A is in communication (via data connections 6010) with devices 6000B and 6000C, which are associated with User B and User C, respectively. Device 6000A includes camera 6001A, which is used to capture video data for the communication session, and display 6004A (e.g., a touchscreen; a display generation component; and/or a display module of an HMD), which is used to display content associated with the communication session. Device 6000A also includes other components, such as a microphone for recording audio for the communication session and a speaker for outputting audio for the communication session.

Device 6000A displays, via display 6004A, communication UI 6020A, which is a user interface for facilitating a communication session (e.g., a video conference session) between device 6000B and device 6000C. Communication UI 6020A includes video feed 6025-1A and video feed 6025-2A. Video feed 6025-1A is a representation of video data captured at device 6000B (e.g., using camera 6001B) and communicated from device 6000B to devices 6000A and 6000C during the communication session. Video feed 6025-2A is a representation of video data captured at device 6000C (e.g., using camera 6001C) and communicated from device 6000C to devices 6000A and 6000B during the communication session.

Communication UI 6020A includes camera preview 6050A, which is a representation of video data captured at device 6000A via camera 6001A. Camera preview 6050A represents to User A the prospective video feed of User A that is displayed at respective devices 6000B and 6000C.

Communication UI 6020A includes one or more controls 6055A for controlling one or more aspects of the communication session. For example, controls 6055A can include controls for muting audio for the communication session, changing a camera view for the communication session (e.g., changing which camera is used for capturing video for the communication session, adjusting a zoom value), terminating the communication session, applying visual effects to the camera view for the communication session, activating one or more modes associated with the communication session. In some embodiments, one or more controls 6055A are optionally displayed in communication UI 60520A. In some embodiments, one or more controls 6055A are displayed separate from camera preview 6050A. In some embodiments, one or more controls 6055A are displayed overlaying at least a portion of camera preview 6050A.

In FIG. 6B, device 6000B represents an electronic device associated with User B, which is in communication (via data connections 6010) with devices 6000A and 6000C. Device 6000B includes camera 6001B, which is used to capture video data for the communication session, and display 6004B (e.g., a touchscreen; a display generation component; and/or a display module of an HMD), which is used to display content associated with the communication session. Device 6000B also includes other components, such as a microphone for recording audio for the communication session and a speaker for outputting audio for the communication session.

Device 6000B displays, via display 6004B, communication UI 6020B, which is similar to communication UI 6020A of device 6000A. Communication UI 6020B includes video feed 6025-1B and video feed 6025-2B. Video feed 6025-1B is a representation of video data captured at device 6000A (e.g., using camera 6001A) and communicated from device 6000A to devices 6000B and 6000C during the communication session. Video feed 6025-2B is a representation of video data captured at device 6000C (e.g., using camera 6001C) and communicated from device 6000C to devices 6000A and 6000B during the communication session. Communication UI 6020B also includes camera preview 6050B, which is a representation of video data captured at device 6000B via camera 6001B, and one or more controls 6055B for controlling one or more aspects of the communication session, similar to controls 6055A. Camera preview 6050B represents to User B the prospective video feed of User B that is displayed at respective devices 6000A and 6000C.

In FIG. 6B, device 6000C represents an electronic device associated with User C, which is in communication (via data connections 6010) with devices 6000A and 6000B. Device 6000C includes camera 6001C, which is used to capture video data for the communication session, and display 6004C (e.g., a touchscreen; a display generation component; and/or a display module of an HMD), which is used to display content associated with the communication session. Device 6000C also includes other components, such as a microphone for recording audio for the communication session and a speaker for outputting audio for the communication session.

Device 6000C displays, via display 6004C, communication UI 6020C, which is similar to communication UI 6020A of device 6000A and communication UI 6020B of device 6000B. Communication UI 6020C includes video feed 6025-1C and video feed 6025-2C. Video feed 6025-1C is a representation of video data captured at device 6000B (e.g., using camera 6001B) and communicated from device 6000B to devices 6000A and 6000C during the communication session. Video feed 6025-2C is a representation of video data captured at device 6000A (e.g., using camera 6001A) and communicated from device 6000A to devices 6000B and 6000C during the communication session. Communication UI 6020C also includes camera preview 6050C, which is a representation of video data captured at device 6000C via camera 6001C, and one or more controls 6055C for controlling one or more aspects of the communication session, similar to controls 6055A and 6055B. Camera preview 6050C represents to User C the prospective video feed of User C that is displayed at respective devices 6000A and 6000B.

While the diagram depicted in FIG. 6B represents a communication session between three electronic devices, the communication session can be established between two or more electronic devices, and the number of devices participating in the communication session can change as electronic devices join or leave the communication session. For example, if one of the electronic devices leaves the communication session, audio and video data from the device that stopped participating in the communication session is no longer represented on the participating devices. For example, if device 6000B stops participating in the communication session, there is no data connection 6010 between devices 6000A and 6000B, and no data connection 6010 between devices 6000C and 6000B. Additionally, device 6000A does not include video feed 6025-1A and device 6000C does not include video feed 6025-1C. Similarly, if a device joins the communication session, a connection is established between the joining device and the existing devices, and the video and audio data is shared among all devices such that each device is capable of outputting data communicated from the other devices.

The embodiment depicted in FIG. 6B represents a diagram of a communication session between multiple electronic devices, including the example communication sessions depicted in FIG. 12AN. In some embodiments, the communication sessions depicted in FIG. 12AN include two or more electronic devices, even if other electronic devices participating in the communication session are not depicted in the figures.

### User Interfaces and Associated Processes

Attention is now directed towards embodiments of user interfaces (“UI”) and associated processes that may be implemented on a computer system, such as a portable multifunction device or a head-mounted device, in communication with one or more display generation components and, optionally, one or more input devices.

FIGS. 7A-7AB illustrate examples of initiating a guest mode of operation of a computer system. FIG. 8 is a flow diagram of an exemplary method 800 for initiating a guest mode of operation of a computer system. The user interfaces in FIGS. 7A-7AB are used to illustrate the processes described below, including the processes in FIG. 8.

FIG. 7A depicts user 710 putting computer system 700 on their head. In the depicted embodiments, computer system 700 is a head-mounted device (HMD). As is more clearly seen in FIG. 7B, computer system 700 includes display module 702, sensors 703, and hardware control 704. In some embodiments, hardware control 704 is a rotatable and depressible input mechanism. In some embodiments, computer system 700 includes a pair of display modules that provide stereoscopic content to different eyes of the same user. For example, computer system 700 includes display module 702 (which provides content to a left eye of the user) and a second display module (which provides content to a right eye of the user). In some embodiments, the second display module displays a slightly different image than display module 702 to generate the illusion of stereoscopic depth.

Any of the features, components, and/or parts, including the arrangements and configurations thereof shown in FIGS. 1B-1P can be included, either alone or in any combination, in computer system 700. For example, in some embodiments, computer system 700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module 702 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, computer system 700 includes one or more sensors 703 that include any of the features, components, and/or parts of any of sensors 190, sensors 306, image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, hardware control 704 includes any of the features, components, and/or parts of any of first button 1-128, button 11.1.1-114, second button 1-132, and or dial or button 1-328, either alone or in any combination. In some embodiments, computer system 700 includes one or more audio output components (e.g., electronic component 1-112) for generating audio feedback (e.g., audio output), optionally generated based on detected events and/or user inputs detected by the computer system 700.

At FIG. 7B, in response to detecting that user 710 has placed computer system 700 on their body, computer system 700 attempts biometric authentication of user 710. At FIG. 7B, computer system 700 displays gaze target 706. As the user looks at gaze target 706, computer system 700 attempts biometric authentication by collecting biometric information from user 710 (e.g., one or more scans of user 710's eyes to perform eye-based biometric authentication). Gaze target 706 is displayed overlaid on three-dimensional environment 708. In the depicted scenario, three-dimensional environment 708 includes objects 708a-708c. In some embodiments, three-dimensional environment 708 is displayed by a display (e.g., display module 702) (e.g., a virtual passthrough environment displayed by display module 702). In some embodiments, three-dimensional environment 708 includes a virtual environment or an image (or video) of a physical environment captured by one or more cameras (e.g., one or more cameras that are part of input sensors 703 and/or one or more external cameras). For example, objects 708a-708c are virtual objects that are representative of physical objects that have been captured by one or more cameras and/or detected by one or more sensors. In some embodiments, three-dimensional environment 708 is visible to a user, but is not displayed by a display. For example, in some embodiments, three-dimensional environment 708 is a physical environment (and, for example, objects 708a-708c are physical objects) that is visible to a user (e.g., through a transparent display module 702) without being displayed by display module 702 (e.g., a physical passthrough and/or an optical passthrough environment that is visible through display module 702 but is not displayed by display module 702). At FIG. 7B, computer system 700 is in a locked state in which features of computer system 700 other than user authentication are not accessible by user 710.

In some embodiments, computer system 700 utilizes user input enrollment information in order to interpret user inputs by a user. For example, in some embodiments, computer system 700 utilizes gaze input enrollment information in order to interpret gaze inputs by a user, and/or utilizes hand input enrollment information in order to interpret hand-based inputs by the user (e.g., hand-based air gestures). In some embodiments, user input enrollment information includes one or more offsets and/or one or more adjustment parameters that are applied by computer system 700 in order for computer system 700 to more accurately interpret user inputs (e.g., gaze-based inputs and/or hand-based inputs) from the user. In some embodiments, user input enrollment information is generated (e.g., by computer system 700 or another computer system) based on one or more input enrollment tasks performed by the user, and measurements collected (e.g., by computer system 700 or another computer system) while the user performs the one or more input enrollment tasks, as will be described in greater detail below. In some embodiments, different users will have different corresponding user input enrollment information due to, for example, physical differences between users. Accordingly, in some embodiments, in order to most accurately interpret user inputs from different users, computer system 700 will apply different sets of user input enrollment information when different users are using computer system 700. Throughout the figures, legend 705 indicates whether user input enrollment information has been applied by computer system 700, and also indicates which user input enrollment information has been applied by computer system 700. At FIG. 7B, legend 705 indicates that no user input enrollment information has been applied, as computer system 700 has not yet determined whether user 710 is a known (e.g., registered user) for which user input enrollment information is available.

At FIG. 7C, computer system 700 determines that user 710 is a known (e.g., registered) user based on biometric authentication of user 710. Based on the determination that user 710 is a known user, computer system 700 displays indication 712 (e.g., an indication indicating that user 710 has been identified as a registered user) and home screen user interface 714. Home screen user interface 714 includes a plurality of application icons 714-1 through 714-9 that, when selected, cause computer system 700 to display content (e.g., one or more user interfaces) corresponding to the selected application. Additionally, based on the determination that user 710 is a known user, computer system 700 applies a first set of user input enrollment information that corresponds to and/or is specific to the known user, as indicated by legend 705, which indicates in FIG. 7C that computer system 700 has applied user input enrollment information corresponding to “Registered User 1.” At FIG. 7C, computer system 700 detects three different user inputs: (1) a first user input that includes air gesture 716a (e.g., a pinch air gesture) and gaze input 716b corresponding to application icon 714-1 (e.g., air gesture 716a that occurs as the user is looking at application icon 714-1); (2) a second user input that includes air gesture 716a (e.g., a pinch air gesture) and gaze input 716c corresponding to application icon 714-6 (e.g., air gesture 716a that occurs as the user is looking at application icon 714-6); and (3) a third user input that includes air gesture 716a (e.g., a pinch air gesture) and gaze input 716d corresponding to settings icon 714-3 (e.g., air gesture 716a that occurs while the user is looking at settings icon 714-3). In some embodiments, each of these user inputs is interpreted based on the user input enrollment information that corresponds to user 710. For example, computer system 700 determines that the user is looking at application icon 714-1 (and not, for example, application icon 714-2) based on the user input enrollment information and/or computer system 700 determines that air gesture 716a is a pinch air gesture and not a different air gesture based on the user input enrollment information.

In certain embodiments described herein, air gesture inputs, such as air gesture input 716a, are depicted and/or described as indirect air gestures, in which a user performs an air gesture while looking at a particular object that the user would like to interact with. However, it should be understood that, in various embodiments, the indirect air gestures described herein can be replaced with direct air gestures (e.g., air gestures in which a user moves his or her hand to a position that corresponds to the position of a user interface object before performing the air gesture to interact with the user interface object). In various embodiments, indirect air gestures described herein can be replaced with controller inputs (e.g., using one or more hardware controllers to interact with user interface objects).

At FIG. 7D, in response to pinch gesture 716a and gaze input 716b, computer system 700 displays application window 718a corresponding to the TV application. In response to pinch gesture 716a and gaze input 716c, computer system 700 displays application window 718b corresponding to the browser application. In response to pinch gesture 716a and gaze input 716d, computer system 700 displays settings user interface 720. Settings window 720 includes options 722a-722d. Option 722a, when selected, causes computer system 700 to cease display of user interface 720 and, optionally, re-display home screen user interface 714. Options 722b-722d correspond to a guest mode of computer system 700. In some embodiments, when the guest mode of computer system 700 is enabled, computer system 700 is able to be used by a guest user (e.g., a non-registered user) with limited access to features and/or content of computer system 700. Option 722b, when selected, allows user 710 to select which content (e.g., which applications) a guest user can access while operating computer system 700 in guest mode. Option 722c, when selected, enables or disables a view mirroring feature of computer system 700. When the view mirroring feature is enabled, content displayed by computer system 700 while computer system 700 is operating in guest mode is shared to another device (e.g., another device associated with user 710) so that user 710 can see, on the other device, what the guest user is viewing on computer system 700. Option 722d, when selected, enables and/or initiates the guest mode of computer system 700. FIG. 7D depicts computer system 700 detecting two different user inputs: (1) a first user input that includes air gesture 724a (e.g., a pinch air gesture) and gaze input 724b corresponding to option 722b (e.g., air gesture 724a that occurs as the user is looking at option 722b); and (2) a second user input that includes air gesture 724a (e.g., a pinch air gesture) and gaze input 724c corresponding to option 722d (e.g., air gesture 724a that occurs as the user is looking at option 722d).

At FIG. 7E, in response to air gesture 724a and gaze input 724b, computer system 700 displays user interface 726. User interface 726 includes option 728a and option 728b. Option 728a, when selected, enables only open applications to be accessed by a guest user when computer system 700 is operating in guest mode. Option 728b, when selected, enables all applications and/or all content to be accessed by a guest user when computer system 700 is operating in guest mode. In some embodiments, even when option 728b is selected, certain information (e.g., highly private and/or highly sensitive information, such as medical information and/or stored password information) is still inaccessible to the guest user when computer system 700 is operating in guest mode. At FIG. 7E, option 728a is selected such that only those applications that are currently open on computer system 700 are accessible to a guest user when computer system 700 is operating in guest mode. At FIG. 7E, computer system 700 detects a user input that includes air gesture 730a (e.g., a pinch air gesture) and gaze input 730b corresponding to back option 728c (e.g., air gesture 730a while the user looks at back option 728c). In response to air gesture 730a and gaze input 730b, computer system 700 would return to the state shown in FIG. 7D.

At FIG. 7F, in response to air gesture 724a and gaze input 724c in FIG. 7D, computer system 700 enables the guest mode of computer system 700 and displays instruction 732, which instructs user 710 to share computer system 700 with a guest user within five minutes in order for the guest user to operate computer system 700 in the guest mode.

At FIG. 7G, user 710 hands computer system 700 to guest user 711. At FIG. 7H, guest user 711 has placed computer system 700 on her head. At FIG. 7H, after detecting that a user has placed computer system 700 on their head, computer system 700 attempts biometric authentication of the user (e.g., user 711).

At FIG. 7I, computer system 700 determines that user 711 is not a registered user (e.g., determines that biometric authentication of user 711 has failed). Furthermore, at FIG. 7I, computer system 700 determines that there are no saved guest user enrollments available to and/or saved on computer system 700. For example, as will be described in greater detail below, in some embodiments, a guest user is able to save their guest user input enrollment information to computer system 700 so that they do not have to go through input enrollment again the next time they user computer system 700. However, in FIG. 7I, computer system 700 determines that there is no saved guest user input enrollment information available to computer system 700. In response, in FIG. 7I, computer system 700 initiates input enrollment of the guest user (user 711). At FIG. 7I, computer system 700 displays user interface 734, which instructs user 711 to start creation of a guest profile by pressing hardware control 704. In some embodiments, prior to input enrollment of a guest user (e.g., gaze input enrollment and/or hand input enrollment), a guest user interacts with computer system 700 via hardware control 704 because computer system 700 is not able to accurately and/or reliably interpret gaze-based and/or hand-based (e.g., air gesture-based) inputs from the user. At FIG. 7I, computer system 700 detects user input 736, which includes a press of hardware control 704.

At FIG. 7J, in response to user input 736, computer system 700 displays introductory video 738 that provides the user with instructions on how to perform input enrollment. At FIG. 7K, after introductory video 738 has concluded, computer system 700 displays user interface 740a. User interface 740a instructs user 711 to look at their hands to perform hand-based input enrollment. In some embodiments, hand-based input enrollment of user 711 includes instructing the user to perform specific hand-based air gestures, and scanning and/or measuring the user's hands while they perform the instructed air gestures. In some embodiments, after hand-based input enrollment of user 711 is completed, hand-based input enrollment information corresponding to user 711 is generated and used by computer system 700 to interpret hand-based inputs by user 711. At FIG. 7K, computer system 700 detects user 711 lifting her hands (742a) and performs hand-based input enrollment of user 711.

At FIG. 7L, after hand-based input enrollment of user 711 has been completed, computer system 700 displays user interface 740b. User interface 740b includes gaze targets 744a-744f, and instructs user 711 to sequentially look at each gaze target 744a-744f and perform a pinch air gesture while looking at each gaze target 744a-744f. In some embodiments, as the user sequentially looks at each gaze target 744a-744f, computer system 700 collects one or more scans of user 711's eyes. In some embodiments, after gaze-based input enrollment of user 711 is completed, gaze-based input enrollment information corresponding to 711 is generated and used by computer system 700 to interpret gaze-based input from user 711. At FIG. 7L, computer system 700 detects user input 742b (e.g., a press of hardware control 704), and detects gaze input 742c, and performs gaze-based input enrollment of user 711.

At FIG. 7M, computer system 700 has completed hand-based input enrollment and gaze-based input enrollment of user 711. At FIG. 7M, after completing input enrollment of user 711, computer system 700 applies the newly generated guest input enrollment information (e.g., as indicated by legend 705) to interpret user inputs by user 711. Additionally, at FIG. 7M, computer system displays user interface 746. User interface 746 includes options 746a-746b. Option 746a, when selected, causes computer system 700 to operate in the guest mode of operation with the guest user input enrollment information corresponding to user 711 applied, and when user 711 has completed her guest session on computer system 700, computer system 700 automatically deletes the guest user input enrollment information corresponding to user 711. In some embodiments, in such scenarios, when guest user 711 uses computer system 700 again in the future, user 711 will be required to go through input enrollment (e.g., FIGS. 7I-7L) again. Option 746b, when selected, causes computer system 700 to operate in the guest mode operation with the guest user input enrollment information corresponding to user 711 applied, and when user 711 has completed her guest session on computer system 700, computer system 700 saves and/or maintains user 711's guest user input enrollment information for future user. In some embodiments, in such scenarios, when guest user 711 uses computer system 700 again in the future, user 711 will be able to skip input enrollment. These features will be described in demonstrated in greater detail below. At FIG. 7M, computer system 700 detects air gesture input 748a (e.g., a pinch air gesture) and gaze input 748b corresponding to option 746b (e.g., air gesture input 748a while user 711 looks at option 746b).

At FIG. 7M-1, in response to air gesture input 748a and gaze input 748b, computer system 700 displays user interface 750, which allows user 711 to enter, in text field 750b, a profile name to be associated with the guest user input enrollment information corresponding to user 711. User interface 750 also include option 750a which, when selected, causes computer system to return to the state shown in FIG. 7M, option 750c which, when selected, causes computer system 700 to return to the state shown in FIG. 7M, and option 750d. At FIG. 7M-1, computer system 700 detects air gesture input 752a (e.g., a pinch air gesture) and gaze input 752b corresponding to option 750d (e.g., air gesture input 752a while user 711 looks at option 750d).

At FIG. 7N, in response to air gesture input 752a and gaze input 752b, computer system 700 operates in the guest mode of operation using the guest input enrollment information corresponding to user 711 to interpret user inputs by user 711. As discussed above, in some embodiments, the guest mode of operation permits access to only a subset of applications, features, and/or content (e.g., compared to when computer system 700 is operating in a registered user mode of operation in FIG. 7C). Furthermore, based on option 728a being selected in FIG. 7E, only those applications that were open at the time user 710 handed computer system 700 to guest user 711 are accessible to guest user 711. Accordingly, in FIG. 7N, computer system 700 displays application window 718a, corresponding to a TV application, and application window 718b, corresponding to a browser application, as those were the open applications when user 710 handed computer system 700 to guest user 711. At FIG. 7N, computer system 700 detects air gesture input 758a (e.g., a pinch air gesture) and gaze input 754b. Gaze input 754b is directed to an upper display region near the edge of display module 702.

At FIG. 7O, in response to air gesture input 758a and gaze input 754b, computer system 700 displays control panel user interface 756. Control panel user interface 756 includes time indication 756a that indicates the current time, date indication 756b that indicates the current date, wifi indication 756c that indicates the strength of a wifi signal at computer system 700, and battery indication 756d that indicates the battery level of computer system 700. Control panel user interface 756 also includes guest mode indication 756e, which indicates that computer system 700 is operating in the guest mode of operation. Control panel user interface 756 also includes option 756f. At FIG. 7O, computer system 700 detects air gesture input 758a (e.g., a pinch air gesture) and gaze input 758b corresponding to option 756f (e.g., air gesture input 758a while user 711 looks at option 756f).

At FIG. 7P, in response to air gesture input 758a and gaze input 758b, computer system 700 displays options 760a-760d. Option 760a, when selected, allows user 711 to access one or more accessibility options of computer system 700. Option 760b, when selected, causes computer system 700 to re-perform gaze-based input enrollment (e.g., FIG. 7L). User 711 may want to access this option, for example, if they feel that their initial gaze-based input enrollment was not performed properly and/or gaze-based inputs are not being interpreted correctly by computer system 700. In some embodiments, in response to user selection of option 760b (e.g., air gesture input 762a and gaze input 762b), computer system 700 returns to the state shown in FIG. 7L. Option 760c, when selected, causes computer system 700 to re-perform hand-based input enrollment (e.g., FIG. 7K). User 711 may want to access this option, for example, if they feel that their initial hand-based input enrollment was not performed properly and/or hand-based inputs are not being interpreted correctly by computer system 700. In some embodiments, in response to user selection of option 760c (e.g., air gesture input 762a and gaze input 762c), computer system 700 returns to the state shown in FIG. 7K.

Option 760d is a “delete eyes and hand data” option that is currently in the off or disabled state. When option 760d is disabled, as it is in FIG. 7P, user input enrollment information corresponding to guest user 711 is saved on and/or by computer system 700 even after guest user 711 finishes using computer system 700 so that when guest user 711 uses computer system 700 again in the future, guest user 711 can load the saved user input enrollment information and skip input enrollment (e.g., FIGS. 7I-7L). When option 760d is enabled, user input enrollment information corresponding to guest user 711 is used while guest user 711 is using computer system 700, but when guest user 711 stops using computer system 700 (e.g., when guest user 711 removes computer system 700 from her head), user input enrollment information corresponding to guest user 711 is deleted such that the next time guest user 711 uses compute system 700, guest user 711 will have to go through input enrollment again. At FIG. 7Q, computer system 700 detects air gesture input 762a (e.g., a pinch air gesture) and gaze input 762d corresponding to option 760d (e.g., air gesture input 762a while user 711 looks at option 760d).

At FIG. 7Q, in response to air gesture input 762a and gaze input 762d, computer system 700 transitions option 760d from the disabled state to the enabled state. When option 760d is in the enabled state, guest user input enrollment information corresponding to guest user 711 is marked for deletion after guest user 711 has completed using computer system 700 (e.g., after guest user 711 has completed their guest session). At FIG. 7Q, computer system 700 detects user input 764, which is a press of hardware control 704.

At FIG. 7R, in response to user input 764, computer system 700 displays home screen user interface 714. In FIG. 7C, home screen user interface 714, when computer system 700 was not operating in the guest mode of operation, included additional application icons 714-2, 714-4, 714-5, 714-7, 714-9 that are not displayed by computer system in FIG. 7R. In FIG. 7R, while computer system 700 is operating in the guest mode of operation, home screen user interface 714 includes application icons 714-1, 714-3, 714-6, which are displayed without displaying other app icons (e.g., without displaying any other app icons) as application icons 714-a, 714-3, 714-6 are the application icons (e.g., the only application icons) that guest user 711 is permitted to access. In FIG. 7R, application icons that correspond to inaccessible and/or non-permitted applications have been removed from user interface 714. In certain embodiments, rather than removing application icons 714-2, 714-4, 714-5, 714-7, 714-9 from user interface 714 (as is shown in FIG. 7R), computer system 700 displays these application icons as disabled and/or non-selectable icons. For example, in some embodiments, when computer system 700 is operating in the guest mode of operation, any inaccessible application icons are displayed in user interface 714 in a visual manner indicating that those application icons are inaccessible (e.g., grayed out, desaturated, and/or dimmed), while permitted application icons (e.g., application icons 714-1, 714-3, 714-6) are displayed in a visual manner indicating that those application icons are accessible and/or selectable (e.g., in the same manner as in FIG. 7C in the registered user mode of operation, without dimming, and/or without desaturating). At FIG. 7R, computer system 700 has not yet deleted the guest user input enrollment information corresponding to guest user 711, as guest user 711 continues to use and/or continues to wear computer system 700. At FIG. 7R, computer system 700 detects air gesture input 766a (e.g., a pinch air gesture) and gaze input 766b directed to an upper edge of display module 702.

At FIG. 7S, in response to air gesture input 766a and gaze input 766b, computer system 700 re-displays control panel user interface 756. At FIG. 7S, computer system 700 detects air gesture input 768a (e.g., a pinch air gesture) and gaze input 768b directed to option 756f (e.g., air gesture input 770a while user 711 looks at option 756f). At FIG. 7T, in response to air gesture input 768a and gaze input 768b, computer system 700 displays options 760a-760d. Option 760d is displayed in the enabled state. At FIG. 7T, computer system 700 detects air gesture input 770a (e.g., a pinch air gesture) and gaze input 770b directed to option 760d (e.g., air gesture input 770a while user 711 looks at option 760d). At FIG. 7U, in response to air gesture input 770a and gaze input 770b, computer system 700 transitions option 760d from the enabled state to the disabled state.

At FIG. 7V, computer system 700 detects that it has been removed from the body of guest user 711. In some embodiments, in response to detecting that computer system 700 has been removed from the body of guest user 711, and based on a determination that option 760d was in the enabled state, computer system 700 saves and/or maintains guest user input enrollment information corresponding to guest user 711.

FIGS. 7I through 7V depicted an example scenario in which there were no saved guest enrollments available to and/or saved on computer system 700. FIG. 7W depicts a second example scenario in which biometric authentication of user 711 has failed in FIG. 7H, but there are one or more saved guest user enrollments available to (e.g., saved on) computer system 700. For example, guest user input enrollment information corresponding to guest user 711 has been saved on computer system 700 after FIG. 7V, and guest user 711 is using computer system 700 again at a later time.

At FIG. 7W, based on a determination that biometric authentication of guest user 711 has failed (e.g., in FIG. 7H), and based on a determination that one or more sets of saved guest user input enrollment information is available on computer system 700, computer system 700 displays user interface 772. User interface 772 includes options 772a-772c, and instructs the user to rotate hardware control 704 to scroll between options 772a-772c, and to press hardware control 704 to select an option. Option 772a, when selected, causes computer system 700 to use first saved guest user input enrollment information that was last used on Mar. 14, 2024 at 10:09 AM. Option 772b, when selected, causes computer system 700 to use second saved guest user input enrollment information that is labeled “ELEANOR K.,” and was last used on Mar. 14, 2024 at 4:14 PM. Option 772c, when selected, causes computer system 700 to initiate new input enrollment (e.g., FIGS. 7I-7L).

In some embodiments, saved guest user input enrollment information is only maintained and/or saved on computer system 700 for a threshold duration of time (e.g., 1 day, 3 days, 5 days, 7 days, or 10 days). For example, in some embodiments, after the threshold duration of time has elapsed, the saved guest user input enrollment information is automatically deleted by computer system 700. In some embodiments, the threshold duration of time is measured from the time the saved guest user input enrollment information is originally generated (e.g., based on input enrollment of a guest user). In some embodiments, the threshold duration of time is measured from the last time the saved guest user input enrollment information was used by a guest user, such that additional use of the saved guest user input enrollment information resets the clock for deleting the saved guest user input enrollment information.

At FIG. 7W, option 772a is currently highlighted. At FIG. 7W, computer system 700 detects user input 774a, which is rotation of hardware control 704. At FIG. 7W-1, computer system 700 displays option 772b as currently highlighted. At FIG. 7W-1, while option 772b is highlighted, computer system 700 detects user input 774b, which is a press of hardware control 704. At FIG. 7X, in response to user input 774b, computer system 700 applies the saved guest user input enrollment information labeled “ELEANOR K.,” as indicated by legend 705, and operates computer system 700 in the guest mode of operation.

While FIGS. 7W-7X depicted an example embodiment in which a guest user is able to selected which guest user input enrollment information to be applied (e.g., a guest user is able to select between options 772a-772c in FIG. 7W), FIG. 7Y depicts an example embodiment in which a registered user and/or an owner of computer system 700 is able to select between options 772a-772c (e.g., options for which guest user input enrollment information to apply and/or whether to initiate a new guest user input enrollment) prior to handing computer system 700 to a guest user.

At FIG. 7Y, registered user 710 is using computer system 700, and computer system 700 displays user interface 720, which was described above. At FIG. 7Y, computer system 700 detects air gesture input 776a (e.g., a pinch air gesture) and gaze input 776b corresponding to option 722d (e.g., air gesture input 776a while user 710 looks at option 722d).

At FIG. 7Z, in response to air gesture input 776a and gaze input 776b, computer system 700 displays user interface 778. User interface 778 includes options 778a, 778b, and 778c, which correspond to options 772a, 772b, 772c discussed above with reference to FIG. 7W. Option 772a, when selected (e.g., air gesture input 780a and gaze input 780b), causes computer system 700 to enable the guest mode of operation (e.g., the state shown in FIG. 7F) and to apply a first set of guest user input enrollment information when the guest user starts using computer system 700. Option 772b, when selected (e.g., air gesture input 780a and gaze input 780c), causes computer system 700 to enable the guest mode of operation (e.g., the state shown in FIG. 7F) and to apply a second set of guest user input enrollment information when the guest user starts using computer system 700. Option 772c, when selected (e.g., air gesture input 780a and gaze input 780d), causes computer system 700 to enable the guest mode of operation (e.g., the state shown in FIG. 7F) and to perform new user input enrollment of the guest user when the guest user starts using computer system 700 (e.g., the state shown in FIG. 7I). In some embodiments, option 778a includes edit option 778a-1, and option 778b includes edit option 778b-1. In some embodiments, option 778a-1, when selected, causes computer system 700 to display one or more options for modifying one or more aspects of the first set of user input enrollment information (e.g., a name and/or an icon associated with the first set of user input enrollment information), and option 778b-1, when selected, causes computer system 700 to display one or more options for modifying one or more aspects of the second set of user input enrollment information (e.g., a name and/or an icon associated with the second set of user input enrollment information). At FIG. 7Z, computer system 700 detects air gesture input 780a (e.g., a pinch air gesture) and gaze input 780e directed to option 778b-1 (e.g., air gesture input 780a while user 710 looks at option 778b-1). At FIG. 7AA, in response to air gesture input 780a and gaze input 780e, computer system 700 displays user interface 782. User interface 782 includes text field 782b that allows user 710 to modify the name of the second set of user input enrollment information corresponding to option 778b. User interface 782 also includes color options 782c to modify the color of an icon associated with the second set of user input enrollment information corresponding to option 778b.

At FIG. 7AB, in response to user selection of option 778a (e.g., air gesture input 780a and gaze input 780b), option 778b (e.g., air gesture input 780a and gaze input 780c), or option 778c (e.g., air gesture input 780a and gaze input 780d) in FIG. 7AA, computer system 700 enables the guest mode of operation, and displays instruction 732 instructing user 710 to hand computer system 700 to a guest user within five minutes.

Additional descriptions regarding FIGS. 7A-7AB are provided below in reference to method 800 described with respect to FIG. 8.

FIG. 8 is a flow diagram of an exemplary method 800 for initiating a guest mode of operation of a computer system, in some embodiments. In some embodiments, method 800 is performed at a computer system (e.g., computer system 101 in FIG. 1A) (e.g., 700) (e.g., a smart phone, a smart watch, a tablet, a laptop, a desktop, a wearable device, and/or head-mounted device) that is in communication with one or more display generation components (e.g., 702) (e.g., display generation component 120 in FIGS. 1A, 3A, and 4) (e.g., a heads-up display, a display, a touchscreen, a projector, etc.) (e.g., a visual output device, a 3D display, a display having at least a portion that is transparent or translucent on which images can be projected (e.g., a see-through display), a projector, a heads-up display, and/or a display controller) and one or more input devices (e.g., 703 and/or 704) (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) and/or one or more mechanical input devices (e.g., a depressible input mechanism; a button; a rotatable input mechanism; a crown; and/or a dial)). In some embodiments, method 800 is governed by instructions that are stored in a non-transitory (or transitory) computer-readable storage medium and that are executed by one or more processors of a computer system, such as the one or more processors 202 of computer system 101 (e.g., controller 110 in FIG. 1A). Some operations in method 800 are, optionally, combined and/or the order of some operations is, optionally, changed.

In some embodiments, the computer system (e.g., 700) detects (802), via the one or more input devices, a first user (e.g., 710 and/or 711) using the computer system (e.g., in some embodiments, detecting one or more user inputs (e.g., via the one or more input devices); detecting a first user beginning use of the computer system; detecting a first user wearing and/or putting on the computer system; and/or detecting a face, eyes, and/or one or more facial features of a first user). In response to detecting the first user using the computer system (804): in accordance with a determination that one or more guest user criteria are satisfied (e.g., in accordance with a determination that the computer system is in a guest user mode; in accordance with a determination that the first user is not identified as a registered user; and/or in accordance with a determination that the first user is identified as a registered guest user) and there is saved guest enrollment information (e.g., gaze-based input calibration information; hand-based input calibration information; and/or air gesture input calibration information) available to the computer system (e.g., a saved guest enrollment that was previously saved on the computer system and/or a saved guest enrollment that is accessible by the computer system) (806) (e.g., FIG. 7W), the computer system initiates (808) a processing for using the saved guest enrollment information (e.g., 772a and/or 772b) to process user inputs by the first user (e.g., 711); and in accordance with a determination that the one or more guest user criteria are satisfied and there is not saved guest enrollment information available to the computer system (810) (e.g., FIG. 7I), the computer system (e.g., 700) initiates (812) a process for performing input enrollment of the first user (e.g., FIGS. 7I-7L) (e.g., initiating a process for enrolling and/or calibrating gaze-based user inputs; initiating a process for enrolling and/or calibrating hand-based user inputs; and/or initiating a process for enrolling and/or calibrating air gesture user inputs).

In some embodiments, performing input enrollment of the first user results in a user input calibration profile being generated for the first user that includes a gaze-based input calibration profile and/or an air gesture input calibration profile for the user. In some embodiments, the one or more guest user criteria are satisfied when the computer system is entered into a guest user mode by a registered user (e.g., 710) of the computer system (e.g., FIGS. 7D-7F). In some embodiments, a registered user (e.g., 710) of the computer system has access to more features than a guest user of the computer system. In some embodiments, the guest user mode (e.g., FIGS. 7N-7S) has access to fewer features of the computer system than when the computer system is in an unlocked mode and/or a registered user mode (e.g., the guest user mode has access to a subset of a plurality of features that are accessible in the unlocked mode and/or the registered user mode) (e.g., FIG. 7C).

In some embodiments, the one or more guest user criteria are satisfied when the first user fails biometric authentication and/or when biometric information (e.g., one or more eye scans, one or more face scans, and/or one or more fingerprint scans) collected from the first user is determined not to match and/or not to correspond with stored biometric information corresponding to a registered user. In some embodiments, the one or more guest user criteria are satisfied when the first user provides one or more user inputs indicating that the first user is a guest user and/or one or more user inputs requesting to operate the computer system in a guest mode of operation. In some embodiments, the one or more guest user criteria are satisfied when the first user is identified as a registered guest user (e.g., via passcode and/or biometric authentication). In some embodiments, a registered guest user has access to fewer features of the computer system than a registered user of the computer system. In some embodiments, in response to detecting the first user using the computer system: in accordance with a determination that the one or more guest user criteria are not satisfied (e.g., in accordance with a determination that the first user is a registered user of the computer system (e.g., based on passcode-based authentication and/or biometric authentication)), the computer system initiates operation in a registered user mode of operation that has access to more features than when the computer system is operating in a guest mode of operation. In some embodiments, guest enrollment information includes gaze-based input calibration information; hand-based input calibration information; and/or air gesture input calibration information. In some embodiments, gaze-based input calibration information includes one or more offset values and/or one or more values that are used in measuring, sensing, and/or responding to gaze inputs from the user (e.g., one or more offset values and/or other values that are determined based on scanning one or more eyes of the user while the user is instructed to look at one or more gaze targets positioned at one or more different display positions). In some embodiments, hand-based input calibration information and/or air gesture input calibration information includes one or more offset values and/or one or more values that are used in measuring, sensing, and/or responding to hand inputs (e.g., gesture inputs and/or air gesture inputs) and/or air gesture input from the user (e.g., one or more offset values and/or other values that are determined based on scanning one or more hands of the user while the user is instructed to perform one or more gestures and/or air gestures). In some embodiments, using the saved guest enrollment information to process user inputs by the first user comprises detecting an input by the first user, and using the saved guest enrollment information to offset, modify, adjust, and/or respond to the input by the first user. For example, in some embodiments, using the saved guest enrollment information to process user inputs by the first user comprises detecting a gaze input by the first user (e.g., detecting the gaze of the first user at a first detected location) (e.g., 752b, 754b, and/or 758b), and using the saved guest enrollment information to offset, modify, adjust, and/or respond to the gaze input by the first user (e.g., using the saved guest enrollment information to adjust the gaze input from the first detected location to a first modified location based on the saved guest enrollment information and/or responding to the gaze input using the first modified location rather than using the first detected location). In some embodiments, using the saved guest enrollment information to process user inputs by the first user comprises detecting a hand input by the first user (e.g., detecting a first detected hand gesture by the first user) (e.g., 752a, 754a, and/or 758a), and using the saved guest enrollment information to offset, modify, adjust, and/or respond to the hand input by the first (e.g., using the saved guest enrollment information to adjust the first detected hand gesture to a first modified hand gesture based on the saved guest enrollment information and/or responding to the first modified hand gesture rather than the first detected hand gesture). Using saved guest enrollment information when it is available, and performing input enrollment for a guest user when saved guest enrollment information is not available, enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, in response to detecting the first user (e.g., 710 and/or 711) using the computer system (e.g., 700): in accordance with a determination that the one or more guest user criteria are not satisfied (e.g., in accordance with a determination that the first user is identified as a registered user and/or is identified as a registered non-guest user), the computer system operates the computer system using registered user enrollment information to process user inputs by the first user (e.g., FIGS. 7B-7F). In some embodiments, registered user enrollment information includes gaze-based input calibration information; hand-based input calibration information; and/or air gesture input calibration information. In some embodiments, gaze-based input calibration information includes one or more offset values and/or one or more values that are used in measuring, sensing, and/or responding to gaze inputs from the user (e.g., one or more offset values and/or other values that are determined based on scanning one or more eyes of the user while the user is instructed to look at one or more gaze targets positioned at one or more different display positions). In some embodiments, hand-based input calibration information and/or air gesture input calibration information includes one or more offset values and/or one or more values that are used in measuring, sensing, and/or responding to hand inputs (e.g., gesture inputs and/or air gesture inputs) and/or air gesture input from the user (e.g., one or more offset values and/or other values that are determined based on scanning one or more hands of the user while the user is instructed to perform one or more gestures and/or air gestures). Automatically operating the computer system using registered user enrollment information when the user is identified as a registered user enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the saved guest enrollment information includes one or more of: hand enrollment information (e.g., hand-based input calibration information) (e.g., FIG. 7K), eye enrollment information (e.g., eye-based and/or gaze-based input calibration information) (e.g., FIG. 7L), or prescription information (e.g., user vision prescription information). In some embodiments, performing input enrollment of the first user includes performing one or more of: hand enrollment (e.g., collecting data while the user performs one or more hand gestures to generate hand-based input calibration information for the user) (e.g., FIG. 7K), eye enrollment (e.g., collecting data while the user looks at one or more gaze targets or perform one or more eye-based movements to generate eye-based input calibration information the user) (e.g. FIG. 7L), or prescription enrollment (e.g., collecting vision prescription information from the user). Using saved guest enrollment information when it is available, and performing input enrollment for a guest user when saved guest enrollment information is not available, enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, initiating the process for using the saved guest enrollment information to process user inputs by the first user comprises concurrently displaying, via the one or more display generation components: a first selectable option (e.g., 772a and/or 772b) that, when selected, causes the computer system to operate the computer system using the saved guest enrollment information; and a second selectable option (e.g., 772c) that, when selected, causes the computer system to initiate the process for performing input enrollment of the first user (e.g., to initiate collection of new input enrollment information without using the saved guest enrollment information). In some embodiments, while concurrently displaying the first selectable option and the second selectable option, the computer system receives, via a first hardware control (e.g., 704) of the computer system (e.g., a crown, a button, a depressible input mechanism, a rotatable input mechanism, and/or rotatable and depressible input mechanism), one or more hardware inputs (e.g., 774a and/or 774b) (e.g., one or more depressions of the first hardware control and/or one or more rotations of the first hardware control). In response to receiving the one or more hardware inputs: in accordance with a determination that the one or more hardware inputs correspond to selection of the first selectable option (e.g., 772a and/or 772b) (e.g., in accordance with a determination that the one or more hardware inputs includes a first combination of hardware inputs), the computer system operates the computer system using the saved guest enrollment information to process user inputs by the first user (e.g., without performing input enrollment of the first user); and in accordance with a determination that the one or more hardware inputs correspond to selection of the second selectable option (e.g., 772c) (e.g., in accordance with a determination that the one or more hardware inputs includes a second combination of hardware inputs different from the first combination of hardware inputs), the computer system initiates the process for performing input enrollment of the first user (e.g., without using the saved guest enrollment information to process inputs by the first user) (e.g., FIGS. 7I-7L). Providing the user with selectable options for either using the saved guest enrollment information for performing a new input enrollment allows the user to perform these operations with fewer inputs. Additionally, gaze and hand inputs are inaccurate before they are properly calibrated with enrollment information, and hardware inputs provide a way for the computer system to be controlled even when gaze and hand inputs are inaccurate due to lack of calibration. As such, allowing the user to select these options using hardware inputs while user-specific input enrollment information has not yet been applied enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, in response to detecting the first user (e.g., 710 and/or 711) using the computer system (e.g., 700): in accordance with a determination that the one or more guest user criteria are satisfied, and there is second saved guest enrollment information different from the guest enrollment information available to the computer system (e.g., gaze-based input calibration information; hand-based input calibration information; and/or air gesture input calibration information), and that biometric information received from the first user (e.g., user eye scan information, user fingerprint scan information, and/or user face scan information) corresponds to the second saved guest enrollment information (and, optionally, does not correspond to the saved guest enrollment information), the computer system initiates a process for using the second saved guest enrollment information to process user inputs by the first user (e.g., without using the saved guest enrollment information to process user inputs by the first user). For example, in some embodiments, in FIG. 7H, if computer system 700 detects that guest user 711 is a known and/or registered guest user with corresponding saved guest user enrollment information available on computer system 700, computer system 700 automatically applies the corresponding saved guest user enrollment information and proceeds for example, to the state shown in FIG. 7N or FIG. 7X. In some embodiments, initiating the process for using the second saved guest enrollment information to process user inputs by the first user includes displaying a confirmation option that, when selected, causes the computer system to operate the computer system using the second saved guest enrollment information to process user inputs by the first user (e.g., without using the saved guest enrollment information to process user inputs by the first user). In some embodiments, initiating the process for using the second saved guest enrollment information to process user inputs by the first user includes requesting user input to confirm that the user approves of operating the computer system using the second saved guest enrollment information to process user inputs by the first user. In some embodiments, initiating the process for using the second saved guest enrollment information to process user inputs by the first user includes operating the computer system using the second saved guest enrollment information to process user inputs by the first user without performing input enrollment of the first user. In some embodiments, using the second saved guest enrollment information to process user inputs by the first user comprises detecting an input by the first user, and using the second saved guest enrollment information to offset, modify, adjust, and/or respond to the input by the first user. For example, in some embodiments, using the second saved guest enrollment information to process user inputs by the first user comprises detecting a gaze input by the first user (e.g., detecting the gaze of the first user at a first detected location) (e.g., 752b, 754b, and/or 758b), and using the second saved guest enrollment information to offset, modify, adjust, and/or respond to the gaze input by the first user (e.g., using the second saved guest enrollment information to adjust the gaze input from the first detected location to a first modified location based on the second saved guest enrollment information and/or responding to the gaze input using the first modified location rather than using the first detected location). In some embodiments, using the second saved guest enrollment information to process user inputs by the first user comprises detecting a hand input by the first user (e.g., detecting a first detected hand gesture by the first user) (e.g., 752a, 754a, and/or 758a), and using the second saved guest enrollment information to offset, modify, adjust, and/or respond to the hand input by the first (e.g., using the second saved guest enrollment information to adjust the first detected hand gesture to a first modified hand gesture based on the second saved guest enrollment information and/or responding to the first modified hand gesture rather than the first detected hand gesture). Automatically selecting a saved guest input enrollment to use when a guest user is biometrically identified allows for performance of these operations without user input. Furthermore, doing so enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, initiating the process for using the saved guest enrollment information to process user inputs by the first user comprises displaying, via the one or more display generation components, an enrollment management user interface (e.g., 772), wherein the enrollment management user interface includes: a first option (e.g., 772a and/or 772b) that, when selected, causes the computer system to operate the computer system using the saved guest enrollment information to process user inputs by the first user; and a second option (e.g., 772c) that, when selected, causes the computer system to initiate the process for performing input enrollment of the first user (e.g., to initiate collection of new input enrollment information without using the saved guest enrollment information) (e.g., FIGS. 7I-7L). Providing the user with selectable options for either using the saved guest enrollment information for performing a new input enrollment allows the user to perform these operations with fewer inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, while concurrently displaying the first option (e.g., 772a and/or 772b) and the second option (e.g., 772c), the computer system receives, via the one or more input devices, a selection input (e.g., 774a and/or 774b) (e.g., one or more user inputs) (e.g., one or more hardware inputs, one or more touch screen inputs, one or more gestures, one or more air gestures, and/or one or more spoken inputs). In response to receiving the selection input: in accordance with a determination that the selection input corresponds to selection of the first option (e.g., 772a and/or 772b) (e.g., without corresponding to selection of the second option), the computer system operates the computer system using the saved guest enrollment information to process user inputs by the first user (e.g., without performing input enrollment of the first user) (e.g., FIG. 7X); and in accordance with a determination that the selection input corresponds to selection of the second option (e.g., 772c) (e.g., without corresponding to selection of the first option), the computer system initiates the process for performing input enrollment of the first user (e.g., without using the saved guest enrollment information to process inputs by the first user) (e.g., FIGS. 7I-7L). Providing the user with selectable options for either using the saved guest enrollment information for performing a new input enrollment allows the user to perform these operations with fewer inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, while displaying the enrollment management user interface (e.g., 772), the computer system receives, via the one or more input devices, a selection input corresponding to selection of the second option (e.g., 772c) (e.g., one or more user inputs corresponding to selection of the second option) (e.g., one or more hardware inputs, one or more touch screen inputs, one or more gestures, one or more air gestures, and/or one or more spoken inputs). In response to receiving the selection input corresponding to selection of the second option, the computer system initiates the process for performing input enrollment of the first user (e.g., FIGS. 7I-7L). Subsequent to performing input enrollment of the first user, the computer system displays, via the one or more display generation components, a save option (e.g., 746b) that, when selected, causes the computer system (e.g., 700) to save new guest enrollment information, wherein the new guest enrollment information is generated based on the input enrollment of the first user. Allowing a guest user to save their input enrollment information allows the user to user the computer system with fewer inputs in the future (e.g., by allowing the user to use the computer system without re-performing input enrollment). Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, while displaying the save option (e.g., 746b), the computer system receives, via the one or more input devices, a first set of one or more user inputs (e.g., one or more hardware inputs, one or more touch screen inputs, one or more gestures, one or more air gestures, and/or one or more spoken inputs). In response to receiving the first set of one or more user inputs: in accordance with a determination that the first set of one or more user inputs corresponds to selection of the save option (e.g., 746b) (e.g., a hardware control input (e.g., a button press) received while the save option is selected and/or highlighted; a gaze input directed to the save option (e.g., looking at the save option for a threshold duration of time); an air gesture input directed to the save option (e.g., a pinch input while pointing at the save option); and/or an air gesture input (e.g., air pinch gesture) while the user is looking at the save option), the computer system saves the new guest enrollment information (e.g., for future use by the first user; and/or in a persistent manner such that the new guest enrollment information is maintained and/or accessible after the first user stops using the computer system and/or after the computer system is turned off and then back on); and operates the computer system using the new guest enrollment information to process user inputs by the first user (e.g., FIG. 7N); and in accordance with a determination that the first set of one or more user inputs corresponds to a user request not to save the new guest enrollment information (e.g., selection of option 746a) (e.g., in some embodiments, in accordance with a determination that the first respective user input corresponds to selection of a continue without saving option (e.g., 746a) different from the save option) (e.g., a hardware control input (e.g., a button press) received while a continue without saving option is selected and/or highlighted; a gaze input directed to a continue without saving option (e.g., looking at the continue without saving option for a threshold duration of time); an air gesture input directed to a continue without saving option (e.g., a pinch input while pointing at the continue without saving option); and/or an air gesture input (e.g., air pinch gesture) while the user is looking at a continue without saving option): the computer system operates the computer system using the new guest enrollment information to process user inputs by the first user without saving the new guest enrollment information (e.g., without saving the new guest enrollment information in a persistent manner such that the new guest enrollment information is maintained and/or remains accessible after the first user stops using the computer system and/or after the computer system is turned off and then back on). Allowing a guest user to save their input enrollment information allows the user to user the computer system with fewer inputs in the future (e.g., by allowing the user to use the computer system without re-performing input enrollment). Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently. Additionally, providing the user with the option to continue without saving their enrollment information improves device security and privacy by ensuring that a user's private information (e.g., their enrollment information) is not improperly stored or accessed without their permission.

In some embodiments, while displaying the save option (e.g., 746b), the computer system receives, via the one or more input devices, a selection input (e.g., 748a and/or 784b) corresponding to selection of the save option (e.g., one or more user inputs corresponding to selection of the save option) (e.g., one or more hardware inputs, one or more touch screen inputs, one or more gestures, one or more air gestures, and/or one or more spoken inputs). In response to receiving the selection input corresponding to selection of the save option: the computer system saves the new guest enrollment information (e.g., for future use by the first user; and/or in a persistent manner such that the new guest enrollment information is maintained and/or accessible after the first user stops using the computer system and/or after the computer system is turned off and then back on); and operates the computer system using the new guest enrollment information to process user inputs by the first user (e.g., FIG. 7N). Subsequent to saving the new guest enrollment information and operating the computer system using the new guest enrollment information to process user inputs by the first user, the computer system detects, via the one or more input devices, a second user (e.g., 710 and/or 711) using the computer system (e.g., 700). In some embodiments, detecting the second user using the computer system comprises detecting one or more user inputs (e.g., via the one or more input devices). In some embodiments, detecting the second user using the computer system comprises detecting a second user beginning use of the computer system. In some embodiments, detecting the second user using the computer system comprises detecting a second user wearing and/or putting on the computer system. In some embodiments, detecting the second user using the computer system comprises detecting a face, eyes, and/or one or more facial features of a second user. In some embodiments, the second user is the same as the first user. In some embodiments, the second user is different from the first user. In response to detecting the second user using the computer system: in accordance with a determination that the one or more guest user criteria are satisfied (e.g., in accordance with a determination that the computer system is in a guest user mode; in accordance with a determination that the second user is not identified as a registered user; and/or in accordance with a determination that the second user is identified as a registered guest user) and that the new guest enrollment information is available to the computer system (e.g., the new guest enrollment information remains saved on the computer system and/or the new guest enrollment information remains accessible to the computer system), the computer system initiates a processing for using the new guest enrollment information to process user inputs by the second user (e.g., FIG. 7W); and in accordance with a determination that the one or more guest user criteria are satisfied and there is not saved guest enrollment information available to the computer system (e.g., the new guest enrollment information has been deleted and/or removed from the computer system), the computer system initiates a process for performing input enrollment of the second user (e.g., initiating a process for enrolling and/or calibrating gaze-based user inputs; initiating a process for enrolling and/or calibrating hand-based user inputs; and/or initiating a process for enrolling and/or calibrating air gesture user inputs) (e.g., FIGS. 7I-7L). In some embodiments, performing input enrollment of the second user results in a user input calibration profile being generated for the second user that includes a gaze-based input calibration profile and/or an air gesture input calibration profile for the user. Using saved guest enrollment information when it is available, and performing input enrollment for a guest user when saved guest enrollment information is not available, enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, subsequent to performing input enrollment of the first user (e.g., FIGS. 7I-7L), the computer system displays, via the one or more display generation components, one or more selectable options (e.g., 750, 750b, 750c, and/or 750d) that, when selected, cause the computer system to save the new guest enrollment information with user-entered identification information (e.g., a name and/or a title for the new guest enrollment information). Allowing a guest user to save their input enrollment information allows the user to user the computer system with fewer inputs in the future (e.g., by allowing the user to use the computer system without re-performing input enrollment). Additionally, allowing the guest users to save their input enrollment information with user-entered identification information allows different guest users to differentiate their saved enrollment information from enrollment information for other guest users. Doing so enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, displaying the enrollment management user interface (e.g., 772) comprises displaying, within the enrollment management user interface, first identifying information (e.g., 772a and/or 772b) corresponding to the saved guest enrollment information and the first option (e.g., first identifying information that provides information about the saved guest enrollment information). In some embodiments, the first identifying information is displayed as part of the first option and/or within the first option. Providing the user with selectable options for either using the saved guest enrollment information for performing a new input enrollment allows the user to perform these operations with fewer inputs. Furthermore, displaying first identifying information corresponding to the saved guest enrollment information and the first option enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first identifying information includes date and/or time information of the last time the saved guest enrollment information was used by a guest user of the computer system (e.g., the last time the saved guest enrollment information was used to process user inputs by a guest user of the computer system) (e.g., 772a indicates last used 3/14/24 at 10:09 AM, and 772b indicates last used 3/14/24 at 4:14 PM). Providing the user with selectable options for either using the saved guest enrollment information for performing a new input enrollment allows the user to perform these operations with fewer inputs. Furthermore, displaying first identifying information corresponding to the saved guest enrollment information and the first option enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first identifying information includes a text identifier (e.g., a user name or nickname or other text entered by a user as a text identifier for the user) corresponding to the saved guest enrollment information (e.g., ELEANOR K. in 772b) (e.g., a user-entered name for naming the saved guest enrollment information; the name of the last user to use the saved guest enrollment information; the name of the user that saved the saved guest enrollment information; and/or the name of the user that performed input enrollment that resulted in generation of the saved guest enrollment information). Providing the user with selectable options for either using the saved guest enrollment information for performing a new input enrollment allows the user to perform these operations with fewer inputs. Furthermore, displaying first identifying information corresponding to the saved guest enrollment information and the first option enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the enrollment management user interface (e.g., 772) further includes a third option (e.g., 772a and/or 772b) that, when selected, causes the computer system to operate the computer system using second saved guest enrollment information different from the saved guest enrollment information to process user inputs by the first user. In some embodiments, displaying the enrollment management user interface (e.g., 772) further comprises displaying, within the enrollment management user interface, second identifying information (e.g., information in 772a and/or 772b) corresponding to the second saved guest enrollment information and the third option (e.g., second identifying information that provides information about the second saved guest enrollment information); the first identifying information includes a first user name corresponding to the saved guest enrollment information (e.g., ELEANOR K. in 772b) (e.g., and does not correspond to the second saved guest enrollment information) (e.g., a user-entered name for naming the saved guest enrollment information; the name of the last user to use the saved guest enrollment information; the name of the user that saved the saved guest enrollment information; and/or the name of the user that performed input enrollment that resulted in generation of the saved guest enrollment information); and the second identifying information includes a second user name different from the first user name and that corresponds to the second saved guest enrollment information (e.g., and does not corresponds to the saved guest enrollment information) (e.g., a user-entered name for naming the second saved guest enrollment information; the name of the last user to use the second saved guest enrollment information; the name of the user that saved the second saved guest enrollment information; and/or the name of the user that performed input enrollment that resulted in generation of the second saved guest enrollment information) (e.g., in some embodiments, option 772a includes a different name from option 772b). Providing the user with selectable options for selecting between different sets of saved guest enrollment information and/or for performing a new input enrollment allows the user to perform these operations with fewer inputs. Furthermore, displaying identifying information corresponding to different sets of saved guest enrollment information enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, subsequent to detecting the first user using the computer system: in accordance with a determination that a first time threshold with respect to the saved guest enrollment information has elapsed (e.g., three days, five days, one week, two weeks, three weeks, or one month), the computer system deletes the saved guest enrollment information (e.g., in some embodiments, after a guest user (e.g., user 711) has stopped using computer system 700, and after a threshold duration of time has elapsed, the saved guest enrollment information is automatically deleted). In some embodiments, subsequent to detecting the first user (e.g., 710 and/or 711) using the computer system (e.g., 700): in accordance with a determination that the first time threshold with respect to the saved guest enrollment information has not elapsed, the computer system forgoes deletion of the saved guest enrollment information (e.g., maintaining the saved guest enrollment information and/or continuing to store and/or save the saved guest enrollment information) (e.g., FIG. 7W). In some embodiments, prior to the first time threshold elapsing, the saved guest enrollment information remains available to be used by the computer system to interpret user inputs by a user. In some embodiments, deleting the saved guest enrollment information causes the saved guest enrollment information to no longer be available and/or accessible to the computer system (e.g., FIG. 7I, in which no saved guest user input enrollment information is available to computer system 700). In some embodiments, the determination that the first time threshold with respect to the saved guest enrollment information has elapsed comprises a determination that a threshold amount of time has elapsed since the saved guest enrollment information was generated, since the saved guest enrollment information was saved to the computer system, and/or since the saved guest enrollment information was made accessible to the computer system. In some embodiments, the determination that the first time threshold with respect to the saved guest enrollment information has elapsed comprises a determination that a threshold amount of time has elapsed since the saved guest enrollment information was last used by the computer system to process user inputs by a guest user. Automatically deleting saved guest enrollment information after a time threshold has elapsed improves device security and privacy by ensuring the biometric information and/or personal information is not stored on the computer system and/or made accessible to the computer system for longer than is authorized by a guest user.

In some embodiments, the determination that the first time threshold with respect to the saved guest enrollment information has elapsed comprises a determination that a threshold amount of time (e.g., three days, five days, one week, two weeks, three weeks, or one month) has elapsed since the saved guest enrollment information was last used by the computer system to process user inputs by a guest user. Automatically deleting saved guest enrollment information after a time threshold has elapsed improves device security and privacy by ensuring the biometric information and/or personal information is not stored on the computer system and/or made accessible to the computer system for longer than is authorized by a guest user.

In some embodiments, while operating the computer system (e.g., 700) using the saved guest enrollment information to process user inputs by the first user (e.g., FIGS. 7M-7U), the computer system displays, via the one or more display generation components, a delete option (e.g., 760d) that, when selected (e.g., when option 760d is in the enabled state), causes the computer system to initiate a process for deleting the saved guest enrollment information. In some embodiments, when the delete option is enabled and/or selected, the computer system deletes the saved guest enrollment information after the guest user has finished using the computer system (e.g., after the guest user removes the computer system from his or her body and/or after the computer system has not been used for a threshold duration of time) (e.g., FIG. 7V). In some embodiments, when the delete option is disabled and/or is unselected, the computer system maintains the saved guest enrollment information after the guest user has finished using the computer system. Providing the guest user with an option to delete saved guest enrollment information improves device security and privacy by ensuring the biometric information and/or personal information is not stored on the computer system and/or made accessible to the computer system for longer than is authorized by a guest user.

In some embodiments, while displaying the delete option (e.g., 760d), the computer system (e.g., 700) receives, via the one or more input devices, a selection input (e.g., 762a and/or 762d) corresponding to selection of the delete option (e.g., one or more inputs corresponding to selection of the delete option). In response to receiving the selection input corresponding to selection of the delete option, the computer system transitions a deletion setting corresponding to the delete option into an enabled state (e.g., from a disabled state) without deleting the saved guest enrollment information (e.g., FIG. 7Q). In some embodiments, the computer system detects that the first user has stopped using the computer system (e.g., detecting that the first user has removed the computer system from his or her body) (e.g., FIG. 7V). In response to detecting that the first user has stopped using the computer system: in accordance with a determination that the deletion setting is in the enabled state, deleting the saved guest enrollment information (e.g., had option 760d been enabled in FIG. 7V, computer system 700 would have deleted the guest user input enrollment information corresponding to guest user 711). In some embodiments, while the deletion setting is in the enabled state, and while the computer system continues to be used by the first user, the saved guest enrollment information is available to be used by the computer system to interpret user inputs by the first user (e.g., FIGS. 7Q-7T and/or user inputs 766a, 766b, 768a, 768b, 770a, and/or 770b)). In some embodiments, deleting the saved guest enrollment information causes the saved guest enrollment information to no longer be available and/or accessible to the computer system.

In some embodiments, detecting that the first user has stopped using the computer system comprises a determination that the first user has stopped using the computer system for at least a threshold duration of time (e.g., a threshold duration of time has elapsed since the first user has removed the computer system from his or her body and has not placed the computer system back on his or her body) (e.g., 0 seconds, 5 seconds, 10 seconds, 30 seconds, 1 minute, or 5 minutes). Based on the determination that the first user has stopped using the computer system for at least the threshold duration of time, the computer system (e.g., 700) deletes the saved guest enrollment information. In some embodiments, if the computer system detects that the first user has removed the computer system from his or her body but has placed the computer system back on his or her body, the computer system does not delete and/or forgoes deleting the saved guest enrollment information such that the saved guest enrollment information continues to be available for use by the computer system to interpret user inputs by the first user. In some embodiments, in response to detecting that the first user has stopped using the computer system: in accordance with a determination that the deletion setting is in a disabled state, the computer system forgoes deleting the saved guest enrollment information (e.g., FIG. 7V). Providing the guest user with an option to delete saved guest enrollment information improves device security and privacy by ensuring the biometric information and/or personal information is not stored on the computer system and/or made accessible to the computer system for longer than is authorized by a guest user.

In some embodiments, subsequent to detecting the selection input (e.g., 726a and/or 762d) corresponding to selection of the delete option (e.g., 760d) and prior to detecting that the first user has stopped using the computer system, the computer system operates the computer system using the saved guest enrollment information to process user inputs (e.g., 766a, 766b, 768a, 768b, 770a, and/or 772b) by the first user (e.g., 711) while the deletion setting is in the enabled state (e.g., using the saved guest enrollment information to process user inputs while the saved guest enrollment information is marked for future deletion). In some embodiments, operating the computer system using the saved guest enrollment information to process user inputs by the first user includes: while displaying a first user interface, receiving a first user input (e.g., 766a, 766b, 768a, 768b, 770a, and/or 770b) from the first user; and in response to receiving the first user input from the first user, displaying visual modification of the first user interface in response to the first user input (e.g., FIGS. 7R-7S, FIGS. 7S-7T, and/or FIGS. 7T-7J), wherein the visual modification of the first user interface is determined and the first user input is interpreted based on the saved guest enrollment information. In some embodiments, the first user input includes a gaze input (e.g., 766b, 768b, and/or 770b), and the gaze input is interpreted based on the saved guest enrollment information. In some embodiments, the gaze input is interpreted as interacting with a first element (e.g., 756f and/or 760d) of the first user interface based on the saved guest enrollment information. In some embodiments, the first user input includes a first air gesture input (e.g., 766a, 768b, and/or 770a). In some embodiments, the first air gesture input is interpreted as being a first type of air gesture input (e.g., a pinch air gesture, a swipe air gesture, a double pinch air gesture, and/or a pinch and hold air gesture) based on the saved guest enrollment information. Providing the guest user with an option to delete saved guest enrollment information improves device security and privacy by ensuring the biometric information and/or personal information is not stored on the computer system and/or made accessible to the computer system for longer than is authorized by a guest user.

In some embodiments, in response to receiving the selection input (e.g., 762 and/or 762d) corresponding to selection of the delete option (e.g., 7060d), the computer system replaces the delete option with a save enrollment option that, when selected, causes the computer system to transition the deletion setting to a disabled state that is different from the enabled state (e.g., from FIG. 7P to FIG. 7Q, option 760d changes from the disabled state to the enabled state). While displaying the save enrollment option (e.g., 760d in FIG. 7T), the computer system receives, via the one or more input devices, a selection input (e.g., 770a and/or 770b) corresponding to selection of the saved enrollment option (e.g., one or more inputs corresponding to selection of the save enrollment option). In response to receiving the selection input corresponding to selection of the save enrollment option, the computer system cancels the process for deleting the saved guest enrollment information (e.g., transitioning option 760d from the enabled state to the disabled state in FIG. 7U). In some embodiments, when the deletion setting is enabled and/or selected (e.g., FIG. 7Q and/or 7T), the computer system deletes the saved guest enrollment information after the guest user has finished using the computer system (e.g., after the guest user removes the computer system from his or her body and/or after the computer system has not been used for a threshold duration of time). In some embodiments, when the deletion setting is disabled and/or is unselected (e.g., FIG. 7P and/or 7U), the computer system maintains the saved guest enrollment information after the guest user has finished using the computer system. Providing the user with a save option that cancels a request to delete the saved guest enrollment information enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, while operating the computer system using the saved guest enrollment information to process user inputs by the first user, the computer system (e.g., 700) displays, via the one or more display generation components (e.g., 702) (and, in some embodiments, concurrently with the delete option and/or the save enrollment option), a first accessibility feature option (e.g., 760a) that, when selected, causes the computer system to initiate a process for enabling a first accessibility feature of the computer system. In some embodiments, the first accessibility feature of the computer system includes, for example, one or more vision accessibility features (e.g., changing screen colors, text size, and/or display zoom; and/or turning audio descriptions, auto-readers, and/or spoken content on or off); one or more hearing accessibility features (e.g., adjusting volume and/or sound EQ settings; turning sound into text; and/or subtitles and captions); one or more mobility accessibility features (e.g., hands-free device control, voice control, dictation, predictive text, and/or customized gestures); and/or one or more speech-related accessibility features (e.g., typing spoken words, making speech requests in text, and/or allowing more time for speech requests). In some embodiments, the first accessibility feature includes one or more gaze input alternatives (e.g., switching from gaze input to head or arm-based pointing). In some embodiments, the first accessibility feature includes one or more hand input alternatives (e.g., using gaze dwell navigation in place of hand input and/or hand-based air gestures). In some embodiments, while displaying the first accessibility feature option, the computer system receives, via the one or more input devices, a user input corresponding to the first accessibility feature option. In response to receiving the user input corresponding to the first accessibility feature option: in accordance with a determination that the user input corresponding to the first accessibility feature option corresponds to a user request to enable the first accessibility feature, the computer system causes the first accessibility feature to be enabled; and in accordance with a determination that the user input corresponding to the first accessibility feature option corresponds to a user request to disable the first accessibility feature, the computer system causes the first accessibility feature to be disabled. Allowing the user of the computer system to manage and/or control accessibility features of the computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently. Additionally, allowing the user of the computer system to manage and/or control accessibility features of the computer system while the computer system is operating in a guest mode of operation enables use of the computer system by a guest user that may be otherwise unable to use the computer system due to physical differences or accessibility needs.

In some embodiments, the computer system performs input enrollment of the first user (e.g., FIGS. 7I-7L) (e.g., gaze input enrollment and/or hand-based input enrollment) to generate first new guest enrollment information (e.g., first new guest enrollment information that includes gaze input calibration information and/or hand input calibration information). Subsequent to performing input enrollment of the first user, the computer system operates the computer system using the first new guest enrollment information to process user inputs by the first user (e.g., FIGS. 7M-7U). In some embodiments, operating the computer system using the first new guest enrollment information to process user inputs by the first user includes: while displaying a first user interface, receiving a first user input (e.g., 748a, 748b, 752a, 752b, 754a, 754b, 758a, 758b, 762a, 762b, 762c, 762d, 766a, 766b, 768a, 768b, 770a, and/or 770b) from the first user; and in response to receiving the first user input from the first user, displaying visual modification of the first user interface in response to the first user input, wherein the visual modification of the first user interface is determined and the first user input is interpreted based on the first new guest enrollment information. In some embodiments, the first user input includes a gaze input (e.g., 748b, 752b, 754b, 758b, 762b, 762c, 762d, 766b, 768b, and/or 770b), and the gaze input is interpreted based on the first new guest enrollment information. In some embodiments, the gaze input is interpreted as interacting with a first element of the first user interface based on the first new guest enrollment information. In some embodiments, the first user input includes a first air gesture input (e.g., 748a, 752a, 754a, 758a, 762a, 766a, 768a, and/or 770a). In some embodiments, the first air gesture input is interpreted as being a first type of air gesture input (e.g., a pinch air gesture, a swipe air gesture, a double pinch air gesture, and/or a pinch and hold air gesture) based on the first new guest enrollment information. Performing input enrollment for guest users enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, subsequent to performing input enrollment of the first user (e.g., FIGS. 7I-7L), the computer system displays, via the one or more display generation components, first visual content (e.g., 746, 750, 718a and/or 718b), wherein the first visual content is automatically centered based on a viewpoint of the first user (e.g., a viewpoint of the first user at the time the first visual content is displayed and/or a viewpoint of the first user at the time input enrollment of the first user is completed) (e.g., user interface 746, user interface 750, window 718a, and/or window 718b are centered based on a viewpoint of user 711 at the time they are displayed). Automatically centering content based on the viewpoint of the user enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, subsequent to operating the computer system using the first new guest enrollment information to process user inputs by the first user, the computer system detects, via the one or more input devices, a registered user (e.g., 710) of the computer system (e.g., 700) (e.g., an owner of the computer system) (e.g., detecting a registered user of the computer system based on biometric identification of the registered user) using the computer system (e.g., in some embodiments, detecting one or more user inputs (e.g., via the one or more input devices); detecting the registered user beginning use of the computer system; detecting the registered user wearing and/or putting on the computer system; and/or detecting a face, eyes, and/or one or more facial features of a registered user). While the registered user of the computer system is using the computer system: the computer system operates the computer system with registered user enrollment information (e.g., registered user enrollment information different from the new guest enrollment information) to process user inputs by the registered user (e.g., FIGS. 7Y-7AB); and displays, via the one or more display generation components, one or more guest enrollment management options (e.g., 778a-1, 778b-1, 782, 782b, and/or 782c) for managing the new guest enrollment information. In some embodiments, operating the computer system using the registered user enrollment information to process user inputs by the registered user includes: while displaying a first user interface, receiving a first user input from the registered user; and in response to receiving the first user input from the registered user, displaying visual modification of the first user interface in response to the first user input, wherein the visual modification of the first user interface is determined and the first user input is interpreted based on the registered user enrollment information. In some embodiments, the first user input includes a gaze input, and the gaze input is interpreted based on the registered user enrollment information. In some embodiments, the gaze input is interpreted as interacting with a first element of the first user interface based on the registered user enrollment information. In some embodiments, the first user input includes a first air gesture input. In some embodiments, the first air gesture input is interpreted as being a first type of air gesture input (e.g., a pinch air gesture, a swipe air gesture, a double pinch air gesture, and/or a pinch and hold air gesture) based on the registered user enrollment information. Providing the registered user with options to manage guest enrollment information improves privacy and device security by ensuring that a registered user and/or an owner of the computer system can prevent unauthorized saving and/or accessing of data on the computer system.

In some embodiments, the one or more guest enrollment management options includes a guest enrollment save option that, when selected, causes the computer system to increase a duration for which the new guest enrollment information will be saved (e.g., in some embodiments, user interface 778 and/or user interface 782 includes a save option that, when selected, increases the duration for which guest enrollment information will be saved) (e.g., making the guest enrollment permanently stored and/or saved for a longer period of time than it would have bene saved in the absence of a user request to save the new guest enrollment information for a longer period of time). Providing the registered user with options to manage guest enrollment information improves privacy and device security by ensuring that a registered user and/or an owner of the computer system can prevent unauthorized saving and/or accessing of data on the computer system.

In some embodiments, the one or more guest enrollment management options includes a guest enrollment deletion option that, when selected, causes the computer system to delete the new guest enrollment information (e.g., in some embodiments, user interface 778 and/or user interface 782 includes a delete option that, when selected, causes computer system 700 to delete the guest enrollment information). In some embodiments, the guest enrollment deletion option, when selected, causes the computer system to delete the new guest enrollment immediately (e.g., because the user does not need the new guest enrollment information to continue to user the computer system). In some embodiments, the guest enrollment deletion option, when selected, causes the computer system to delete the new guest enrollment at a later time (e.g., after the user has stopped using the computer system) (e.g., because the new guest enrollment information is needed in order for the user to continue using the computer system). Providing the registered user with options to manage guest enrollment information improves privacy and device security by ensuring that a registered user and/or an owner of the computer system can prevent unauthorized saving and/or accessing of data on the computer system.

In some embodiments, the computer system receives, via the one or more input devices, a user request to enable a guest mode setting of the computer system (e.g., user inputs 716a and 716d; and/or user inputs 724a and 724c) (e.g., one or more user inputs corresponding to a user request to enable a guest mode setting of the computer system), wherein the guest mode setting permits a guest user (e.g., a non-registered user) to use the computer system (e.g., 700) in a guest mode (e.g., in some embodiments, a guest mode that includes access to fewer features than a registered user mode). In response to receiving the user request to enable the guest mode setting of the computer system: the computer system enables the guest mode setting of the computer system; and enables a view sharing setting (e.g., 722c) of the computer system, wherein the view sharing setting of the computer system, when enabled, causes the computer system to transmit at least a portion of visual content being displayed by the computer system to an external computer system (e.g., an external computer system that corresponds to a registered user of the computer system) (e.g., causes the computer system to mirror visual content being displayed by the computer system on the external computer system and/or to display at least a portion of visual content being displayed by the computer system on an external computer system). In some embodiments, when the guest mode is enabled, display mirroring and/or view sharing is automatically turned on. Automatically enabling display mirroring and/or view sharing of the computer system when the guest mode setting is enabled improves privacy and device security by ensuring that a registered user can monitor the activities of guest users, and that guest users do not access private information or other information that they are not authorized to access.

In some embodiments, the computer system receives, via the one or more input devices, a user request to enable a guest mode setting of the computer system (e.g., user inputs 716a, 716d, 724a, 724b, and/or 724c) (e.g., one or more user inputs corresponding to a user request to enable a guest mode setting of the computer system), wherein the guest mode setting permits a guest user (e.g., a non-registered user) to use the computer system in a guest mode (e.g., in some embodiments, a guest mode that includes access to fewer features than a registered user mode). In response to receiving the user request to enable the guest mode setting of the computer system: the computer system displays, via the one or more display generation components, representations of two or more applications of the computer system that are available to be accessed while the guest mode setting is enabled, including: a representation of a first application that, when selected, causes the computer system to enable or disable the first application while the guest mode setting is enabled; and a representation of a second application different from the first application that, when selected, causes the computer system to enable or disable the first application while the guest mode setting is enabled (e.g., in some embodiments, user interface 720 and/or user interface 726 include and/or display a list of applications that are enabled for the guest mode (e.g., similar to user interface 924 shown in FIG. 9F-1 and described below).

In some embodiments, while displaying the representations of the two or more applications of the computer system that are available to be accessed while the guest mode setting is enabled (and, in some embodiments, while the representation of the first application is in a disabled state) (e.g., such as application options 924a-924i in FIG. 9F-1), the computer system receives, via the one or more input devices, a selection input corresponding to selection of the representation of the first application (e.g., a selection input corresponding to one of application options 924a-924i). In response to receiving the selection input corresponding to selection of the representation of the first application, the computer system transitions the representation of the first application from a disabled state to an enabled state, wherein the enabled state is indicative of the first application being available for use while the computer system is used by a guest user (e.g., a selection input corresponding to application option 924f in FIG. 9F-1 would cause the photos application to transition from a disabled state to an enabled state). In some embodiments, while displaying the representations of the two or more applications of the computer system that are available to be accessed while the guest mode setting is enabled (and, in some embodiments, while the representation of the first application is in an enabled state), the computer system receives, via the one or more input devices, a selection input corresponding to selection of the representation of the first application (e.g., a selection input corresponding to one of application options 924a-924i in FIG. 9F-1). In response to receiving the selection input corresponding to selection of the representation of the first application, the computer system transitions the representation of the first application from an enabled state to a disabled state (e.g., a selection input corresponding to application option 924a in FIG. 9F-1 would cause the TV application to transition from an enabled state to a disabled state), wherein the disabled state is indicative of the first application being unavailable for use while the computer system is used by a guest user.

In some embodiments, while displaying the representations of the two or more applications of the computer system that are available to be accessed while the guest mode setting is enabled (and, in some embodiments, while the representation of the second application is in a disabled state) (e.g., such as application options 924a-924i in FIG. 9F-1), the computer system receives, via the one or more input devices, a selection input corresponding to selection of the representation of the second application (e.g., a selection input corresponding to one of application options 924a-924i). In response to receiving the selection input corresponding to selection of the representation of the second application, the computer system transitions the representation of the second application from a disabled state to enabled state (e.g., a selection input corresponding to application option 924f in FIG. 9F-1 would cause the photos application to transition from a disabled state to an enabled state), wherein the enabled state is indicative of the second application being available for use while the computer system is used by a guest user. In some embodiments, while displaying the representations of the two or more applications of the computer system that are available to be accessed while the guest mode setting is enabled (and, in some embodiments, while the representation of the second application is in an enabled state), the computer system receives, via the one or more input devices, a selection input corresponding to selection of the representation of the second application (e.g., a selection input corresponding to one of application options 924a-924i in FIG. 9F-1). In response to receiving the selection input corresponding to selection of the representation of the second application, the computer system transitions the representation of the second application from an enabled state to a disabled state (e.g., a selection input corresponding to application option 924a in FIG. 9F-1 would cause the TV application to transition from an enabled state to a disabled state), wherein the disabled state is indicative of the second application being unavailable for use while the computer system is used by a guest user. Allowing a user (e.g., a registered user) to control which applications are accessible during guest mode improves privacy and device security by ensuring that guest users do not access unauthorized and/or private information.

In some embodiments, the computer system receives, via the one or more input devices, a user request to enable a guest mode setting of the computer system (e.g., user inputs 716a, 716d, 724a, 724b, 724c, 776a, and/or 776b) (e.g., one or more user inputs corresponding to a user request to enable a guest mode setting of the computer system) (e.g., one or more user inputs corresponding to selection of a guest mode affordance) (e.g., one or more gaze inputs, one or more gesture inputs, one or more air gesture inputs, and/or one or more hardware control inputs corresponding to selection of a guest mode affordance), wherein the guest mode setting permits a guest user (e.g., a non-registered user) to use the computer system in a guest mode (e.g., in some embodiments, a guest mode that includes access to fewer features than a registered user mode). In response to receiving the user request to enable the guest mode setting of the computer system, the computer system concurrently displays, via the one or more display generation components: a first saved guest enrollment option (e.g., 778a and/or 778b) that, when selected, causes the computer system to initiate a process for using the saved guest enrollment information to process user inputs by a guest user; and a new guest user option (e.g., 778c) that, when selected, causes the computer system to initiate a process for performing input enrollment of a guest user (e.g., FIGS. 7I-7L). Allowing a user (e.g., a registered user and/or a guest user) to decide whether to use saved guest enrollment information or to perform a new input enrollment enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system receives, via the one or more input devices, a user request to enable a guest mode setting of the computer system (e.g., user inputs 716a, 716d, 724a, 724b, 724c, 776a, and/or 776b) (e.g., one or more user inputs corresponding to a user request to enable a guest mode setting of the computer system) (e.g., in some embodiments, while the computer system is being used by a first respective user (e.g., a registered user)) (e.g., one or more user inputs corresponding to selection of a guest mode affordance) (e.g., one or more gaze inputs, one or more gesture inputs, one or more air gesture inputs, and/or one or more hardware control inputs corresponding to selection of a guest mode affordance), wherein the guest mode setting permits a guest user (e.g., a non-registered user) to use the computer system in a guest mode (e.g., in some embodiments, a guest mode that includes access to fewer features than a registered user mode). In some embodiments, subsequent to receiving the user request to enable the guest mode setting of the computer system, the computer system detects that the computer system has been removed from the body of a first respective user (e.g., 710 and/or 711) and has been placed on the body of a second respective user (e.g., 710 and/or 711) (e.g., a second respective user that is different from the first respective user or the same as the second respective user). In response to detecting that the computer system has been removed from the body of the first respective user and has been placed on the body of the second respective user: in accordance with a determination that the second respective user is different from the first respective user (e.g., based on biometric authentication and/or biometric identification) (e.g., based on facial identification, eye-based identification, and/or fingerprint-based identification), the computer system initiates the guest mode of the computer system (e.g., FIGS. 7F-7I). In some embodiments, in response to detecting that the computer system has been removed from the body of the first respective user and has been placed on the body of the second respective user: in accordance with a determination that the second respective user is the same as the first respective user, the computer system forgoes initiating the guest mode of the computer system (e.g., maintains the computer system in a registered user mode that has access to more features than the guest mode of the computer system) (e.g., in FIG. 7G, had user 710 placed computer system 700 back on his body, computer system 700 would, in some embodiments, return to the state shown in FIG. 7F or the state shown in FIG. 7C). In some embodiments, the guest mode of the computer system is initiated based on one or more inputs by a registered user and/or a device owner followed by a different user starting to use the computer system.

In some embodiments, detecting that the computer system has been removed from the body of the first respective user includes using one or more sensors (e.g., 703) to detect that the computer system has been removed from the body of the first respective user (e.g., using one or more proximity sensors to determine that the computer system has been moved away from an object (e.g., a body and/or a user); using one or more face sensors to detect that the computer system has been moved away from the face of a user and/or to determine that one or more facial features of a user are no longer detected; and/or using one or more eye sensors to detect that the computer system has been moved away from one or more eyes of a user and/or that one or more eyes of a user are no longer detected). In some embodiments, detecting that the computer system has been placed on the body of a second respective user includes using one or more sensors (e.g., 703) to detect that the computer system has been placed on the body of a second respective user (e.g., using one or more proximity sensors to determine that the computer system has been moved onto and/or towards an object (e.g., a body and/or a user); using one or more face sensors to detect that the computer system has been moved towards the face of a user and/or to determine that one or more facial features of a user are detected; and/or using one or more eye sensors to detect that the computer system has been towards one or more eyes of a user and/or that one or more eyes of a user are detected). Automatically initiating the guest mode in response to one or more inputs by a registered user followed by a different user starting to use the computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system receives, via the one or more input devices (e.g., 703 and/or 704), a user request to enable a guest mode setting of the computer system (e.g., user inputs 716a, 716d, 724a, 724b, 724c, 776a, and/or 776b) (e.g., one or more user inputs corresponding to a user request to enable a guest mode setting of the computer system) (e.g., in some embodiments, while the computer system is being used by a first respective user (e.g., a registered user)) (e.g., one or more user inputs corresponding to selection of a guest mode affordance) (e.g., one or more gaze inputs, one or more gesture inputs, one or more air gesture inputs, and/or one or more hardware control inputs corresponding to selection of a guest mode affordance), wherein the guest mode setting permits a guest user (e.g., a non-registered user) to use the computer system in a guest mode (e.g., in some embodiments, a guest mode that includes access to fewer features than a registered user mode). Subsequent to receiving the user request to enable the guest mode setting of the computer system, the computer system detects that the computer system has been removed from the body of a first respective user (e.g., 710 and/or 711) and has been placed on the body of a second respective user (e.g., 710 and/or 711) (e.g., a second respective user that is different from the first respective user or the same as the second respective user) (e.g., FIG. 7G). In response to detecting that the computer system has been removed from the body of the first respective user and has been placed on the body of the second respective user, the computer system initiates the guest mode of the computer system (e.g., without consideration for whether the second respective user is different from the first respective user) (e.g., FIGS. 7G-7I). In some embodiments, the guest mode of the computer system is initiated based on one or more inputs by a registered user (e.g., 710) and/or a device owner followed by the computer system being removed from the body of a first respective user (e.g., 710) and being put on the body of a second respective user (e.g., FIGS. 7G-7H), without consideration for whether the second respective user is the same user or is a different user from the first respective user.

In some embodiments, detecting that the computer system has been removed from the body of the first respective user includes using one or more sensors (e.g., 703) to detect that the computer system has been removed from the body of the first respective user (e.g., using one or more proximity sensors to determine that the computer system has been moved away from an object (e.g., a body and/or a user); using one or more face sensors to detect that the computer system has been moved away from the face of a user and/or to determine that one or more facial features of a user are no longer detected; and/or using one or more eye sensors to detect that the computer system has been moved away from one or more eyes of a user and/or that one or more eyes of a user are no longer detected).

In some embodiments, detecting that the computer system has been placed on the body of a second respective user includes using one or more sensors (e.g., 703) to detect that the computer system has been placed on the body of a second respective user (e.g., using one or more proximity sensors to determine that the computer system has been moved onto and/or towards an object (e.g., a body and/or a user); using one or more face sensors to detect that the computer system has been moved towards the face of a user and/or to determine that one or more facial features of a user are detected; and/or using one or more eye sensors to detect that the computer system has been towards one or more eyes of a user and/or that one or more eyes of a user are detected). Automatically initiating the guest mode in response to one or more conditions being met enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, aspects/operations of methods 800, 1000, 1100, 1300, 1500, and/or 1700 may be interchanged, substituted, and/or added between these methods. For example, in some embodiments, the computer systems recited in methods 800, 1200, and/or 1700 are the same computer system, the first computer system recited in method 1000, the wearable device recited in method 1500, and/or the external computer system recited in method 1100. In another example, in some embodiments, the computer system recited in method 1100 is the second computer system recited in method 1000. For brevity, these details are not repeated here.

FIGS. 9A-9AA illustrate examples of initiating a guest mode of operation of a computer system, in some embodiments. FIG. 10 is a flow diagram of an exemplary method 1000 for initiating a guest mode of operation of a computer system. FIG. 11 is a flow diagram of an exemplary method of responding to a request to initiate a guest mode of operation on an external computer system. The user interfaces in FIGS. 9A-9AA are used to illustrate the processes described below, including the processes in FIG. 10 and FIG. 11.

FIG. 9A depicts user 900 placing computer system 700 on their head. At FIG. 9B, based on a determination that computer system 700 has been placed on the head of a user, computer system 700 displays gaze target 706 and attempts biometric authentication of user 900 (e.g., face-based, eye-based, and/or iris-based biometric authentication). In the depicted embodiments, computer system 700 is a head-mounted device that includes input sensors 703, hardware control 704, and display module 702. Various embodiments of computer system 700 were described above, for example, with reference to FIGS. 7A-7AB.

FIG. 9C depicts a first example scenario in which user 900 is a registered user, e.g., registered user 710. At FIG. 9C, computer system 700 determines that biometric authentication of user 900 (e.g., user 710) is successful (e.g., successfully identifies user 710 as a registered user of computer system 700). Based on the determination that biometric authentication of user 900 (e.g., user 710) successfully authenticates user 900 as a registered user of computer system 700, computer system 700 transitions from a locked state (e.g., in FIG. 9B) to an unlocked state in FIG. 9C, applies user input enrollment information corresponding to the registered user (e.g., as indicated by legend 705), and displays home screen user interface 714, which includes application icons 714-a through 714-9. Various embodiments of home screen user interface 714 were described above, for example, with reference to FIG. 7C.

FIG. 9D depicts a second example scenario in which user 900 is a guest user, e.g., guest user 711, and biometric authentication of user 900 (e.g., user 711) is unsuccessful (e.g., does not identify user 711 as a registered user of computer system 700). At FIG. 9D, based on the determination that biometric authentication of user 900 (e.g., user 711) is unsuccessful, computer system 700 displays, via display module 702, user interface 902. User interface 902 instructs user 711 to press hardware control 704 in order to send a notification to the device owner requesting to operate computer system 700 in a guest mode of operation. At FIG. 9D, computer system 700 detects user input 904, which is a press of hardware control 704.

At FIG. 9E, in response to user input 904, computer system 700 displays notification 906, which indicates that computer system 700 is waiting for authorization from the device owner, and that a notification has been sent to the device owner. Additionally, at FIG. 9E, in response to user input 904, computer system 700 has transmitted a request (e.g., directly and/or indirectly) to computer system 910. Computer system 910 is a second computer system that is associated with registered user 710. For example, in some embodiments, registered user 710 is a registered user of both computer system 700 and computer system 910. In some embodiments, registered user 710 is registered as the owner of both computer system 700 and computer system 910. In some embodiments, both computer system 700 and computer system 910 are logged into the same user account belonging to registered user 710. In the depicted embodiments, computer system 910 is a smart phone with touch-sensitive display 912 and button 913.

At FIG. 9E, in response to receiving the request from computer system 700, computer system 910 displays user interface 916. In the depicted embodiments, user interface 916 is overlaid on lock screen user interface 914 (e.g., a lock screen user interface 914 that is indicative of computer system 910 being in a locked state). User interface 916 includes options 916a, 916b. Option 916a, when selected, causes computer system 910 to proceed with and/or initiate a process for approving operation of computer system 700 in the guest mode of operation. Option 916b, when selected, causes computer system 910 to transmit to computer system 700 (e.g., indirectly or directly) information indicating that the request to operate computer system 700 in the guest mode of operation has been denied. In some embodiments, when computer system 700 receives information indicating that the request to operate computer system 700 in the guest mode of operation has been denied, computer system 700 displays, via display module 702, an indication that the request to operate computer system 700 in the guest mode of operation has been denied, and maintains computer system 700 in the locked state. At FIG. 9E, computer system 910 detects user input 918 (e.g., a tap input) corresponding to selection of option 916a.

At FIG. 9F, in response to user input 918, computer system 910 displays user interface 920. User interface 920 includes options 920a-920d. Option 920d, when selected, causes computer system 910 to cease display of user interface 920. In some embodiments, option 920d, when selected, causes computer system 910 to transmit to computer system 700 (e.g., indirectly or directly) information indicating that the request to operate computer system 700 in the guest mode of operation has been denied. Option 920a, when selected (e.g., user input 922a), causes computer system 700 (e.g., based on one or more transmissions from computer system 910) to be operated in the guest mode of operation with access to only those applications that were previously open on computer system. Option 920c, when selected (e.g., user input 922c), causes computer system 700 (e.g., based on one or more transmissions from computer system 910) to be operated in the guest mode of operation with access to all applications on computer system 700. In some embodiments, even when option 920c is selected, certain information (e.g., highly private and/or highly sensitive information, such as medical information and/or stored password information) is still inaccessible to the guest user when computer system 700 is operating in guest mode. Option 920b, when selected, causes computer system 910 to display a set of applications that the user of computer system 910 can selectively enable or disable. At FIG. 9F, computer system 910 detects user input 922b (e.g., a tap input) corresponding to selection of option 920b.

At FIG. 9F-1, in response to user input 922b, computer system 910 displays user interface 924. User interface 924 includes options 924a-924i which correspond to different applications of computer system 700. Using user interface 924, user 7f10 can selectively enable or disable individual applications of computer system 700 for the guest session of guest user 711. In FIG. 9F-1, a TV application, a browser application, and a music application have been enabled (e.g., as indicated by indications 924a-1, 924b-1, and 924c-1, respectively), while all other applications have been disabled. In some embodiments, when one or more applications and/or features are disabled for the guest session of guest user 711, one or more other applications and/or features that are dependent on access to the to the disabled applications and/or features are also disabled automatically. For example, in some embodiments, when a photos application (e.g., represented by option 924f) is disabled and/or access to a media library is disabled, one or more other applications and/or features that require access to the photos application and/or the media library are also automatically disabled. For example, in some embodiments, when the photos application is disabled (and/or access to a media library is disabled), a media generation feature that automatically generates visual media (e.g., based on a non-deterministic process, based on a machine learning process, and/or a generative AI process) based on content in the media library and/or in the photos application is also automatically disabled. User interface 924 also includes confirm option 926a and cancel option 926b. In some embodiments, cancel option 926b, when selected, causes computer system 910 to cease display of user interface 924 and return to the state shown in FIG. 9F. In some embodiments, confirm option 926a, when selected, causes computer system 910 to transmit information to computer system 700 (e.g., indirectly or directly) indicating that the request to authorize the guest mode of operation on computer system 700 has been approved, and also indicating which applications have been authorized and/or enabled and/or which applications have not been authorized and/or have been disabled for the guest mode of operation. At FIG. 9F-1, computer system 910 detects user input 928 (e.g., a tap input) corresponding to selection of option 926a.

At FIG. 9G, in response to user input 928 (or, in some embodiments, in response to user input 922a or user input 922c in FIG. 9F), computer system 910 transmits information to computer system 700 (e.g., indirectly or directly) indicating that the request to operate computer system 700 in the guest mode of operation has been approved. Additionally, at FIG. 9G, in response to user input 928, computer system, 910 displays user interface 930. User interface 930 includes screen sharing region 930a, approved content region 930b, screen sharing option 930c, and end session option 930d. Screen sharing region 930a displays content that is being displayed on computer system 700 so that user 710, using computer system 910, can see what guest user 711 is doing on computer system 700. In some embodiments, screen sharing region 930a displays content that is being displayed on computer system 700 when screen sharing option 930c is in an enabled state (as shown in FIG. 9G). In some embodiments, screen sharing option 930c, when selected, transitions between the enabled state and a disabled state. When screen sharing option 930c is in the disabled state, screen sharing region 930a and/or computer system 910 does not display content being displayed by computer system 700.

Approved content region 930b includes options 930b-1, 930b-2, and 930b-3. Option 930b-1, when selected, causes computer system 910 to transmit to computer system 700 (e.g., indirectly or directly) information indicating that a first set of applications (e.g., currently opened applications and/or previously opened application) are permitted for use during the guest mode of operation, and causes computer system 700 to permit access to only that first set of applications. Option 930b-2, when selected, causes computer system 910 to transmit to computer system 700 (e.g., indirectly or directly) information indicating that a second set of applications (e.g., all applications) are permitted for use during the guest mode of operation, and causes computer system 700 to permit access to the second set of applications. Option 930c-1, when selected, causes computer system 910 to transmit to computer system 700 (e.g., indirectly or directly) information indicating that a third set of applications (e.g., applications selected by user 710 in user interface 924) are permitted for use during the guest mode of operation, and causes computer system 700 to permit access to only that third set of applications. In FIG. 9G, option 930b-3 is selected, as indicated by the check mark in option 930b-3, and, as such, only those applications selected by the user in user interface 924 are accessible on computer system 700. In some embodiments, selection of a right portion of option 930b-3 (e.g., the carat at the right of option 930b-3) causes computer system 910 to re-display user interface 924, so that user 710 can enable or disable different applications. Option 930d, when selected, causes computer system 910 to transmit to computer system 700 (e.g., indirectly or directly) information which causes computer system 700 to end operation of computer system 700 in the guest mode of operation, as will be described in greater detail below.

At FIG. 9G, in response to receiving the approval information from computer system 910, computer system 700 displays user interface 772, various embodiments of which were described above with reference to FIG. 7W. In some embodiments, as discussed above, computer system 700 displays user interface 772 based on a determination that one or more sets of saved guest user input enrollment information are available to computer system 700. In some embodiments, when computer system 700 determines that no saved guest user input enrollment information is available, computer system 700 initiates input enrollment of guest user 711 (e.g., FIG. 7I). User interface 772 includes options 772a-772c, and instructs the user to rotate hardware control 704 to scroll between options 772a-772c, and to press hardware control 704 to select an option. Option 772a, when selected, causes computer system 700 to use first saved guest user input enrollment information that was last used on Mar. 14, 2024 at 10:09 AM. Option 772b, when selected, causes computer system 700 to use second saved guest user input enrollment information that is labeled “ELEANOR K.,” and was last used on Mar. 14, 2024 at 4:14 PM. Option 772c, when selected, causes computer system 700 to initiate new input enrollment (e.g., FIGS. 7I-7L). At FIG. 9G, option 772a is highlighted, and computer system 700 detects user input 932, which is a press of hardware control 704.

At FIG. 9H, in response to user input 932, computer system 700 applies a first set of saved guest user input enrollment information corresponding to option 772a, and operates computer system 700 in the guest mode of operation. At FIG. 9H, computer system 910 displays, within region 930a, content being displayed by computer system 700. At FIG. 9H, computer system 910 detects user input 934, which is a swipe up input from the bottom of display 912.

At FIG. 9I, in response to user input 934, computer system 910 ceases display of user interface 930, and displays home screen user interface 936 as well as overlay 938. Overlay 938 corresponds to user interface 930, and includes options 938a, 938b. Option 938a, when selected, causes computer system 910 to re-display user interface 930. Option 938b is an end guest session option and, when selected, causes computer system 910 to transmit to computer system 700 (e.g., directly or indirectly) information that causes computer system 700 to end operation of computer system 700 in the guest mode of operation, as will be described in greater detail below with reference to FIG. 9M. At FIG. 9I, computer system 910 detects user input 940, which is a tap input corresponding to selection of music application icon 936a.

At FIG. 9J, in response to user input 940, computer system 910 ceases display of home screen user interface 936 and displays music application user interface 942. Additionally, at FIG. 9J, computer system 910 displays overlay 944. Overlay 944 is a reduced-size version of overlay 938 and, when selected, causes computer system 900 to re-display overlay 938. In some embodiments, when computer system 910 transitions from home screen user interface 936 to music application user interface 942, computer system 910 maintains display of overlay 938. In some embodiments, computer system 910 transitions from overlay 938 to overlay 944 in response to a determination that the user has not interacted with overlay 938 for a threshold duration of time, and/or in response to a specific user input interacting with overlay 938 (e.g., a swipe up input on overlay 938). At FIG. 9J, computer system 910 detects user input 946, which is a tap input corresponding to overlay 944.

At FIG. 9K, in response to user input 946, computer system 910 expands overlay 944 to re-display overlay 938. At FIG. 9K, computer system 910 detects user input 948, which is a press of button 913. At FIG. 9L, in response to user input 948, computer system 910 transitions computer system 910 from an unlocked state to a locked state, and displays lock screen user interface 914 indicating that computer system 910 is in a locked state. Lock screen user interface 914 includes overlay 950, which corresponds to overlay 938 and the guest mode of computer system 700. Overlay 950 includes option 950a and option 950b. Option 950a, when selected (e.g., user input 952a), causes computer system 910 to display user interface 930. In some embodiments, option 950a, when selected, causes computer system 910 to display user interface 930 after the user of computer system 910 is authenticated (e.g., via biometric authentication and/or passcode-based authentication) and computer system 910 is transitioned from the locked state to the unlocked state. Option 950b is an end guest session option and, when selected, causes computer system 910 to transmit to computer system 700 (e.g., directly or indirectly) information that causes computer system 700 to end operation of computer system 700 in the guest mode of operation. In some embodiments, option 950b, when selected, transmits the end guest mode information to computer system 700 after the user of computer system 910 is authenticated (e.g., via biometric authentication and/or passcode-based authentication) and computer system 910 is transitioned from the locked state to the unlocked state. At FIG. 9L, computer system 910 detects user input 952b, which is a tap input corresponding to selection of option 950b.

At FIG. 9M, in response to user input 952b, computer system 910 transmits, to computer system 700 (e.g., indirectly or directly), information indicating that the user of computer system 910 has requested that computer system 700 stop operating in the guest mode of operation (e.g., has requested that the guest session of guest user 711 be terminated). At FIG. 9M, in response to receiving this information from computer system 910, computer system 700 ceases display of displayed content (e.g., windows 718a, 718b) and displays notification 754 indicating that the guest session has been ended by the owner of computer system 700 (e.g., registered user 710). In the depicted embodiment, after receiving the command to terminate the guest mode of operation and after terminating operation of computer system 700 in the guest mode of operation, computer system 700 maintains display of passthrough environment 708.

FIGS. 9N-9T depict various example scenarios in which a guest user is provided with access to different sets of features based on inputs provided by an owner and/or registered user of computer system 700. At FIG. 9N, similar to the scenario described above with reference to FIG. 9E, user 711 (e.g., a guest user) is wearing computer system 700, and has provided user input requesting to operate computer system 700 in a guest mode of operation. At FIG. 9N, as was described above with reference to FIG. 9E, computer system 700 displays notification 906, and computer system 910 displays user interface 916. Notification 916 informs user 711 that a notification has been sent to the owner of computer system 700, and user interface 916 provides user 710 (e.g., the owner of computer system 700) with options 916a, 916b which allow user 710 to permit or deny operation of computer system 700 in the guest mode of operation, respectively. At FIG. 9N, computer system 910 detects user input 954 (e.g., a selection input such as a touch input, button input, and/or press input) corresponding to selection of option 916a.

At FIG. 9O, in response to detecting user input 954, computer system 910 displays user interface 920, various embodiments of which were described above, for example, with reference to FIG. 9F. User interface 920 includes options 920a-920d. Option 920d, when selected, causes computer system 910 to cease display of user interface 920. In some embodiments, option 920d, when selected, causes computer system 910 to transmit to computer system 700 (e.g., indirectly or directly) information indicating that the request to operate computer system 700 in the guest mode of operation has been denied. Option 920a, when selected (e.g., user input 922a), causes computer system 700 (e.g., based on one or more transmissions from computer system 910) to be operated in the guest mode of operation with access to only those applications that were previously open on computer system. Option 920c, when selected (e.g., user input 922c), causes computer system 700 (e.g., based on one or more transmissions from computer system 910) to be operated in the guest mode of operation with access to a majority of or all applications on computer system 700. In some embodiments, even when option 920c is selected, certain information (e.g., highly private and/or highly sensitive information, such as medical information and/or stored password information) is still inaccessible to the guest user when computer system 700 is operating in guest mode. Option 920b, when selected, causes computer system 910 to display a set of applications that the user of computer system 910 can selectively enable or disable. FIG. 9O depicts three different scenarios in which computer system 910 detects three different user inputs: user input 955a (e.g., a selection input, such as a touch input, a button input, and/or a press input) corresponding to selection of option 920a; user input 955b (e.g., a selection input, such as a touch input, a button input, and/or a press input) corresponding to selection of option 920b; and user input 955c (e.g., a selection input, such as a touch input, a button input, and/or a press input) corresponding to selection of option 920c. Different scenarios and user inputs are described in greater detail below.

At FIG. 9P, in response to detecting user input 955a in FIG. 9O, computer system 910 transmits information to computer system 700 (e.g., directly or indirectly) indicating that the request to operate computer system 700 in the guest mode of operation has been approved, and that computer system 700 is permitted to provide access to a set of currently open applications while computer system 700 is operating in the guest mode of operation. In the scenario shown in FIG. 9P, three applications are currently open: a TV application, a settings application, and a browser application. In response to receiving communication from computer system 910 that computer system 700 is approved to operate in the guest mode of operation, computer system 700 displays home screen user interface 714, various embodiments of which were described above, for example, with reference to FIGS. 7C and 7R. Furthermore, in FIG. 9P, in response to receiving communication from computer system 910 indicating that computer system 700 is only permitted to provide access to a set of currently open applications (e.g., based on user input 955a in FIG. 9O), home screen user interface 914 includes only application icons 714-1, 714-3, and 714-6 corresponding to the approved applications, and excludes any applications icons that are not permitted to be accessed while computer system 700 is operating in the guest mode of operation. Additionally, in FIG. 9P, in response to detecting user input 955a in FIG. 9O, computer system 910 displays user interface 930, various embodiments of which were described above, for example, with reference to FIGS. 9G-9H.

At FIG. 9Q, in response to detecting user input 955c in FIG. 9O, computer system 910 transmits information to computer system 700 (e.g., directly or indirectly) indicating that the request to operate computer system 700 in the guest mode of operation has been approved, and that computer system 700 is permitted to provide access to all available applications while computer system 700 is operating in the guest mode of operation. As described above, in some embodiments, even when the guest user is permitted to access all available applications, certain features and/or information are made unavailable while computer system 700 is operating in the guest mode of operation, such as personal information, medical information, previously exchanged messages with remote users, call logs, browser history, and/or purchase history. In response to receiving communication from computer system 910 that computer system 700 is approved to operate in the guest mode of operation, computer system 700 displays home screen user interface 714. Additionally, in FIG. 9Q, in response to detecting user input 955c in FIG. 9O, computer system 910 displays user interface 930, various embodiments of which were described above, for example, with reference to FIGS. 9G-9H. In FIG. 9Q, in response to receiving communication from computer system 910 indicating that computer system 700 is permitted to provide access to all available applications (e.g., based on user input 955c in FIG. 9O), home screen user interface 914 includes application icons corresponding to all or a majority of available applications. In contrast to FIG. 9P, in which home screen user interface 914 included only three application icons, in FIG. 9Q, home screen user interface 914 displays application icons 714-1 through 714-9, and also includes additional pages of application icons, as indicated by page indication 717. In FIG. 9Q, additional pages of application icons are represented by page representations 714a-714c. Page representation 714a shows that a first page of application icons (e.g., displayed in FIG. 9Q) includes nine applications (e.g., applications 1-9), page representation 714b shows that a second page of application icons includes nine additional applications (e.g., applications 10-18), and page representation 714c shows that a third page of application icons includes five additional applications (e.g., applications 19-23). In FIG. 9P, user interface 714 was limited to a single page of application icons due to the guest user's access being limited to only three applications, while in FIG. 9Q, user interface 714 includes multiple pages of application icons that include twenty-three total application icons. In some embodiments, user interface 714 is re-arranged and/or re-grouped such that application icons corresponding to accessible applications are displayed in the fewer number of pages possible while still adhering to the maximum number of application icons that can be displayed in a single page (which, in the depicted embodiments, is nine application icons).

FIGS. 9P-9Q also depict a feature in which, in some embodiments, when guest user access is provided with less than a threshold level of access (e.g., is provided with access to fewer than all available applications, is provided with access to fewer than a threshold number of applications, and/or is denied access to a specific set of applications), computer system 700 also prevents access to one or more additional features. In contrast, in some embodiments, when a guest user is provided with greater than a threshold level of access (e.g., access to all available applications, access to a threshold number of applications, and/or access to a specific set of applications), the guest user is permitted to access those additional features. For example, in FIGS. 9P and 9Q, computer system 700 displays panel 715 alongside user interface 714. Panel 715 includes options 715-1, 715-2, 715-3. Option 715-1, when selected, causes computer system 700 to display home screen user interface 714 (e.g., a home screen user interface that displays one or more application icons). Option 715-2, when selected, causes computer system 700 to display a communications user interface (e.g., user interface 1287 shown and described below with reference to FIG. 12AJ) that provides access to one or more options for communicating with one or more remote users and/or one or more remote computer systems (e.g., via text message, phone call, and/or video call). Option 715-3, when selected, causes computer system 700 to display an environments user interface that provides the user with one or more options for modifying a virtual environment displayed by computer system 700 (e.g., modify three-dimensional environment 708). At FIG. 9P, due to the guest user's access being limited to only a subset of available applications (e.g., limited to only currently open applications), option 715-2 is disabled, and the guest user is prevented from accessing the communications user interface and/or is prevented from contacting remote users. In contrast, in FIG. 9Q, due to the guest user being permitted to access all available applications, option 715-2 is enabled, and the guest user is able to access the communications user interface and/or is able to contact remote users. In some embodiments, in FIG. 9P, rather than displaying option 715-2 in a disabled and/or non-selectable state, computer system 700 does not display option 715-2 when option 715-2 is disabled and/or when the feature is not available.

At FIG. 9R, in response to detecting user input 955b in FIG. 9O, computer system 910 displays user interface 924. User interface 924 displays options 924a-924i so that user 710 can specify which applications to make accessible while user 711 is operating computer system 700 in the guest mode of operation. Various embodiments of user interface 924 were described, above, for example, with reference to FIG. 9F-1. At FIG. 9R, computer system 910 detects user inputs 956a-956e corresponding to selection of options 924a, 924b, 924c, 924f, and 924g, respectively. At FIG. 9S, in response to detecting user inputs 956a-956e, computer system 910 displays options 924a, 924b, 924c, 924f, 924g with indications 924a-1, 924b-1, 924c-1, 924f-1, 924g-1, respectively, to indicate that those options have been selected. At FIG. 9S, computer system 910 detects user input 957 (e.g., a selection input such as a touch input, button input, or press input) corresponding to selection of option 926a.

At FIG. 9T, in response to detecting user input 926a, computer system 910 transmits information to computer system 700 (e.g., directly or indirectly) indicating that the request to operate computer system 700 in the guest mode of operation has been approved, and that computer system 700 is permitted to provide access to the five applications that were selected in FIG. 9S. In response to receiving communication from computer system 910 that computer system 700 is approved to operate in the guest mode of operation, computer system 700 displays home screen user interface 714. Furthermore, in FIG. 9S, home screen user interface 714 is displayed with application icons 714-1, 714-2, 714-6, 714-7, 714-10 in response to receiving communication from computer system 910 indicating that computer system 700 is permitted to provide access to the five applications that were selected by user 710 on computer system 910 in FIG. 9S. In FIG. 9T, the five application icons 714-1, 714-2, 714-6, 714-7, 714-10 are re-arranged and displayed in a single page of application icons. For example, application icon 714-10 is not displayed in a first page of application icons when the guest user is provided access to all available applications (e.g., as shown in FIG. 9Q), but is moved to the first page of application icons in FIG. 9T in order to condense the permitted application icons into the fewer possible number of pages (which, in FIG. 9T, is a single page of application icons). Additionally, as described above, based on the guest user being provided access to only a subset of applications, option 715-2 in panel 715 is disabled in FIG. 9T.

FIGS. 9U-9AA depict various example scenarios and embodiments in which a guest user is permitted access to and/or is denied access to a view mirroring feature of computer system 700. At FIG. 9U, user 711 (e.g., a guest user) is wearing computer system 700 and is operating computer system 700 in a guest mode of operation. Computer system 910 is being used by user 710, who is the owner of computer system 700. Computer system 910 displays user interface 930, various embodiments of which were described above. As described above, user interface 930 includes region 930a and option 930c. When option 930c is in an on or enabled state, region 930a displays content that is being displayed on computer system 700 and/or that is visible on computer system 700. When option 930c is in an off or disabled state, region 930a does not display content that is being displayed on computer system 700. In FIG. 9U, option 930c is in the on state, and region 930a displays content that is being displayed on computer system 700. At FIG. 9U, computer system 700 detects air gesture input 958a (e.g., a pinch air gesture) and gaze input 958b directed to an upper edge of display module 702.

At FIG. 9V, in response to detecting air gesture input 958a and gaze input 958b, computer system 700 displays control panel user interface 756, various embodiments of which were described above, for example, with reference to FIGS. 7O-7Q. At FIG. 9V, computer system 700 detects air gesture input 959a (e.g., a pinch air gesture) and gaze input 959b directed to option 756f (e.g., air gesture input 959a while user 711 looks at option 756f). At FIG. 9W, in response to detecting air gesture input 959a and gaze input 959b, computer system 700 displays options 760a-760e. Various embodiments of options 760a-760d were described above, for example, with reference to FIGS. 7O-7Q. In FIG. 9W, control panel user interface 756 also includes option 760e. Option 760e, when selected, initiates a process for the user of computer system 700 to mirror the view of computer system 700 (e.g., at least a portion of the view of computer system 700 and/or at least a portion of content being displayed on computer system 700) to a different device (e.g., to display and/or mirror content being displayed by computer system 700 to another device). However, in FIG. 9W, option 760e is disabled (e.g., is not selectable) based on a determination that computer system 910 is already mirroring content being displayed by computer system 700. In some embodiments, while computer system 910 is mirroring and/or viewing content being displayed by computer system 700, option 760e is disabled. In this way, the owner of computer system 700 (e.g., user 710) can disable the view mirroring feature of computer system 700 using computer system 910 (e.g., by mirroring the view of computer system 700 to computer system 910). FIG. 9W depicts two different example scenarios in which computer system 910 detects two different user inputs: user input 960a, which is a swipe up input; and user input 960b (e.g., a selection input, such as a touch input, a button input, and/or a press input) corresponding to selection of option 930c. In some embodiments, either one of user input 960a and/or user input 960b cause computer system 910 to stop displaying content being displayed by computer system 700. For example, in some embodiments, user input 960a causes computer system 910 to cease display of user interface 930; and in some embodiments, user input 960b causes computer system 910 to stop displaying content being displayed by computer system 700 while maintaining display of user interface 930. In some embodiments, either one of user input 960a and/or user input 960b results in the view mirroring feature of computer system 700 (e.g., option 760e) being enabled, as will be described in greater detail below.

At FIG. 9X, in response to detecting user input 960b, computer system 910 switches option 930c to the off state, and stops displaying content being displayed by computer system 700 within region 930a. Furthermore, at FIG. 9X, computer system 700 receives information indicating that computer system 910 is no longer displaying content being displayed by computer system 700 and, in response to receiving this information, enables option 760e. At FIG. 9X, computer system 700 detects air gesture input 962a (e.g., a pinch air gesture) and gaze input 962b corresponding to option 760e (e.g., air gesture input 962a while user 711 looks at option 760e).

At FIG. 9Y, in response to detecting air gesture input 962a and gaze input 962b, computer system 700 displays user interface 966. User interface 966 includes option 966a and options 968a-968d. Option 966a, when selected, causes computer system 700 to cease display of user interface 966 (and, for example, return to the state shown in FIG. 9X). Option 968a corresponds to a first external device (e.g., television 964) that is available for view mirroring (e.g., a first external device that is available to display content that is being displayed on computer system 700); option 968b corresponds to a second external device (e.g., a tablet) that is available for view mirroring (e.g., a second external device that is available to display content that is being displayed on computer system 700); and option 968c corresponds to a third external device (e.g., a desktop display) that is available for view mirroring (e.g., a third external device that is available to display content that is being displayed on computer system 700). Option 968d, when selected, causes computer system 700 to cease view mirroring to an external device. In FIG. 9Y, option 968d is disabled because computer system 700 is not mirroring its view to another device. At FIG. 9Y, computer system 700 detects air gesture input 969a (e.g., a pinch air gesture) and gaze input 969b corresponding to option 968a (e.g., air gesture input 969a while user 711 looks at option 968a).

At FIG. 9Z, in response to detecting air gesture input 969a and gaze input 969b, computer system 700 causes television 964 to display content that is being displayed on computer system 700. At FIG. 9Z, while computer system 700 is causing television 964 to display content that is being displayed on computer system 700 (e.g., while computer system 700 is mirroring its view to television 964), computer system 910 detects user input 970 (e.g., a selection input, such as a touch input, a button input, and/or a press input) corresponding to selection of option 930c.

At FIG. 9AA, in response to detecting user input 970, computer system 910 turned option 930c into the on state or the enabled state, and displays, within region 930a, content that is being displayed on computer system 700. Additionally, in response to detecting user input 970, computer system 910 transmits information to computer system 700 indicating that computer system 910 is displaying content that is being displayed on computer system 700 (e.g., indicating that computer system 910 is mirroring the view of computer system 700). In response to receiving this information, computer system 700 disables its view mirroring feature (e.g., disables option 760e), and ceases causing television 964 to display content that is being displayed on computer system 700 (e.g., ceases transmitting information to television 964 that causes television 964 to display content that is being displayed on computer system 700). As described above, in this way, user 710 (e.g., the owner of computer system 700) is able to enable or disable the view mirroring feature of computer system 700 using his other computer system, computer system 910.

Additional descriptions regarding FIGS. 9A-9AA are provided below in reference to method 1000 and method 1100 described with respect to FIG. 10 and FIG. 11.

FIG. 10 is a flow diagram of an exemplary method 1000 for initiating a guest mode of operation of a computer system, in some embodiments. In some embodiments, method 1000 is performed at a first computer system (e.g., computer system 101 in FIG. 1A) (e.g., 700) that is in communication with one or more display generation components (e.g., 702) (e.g., display generation component 120 in FIGS. 1A, 3A, and 4) (e.g., a heads-up display, a display, a touchscreen, a projector, etc.) (e.g., a visual output device, a 3D display, a display having at least a portion that is transparent or translucent on which images can be projected (e.g., a see-through display), a projector, a heads-up display, and/or a display controller) and one or more input devices (e.g., 702 and/or 703) (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) and/or one or more mechanical input devices (e.g., a depressible input mechanism; a button; a rotatable input mechanism; a crown; and/or a dial)). In some embodiments, method 1000 is governed by instructions that are stored in a non-transitory (or transitory) computer-readable storage medium and that are executed by one or more processors of a computer system, such as the one or more processors 202 of computer system 101 (e.g., controller 110 in FIG. 1A). Some operations in method 1000 are, optionally, combined and/or the order of some operations is, optionally, changed.

The first computer system detects (1002), via the one or more input devices, an attempt to authenticate a first user (e.g., 900, 710, and/or 711) at the first computer system (e.g., 700) (e.g., FIG. 9B), wherein a registered account is associated with a registered user for the first computer system (e.g., via passcode-based authentication and/or biometric authentication (e.g., eye-based authentication, face-based authentication, and/or fingerprint-based authentication)). In response to detecting the attempt to authenticate the first user (1004): in accordance with a determination that the attempt to authenticate the first user meets a first set of criteria, including a first criterion that is satisfied when the attempt to authenticate the first user fails (1006) (e.g., FIG. 9D) (e.g., the attempt to authenticate the first user does not identify the first user as a registered user, the attempt to authenticate the first user fails to authenticate the first user as a registered user using biometric authentication and/or password/passcode authentication) (in some embodiments, the attempt to authenticate the first user identifies the first user as a guest user and/or as a registered guest user), the first computer system (e.g., 700) initiates (1008) a process to operate the first computer system in a guest mode of operation that has restricted access to one or more of a plurality of features of the first computer system, including causing a second computer system (e.g., 910) associated with the registered account to output a request for authorization (e.g., 916) for the first computer system (e.g., 700) to be operated in the guest mode of operation (e.g., a guest mode of operation that has access to a subset of a plurality of features that are accessible in an unlocked mode of operation and/or a registered user mode of operation, and/or a guest mode of operation that has access to fewer features than are available in the unlocked mode of operation and/or the registered user mode of operation). Subsequent to initiating the process to operate the first computer system (e.g., 700) in the guest mode of operation and causing the second computer system (e.g., 910) associated with the registered account to output a request (e.g., 916) for authorization for the first computer system to be operated in the guest mode of operation (1010) (e.g., during and/or as part of the process to operate the first computer system in the guest mode of operation): in accordance with a determination that operation of the first computer system (e.g., 700) in the guest mode of operation is authorized based on input received at the second computer system (e.g., 910) that is associated with the registered account (1012) (e.g., user input 918) (e.g., by an owner of the first computer system and/or another registered user of the first computer system) (e.g., in accordance with a determination that the registered user of the first computer system has approved operation of the first computer system in the guest mode of operation (e.g., via user input on an external device and/or the second computer system that is in communication with the first computer system and/or an external device that is associated with the registered user of the first computer system (e.g., the second computer system))), the first computer system initiates (1014) the guest mode of operation (e.g., transitioning the first computer system from a locked mode of operation to the guest mode of operation). In some embodiments, the locked mode of operation has access to fewer features of the first computer system than the guest mode of operation. In some embodiments, in accordance with a determination that operation of the first computer system (e.g., 700) in the guest mode of operation is not authorized by the registered account of the first computer system (1016) (e.g., user input selecting option 916b) (e.g., because the request for authorization for the first computer system to be operated in the guest mode of operation that was output at the second computer system was not responded to and/or was denied) (e.g., in accordance with a determination that the registered user of the first computer system has not approved operation of the first computer system in the guest mode of operation; and/or the registered user of the first computer system has not provided user input via an external device (e.g., the second computer system) authorizing operation of the first computer system in the guest mode of operation), the first computer system forgoes initiating (1018) the guest mode of operation (e.g., maintaining the first computer system in a locked mode of operation) (e.g., maintain computer system 700 in the state shown in FIGS. 9D, 9E, and/or 9M). In some embodiments, the locked mode of operation prevents access to any features of the first computer system. In some embodiments, the locked mode of operation permits access only to a locked user interface and/or an authentication user interface via which a user is able to enter authentication information (e.g., biometric information and/or passcode-based authentication information) to transition the first computer system out of the locked mode of operation.

In some embodiments, in response to detecting the attempt to authenticate the first user: in accordance with a determination that the attempt to authenticate the first user does not meet the first set of criteria, including a determination that the attempt to authenticate the first user succeeds in authenticating the first user (e.g., FIG. 9C), the first computer system (e.g., 700) initiates a process to operate the first computer system in a registered user mode of operation that includes permitted access to the plurality of features of the first computer system (e.g., a plurality of features associated with a registered user experience and/or a plurality of features associated with an authenticated and/or known user). In some embodiments, the registered user mode of operation includes access to more features than the guest mode of operation. In some embodiments, the guest mode of operation prohibits access to a subset of content that is accessible to the registered user and/or the registered account (e.g., that is accessible in a registered user mode). In some embodiments, the guest mode of operation prohibits access to one or more features within one or more applications that are accessible in the registered user mode of operation. In some embodiments, the guest mode of operation prohibits access to one or more applications that are accessible in the registered user mode of operation. Forgoing initiating the guest mode of operation when it is not authorized by the registered account of the first computer system, and initiating the guest mode of operation only when it is authorized by the registered account of the first computer system, improves privacy and device security by ensuring that unauthorized users are not permitted to access private or confidential information. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first computer system (e.g., 700) is in communication with one or more head-mounted displays (e.g., 702) (e.g., displays worn on the head of a user); detecting the attempt to authenticate the first user, initiating the process to operate the first computer system (e.g., 700) in a guest mode of operation, and causing a second computer system (e.g., 910) associated with the registered account to output a request for authorization for the second computer system to be operated in the guest mode of operation are performed while the first computer system (e.g., 700) is worn on the body of the first user (e.g., 900, 710, and/or 711) (e.g., while at least a portion of the first computer system is worn on the head of the first user); and content displayed by the one or more head-mounted displays (e.g., 702) is visible to only the first user while the first computer system (e.g., 700) is worn on the body of the first user (e.g., the one or more head-mounted displays are worn on the face of the first user and cannot be seen by other people while the one or more head-mounted displays are worn on the face of the first user). Forgoing initiating the guest mode of operation when it is not authorized by the registered account of the first computer system, and initiating the guest mode of operation only when it is authorized by the registered account of the first computer system, improves privacy and device security by ensuring that unauthorized users are not permitted to access private or confidential information. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently. Additionally, allowing a registered user to authorize the guest mode of operation using a separate, second computer system improves system efficiency by, for example, allowing a guest user to use the first computer system without requiring the authorized user to first use the first computer system, remove the first computer system, hand the first computer system to the guest user, and potentially modify physical components of the first computer system (e.g., headband, light seal, and/or prescription lens inserts) to fit the guest user.

In some embodiments, in response to detecting the attempt to authenticate the first user: in accordance with a determination that the attempt to authenticate the first user does not meet the first set of criteria, including a determination that the attempt to authenticate the first user succeeds in authenticating the first user as the registered user (e.g., FIG. 9C) (e.g., based on biometric authentication and/or biometric identification of the first user; and/or based on passcode-based authentication of the first user), the first computer system (e.g., 700) transitions the first computer system from a locked mode of operation (e.g., FIG. 9B) to an unlocked mode of operation (e.g., FIG. 9C) that includes access to more features of the first computer system than the locked mode of operation. In some embodiments, the locked mode of operation prevents access to any features of the first computer system. In some embodiments, the locked mode of operation permits access only to a locked user interface and/or an authentication user interface (e.g., 706) via which a user is able to enter authentication information (e.g., biometric information and/or passcode-based authentication information) to transition the first computer system out of the locked mode of operation. In some embodiments, the locked mode of operation prevents access to one or more applications of the first computer system while the unlocked mode of operation provides and/or permits access to the one or more applications of the first computer system. In some embodiments, the locked mode of operation prevents access to one or more files of the first computer system while the unlocked mode of operation provides and/or permits access to the one or more files of the first computer system. Unlocking the first computer system when the first user is identified as a registered user improves privacy and device security by ensuring that unauthorized users are not permitted to access private or confidential information. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, in response to detecting the attempt to authenticate the first user: in accordance with a determination that the attempt to authenticate the first user does not meet the first set of criteria, including a determination that the attempt to authenticate the first user succeeds in authenticating the first user as the registered user (e.g., FIG. 9C), the first computer system (e.g., 700) operates the first computer system in a registered user mode of operation (e.g., transitioning the first computer system from a locked mode of operation to the registered user mode of operation) that includes permitted access to the plurality of features of the first computer system (e.g., FIG. 9C) (e.g., a plurality of features associated with a registered user experience and/or a plurality of features associated with an authenticated and/or known user). In some embodiments, the registered user mode of operation (e.g., FIG. 9C) includes access to more features than the guest mode of operation (e.g., FIG. 7R). Unlocking the first computer system when the first user is identified as a registered user improves privacy and device security by ensuring that unauthorized users are not permitted to access private or confidential information. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the attempt to authenticate the first user comprises an attempt to biometrically authenticate the first user (e.g., FIG. 9B) (e.g., based on biometric information collected from the first user and/or a biometric profile associated with the registered user for the first computer system) (e.g., face-based biometric authentication, eye-based biometric authentication, and/or fingerprint-based biometric authentication). Forgoing initiating the guest mode of operation when it is not authorized by the registered account of the first computer system, and initiating the guest mode of operation only when it is authorized by the registered account of the first computer system, improves privacy and device security by ensuring that unauthorized users are not permitted to access private or confidential information. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, initiating the process to operate the first computer system (e.g., 700) in the guest mode of operation includes displaying, via the one or more display generation components, a first set of instructions (e.g., 902) instructing the first user to provide one or more user inputs which, when received by the first computer system (e.g., 700), cause the first computer system to transmit instructions to the second computer system (e.g., 910) that cause the second computer system to output the request for authorization for the first computer system to be operated in the guest mode of operation (e.g., 916). Requiring that the registered account provide authorization for the guest mode of operation via the second computer system improves privacy and device security by ensuring that unauthorized users are not permitted to access private or confidential information. Furthermore, providing the first user with instructions on how to request authorization for the guest mode of operation enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, while displaying the first set of instructions (e.g., 902) instructing the first user to provide one or more user inputs (or, in some embodiments, subsequent to displaying the first set of instructions), the first computer system detects, via the one or more input devices, a first set of one or more user inputs (e.g., 904) that are in compliance with the first set of instructions (e.g., one or more inputs (e.g., one or more gaze inputs, one or more touch inputs, one or more gesture inputs, one or more air gesture inputs, and/or one or more hardware control inputs) corresponding to selection of a first affordance (e.g., a first affordance indicating confirmation of a user request to operate the first computer system in the guest mode of operation)). In response to detecting the first set of one or more user inputs (e.g., 904) that are in compliance with the first set of instructions, the first computer system (e.g., 700) causes the second computer system (e.g., 910) associated with the registered account to output a request (e.g., 916) for authorization for the first computer system to be operated in the guest mode of operation. Causing the second computer system to output a request for authorization for the first computer system to be operated in the guest mode of operation, and requiring that the registered account provide authorization for the guest mode of operation via the second computer system, improves privacy and device security by ensuring that unauthorized users are not permitted to access private or confidential information.

In some embodiments, causing the second computer system (e.g., 910) associated with the registered account to output a request (e.g., 916) for authorization for the first computer system to be operated in the guest mode of operation comprises causing the second computer system associated with the registered account to display an authorization affordance (e.g., 916a) that, when selected on the second computer system (e.g., 910), causes the second computer system to transmit information to the first computer system (e.g., 700) indicating that the registered account has authorized for the first computer system to be operated in the guest mode of operation (e.g., an authorization affordance that is selectable by a user to authorized operation of the first computer system in the guest mode of operation). In some embodiments, the authorization affordance is displayed concurrently on the second computer system with an authentication user interface (e.g., in some embodiments, 916 is displayed concurrently with authentication user interface 1234 and/or a biometric authentication user interface such as user interface 706) (e.g., a passcode, password, and/or pattern entry user interface to authenticate a user and/or to unlock the second computer system). Causing the second computer system to output a request for authorization for the first computer system to be operated in the guest mode of operation, and requiring that the registered account provide authorization for the guest mode of operation via the second computer system, and also requiring that the registered account be authenticated on the second computer system, improves privacy and device security by ensuring that unauthorized users are not permitted to access private or confidential information.

In some embodiments, the first set of instructions (e.g., 902) include one or more instructions instructing the first user to provide one or more user inputs via a hardware control (e.g., 704) (e.g., “press digital crown” in FIG. 9D) (e.g., instructing the user to press one or more depressible hardware controls; and/or instructing the user to rotate one or more rotatable hardware controls). Requiring that the registered account provide authorization for the guest mode of operation via the second computer system improves privacy and device security by ensuring that unauthorized users are not permitted to access private or confidential information. Furthermore, providing the first user with instructions on how to request authorization for the guest mode of operation enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first set of instructions include one or more instructions instructing the first user to select a displayed affordance (e.g., in some embodiments, user interface 902 includes a selectable affordance) (e.g., an affordance that is displayed via the one or more display generation components) (e.g., via one or more touch inputs, via one or more hardware control inputs, and/or via one or more air gesture inputs). Requiring that the registered account provide authorization for the guest mode of operation via the second computer system improves privacy and device security by ensuring that unauthorized users are not permitted to access private or confidential information. Furthermore, providing the first user with instructions on how to request authorization for the guest mode of operation enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first set of criteria includes a second criterion that is satisfied when the registered account has enabled the guest mode of operation to be initiated after an attempt to authenticate a user fails (e.g., as shown in FIGS. 7D-7F; and/or enabling a setting and/or a toggle that enables the guest mode of operation to be initiated after an attempt to authenticate a user fails) (e.g., the second criterion is met when the registered account has enabled a guest mode of operation setting and is not met when the registered account has not enabled the guest mode of operation setting) (e.g., a second criterion that must be met in order for the first set of criteria to be met). In some embodiments, in accordance with a determination that the registered account has not enabled the guest mode of operation to be initiated after the attempt to authenticate the user fails and/or in accordance with a determination that the first set of criteria are not met, the first computer system (e.g., 700) forgoes initiating the process to operate the first computer system in the guest mode of operation (e.g., forgoes causing the second computer system to output the request for authorization for the first computer system to be operated in the guest mode of operation) and/or maintains the first computer system in a locked mode. Requiring that the registered account has enabled a guest mode of operation, and forgoing initiating the guest mode of operation when the first set of criteria are not met, improves privacy and device security by ensuring that unauthorized users are not permitted to access private or confidential information.

In some embodiments, the first set of criteria includes a third criterion that is satisfied when the second computer system (e.g., 910) (e.g., when an external computer system associated with the registered user and/or the registered account) is within a threshold distance of the first computer system (e.g., 700) (e.g., a third criterion that is satisfied when the second computer system is within wireless communication range) (in some embodiments, a threshold distance that is determined based on wireless signal strength rather than a fixed distance) (e.g., a third criterion that must be met in order for the first set of criteria to be met). In some embodiments, in accordance with a determination that the second computer system (e.g., 910) is not within the threshold distance of the first computer system (e.g., 700) and/or in accordance with a determination that the first set of criteria are not met, the first computer system (e.g., 700) forgoes initiating the process to operate the first computer system in the guest mode of operation (e.g., forgoes causing the second computer system to output the request for authorization for the first computer system to be operated in the guest mode of operation) and/or maintains the first computer system in a locked mode. Requiring that the second computer system be within a threshold distance of the first computer system, and forgoing initiating the guest mode of operation when the first set of criteria are not met, improves privacy and device security by ensuring that unauthorized users are not permitted to access private or confidential information.

In some embodiments, initiating the guest mode of operation comprises initiating the guest mode of operation using one or more options specified by the registered user on the second computer system (e.g., 910) (e.g., options 920a, 920b, 920c, 924a-924i, 930b-1, 930b-2, 930b-3, and/or 930c). In some embodiments, initiating the guest mode of operation using one or more options specified by the registered user on the second computer system includes initiating the guest mode of operation with access to a first set of applications based on the registered user selecting the first set of applications on the second computer system for permitted access (e.g., options 920a, 920b, 920c, 924a-924i, 930b-1, 930b-2, an d/or 930b-3). In some embodiments, initiating the guest mode of operation using one or more options specified by the registered user on the second computer system includes initiating the guest mode of operation without access to a second set of applications based on the registered user selecting the second set of applications on the second computer system for restricted access (e.g., options 920a, 920b, 920c, 924a-924i, 930b-1, 930b-2, an d/or 930b-3). Allowing the registered user to specify and/or define various settings and/or options of the guest mode of operation using the second computer system improves privacy and device security by ensuring that unauthorized users are not permitted to access private or confidential information. Furthermore, allowing the registered user to perform these actions on the second computer system rather than requiring that they be performed on the first computer system improves efficiency.

In some embodiments, the first computer system (e.g., 700) comprises a set of applications (e.g., a set of installed applications and/or a set of applications that is accessible by the registered account and/or the registered user). In some embodiments, the one or more options specified by the registered user on the second computer system (e.g., 910) includes identification of (e.g., selection of and/or user input identifying and/or selecting) a first subset of the set of applications (e.g., a first subset that includes less than all of the set of applications; a first subset that excludes one or more applications of the set of applications; and/or a first subset that includes the entire set of applications) to be enabled on the first computer system while the first computer system is operating in the guest mode of operation (e.g., FIG. 9O and/or FIGS. 9R-9S). In some embodiments, initiating the guest mode of operation further comprises: in accordance with a determination that the first subset of the set of applications includes a first number of applications, displaying, via the one or more display generation components, a first set of applications icons representative of the first subset of the set of applications with a first spatial arrangement (e.g., a first spatial arrangement in which the first set of application icons is spread across a first number and/or a first plurality of user interface pages and/or home screen pages; and/or a first spatial arrangement in which the first set of applications icons is displayed in a single user interface page) (e.g., in FIG. 9P, application icons 714-1, 714-3, 714-6 are displayed in a first arrangement; in FIG. 9Q, application icons 714-1 through 714-9 and additional application icons in pages two and three of user interface 714 are displayed in a second arrangement; and/or in FIG. 9T, application icons 714-1, 714-2, 714-6, 714-7, 714-10 are displayed in a third arrangement); and in accordance with a determination that the first subset of the set of applications includes a second number of applications different from the first number of applications, displaying, via the one or more display generation components, a second set of application icons representative of the first subset of the set of applications with a second spatial arrangement that is different from the first spatial arrangement (e.g., a second spatial arrangement in which the second set of application icons is spread across a second number and/or a second plurality of user interface pages that is different from the first number of and/or first plurality of user interfaces pages; and/or a second spatial arrangement in which the second set of applications icons is displayed in a single user interface page) (e.g., in FIG. 9P, application icons 714-1, 714-3, 714-6 are displayed in a first arrangement; in FIG. 9Q, application icons 714-1 through 714-9 and additional application icons in pages two and three of user interface 714 are displayed in a second arrangement; and/or in FIG. 9T, application icons 714-1, 714-2, 714-6, 714-7, 714-10 are displayed in a third arrangement). In some embodiments, the first number of applications is greater than the second number of applications; the first spatial arrangement divides the first set of application icons across a first number of pages; and the second spatial arrangement divides the second set of application icons across a second number of pages, wherein the first number of pages is greater than the second number of pages. In some embodiments, when fewer applications are selected to be enabled, the corresponding application icons are condensed into a smaller number of home screen pages compared to when a greater number of applications are selected to be enabled. Allowing the registered user to specify and/or define which applications are to be enabled in the guest mode of operation using the second computer system improves privacy and device security by ensuring that unauthorized users are not permitted to access private or confidential information. Furthermore, allowing the registered user to perform these actions on the second computer system rather than requiring that they be performed on the first computer system improves efficiency. Additionally, displaying application icons in different spatial arrangements when different numbers of applications are enabled (e.g., condensing the number of home screen pages when fewer applications are enabled) enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, initiating the guest mode of operation further comprises: in accordance with a determination that the one or more options specified by the registered user on the second computer system (e.g., 910) does not include access to a media library feature of the computer system (e.g., does not include access to a media library associated with the computer system; does not include access to a media library that is stored on the computer system; does not include access to a media library that is accessible on the computer system when the computer system is being used by a registered user of the computer system; does not include access to a media library application; and/or does not include access to a photos application) (e.g., in FIG. 9F-1, option 924f corresponding to a photos application is disabled and/or not selected), disabling one or more additional features of the computer system that are separate from the media library feature of the computer system (e.g., a photos application represented by option 924f) and are dependent on access to the media library feature of the computer system (e.g., one or more additional features of the computer system that use and/or require access to media items in the media library in order to carry out their respective functions). In some embodiments, the media library feature of the computer system (e.g., a photos application represented by option 924f) provides access to a media library associated with the computer system. For example, in some embodiments, the media library feature of the computer system is a photos application and/or a media library application that allows a user to view and/or play media items contained in the media library. In some embodiments, when access to a media library, a media library application, and/or a photos application is disabled for the guest user (e.g., in FIG. 9F-1, option 924f corresponding to a photos application is disabled and/or not selected), other features that are reliant on the media library, media library application, and/or the photos application (e.g., other features that use media items in the media library to carry out their functions) are also automatically disabled.

In some embodiments, initiating the guest mode of operation further comprises: in accordance with a determination that the one or more options specified by the registered user on the second computer system does include access to the media library feature of the computer system (e.g., includes access to a media library associated with the computer system; includes access to a media library that is stored on the computer system; includes access to a media library that is accessible on the computer system when the computer system is being used by a registered user of the computer system; includes access to a media library application; and/or includes access to a photos application) (e.g., in FIG. 9F-1, if option 924f was enabled and/or selected), enabling access to at least some of the one or more additional features of the computer system that are separate from the media library feature of the computer system and are dependent on access to the media library feature of the computer system. In some embodiments, initiating the guest mode of operation further comprises: in accordance with a determination that the one or more options specified by the registered user on the second computer system does include access to the media library feature of the computer system (e.g., in FIG. 9F-1, if option 924f was enabled and/or selected) and includes access to a first subset of the one or more additional features of the computer system that are separate from the media library feature of the computer system and are dependent on access to the media library feature of the computer system, enabling access to the first subset of the one or more additional features of the computer system that are separate from the media library feature of the computer system and are dependent on access to the media library feature of the computer system (and, optionally, without enabling access to a second subset of the one or more additional features of the computer system that are separate from the media library feature of the computer system and are dependent on access to the media library feature of the computer system and are not enabled by the one or more options specified by the registered user on the second computer system). Allowing the registered user to specify and/or define which applications are to be enabled in the guest mode of operation using the second computer system improves privacy and device security by ensuring that unauthorized users are not permitted to access private or confidential information. Furthermore, allowing the registered user to perform these actions on the second computer system rather than requiring that they be performed on the first computer system improves efficiency. Additionally, automatically disabling features that are reliant on the media library feature when the media library feature is disabled improves efficiency and allows for these operations to be performed with fewer user inputs, while also reducing potential erroneous inputs by a user.

In some embodiments, the one or more additional features of the computer system (e.g., 700) that are separate from the media library feature of the computer system and are dependent on access to the media library feature of the computer system includes a media generation feature that automatically generates (e.g., based on a non-deterministic process, a machine learning process, and/or a generative AI process) visual media (e.g., photographs, videos, and/or other visual media) based on content contained in the media library feature (e.g., media items, photos, and/or videos contained in the media library feature). Allowing the registered user to specify and/or define which applications are to be enabled in the guest mode of operation using the second computer system improves privacy and device security by ensuring that unauthorized users are not permitted to access private or confidential information. Furthermore, allowing the registered user to perform these actions on the second computer system rather than requiring that they be performed on the first computer system improves efficiency. Additionally, automatically disabling features that are reliant on the media library feature when the media library feature is disabled improves efficiency and allows for these operations to be performed with fewer user inputs, while also reducing potential erroneous inputs by a user.

In some embodiments, causing the second computer system (e.g., 910) associated with the registered account to output a request for authorization for the first computer system to be operated in the guest mode of operation includes causing the second computer system to display an indication (e.g., 916) of a request to operate the first computer system in the guest mode of operation. Displaying an indication on the second computer system that someone is attempting to use the first computer system in the guest mode of operation improves privacy and device security by ensuring that unauthorized users are not permitted to access private or confidential information.

In some embodiments, subsequent to causing the second computer system (e.g., 910) associated with the registered account to output a request (e.g., 916) for authorization for the first computer system to be operated in the guest mode of operation, and prior to receiving authorization to operate the first computer system in the guest mode of operation, the first computer system (e.g., 700) displays, via the one or more display generation components (e.g., 702), a visual indication (e.g., 906) that permission to operate the first computer system in the guest mode of operation has not yet been received (e.g., a text indication and/or a notification that permission to operate the first computer system in the guest mode of operation has not yet been received). Displaying an indication that the first computer system is waiting for authorization from the registered user to operate the first computer system in the guest mode of operation provides improved visual feedback about a state of the first computer system. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, subsequent to initiating the process to operate the first computer system (e.g., 700) in the guest mode of operation and causing the second computer system (e.g., 910) associated with the registered account to output a request for authorization for the first computer system to be operated in the guest mode of operation: in accordance with a determination that operation of the first computer system in the guest mode of operation is authorized based on input (e.g., 918, 922a, 922b, 922c, and/or 928) received at the second computer system that is associated with the registered account, the first computer system (e.g., 700) displays, via the one or more display generation components (e.g., 702), an introductory user interface that corresponds to input enrollment (e.g., user interface 772; and/or in some embodiments, in FIG. 9G, rather than showing user interface 772, computer system 700 displays user interface 734, 738, 740a, and/or 740b) (e.g., an introductory user interface that includes instructions for performing and/or initiating input enrollment and/or input calibration (e.g., gaze-based input, gesture-based input, air gesture input, and/or hand-based input)). In some embodiments, the introductory user interface corresponds to gaze-based input enrollment (e.g., includes instructions for performing and/or initiating gaze-based input enrollment and/or calibration) (e.g., user interface 738 and/or user interface 740b). In some embodiments, the introductory user interface corresponds to hand-based input enrollment (e.g., air gesture input enrollment) (e.g., includes instructions for performing and/or initiating hand-based input enrollment and/or calibration) (e.g., user interface 783 and/or user interface 740a). Displaying an introductory user interface for user input enrollment enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, while operating the first computer system (e.g., 700) in the guest mode of operation, the first computer system (e.g., 700) receives a remote request from the second computer system (e.g., 910) to end operation of the first computer system in the guest mode of operation (e.g., based on one or more user inputs received at the second computer system and/or without receiving user input at the first computer system) (e.g., a remote request corresponding to user input 952b). In response to receiving the remote request from the second computer system (e.g., 910) to end operation of the first computer system (e.g., 700) in the guest mode of operation, the first computer system (e.g., 700) ceases to operate the first computer system in the guest mode of operation including ceasing to provide access to one or more functions that were available in the guest mode of operation (e.g., FIG. 9M) (e.g., transitioning the first computer system from the guest mode of operation to a locked mode; and/or ceasing display of content on the first computer system). Allowing the registered user to end the guest session on the first computer system using the second computer system improves privacy and device security by ensuring that unauthorized users are not permitted to access private or confidential information.

In some embodiments, ceasing to operate the first computer system in the guest mode of operation includes: ceasing display of at least some content (e.g., windows 718a, 718b in FIGS. 9L-9M) that was displayed via the one or more display generation components (e.g., 702) of the first computer system prior to receiving the remote request from the second computer system (e.g., 910), while permitting continued access to a passthrough environment (e.g., 708, 708a, 708b, 708c in FIG. 9M) (e.g., a passthrough environment that is displayed by the one or more display generation components of the first computer system and/or that is visible through the one or more display generation components of the first computer system) (e.g., permitting display and/or maintaining display of a virtual passthrough environment; and/or permitting display and/or forgoing obscuring an optical passthrough environment). Allowing the registered user to end the guest session on the first computer system using the second computer system improves privacy and device security by ensuring that unauthorized users are not permitted to access private or confidential information. Additionally, continuing to permit access to the passthrough environment on the first computer system improves user safety by allowing the user of the first computer system to continue viewing their physical environment even when the guest session (e.g., the guest mode of operation) ends.

In some embodiments, aspects/operations of methods 800, 1000, 1100, 1300, 1500, and/or 1700 may be interchanged, substituted, and/or added between these methods. For example, in some embodiments, the computer systems recited in methods 800, 1200, and/or 1700 are the same computer system, the first computer system recited in method 1000, the wearable device recited in method 1500, and/or the external computer system recited in method 1100. In another example, in some embodiments, the computer system recited in method 1100 is the second computer system recited in method 1000. For brevity, these details are not repeated here.

FIG. 11 is a flow diagram of an exemplary method 1100 for responding to a request to initiate a guest mode of operation on an external computer system, in some embodiments. In some embodiments, method 1100 is performed at a computer system (e.g., 910) (e.g., computer system 101 in FIG. 1A) (e.g., a smart phone, a smart watch, a tablet, a laptop, a desktop, a wearable device, and/or head-mounted device) that is in communication with one or more display generation components (e.g., 912) (e.g., display generation component 120 in FIGS. 1A, 3A, and 4) (e.g., a heads-up display, a display, a touchscreen, a projector, etc.) (e.g., a visual output device, a 3D display, a display having at least a portion that is transparent or translucent on which images can be projected (e.g., a see-through display), a projector, a heads-up display, and/or a display controller) (and, optionally, one or more input devices (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) and/or one or more mechanical input devices (e.g., a depressible input mechanism; a button; a rotatable input mechanism; a crown; and/or a dial))). In some embodiments, method 1100 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1100 are, optionally, combined and/or the order of some operations is, optionally, changed.

The computer system (e.g., 910) receives (1102) an indication of a first event corresponding to a request to initiate a guest mode of operation on an external computer system (e.g., 700) (e.g., a companion device; an external computer system that is associated with the computer system; an external computer system that corresponds to a first user account that is also associated with the computer system; and/or an external computer system that is registered to a first user account that is also associated with, registered to, and/or logged into the computer system). In some embodiments, the computer system (e.g., 910) receives the indication of the first event from the external computer system (e.g., 700). In some embodiments, the external computer system (e.g., 700) detects the first event and transmits the indication of the first event to the computer system (e.g., 910). A registered user mode of operation of the external computer system (e.g., 700) provides access to a first plurality of features of the external computer system (e.g., FIG. 9C); and a guest mode of operation of the external computer system provides access to a subset of the first plurality of features and provides access to fewer features of the external computer system than the registered user mode of operation (e.g., FIG. 7R). In some embodiments, the external computer system is also operable in a locked mode of operation that provides access to fewer features than the guest mode of operation (e.g., the guest mode of operation provides access to more features than the locked mode of operation). In response to receiving the indication of the first event corresponding to a request to initiate a guest mode of operation on the external computer system (e.g., 700) (1104), the computer system (e.g., 910) displays (1106), via the one or more display generation components, a visual indication (e.g., 916) of the request to initiate the guest mode of operation on the external computer system. Displaying a visual indication of a request to initiate a guest mode of operation on the external computer system improves privacy and device security by ensuring that unauthorized users are not permitted to access private or confidential information.

In some embodiments, the external computer system (e.g., 700) is in communication with one or more head-mounted displays (e.g., 702) (e.g., displays worn on the head of a user); receiving the indication of the first event and displaying the visual indication (e.g., 916) of the request to initiate the guest mode of operation on the external computer system are performed while the external computer system (e.g., 700) is worn on the body of a first respective user (e.g., 711 in FIG. 9E) (e.g., while at least a portion of the first computer system is worn on the head of the first respective user) (e.g., a first respective user that is different from the user of the computer system); and content displayed by the one or more head-mounted displays (e.g., 702) is visible to only the first respective user (e.g., 711 in FIG. 9E) while the external computer system (e.g., 700) is worn on the body of the first respective user (e.g., the one or more head-mounted displays are worn on the face of the first respective user and cannot be seen by other people while the one or more head-mounted displays are worn on the face of the first respective user). Displaying a visual indication of a request to initiate a guest mode of operation on the external computer system improves privacy and device security by ensuring that unauthorized users are not permitted to access private or confidential information. Additionally, allowing a user of the computer system to use the computer system to authorize the guest mode of operation on the external computer system improves system efficiency by, for example, allowing a guest user to use the external computer system without requiring the authorized user to first use the external computer system, remove the external computer system, hand the external computer system to the guest user, and potentially modify physical components of the external computer system (e.g., headband, light seal, and/or prescription lens inserts) to fit the guest user.

In some embodiments, the first event corresponding to the request to initiate a guest mode of operation on the external computer system (e.g., 700) comprises failed authentication of a user of the external computer system (e.g., failed biometric authentication and/or passcode-based authentication) (e.g., FIG. 9D). Displaying a visual indication of a request to initiate a guest mode of operation on the external computer system improves privacy and device security by ensuring that unauthorized users are not permitted to access private or confidential information.

In some embodiments, the first event corresponding to the request to initiate a guest mode of operation on the external computer system (e.g., 700) further comprises one or more user inputs (e.g., 904) received at the external computer system subsequent to failed authentication of the user of the external computer system (e.g., one or more hardware control inputs, one or more gaze inputs, one or more air gesture inputs, and/or one or more touch inputs corresponding to a user request (e.g., by a user of the external computer system) to initiate the guest mode of operation on the external computer system). Displaying a visual indication of a request to initiate a guest mode of operation on the external computer system improves privacy and device security by ensuring that unauthorized users are not permitted to access private or confidential information.

In some embodiments, displaying the visual indication (e.g., 916, 920, and/or 924) of the request to initiate the guest mode of operation on the external computer system comprises displaying (e.g., as part of the visual indication of the request) an enable option (e.g., 916a, 920a, 920c, and/or 926a) that, when selected, causes the computer system (e.g., 910) to transmit authorization to the external computer system (e.g., 700) to initiate the guest mode of operation on the external computer system (e.g., authorization that, when received by the external computer system, causes the external computer system to initiate the guest mode of operation on the external computer system). In some embodiments, while displaying the enable option, the computer system receives, via one or more input devices, a selection input corresponding to selection of the enable option (e.g., one or more user inputs corresponding to selection of the enable option); and in response to receiving the selection input corresponding to selection of the enable option, the computer system: causes the external computer system to initiate the guest mode of operation on the external computer system; causes the external computer system to operate in the guest mode of operation; and/or transmits authorization to the external computer system to operate in the guest mode of operation. Providing the user with an enable option allows the user to enable the guest mode of operation on the external computer system with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently. Displaying a visual indication of a request to initiate a guest mode of operation on the external computer system improves privacy and device security by ensuring that unauthorized users are not permitted to access private or confidential information.

In some embodiments, while displaying the enable option (e.g., 916a, 920a, 920c, and/or 926a), the computer system receives, via the one or more input devices, a selection input (e.g., 918, 922a, 922c, and/or 928) corresponding to selection of the enable option (e.g., one or more user inputs corresponding to selection of the enable option). In response to receiving the selection input corresponding to selection of the enable option: in accordance with a determination that authentication criteria are satisfied (e.g., authentication criteria indicating that a user of the computer system is required to be authenticated) (in some embodiments, authentication criteria are always satisfied such that authentication always occurs; in some embodiments, authentication criteria are only satisfied in certain circumstances such that authentication is only sometimes required), the computer system receives, via the one or more input devices, authentication information from a user of the computer system (e.g., biometric information for biometric authentication (e.g., one or more face scans, eye scans, and/or fingerprint scans) and/or passcode and/or password information for passcode-based authentication). In response to receiving the authentication information from the user of the computer system: in accordance with a determination that the user of the computer system has been successfully authenticated (e.g., has been successfully authenticated as a registered user of the computer system and/or the external computer system) (e.g., based on biometric authentication and/or passcode-based authentication), the computer system (e.g., 910) causes the external computer system (e.g., 700) to initiate the guest mode of operation on the external computer system (and/or, in some embodiments, causing the external computer system to operate in the guest mode of operation; and/or transmitting authorization to the external computer system to operate in the guest mode of operation). In some embodiments, user authentication is required at computer system 910 in order to authorize the guest mode of operation on computer system 700. In some embodiments, in response to receiving the authentication information from the user of the computer system: in accordance with a determination that the user of the computer system has not been successfully authenticated (e.g., has not been successfully authenticated as a registered user of the computer system and/or the external computer system) (e.g., based on biometric authentication and/or passcode-based authentication), the computer system (e.g., 910) forgoes causing the external computer system (e.g., 700) to initiate the guest mode of operation on the external computer system (e.g., forgoes causing the external computer system to operate in the guest mode of operation and/or forgoes transmitting authorization to the external computer system to operate in the guest mode of operation). In some embodiments, in response to receiving the selection input corresponding to selection of the enable option: in accordance with a determination that the authentication criteria are not satisfied, the computer system causes the external computer system to initiate the guest mode of operation on the external computer system; causes the external computer system to operate in the guest mode of operation; and/or transmits authorization to the external computer system to operate in the guest mode of operation. In some embodiments, in response to receiving the selection input corresponding to selection of the enable option: in accordance with a determination that the authentication criteria are not satisfied, the computer system forgoes receiving authentication information from the user of the computer system. In some embodiments, in response to receiving the selection input corresponding to selection of the enable option: in accordance with a determination that the authentication criteria are not satisfied, the computer system causes the external computer system to initiate the guest mode of operation on the external computer system without receiving authentication information from the user of the computer system. Requiring that the user of the computer system be authenticated before enabling the guest mode of operation to be initiated on the external computer system improves privacy and device security by ensuring that unauthorized users are not permitted to access private or confidential information.

In some embodiments, the authentication criteria include a first criterion that is satisfied when the computer system (e.g., 910) is in a locked mode of operation that includes access to fewer features of the computer system than an unlocked mode of operation of the computer system. In some embodiments, the authentication criteria are satisfied when the first criterion is satisfied. In some embodiments, the locked mode of operation prevents access to any features of the computer system. In some embodiments, the locked mode of operation permits access only to a locked user interface and/or an authentication user interface via which a user is able to enter authentication information (e.g., biometric information and/or passcode-based authentication information) to transition the computer system out of the locked mode of operation. In some embodiments, the locked mode of operation prevents access to one or more functions of the computer system (e.g., 910) (e.g., the ability to access information. change system settings, change account information, change authentication information, and/or other sensitive functions) while the unlocked mode of operation provides and/or permits access to the one or more functions of the computer system. In some embodiments, the locked mode of operation prevents access to one or more applications of the computer system (e.g., 910) while the unlocked mode of operation provides and/or permits access to the one or more applications of the computer system (e.g., 910). In some embodiments, the locked mode of operation prevents access to one or more files of the computer system (e.g., 910) while the unlocked mode of operation provides and/or permits access to the one or more files of the computer system (e.g., 910). Requiring that the user of the computer system be authenticated before enabling the guest mode of operation to be initiated on the external computer system improves privacy and device security by ensuring that unauthorized users are not permitted to access private or confidential information.

In some embodiments, the authentication criteria include a second criterion that is satisfied when the user (e.g., 710) of the computer system (e.g., 910) has not been authenticated within a threshold duration of time (e.g., in the last 5 minutes, in the last 10 minutes, in the last 30 minutes, in the last hour, or the last 4 hours). In some embodiments, the authentication criteria are satisfied when the second criterion is satisfied. Requiring that the user of the computer system be authenticated before enabling the guest mode of operation to be initiated on the external computer system improves privacy and device security by ensuring that unauthorized users are not permitted to access private or confidential information.

In some embodiments, while displaying the visual indication (e.g., 916, 920, and/or 924) of the request to initiate the guest mode of operation on the external computer system, the computer system (e.g., 910) receives, via the one or more input devices, a first user input directed to the visual indication of the request (e.g., one or more user inputs directed to the visual indication of the request). In response to receiving the first user input: in accordance with a determination that the first user input is a first type of user input (e.g., a user input directed to the enable option) (e.g., selection of option 916a, 920a, 920c, and/or 926a), the computer system (e.g., 910) causes the external computer system (e.g., 700) to initiate the guest mode of operation on the external computer system (and/or, in some embodiments, causes the external computer system to operate in the guest mode of operation; and/or transmits authorization to the external computer system to operate in the guest mode of operation); and in accordance with a determination that the first user input is a second type of user input different from the first type of user input (e.g., a user input that is not directed to the enable option) (e.g., selection of option 916b, 920d, and/or 926b), the computer system (e.g., 910) forgoes causing the external computer system (e.g., 700) to initiate the guest mode of operation on the external computer system (e.g., in some embodiments, forgoing causing the external computer system to operate in the guest mode of operation; and/or forgoing transmitting authorization to the external computer system to operate in the guest mode of operation). Providing the user with an enable option allows the user to enable the guest mode of operation on the external computer system with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently. Displaying a visual indication of a request to initiate a guest mode of operation on the external computer system improves privacy and device security by ensuring that unauthorized users are not permitted to access private or confidential information.

In some embodiments, in response to receiving the first user input, the computer system (e.g., 910) ceases display of the visual indication (e.g., 916, 920, and/or 924) of the request to initiate the guest mode of operation (e.g., regardless of whether the first user input is the first type of user input or the second type of user input). Displaying a visual indication of a request to initiate a guest mode of operation on the external computer system improves privacy and device security by ensuring that unauthorized users are not permitted to access private or confidential information.

In some embodiments, the computer system is configured to communicate with one or more input devices, and subsequent to (e.g., after and/or while) displaying the visual indication (e.g., 916, 920, and/or 924) of the request to initiate the guest mode of operation on the external computer system (e.g., 700), the computer system (e.g., 910) detects, via the one or more input devices, an authorization input (e.g., 918, 922a, 922c, and/or 928) corresponding to a user of the computer system authorizing the guest mode of operation on the external computer system (e.g., one or more user inputs corresponding to a user of the computer system authorizing the guest mode of operation on the external computer system). In response to receiving the authorization input, the computer system displays, via the one or more display generation components, one or more guest mode options (e.g., 920a-920c, 924a-924i, 930b, 930c, and/or 930d) pertaining to the guest mode of operation on the external computer system (e.g., one or more user-selectable options and/or one or more user-modifiable options). Providing the user of the computer system with one or more guest mode options pertaining to the guest mode of operation on the external computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently. Furthermore, doing so also improves privacy and device security by allowing the user of the computer system to control one or more aspects of the guest mode of operation on the external computer system (e.g., what content the guest user of the external computer system can view and/or access).

In some embodiments, the one or more guest mode options includes a first guest mode option wherein, when the first guest mode option is in an enabled state, a first type of content (e.g., content pertaining to a first application; and/or content belonging to a first category) is accessible on the external computer system while the external computer system is operating in the guest mode of operation, and when the first guest mode option is in a disabled state, the first type of content is not accessible on the external computer system while the external computer system is operating in the guest mode of operation (e.g., 920a-920c, 924a-924i, 930b-1, 930b-1, and/or 930b-3). In some embodiments, the one or more guest mode options enable a user of the computer system (e.g., 910) to control what content is available and/or accessible on the external computer system (e.g., 700) while the external computer system is operating in the guest mode of operation. In some embodiments, while displaying the one or more guest mode options, the computer system receives, via the one or more input devices, a user input corresponding to the first guest mode option. In response to receiving the user input corresponding to the first guest mode option: in accordance with a determination that the user input corresponding to the first guest mode option corresponds to a user request to enable the first guest mode option, the computer system causes the first type of content to be accessible on the external computer system while the external computer system is operating in the guest mode of operation; and in accordance with a determination that the user input corresponding to the first guest mode option corresponds to a user request to disable the first guest mode option, the computer system causes the first type of content to be inaccessible and/or unavailable on the external computer system while the external computer system is operating in the guest mode of operation. Providing the user of the computer system with one or more guest mode options pertaining to the guest mode of operation on the external computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently. Furthermore, doing so also improves privacy and device security by allowing the user of the computer system to control one or more aspects of the guest mode of operation on the external computer system (e.g., what content the guest user of the external computer system can view and/or access).

In some embodiments, the one or more guest mode options includes: a first application option (e.g., 920a, 920b, and/or 920c) wherein, when the first application option is in an enabled state (and, optionally, when the second application option is in a disabled state; and/or when the first application option is selected (and, optionally, when the second application option is not selected)), a first set of applications is accessible on the external computer system while the external computer system is operating in the guest mode of operation (e.g., a first of one or more applications; all applications that are accessible on (e.g., available on and/or installed on) the external computer system when the external computer system is operating in the registered user mode of operation; and/or all applications that are accessible on (e.g., installed on and/or available on) the external computer system); and a second application option (e.g., 920a, 920b, and/or 920c) separate from the first application option wherein, when the second application option is in an enabled state, a subset of the first set of applications is accessible on the external computer system while the external computer system is operating in the guest mode of operation (e.g., a set of applications selected by a registered user of the external computer system and/or a user of the computer system; a set of recently shared applications; and/or a set of currently open applications), wherein the subset of the first set of applications excludes one or more applications of the first set of applications. In some embodiments, while displaying the one or more guest mode options (e.g., including the first application option and the second application option), the computer system detects, via the one or more input devices, a user input (e.g., 955a, 955b, and/or 955c). In response to detecting the user input: in accordance with a determination that the user input corresponds to selection of the first application option (and, optionally, does not correspond to selection of the second application option), the computer system causes the first set of applications to be accessible on the external computer system while the external computer system is operating in the guest mode of operation (e.g., FIG. 9Q); and in accordance with a determination that the user input corresponds to selection of the second application option (and, optionally, does not correspond to selection of the first application option), the computer system causes the subset of the first set of applications to be accessible on the external computer system while the external computer system is operating in the guest mode of operation, and causes one or more applications of the first set of applications not to be accessible while the external computer system is operating in the guest mode of operation (e.g., the one or more applications of the first set of applications that is excluded from the subset of the first set of applications) (e.g., FIG. 9P and/or FIG. 9T). Providing the user of the computer system with one or more guest mode options pertaining to the guest mode of operation on the external computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently. Furthermore, doing so also improves privacy and device security by allowing the user of the computer system to control one or more aspects of the guest mode of operation on the external computer system (e.g., what content the guest user of the external computer system can view and/or access).

In some embodiments, while displaying the one or more guest mode options (e.g., 920a, 920b, 920c, and/or 924a-924i), the computer system detects, via the one or more input devices, a first set of user inputs (e.g., one or more user inputs) corresponding to the one or more guest mode options (e.g., 955a, 955b, 955c, 956a, 956b, 956c, 956d, and/or 956e). In response to detecting the first set of user inputs corresponding to the one or more guest mode options: in accordance with a determination that the first set of user inputs correspond to a user request to grant a threshold amount of access while the external computer system is operating in the guest mode of operation (e.g., FIG. 9Q) (e.g., in accordance with a determination that the first set of user inputs correspond to a user request to enable a first feature and/or a first set of features while the external computer system is operating in the guest mode of operation; and/or in accordance with a determination that the first set of user inputs correspond to a user request to enable a first application and/or a first set of applications while the external computer system is operating in the guest mode of operation), the computer system causes a first user interface (e.g., 1287) (e.g., a communications user interface; a people user interface; and/or a contacts user interface) to be accessible while the external computer system is operating in the guest mode of operation (e.g., in FIG. 9Q, option 715-2, which, in some embodiments, is selectable to display user interface 1287, is selectable and/or enabled); and in accordance with a determination that the first set of user inputs correspond to a user request to grant less than the threshold amount of access while the external computer system is operating in the guest mode of operation (e.g., in accordance with a determination that the first set of user inputs correspond to a user request to exclude and/or disable a first feature and/or a first set of features while the external computer system is operating in the guest mode of operation; and/or in accordance with a determination that the first set of user input correspond to a user request to exclude and/or disable access to a first application and/or a first set of applications while the external computer system is operating in the guest mode of operation), the computer system causes the first user interface (e.g., 1287) to be inaccessible while the external computer system is operating in the guest mode of operation (e.g., causing a user interface object that, when selected, causes the external computer system to display the first user interface to be hidden and/or otherwise made not selectable) (e.g., in FIG. 9R and/or FIG. 9T, option 715-2, which, in some embodiments, is selectable to display user interface 1287, is disabled and/or is not selectable). In some embodiments, the first user interface (e.g., 1287) is a communications user interface that provides one or more options (e.g., 1287-1 through 1287-5) for initiating a process for communicating with one or more external computer systems and/or communicating with one or more external users separate from the user of the external computer system. In some embodiments, the first user interface (e.g., 1287) is a contacts user interface that identifies one or more contacts (e.g., one or more people and/or one more entities). In some embodiments, the contacts user interface includes one or more options (e.g., 1287-1 through 1287-5) for initiating a process for communicating with the one or more contacts. In some embodiments, causing the first user interface to be accessible while the external computer system is operating in the guest mode of operation comprises displaying a first selectable object (e.g., 715-2) that, when selected, causes the computer system to display the first user interface. In some embodiments, causing the first user interface to be inaccessible while the external computer system is operating in the guest mode of operation comprises forgoing displaying the first selectable object (e.g., 715-2). In some embodiments, causing the first user interface to be accessible while the external computer system is operating in the guest mode of operation comprises displaying the first selectable object (e.g., 715-2) within a home user interface. In some embodiments, the first user interface object is displayed concurrently with a second user interface object (e.g., 715-1 and/or 715-3) (e.g., a second user interface object that, when selected, causes the computer system to display a second user interface different from the first user interface) within the home user interface. In some embodiments, causing the first user interface to be inaccessible while the external computer system is operating in the guest mode of operation comprises displaying the home user interface (e.g., 714 and/or 715), including displaying the second user interface object (e.g., 715-1 and/or 715-3), without displaying the first user interface object (e.g., 715-2). Providing the user of the computer system with one or more guest mode options pertaining to the guest mode of operation on the external computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently. Furthermore, doing so also improves privacy and device security by allowing the user of the computer system to control one or more aspects of the guest mode of operation on the external computer system (e.g., what content the guest user of the external computer system can view and/or access).

In some embodiments, the one or more guest mode options includes a content sharing option (e.g., 930c) wherein, when the content sharing option is in an enabled state, information pertaining to content displayed by the external computer system (e.g., 700) is transmitted to the computer system (e.g., 910) (e.g., for display on the computer system) and when the content sharing option is in a disabled state, information pertaining to content displayed by the external computer system is not transmitted to the computer system. In some embodiments, the one or more guest mode options enable a user of the computer system (e.g., 910) to control whether content displayed by the external computer system (e.g., 700) is mirrored and/or shared to another computer system (e.g., for display on the other computer system). In some embodiments, while displaying the one or more guest mode options, the computer system receives, via the one or more input devices, a user input corresponding to the content sharing option. In response to receiving the user input corresponding to the content sharing option: in accordance with a determination that the user input corresponding to the view content sharing corresponds to a user request to enable the content sharing option, the computer system causes the external computer system to transmit information pertaining to content displayed by the external computer system to the computer system (e.g., so that the computer system can display at least a portion of the content that is being displayed by the external computer system); and in accordance with a determination that the user input corresponding to the content sharing option corresponds to a user request to disable the content sharing option, the computer system forgoes causing the external computer system to transmit information pertaining to content displayed by the external computer system to the computer system. Providing the user of the computer system with one or more guest mode options pertaining to the guest mode of operation on the external computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently. Furthermore, doing so also improves privacy and device security by allowing the user of the computer system to control one or more aspects of the guest mode of operation on the external computer system (e.g., what content the guest user of the external computer system can view and/or access).

In some embodiments, subsequent to displaying (e.g., after displaying and/or while display) the visual indication (e.g., 916, 920, and/or 924) of the request to initiate the guest mode of operation on the external computer system (e.g., 700), the computer system (e.g., 700) causes the external computer system (e.g., 700) to operate in the guest mode of operation (e.g., in some embodiments, causing the external computer system to operate in the guest mode of operation by, for example, transmitting authorization for the external computer system to operate in the guest mode of operation) (e.g., FIGS. 9G-9H); and displays, via the one or more display generation components, visual content that is being displayed by the external computer system (e.g., 930a). In some embodiments, the computer system displays visual content that is visible on the external computer system (e.g., including certain content that is visible on the external computer system but is not displayed by the external computer system (e.g., an optical passthrough environment)). In some embodiments, the computer system automatically displays a view of content that is visible on and/or displayed by the external computer system when the external computer system begins operating in the guest mode of operation and/or initiates operation in the guest mode of operation. Displaying, on the computer system, visual content that is visible on the external computer system improves privacy and device security by allowing an owner and/or registered user of the external computer system to see what is being accessed and/or viewed by a guest user of the external computer system, which allows the owner and/or registered user to ensure that unauthorized users are not accessing private or confidential information.

In some embodiments, the computer system is configured to communicate with one or more input devices, and while the external computer system (e.g., 700) is operating in the guest mode of operation, the computer system (e.g., 910) detects, via the one or more input devices, a set of one or more user inputs (e.g., one or more touch inputs, one or more spoken inputs, and/or one or more gesture inputs) (e.g., 970) corresponding to a request to display, via the one or more display generation components of the computer system (e.g., 912), visual content that is being displayed by the external computer system (e.g., 700). In response to detecting the set of one or more user inputs corresponding to the request to display, via the one or more display generation components of the computer system, visual content that is being displayed by the external computer system (e.g., 970): the computer system (e.g., 910) displays, via the one or more display generation components (e.g., 912), visual content that is being displayed by the external computer system (e.g., 700) (e.g., region 930a in FIG. 9AA); and causes the external computer system (e.g., 700) to disable control of a view mirroring feature of the external computer system by a user (e.g., a guest user) of the external computer system (e.g., disabling the ability of the external computer system and/or the guest user of the external computer system to mirror visual content that is being displayed by the external computer system to one or more separate external computer systems and/or one or more separate display generation components that are separate from the external computer system and/or the one or more display generation components of the computer system) (e.g., option 760e disabled in FIG. 9AA). In some embodiments, while the computer system (e.g., 910) is displaying visual content that is being displayed by the external computer system (e.g., 700), the external computer system and/or the guest user of the external computer system is prevented from view mirroring to a different device. Displaying, on the computer system, visual content that is being displayed by the external computer system improves privacy and device security by allowing an owner and/or registered user of the external computer system to see what is being accessed and/or viewed by a guest user of the external computer system, which allows the owner and/or registered user to ensure that unauthorized users are not accessing private or confidential information. Furthermore, disabling the view mirroring feature of the external computer system while the computer system is displaying visual content that is being displayed by the external computer system also improve privacy and device security by allowing an owner and/or registered user of the external computer system to disable the view mirroring feature of the external computer system.

In some embodiments, while displaying the visual content that is being displayed by the external computer system (e.g., 700), and while the view mirroring feature of the external computer system is disabled, the computer system (e.g., 910) detects, via the one or more input devices, a second set of one or more user inputs (e.g., one or more touch inputs, one or more spoken inputs, and/or one or more gesture inputs) corresponding to a request to cease displaying the visual content that is being displayed by the external computer system (e.g., user input 960a and/or 960b). In response to detecting the second set of one or more user inputs corresponding to the request to cease display of the visual content that is being displayed by the external computer system: the computer system (e.g., 910) ceases display of the visual content that is being displayed by the external computer system (e.g., while the visual content continues to be displayed by the external computer system) (e.g., FIG. 9X, region 930a no longer mirroring the view of computer system 700); and causes the external computer system (e.g., 700) to enable control of (e.g., make accessible) the view mirroring feature of the external computer system by a user (e.g., by a guest user) of the external computer system (e.g., allowing and/or enabling the external computer system and/or the guest user of the external computer system to mirror visual content that is being displayed by the external computer system to one or more separate external computer systems and/or one or more separate display generation components that are separate from the external computer system and/or the one or more display generation components of the computer system) (e.g., in FIG. 9X, option 760e is selectable and/or enabled). In some embodiments, when the computer system (e.g., 910) stops displaying visual content that is being displayed by the external computer system (e.g., 700) (e.g., when the computer system stops mirroring the view of the external computer system), the external computer system is permitted to mirror its view and/or share its view to other devices. Displaying, on the computer system, visual content that is being displayed by the external computer system improves privacy and device security by allowing an owner and/or registered user of the external computer system to see what is being accessed and/or viewed by a guest user of the external computer system, which allows the owner and/or registered user to ensure that unauthorized users are not accessing private or confidential information. Furthermore, disabling the view mirroring feature of the external computer system while the computer system is displaying visual content that is being displayed by the external computer system also improve privacy and device security by allowing an owner and/or registered user of the external computer system to disable the view mirroring feature of the external computer system.

In some embodiments, while the external computer system (e.g., 700) is causing an external device (e.g., 964) (e.g., a second external computer system and/or an external display generation component that is separate from the computer system and the external computer system) separate from the computer system (e.g., 910) and the external computer system (e.g., 700) to display visual content that is being displayed by the external computer system (e.g., 964 in FIG. 9Z) (e.g., while the external computer system is mirroring and/or sharing its view to another device separate from the computer system and the external computer system), the computer system detects, via the one or more input devices, a third set of one or more user inputs (e.g., 970) (e.g., one or more touch inputs, one or more spoken inputs, and/or one or more gesture inputs) corresponding to a request to display, via the one or more display generation components of the computer system (e.g., 912), visual content that is being displayed by the external computer system (e.g., 700). In response to detecting the third set of one or more user inputs corresponding to a request to display, via the one or more display generation components of the computer system, visual content that is being displayed by the external computer system: the computer system (e.g., 910) displays, via the one or more display generation components (e.g., 912), visual content that is being displayed by the external computer system (e.g., 910 in FIG. 9AA); and causes the external computer system (e.g., 700) to disable the view mirroring feature of the external computer system, including causing the external computer system to cease causing the external device (e.g., 964) to display of visual content that is being displayed by the external computer system (e.g., causing the external computer system to stop mirroring and/or sharing its view to the external device) (e.g., in FIG. 9AA, television 964 is no longer mirroring the view of computer system 700, and option 760e is disabled). In some embodiments, when the computer system (e.g., 910) begins displaying visual content that is being displayed by the external computer system (e.g., 700) (e.g., when the computer system begins view mirroring), the computer system causes the external computer system to stop sharing its view to other devices. Displaying, on the computer system, visual content that is being displayed by the external computer system improves privacy and device security by allowing an owner and/or registered user of the external computer system to see what is being accessed and/or viewed by a guest user of the external computer system, which allows the owner and/or registered user to ensure that unauthorized users are not accessing private or confidential information. Furthermore, disabling the view mirroring feature of the external computer system while the computer system is displaying visual content that is being displayed by the external computer system also improve privacy and device security by allowing an owner and/or registered user of the external computer system to disable the view mirroring feature of the external computer system.

In some embodiments, subsequent to displaying (e.g., after displaying and/or while display) the visual indication (e.g., 916, 920, and/or 924) of the request to initiate the guest mode of operation on the external computer system, the computer system (e.g., 910) causes the external computer system (e.g., 700) to operate in the guest mode of operation (e.g., in some embodiments, causing the external computer system to operate in the guest mode of operation by, for example, transmitting authorization for the external computer system to operate in the guest mode of operation); and displays, via the one or more display generation components, a persistent visual indication (e.g., 930, 938, 944, and/or 950) that the external computer system is operating in the guest mode of operation while the external computer system is operating in the guest mode of operation. Displaying, on the computer system, a visual indication that the external computer system is operating in the guest mode of operation improves privacy and device security by allowing an owner and/or registered user of the external computer system to see when the external computer system is operating in the guest mode of operation, which allows the owner and/or registered user to ensure that unauthorized users are not using the external computer system without permission and/or accessing private or confidential information.

In some embodiments, the computer system (e.g., 910) concurrently displays, via the one or more display generation components, the persistent visual indication (e.g., 938 and/or 944) that the external computer system is operating in the guest mode of operation and a first user interface corresponding to a first application (e.g., 936). While concurrently displaying the persistent visual indication that the external computer system is operating in the guest mode of operation and the first user interface corresponding to the first application, the computer system receives, via the one or more input devices, a user request to transition from the first application to a second application different from the first application (e.g., user input 940) (e.g., one or more user inputs to transition from the first application the second application). In response to receiving the user request to transition from the first application to the second application, the computer system ceases display of at least a portion of the first user interface corresponding to the first application (e.g., 936); and displays, via the one or more display generation components, a second user interface (e.g., 942) that corresponds to the second application (and, optionally, does not correspond to the first application) and that is different from the first user interface while maintaining display of the persistent visual indication that the external computer system is operating in the guest mode of operation (e.g., maintaining display of 938 and/or 944) (in some embodiments, in FIG. 9J, computer system 910 maintains display of 938 rather than transitioning to 944). In some embodiments, the persistent visual indication (e.g., 938 and/or 944) continues to be displayed even as the computer system switches between different user interfaces and/or different applications. In some embodiments, the persistent visual indication continues to be displayed as the computer system transitions from an unlocked state (e.g., with permitted access to a plurality of features) to a locked state (e.g., with limited access and/or without access to the plurality of features) and/or when the computer system displays a lock screen user interface indicative of the computer system being in the locked state. In some embodiments, the persistent visual indication, when selected, causes the computer system to display a user interface corresponding to the guest mode of the external computer system (e.g., a user interface that displays screen sharing content from the external computer system). In some embodiments, the persistent visual indication optionally changes appearance over time to indicate a change in state of the guest mode of the external computer system (e.g., changes appearance in response to the computer system receiving information indicative of a change in state of the guest mode of the external computer system). Displaying, on the computer system, a visual indication that the external computer system is operating in the guest mode of operation improves privacy and device security by allowing an owner and/or registered user of the external computer system to see when the external computer system is operating in the guest mode of operation, which allows the owner and/or registered user to ensure that unauthorized users are not using the external computer system without permission and/or accessing private or confidential information.

In some embodiments, displaying the persistent visual indication that the external computer system is operating in the guest mode of operation comprises displaying the persistent visual indication (e.g., 938) at a first size (e.g., a first display size and/or a first display area). While displaying the persistent visual indication at the first size, the computer system detects that indication criteria are satisfied; and in response to detecting that indication criteria are satisfied, the computer system displays the persistent visual indication that the external computer system is operating in the guest mode of operation at a second size that is different from (e.g., larger than or smaller than) the first size (e.g., a second display size and/or a second display area) (e.g., 944 and/or 950 is a different size than 938). In some embodiments, the indication criteria are satisfied when the computer system detects one or more user inputs corresponding to a user request to transition the persistent visual indication from the first size to the second size. In some embodiments, the indication criteria are satisfied when the computer system detects one or more user inputs directed to the persistent visual indication (e.g., one or more touch inputs and/or one or more tap inputs). In some embodiments, the indication criteria are satisfied when the computer system has not detected user input for a threshold duration of time (e.g., 5 seconds, 10 seconds, 20 seconds, 30 seconds, or 1 minute) and/or when the computer system has not detected user input directed to the persistent visual indication for a threshold duration of time (e.g., 5 seconds, 10 seconds, 20 seconds, 30 seconds, or 1 minute). Displaying, on the computer system, a visual indication that the external computer system is operating in the guest mode of operation improves privacy and device security by allowing an owner and/or registered user of the external computer system to see when the external computer system is operating in the guest mode of operation, which allows the owner and/or registered user to ensure that unauthorized users are not using the external computer system without permission and/or accessing private or confidential information.

In some embodiments, the persistent visual indication (e.g., 938) includes one or more guest mode management options (e.g., 938a and/or 938b) pertaining to the guest mode of operation on the external computer system (e.g., one or more user-selectable options and/or one or more user-modifiable options). Providing the user of the computer system with one or more guest mode options pertaining to the guest mode of operation on the external computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently. Furthermore, doing so also improves privacy and device security by allowing the user of the computer system to control one or more aspects of the guest mode of operation on the external computer system (e.g., what content the guest user of the external computer system can view and/or access).

In some embodiments, the one or more guest mode management options includes a content sharing option (e.g., 938a) that, when selected, causes the computer system to display visual content that is being displayed by the external computer system (e.g., causes computer system, 910 to re-display user interface 930 which includes content mirroring region 930a). In some embodiments, while displaying the one or more guest mode management options including the content sharing option (e.g., 938a), the computer system (e.g., 910) receives, via the one or more input devices, one or more user inputs corresponding to the content sharing option (e.g., one or more touch inputs and/or one or more tap inputs corresponding to selection of the content sharing option). In response to receiving the one or more user inputs corresponding to the content sharing option, the computer system displays, via the one or more display generation components, visual content that is being displayed by the external computer system (and/or, in some embodiments, visual content that is visible on the external computer system) (e.g., in response to selection of option 938a, computer system 910 displays user interface 930, which includes content sharing region 930a). In some embodiments, the computer system (e.g., 910) displays visual content that is visible on the external computer system (e.g., 700) (e.g., including certain content that is visible on the external computer system but is not displayed by the external computer system (e.g., an optical passthrough environment)). Displaying, on the computer system, visual content that is visible on the external computer system improves privacy and device security by allowing an owner and/or registered user of the external computer system to see what is being accessed and/or viewed by a guest user of the external computer system, which allows the owner and/or registered user to ensure that unauthorized users are not accessing private or confidential information.

In some embodiments, the one or more user inputs corresponding to the content sharing option is received while the external computer system (e.g., 700) is causing a second external device (e.g., 964) separate from the computer system (e.g., 910) and the external computer system (e.g., 700) to display visual content that is being displayed by the external computer system (e.g., 964 in FIG. 9Z) (e.g., the user input corresponding to the content sharing option is received while the external computer system is sharing and/or mirroring content to a second external device separate from the computer system and the external computer system). In some embodiments, in response to receiving the one or more user inputs corresponding to the content sharing option, the computer system (e.g., 910) causes the external computer system (e.g., 700) to cease causing the external device (e.g., 964) to display visual content that is being displayed by the external computer system (e.g., causing the external computer system to stop mirroring and/or sharing its view to the second external device) (e.g., in FIG. 9AA, television 964 no longer mirrors the view of computer system 700). In some embodiments, in response to receiving the one or more user inputs corresponding to the content sharing option, the computer system causes the external computer system (e.g., 700) to disable control of a view mirroring feature of the external computer system (e.g., in FIG. 9AA, option 760e is disabled). For example, in some embodiments, while the computer system (e.g., 910) is displaying visual content that is being displayed by the external computer system (e.g., 700) (e.g., while the view of the external computer system is being mirrored to the computer system) (e.g., FIG. 9W and/or FIG. 9AA), the external computer system (e.g., 700) is prevented from mirroring and/or sharing its view to a different device other than the computer system (e.g., in FIG. 9W and/or FIG. 9AA, option 760e is disabled). In some embodiments, when the view of the external computer system (e.g., 700) is not being displayed and/or mirrored on the computer system (e.g., 910 in FIGS. 9X-9Y), the view mirroring feature of the external computer system (e.g., 700) is enabled and/or the external computer system is permitted to share and/or mirror its view to a different device other than the computer system (e.g., in FIG. 9X, option 760e is enabled and/or is selectable). In some embodiments, when the computer system (e.g., 910) begins displaying visual content that is being displayed by the external computer system (e.g., 700) (e.g., when the computer system begins view mirroring), the computer system causes the external computer system to stop sharing its view to other devices (e.g., FIGS. 9Z-9AA). Displaying, on the computer system, visual content that is visible on the external computer system improves privacy and device security by allowing an owner and/or registered user of the external computer system to see what is being accessed and/or viewed by a guest user of the external computer system, which allows the owner and/or registered user to ensure that unauthorized users are not accessing private or confidential information. Furthermore, disabling the view mirroring feature of the external computer system while the computer system is displaying visual content that is being displayed by the external computer system also improve privacy and device security by allowing an owner and/or registered user of the external computer system to disable the view mirroring feature of the external computer system.

In some embodiments, the one or more guest mode management options includes an end guest session option (e.g., 938b) that, when selected, causes the computer system (e.g., 910) to transmit instructions to the external computer system (e.g., 700) to cease operating in the guest mode of operation. In some embodiments, while displaying the one or more guest mode management options including the end guest session option (e.g., 938b), the computer system receives, via the one or more input devices, a user input corresponding to the end guest session option (e.g., one or more user inputs) (e.g., one or more touch inputs and/or one or more tap inputs corresponding to selection of the end guest session option). In response to receiving the user input corresponding to the end guest session option, the computer system (e.g., 910) transmits, to the external computer system (e.g., 700), instructions to cease operating in the guest mode of operation, wherein the instructions cause the external computer system to cease operating in the guest mode of operation (e.g., FIG. 9M). In some embodiments, the instructions to the external computer system cause the external computer system to cease operating in the guest mode of operation. In some embodiments, causing the external computer system to cease operating in the guest mode of operation includes causing the external computer system to transition to a locked mode. In some embodiments, causing the external computer system to cease operating in the guest modem of operation includes causing the external computer system to cease display of at least some content or all content that was being displayed on the external computer system prior to the external computer system receiving the instructions from the computer system to cease operating in the guest mode of operation. Providing the user of the computer system with an option to end the guest mode on the external computer system improves privacy and device security by allowing an owner and/or registered user of the external computer system to cause the external computer system to stop operating in the guest mode of operation, which allows the owner and/or registered user to ensure that unauthorized users are not accessing private or confidential information.

In some embodiments, the external computer system (e.g., 700) is a head-mounted device; and the instructions to the external computer system to cease operating in the guest mode of operation cause the external computer system to stop displaying at least some content (e.g., 718a-718b) that was displayed on the external computer system while permitting continued access to a passthrough environment (e.g., 708a-708c) (e.g., FIG. 9M) (e.g., a passthrough environment that is displayed by the one or more display generation components of the external computer system and/or that is visible through the one or more display generation components of the external computer system) (e.g., permitting display and/or maintaining display of a virtual passthrough environment; and/or permitting display and/or forgoing obscuring an optical passthrough environment). Providing the user of the computer system with an option to end the guest mode on the external computer system improves privacy and device security by allowing an owner and/or registered user of the external computer system to cause the external computer system to stop operating in the guest mode of operation, which allows the owner and/or registered user to ensure that unauthorized users are not accessing private or confidential information. Additionally, continuing to permit access to the passthrough environment on the external computer system improves user safety by allowing the user of the external computer system to continue viewing their physical environment even when the guest session (e.g., the guest mode of operation) ends.

In some embodiments, the one or more guest mode management options includes a first content option that, when selected, causes the computer system to transition the first content option to a disabled state or an enabled state, wherein, when the first content option is in an enabled state, a first type of content (e.g., content pertaining to a first application; and/or content belonging to a first category) is accessible on the external computer system while the external computer system is operating in the guest mode of operation, and when the first content option is in a disabled state, the first type of content is not accessible on the external computer system while the external computer system is operating in the guest mode of operation (e.g., in some embodiments, overlay 938 includes options similar to options 930b-1, 930b-2, 930b-3 and/or options 924a-924i so that the user of computer system 910 can control what content is accessible on computer system 700 from overlay 938). While displaying the one or more guest mode management options including the first content option, the computer system receives, via the one or more input devices, a user input corresponding to the first content option (e.g., one or more user inputs) (e.g., one or more touch inputs and/or one or more tap inputs corresponding to selection of the first content option). In response to receiving the user input corresponding to the first content option: in accordance with a determination that the user input corresponding to the first content option corresponds to a user request to enable the first content option (e.g., in accordance with a determination that the user input corresponding to the first content option is received while the first content option is in a disabled state), the computer system (e.g., 910) causes the first type of content to be accessible on the external computer system while the external computer system is operating in the guest mode of operation (e.g., selection of option 930b-1 causes a first set of applications to be accessible, while selection of option 930b-2 causes a second set of applications to be accessible) (e.g., selection of option 924a causes the TV application to be enabled and accessible or causes the TV application to be disabled and inaccessible); and in accordance with a determination that the user input corresponding to the first content option corresponds to a user request to disable the first content option (e.g., in accordance with a determination that the user input corresponding to the first content option is received while the first content option is in an enabled state), causing the first type of content to be inaccessible (e.g., unavailable) on the external computer system while the external computer system is operating in the guest mode of operation (e.g., selection of option 930b-1 causes a first set of applications to be accessible, while selection of option 930b-2 causes a second set of applications to be accessible) (e.g., selection of option 930b-1 causes a first set of applications to be accessible, while selection of option 930b-2 causes a second set of applications to be accessible) (e.g., selection of option 924a causes the TV application to be enabled and accessible or causes the TV application to be disabled and inaccessible). In some embodiments, the one or more guest mode management options enable a user of the computer system to control what content is available and/or accessible on the external computer system (e.g., what applications are available and/or accessible on the external computer system) while the external computer system is operating in the guest mode of operation. Allowing the user of the computer system to manage and/or control what content is accessible on the external computer system while the external computer system is operating in the guest mode of operation improves privacy and device security by allowing an owner and/or registered user of the external computer system to ensure that guest users are not accessing private or confidential information while the external computer system is operating in the guest mode of operation.

In some embodiments, the one or more guest mode management options includes a first content option (e.g., 924a-924i) that, when selected, causes the computer system to transition the first content option to a disabled state or an enabled state, wherein, when the first content option is in an enabled state, a first type of content (e.g., content pertaining to a first application; and/or content belonging to a first category) is accessible on the external computer system while the external computer system is operating in the guest mode of operation, and when the first content option is in a disabled state, the first type of content is not accessible on the external computer system while the external computer system is operating in the guest mode of operation. In some embodiments, while the first content option (e.g., 924a-924i) is in the disabled state and the first type of content is not accessible on the external computer system, and while displaying the one or more guest mode management options including the first content option, the computer system receives, via the one or more input devices, a user input corresponding to the first content option (e.g., one or more user inputs) (e.g., one or more touch inputs and/or one or more tap inputs corresponding to selection of the first content option). In response to receiving the user input corresponding to the first content option: causing the first type of content to be accessible on the external computer system while the external computer system is operating in the guest mode of operation; and causing the external computer system to display, via one or more display generation components of the external computer system, the first type of content (e.g., causing the external computer system to display a user interface generated by and/or corresponding to a first application). In some embodiments, options 924a-924i are displayed on computer system 910 (e.g., as in FIG. 9F-1) while computer system 700 is operating in the guest mode of operation (e.g., as in FIG. 9H). In some embodiments, selection of a respective disabled application on computer system 910 (e.g., selection of option 924f in FIG. 9F-1) causes computer system 700 to display the selected application (e.g., selection of option 924f in FIG. 9F-1 causes computer system 700 to display the photos application). Allowing the user of the computer system to manage and/or control what content is accessible on the external computer system while the external computer system is operating in the guest mode of operation improves privacy and device security by allowing an owner and/or registered user of the external computer system to ensure that guest users are not accessing private or confidential information while the external computer system is operating in the guest mode of operation.

In some embodiments, the one or more guest mode management options (e.g., in 938 and/or in 930) includes a first accessibility feature option that, when selected, causes the computer system to enable or disable an accessibility feature of the external computer system while the external computer system is operating in the guest mode of operation (e.g., by transmitting one or more instructions to the external computer system). In some embodiments, the one or more guest mode management options enable a user of the computer system to turn on or turn off one or more accessibility features of the external computer system while the external computer system is operating in the guest mode of operation. In some embodiments, accessibility features include, for example, vision accessibility features (e.g., changing screen colors, text size, and/or display zoom; and/or turning audio descriptions, auto-readers, and/or spoken content on or off); hearing accessibility features (e.g., adjusting volume and/or sound EQ settings; turning sound into text; and/or subtitles and captions); mobility accessibility features (e.g., hands-free device control, voice control, dictation, predictive text, and/or customized gestures); and/or speech-related accessibility features (e.g., typing spoken words, making speech requests in text, and/or allowing more time for speech requests). In some embodiments, accessibility features include gaze input alternatives (e.g., switching from gaze input to head or arm-based pointing). In some embodiments, accessibility features include hand input alternatives (e.g., using gaze dwell navigation in place of hand input and/or hand-based air gestures). In some embodiments, while displaying the one or more guest mode management options, the computer system receives, via the one or more input devices, a user input corresponding to the first accessibility feature option. In response to receiving the user input corresponding to the first accessibility feature option: in accordance with a determination that the user input corresponding to the first accessibility feature option corresponds to a user request to enable the first accessibility feature, the computer system causes the first accessibility feature to be enabled on the external computer system while the external computer system is operating in the guest mode of operation; and in accordance with a determination that the user input corresponding to the first accessibility feature option corresponds to a user request to disable the first accessibility feature, the computer system causes the first accessibility feature to be disabled while the external computer system is operating in the guest mode of operation. Allowing the user of the computer system to manage and/or control accessibility features of the external computer system while the external computer system is operating in the guest mode of operation enhances the operability of the system and makes the user-system interface more efficient (e.g., by helping the user to provide proper inputs and reducing errors) which, additionally, reduces power usage and improves battery life of the device by enabling the user to use the system more quickly and efficiently. Additionally, allowing the user of the computer system to manage and/or control accessibility features of the external computer system while the external computer system is operating in the guest mode of operation enables use of the external computer system by a guest user that may be otherwise unable to use the external computer system due to physical differences or accessibility needs.

In some embodiments, the one or more guest mode management options (e.g., in 938 and/or in 930) includes a first input re-enrollment option that, when selected, causes the external computer system (e.g., 700) to initiate a process for performing input enrollment of a user of the external computer system (e.g., FIGS. 7I-7M) (e.g., initiating a process for enrolling and/or calibrating gaze-based user inputs; initiating a process for enrolling and/or calibrating hand-based user inputs; and/or initiating a process for enrolling and/or calibrating air gesture user inputs) (e.g., in some embodiments, 938 and/or 930 includes a new input enrollment option similar to option 760b, option 760c, and/or option 760e described below). In some embodiments, performing input enrollment of the first user results in a user input calibration profile being generated for the first user that includes a gaze-based input calibration profile and/or an air gesture input calibration profile for the user. In some embodiments, gaze-based input calibration information and/or a gaze-based input calibration profile includes one or more offset values and/or one or more values that are used in measuring, sensing, and/or responding to gaze inputs from a user (e.g., one or more offset values and/or other values that are determined based on scanning one or more eyes of the user while the user is instructed to look at one or more gaze targets positioned at one or more different display positions). In some embodiments, hand-based input calibration information, a hand-based input calibration profile, air gesture input calibration information, and/or an air gesture input calibration profile includes one or more offset values and/or one or more values that are used in measuring, sensing, and/or responding to hand inputs (e.g., gesture inputs and/or air gesture inputs) and/or air gesture input from a user (e.g., one or more offset values and/or other values that are determined based on scanning one or more hands of the user while the user is instructed to perform one or more gestures and/or air gestures).

In some embodiments, the one or more guest mode management options includes a first input re-enrollment option that, when selected, causes the external computer system to initiate a process for performing a first type of input enrollment of the user of the external computer system (e.g., gaze-based input enrollment or hand-based input enrollment) (e.g., in some embodiments, 938 and/or 930 includes an option similar to option 760 and/or option 760c); and a second input re-enrollment option that, when selected, causes the external computer system to initiate a process for performing a second type of input enrollment of the user of the external computer system (e.g., gaze-based input enrollment or hand-based input enrollment) that is different from the first type of input enrollment (e.g., gaze-based input enrollment or hand-based input enrollment) (e.g., in some embodiments, 938 and/or 930 includes an option similar to option 760 and/or option 760c). In some embodiments, while displaying the one or more guest mode management options, the computer system receives, via the one or more input devices, a user input corresponding to the first input re-enrollment option. In response to receiving the user input corresponding to the first accessibility feature option, the computer system causes the external computer system to initiate a process for performing input enrollment of a user of the external computer system (e.g., FIGS. 7I-7M). If input enrollment of a guest user of the external computer system is not performed properly or is faulty, the guest user may not be able to provide correct inputs to the external computer system to re-perform input enrollment. Accordingly, allowing the user of the computer system to initiate input enrollment of a user of the external computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently. Additionally, allowing the user of the computer system to initiate input enrollment of a user of the external computer system enables use of the external computer system by a guest user that may be otherwise unable to use the external computer system due to failed or inaccurate input enrollment.

In some embodiments, aspects/operations of methods 800, 1000, 1100, 1300, 1500, and/or 1700 may be interchanged, substituted, and/or added between these methods. For example, in some embodiments, the computer systems recited in methods 800, 1200, and/or 1700 are the same computer system, the first computer system recited in method 1000, the wearable device recited in method 1500, and/or the external computer system recited in method 1100. In another example, in some embodiments, the computer system recited in method 1100 is the second computer system recited in method 1000. For brevity, these details are not repeated here.

FIGS. 12A-12AN illustrate examples of initiating a guest mode of operation of a computer system. FIG. 13 is a flow diagram of an exemplary method 1300 for initiating a guest mode of operation of a computer system. The user interfaces in FIGS. 12A-12AN are used to illustrate the processes described below, including the processes in FIG. 13.

FIG. 12A depicts user 1200 placing computer system 700 on their head. At FIG. 12B, based on a determination that computer system 700 has been worn on the head of a user, computer system 700 displays gaze target 706 and attempts biometric authentication of user 1200 (e.g., face-based, eye-based, and/or iris-based biometric authentication). In the depicted embodiments, computer system 700 is a head-mounted device that includes input sensors 703, hardware control 704, and display module 702. Various embodiments of computer system 700 were described above, for example, with reference to FIGS. 7A-7AB.

FIG. 12C depicts a first example scenario in which user 1200 is a registered user, e.g., registered user 710. At FIG. 12C, computer system 700 determines that biometric authentication of user 1200 (e.g., user 710) is successful (e.g., successfully identifies user 710 as a registered user of computer system 700). Based on the determination that biometric authentication of user 1200 (e.g., user 710) successfully authenticates user 1200 as a registered user of computer system 700, computer system 700 transitions from a locked state (e.g., in FIG. 12B) to an unlocked state in FIG. 12C, applies user input enrollment information corresponding to the registered user (e.g., as indicated by legend 705), and displays home screen user interface 714, which includes application icons 714-a through 714-9. Various embodiments of home screen user interface 714 were described above, for example, with reference to FIG. 7C.

FIG. 12D depicts a second example scenario in which user 1200 is a guest user, e.g., guest user 711, and biometric authentication of user 1200 (e.g., user 711) is unsuccessful (e.g., does not identify user 711 as a registered user of computer system 700). At FIG. 12D, based on the determination that biometric authentication of user 1200 (e.g., user 711) is unsuccessful, computer system 700 displays, via display module 702, user interface 1202. In some embodiments, user interface 1202 is a different embodiment of user interface 772 discussed above. In some embodiments, user interface 1202 is displayed by computer system 700 based on registered user 710 having previously entered computer system 700 into the guest mode of operation (e.g., as shown in FIGS. 7C-7G). In some embodiments, user interface 1202 is displayed by computer system 700 based on computer system 700 receiving authorization of the guest mode of operation from an external device corresponding to registered user 710 (e.g., such as computer system 910 in FIGS. 9D-9G). User interface 1202 includes options 1202a-1202c, and instructs the user to rotate hardware control 704 to scroll between options 1202a-1202c, and to press hardware control 704 to select an option. Option 1202a, when selected, causes computer system 700 to initiate new input enrollment (e.g., FIGS. 7I-7L) of user 711. Option 1202c, when selected, causes computer system 700 to use first saved guest user input enrollment information that was last used on Mar. 14, 2024 at 10:09 AM. Option 1202b, when selected, causes computer system 700 to initiate a process for importing user input enrollment information for user 711 from an external device. At FIG. 12D, computer system 700 detects user input 1204a (e.g., a press of hardware control 704) and user input 1204b (e.g., rotation of hardware control 704) to select option 1202b.

At FIG. 12E, in response to user input 1204a and user input 1204b corresponding to selection of option 1202b, computer system 700 ceases display of user interface 1202 and displays user interface 1206. User interface 1206 includes instruction 1206a, which instructs user 711 to look at their other device, as well as frame 1206b. Additionally, at FIG. 12E, in response to selection of option 1202b, computer system 700 transmits a signal to communicate to electronic devices within a threshold distance of computer system 700 (e.g., within wireless communication distance of computer system 700). In some embodiments, the signal is indicative of a request to import user input enrollment information.

At FIG. 12E, user 711 is holding computer system 1210, which is a smart phone with touch-sensitive display 1211. Computer system 1210 receives the transmitted signal from computer system 700 and, in response, displays computer-readable code (e.g., QR code) 1212. At FIG. 12E-1, user 711 has moved computer system 1210 relative to computer system 700 such that computer-readable code 1212 is now within frame 1206b. At FIG. 12F, computer system 700 uses computer-readable code 1212 to pair with computer system 1210 and receive, from computer system 1210, user input enrollment information for guest user 711 (and, correspondingly, computer system 1210 transmits to computer system 700 the user input enrollment information for guest user 711). At FIG. 12F, after receiving the user input enrollment information for guest user 711 from computer system 1210, computer system 700 applies the user input enrollment information received from computer system 1210 (e.g., as indicated by legend 705), transitions computer system 700 into an unlocked state, operates computer system 700 using the guest mode of operation, and displays windows 718a, 718b. At FIG. 12F, computer system 700 detects air gesture input 1214a (e.g., a pinch air gesture) and gaze input 1214b, which is directed to an upper region and/or an upper edge of display module 702. In some embodiments, air gesture input 1214a and gaze input 1214b are interpreted using the user input enrollment information received from computer system 1210.

At FIG. 12G, in response to air gesture input 1214a and gaze input 1214b (and, based on the user input enrollment information received from computer system 1210), computer system 700 displays control center user interface 756. At FIG. 12G, computer system 700 detects air gesture input 1216a (e.g., a pinch air gesture) and gaze input 1216b corresponding to option 756f (e.g., air gesture input 1216a while user 711 looks at option 756f).

At FIG. 12H, in response to air gesture input 1216a and gaze input 1216b, computer system 700 displays options 760a-760e. Options 760a-760d were discussed above, for example, with reference to FIG. 7P. In the embodiment shown in FIG. 12H, control panel user interface 756 includes additional option 760e. Whereas option 760b, when selected, causes computer system 700 to re-perform gaze-based input enrollment, and option 760c, when selected, causes computer system 700 to re-perform hand-based input enrollment, option 760e, when selected, causes computer system 700 to re-perform both gaze-based and hand-based input enrollment. At FIG. 12H, computer system 700 detects air gesture input 1218a (e.g., a pinch air gesture) and gaze input 1218b directed to option 760e (e.g., air gesture input 1218a while user 711 looks at option 760e).

At FIG. 12I, in response to air gesture input 1218a and gaze input 1218b, computer system 700 stops using and/or ceases application of the user input enrollment information received from computer system 1210 (e.g., as indicated by legend 705), and displays introductory video 738, which was described above with reference to FIG. 7J. In some embodiments, introductory video 738 provides a demonstration and/or instructions pertaining to user input enrollment (e.g., gaze-based input enrollment and hand-based input enrollment). At FIG. 12J, after introductory video 738 has concluded, computer system 700 displays user interface 740a. User interface 740a instructs user 711 to look at their hands to perform hand-based input enrollment. In some embodiments, hand-based input enrollment of user 711 includes instructing the user to perform specific hand-based air gestures, and scanning and/or measuring the user's hands while they perform the instructed air gestures. In some embodiments, after hand-based input enrollment of user 711 is completed, hand-based input enrollment information corresponding to user 711 is generated and used by computer system 700 to interpret hand-based inputs by user 711. At FIG. 12J, computer system 700 detects user 711 lifting her hands (1220) and performs hand-based input enrollment of user 711.

At FIG. 12K, after hand-based input enrollment of user 711 has been completed, computer system 700 displays user interface 740b. User interface 740b includes gaze targets 744a-744f, and instructs user 711 to sequentially look at each gaze target 744a-744f and perform a pinch air gesture while looking at each gaze target 744a-744f. In some embodiments, as the user sequentially looks at each gaze target 744a-744f, computer system 700 collects one or more scans of user 711's eyes. In some embodiments, after gaze-based input enrollment of user 711 is completed, gaze-based input enrollment information corresponding to 711 is generated and used by computer system 700 to interpret gaze-based input from user 711. At FIG. 12K, computer system 700 detects user input 1222 (e.g., a press of hardware control 704), and performs gaze-based input enrollment of user 711.

At FIG. 12L, computer system 700 has completed hand-based input enrollment and gaze-based input enrollment of user 711. At FIG. 12L, after completing input enrollment of user 711, computer system 700 applies the newly generated guest input enrollment information (e.g., as indicated by legend 705) to interpret user inputs by user 711. Additionally, at FIG. 12L, computer system displays user interface 746. User interface 746 includes options 746a-746b. Option 746a, when selected, causes computer system 700 to operate in the guest mode of operation with the new guest user input enrollment information corresponding to user 711 applied, and when user 711 has completed her guest session on computer system 700, computer system 700 automatically deletes the new guest user input enrollment information corresponding to user 711. Option 746b, when selected, causes computer system 700 to operate in the guest mode operation with the new guest user input enrollment information corresponding to user 711 applied, and when user 711 has completed her guest session on computer system 700, computer system 700 saves and/or maintains user 711's new guest user input enrollment information for future user. At FIG. 12L, computer system 700 detects air gesture input 1224a (e.g., a pinch air gesture) and gaze input 1224b corresponding to option 746b (e.g., air gesture input 748a while user 711 looks at option 746b).

At FIG. 12M, in response to air gesture input 1224a and gaze input 1224b, computer system 700 displays user interface 1226. User interface 1226 includes options 1226a-1226b. User interface 1226 instructs user 711 that user 711 can choose to save the newly generated guest user input enrollment information on her own device (e.g., computer system 1210) for future use by user 711. Option 1226a, when selected, causes computer system 700 to proceed with operating computer system 700 in the guest mode of operation, using the newly generated guest user input enrollment information, and without saving the newly generated guest user input enrollment information to a separate device (e.g., computer system 1210). Option 1226b, when selected, causes computer system 700 to proceed with operating computer system 700 in the guest mode of operation, using the newly generated guest user input enrollment information, and also causes computer system 700 to save the newly generated guest user input enrollment information to a separate device (e.g., computer system 1210). At FIG. 12M, computer system 700 detects air gesture input 1228a (e.g., a pinch air gesture) and gaze input 1228b corresponding to option 1226b (e.g., air gesture input 1228a while user 711 looks at option 1226b).

At FIG. 12M-1, in response to air gesture input 1228a and gaze input 1228b, computer system 700 displays instruction 1229, which instructs user 711 to use their personal device (e.g., computer system 1210) to save the newly generated guest user input enrollment information to their personal device. Additionally, at FIG. 12M-1, in response to air gesture input 1228a and gaze input 1228b, computer system 700 transmits a communication (e.g., a direct communication or an indirect and/or broadcast communication) indicating that user 711 would like to save user input enrollment information to a device. At FIG. 12M-1, computer system 1210 receives the communication from computer system 700 and, in response, displays user interface 1230. User interface 1230 includes options 1230a-1230c. Option 1230a, when selected, causes computer system 1210 to cease display of user interface 1230 without receiving and/or without saving guest user input enrollment information from computer system 700. Option 1230b, when selected, causes computer system 1210 to proceed with a process for receiving and saving guest user input enrollment information from computer system 700. Option 1230c, when selected, causes computer system 1210 to cease display of user interface 1230 without receiving and/or without saving guest user input enrollment information from computer system 700. At FIG. 12M-1, computer system 1210 detects user input 1232 (e.g., a tap input) corresponding to selection of option 1230b.

At FIG. 12M-2, in response to user input 1232, computer system 1210 displays authentication user interface 1234 so that user 711 can provide authentication information that, for example, proves that user 711 is authorized to save new data (e.g., guest input enrollment information) to computer system 1210. At FIG. 12M-2, computer system 1210 detects user inputs 1236a-1236c interacting with authentication user interface 1234.

At FIG. 12N, in response to user inputs 1236a-1236c, computer system 1210 determines that user 711 has been authenticated (e.g., passcode-based authentication information received via user inputs 1236a-1236c match a saved passcode), and displays computer-readable code 1238. Additionally, while computer system 1210 displays computer readable code 1238, computer system 700 displays frame 1240b and instruction 1240a. Instruction 1240a instructs user 711 to look at computer system 1210 (e.g., while wearing computer system 700 on her head).

At FIG. 12O, user 711 has moved computer system 1210 and computer-readable code 1238 within frame 1240b. Computer system 700 detects computer-readable code 1238 (e.g., via sensors 703 and/or one or more frontward facing cameras and/or sensors). At FIG. 12O, in response to detecting computer-readable code 1238, computer system 700 communicates with computer system 1210, transmits the newly generated guest user input enrollment information to computer system 1210, and displays indication 1242. In the future, user 711 can now use computer system 1210 to import the new guest user input enrollment information to other devices (e.g., in a manner similar to what was shown and described above with reference to FIGS. 12A-12F). At FIG. 12P, after the guest user input enrollment information has been saved to computer system 1210, computer system 700 operates in the guest mode of operation using the newly generated guest user input enrollment information that was generated as a results of user input enrollment in FIGS. 12I-12K.

FIGS. 12Q-12AD illustrate example scenarios and/or embodiments in which a guest user is able to import guest user information from their personal device (e.g., a phone or a tablet or other device) to another computer system (e.g., an HMD) on which they are a guest user (e.g., on which they are not a registered user). In some embodiments, the guest user information includes guest user input enrollment information, such as gaze input enrollment information and/or hand input enrollment information. In some embodiments, when a user performs input enrollment on a device (e.g., on their own HMD and/or on someone else's HMD), such as the input enrollment discussed above with reference to FIGS. 7K-7M, the user is given the option to store the input enrollment information on their personal device. By storing their input enrollment on their personal device, a user can quickly and easily import their input enrollment information to other devices (e.g., other HMDs) without having to re-perform input enrollment. At FIG. 12Q, user 711 (e.g., a guest user of computer system 700) has placed computer system 700 on her head. At FIG. 12Q, based on a determination that computer system 700 has been worn on the head of a user, computer system 700 displays gaze target 706 and attempts biometric authentication of user 711 (e.g., face-based, eye-based, and/or iris-based biometric authentication).

At FIG. 12R, computer system 700 determines that biometric information collected from user 711 does not correspond to any registered user of computer system 700. In response to determining that biometric information collected from user 711 does not correspond to any registered user of computer system 700, computer system 700 displays passcode entry user interface 1246. Passcode entry user interface 1246 includes keyboard 1246a for a user to enter a passcode to log in to and/or access computer system 700 as a registered user. Passcode entry user interface 1246 also includes instruction 1246b, which instructs the user that the user can press hardware control 704 if the user would like to operate computer system 700 as a guest user and/or in a guest mode of operation. At FIG. 12R, computer system 700 detects user input 1248, which is a press of hardware control 704.

At FIG. 12S, in response to detecting user input 1248, computer system 700 displays notification 906, which indicates that computer system 700 has transmitted a request to the owner of computer system 700 to operate computer system 700 in a guest mode of operation, and that computer system 700 is waiting for authorization from the device owner (e.g., as described above, for example, with reference to FIG. 9E). At FIG. 12T, computer system 700 has received information (e.g., from a separate device associated with the owner of computer system 700) indicating that the owner has authorized operation of computer system 700 in the guest mode of operation (e.g., various examples and/or embodiments of such owner approval were described above, for example, with reference to FIGS. 9E-9H and/or FIGS. 9N-9T). At FIG. 12T, in response to receiving information indicating that the owner has authorized operation of computer system 700 in the guest mode of operation, computer system 700 displays user interface 1249. User interface 1249 includes instruction 1249a, which instructs user 711 to bring her phone or tablet nearby to start using computer system 700 in the guest mode of operation. User interface 1249 also includes instruction 1249b, which instructs user 711 to double press hardware control 704 in order to proceed with using computer system 700 in the guest mode of operation without using user 711's phone or tablet.

At FIG. 12U, user 711 has moved computer system 1250 towards computer system 700. In the depicted embodiments and scenarios, computer system 1250 is a smart phone with touch-sensitive display 1252, and computer system 1250 is associated with user 711 (e.g., computer system 1250 belongs to user 711 and/or is logged into a user account that corresponds to, is associated with, and/or belongs to user 711). In some embodiments, computer system 1250 is computer system 1210, discussed above. At FIG. 12U, in response to detecting that computer system 1250 has been moved proximate computer system 700 (e.g., within a threshold distance of computer system 700 and/or within wireless communication distance of computer system 700), computer system 700 ceases display of user interface 1249 and displays user interface 1254a, which instructs user 711 to follow the instructions on her phone (e.g., computer system 1250). Additionally, in response to detecting that computer system 1250 has been moved proximate computer system 700, computer system 1250 displays user interface 1256. User interface 1256 includes option 1256a and option 1256b. Option 1256a, when selected, causes computer system 1250 to cease display of user interface 1256 (e.g., in some embodiments, without transmitting guest user information from computer system 1250 to computer system 700). Option 1256b, when selected, causes computer system 1250 to proceed with a process for transmitting guest user information from computer system 1250 to computer system 700. At FIG. 12U, computer system 1250 detects user input 1257 (e.g., a selection input, such as a touch input, a button input, and/or a press input) corresponding to selection of option 1256b.

At FIG. 12V, in response to detecting user input 1257, computer system 1250 displays passcode entry user interface 1258. Passcode entry user interface 1258 includes keypad 1258a for a user to enter a passcode to transition computer system 1250 from a locked state to an unlocked state. At FIG. 12V, computer system 1250 detects user inputs 1259a, 1259b, 1259c, which are selection inputs (e.g., such as one or more touch inputs, one or more press inputs, and/or one or more button inputs) interacting with keyboard 1258a to enter a passcode to unlock computer system 1250.

At FIG. 12W, in response to detecting user inputs 1259a, 1259b, 1259c, and in accordance with a determination that the passcode entered by user 711 matches a known and/or stored passcode for unlocking computer system 1250, computer system 1250 transitions from a locked state to an unlocked state, and displays user interface 1260. User interface 1260 includes options 1260a, 1260b, and 1260c. Option 1260a, when selected, causes computer system 1250 to cease display of user interface 1260 (e.g., in some embodiments, without transmitting guest user information from computer system 1250 to computer system 700). Option 1260c, when selected (e.g., with a user input such as user input 1261b in FIG. 12W), causes computer system 1250 to cease display of user interface 1260 (e.g., in some embodiments, without transmitting guest user information from computer system 1250 to computer system 700). Option 1260b, when selected, causes computer system 1250 to proceed with a process for transmitting guest user information from computer system 1250 to computer system 700. At FIG. 12W, computer system 1250 detects user input 1261 (e.g., a selection input, such as a touch input, a button input, and/or a press input) corresponding to selection of option 1260b.

At FIG. 12X, in response to detecting user input 1261, computer system 1250 displays computer-readable code 1262. In some embodiments, computer-readable code 1262 is scannable by computer system 700 to proceed with the process for transmitting guest user information from computer system 1250 to computer system 700. Computer-readable code 1262 is displayed with option 1262a and instruction 1262b. Option 1262a, when selected, causes computer system 1250 to cease display of computer-readable code 1262. Instruction 1262b instructs the user to look at computer-readable code 1262 with computer system 700 (e.g., so that computer system 700 can scan computer-readable code 1262). Additionally, in response to detecting user input 1261, computer system 1250 transmits information to computer system 700 indicating that computer system 1250 is displaying computer-readable code 1262 to be scanned by computer system 700. In response to receiving information from computer system 1250 indicating that computer system 1250 is displaying computer-readable code 1262, computer system 700 replaces user interface 1254a with user interface 1254b. User interface 1254b instructs user 711 to look at computer-readable code 1262 (e.g., while wearing computer system 700 so that computer system 700 can scan computer-readable code 1262). At FIG. 12Y, user 711 moves computer system 1250 so that computer-readable code 1262 is positioned within user interface 1254b, and computer system 700 reads and/or scans computer-readable code 1262.

At FIG. 12Z, after computer system 700 scans computer-readable code 1262 (e.g., in response to and/or based on computer system 700 scanning computer-readable code 1262), computer system 700 and computer system 1250 exchange information such that computer system 1250 transmits guest user information corresponding to user 711 to computer system 700. As discussed above, in some embodiments, guest user information corresponding to user 711 includes input enrollment information corresponding to user 711, such as gaze input enrollment information and/or hand input enrollment information. In some embodiments, the input enrollment information corresponding to user 711 was previously generated by another device (e.g., another HMD) after user 711 performed input enrollment on that device, and the resultant input enrollment information was then stored on and/or saved to computer system 1250. For example, in FIG. 12AA, user 711 is shown using a different computer system 1274. In the depicted embodiments, computer system 1274 is an HMD that belongs to user 711. User 711 previously performed input enrollment on computer system 1274 (e.g., various examples and/or embodiments of which were described above, for example, with reference to FIGS. 7K-7L). At FIG. 12AA, computer system 1274 is shown displaying user interface 1276, which includes option 1276a. Option 1276a, when in an enabled state, causes computer system 1274 to sync and/or save user input enrollment information corresponding to user 711 to computer system 1250, which is user 711's phone. In some embodiments, when option 1276a is transitioned from the enabled state to the disabled state (e.g., via gaze input 1278b and air gesture input 1278a shown in FIG. 12AA), computer system 1274 erases and/or removes the user input enrollment information corresponding to user 711 from computer system 1250. User interface 1276 also includes indication 1276b, which indicates that the user's input enrollment information was last saved on Oct. 12, 2023, and option 1276c, which, when selected, causes computer system 1274 to save user 711's input enrollment information to computer system 1250. At FIG. 12AA, computer system 1250 displays user interface 1277. User interface 1277 includes option 1277a, which indicates that user input enrollment information synchronization between computer system 1274 and computer system 1250 is currently on. In some embodiments, input enrollment information for user 711 is saved by computer system 1274 to a cloud storage service, and is retrieved by computer system 1250 from the cloud storage service.

Returning to FIG. 12Z, computer system 700 has received the input enrollment information corresponding to user 711 from computer system 1250, and uses the input enrollment information corresponding to user 711 to detect, respond to, and/or interpret inputs by user 711 (e.g., gaze-based inputs and/or hand gesture-based inputs). In some embodiments, computer system 700 also receives additional guest user information corresponding to user 711 in addition to the input enrollment information corresponding to user 711. For example, in some embodiments, guest user information corresponding to user 711 includes user account information, user settings information, user preferences information, user accessibility features and/or preferences, user spatial audio settings, and/or other user information that is specific to and/or corresponds to user 711. In some embodiments, this additional guest user information is used and/or applied by computer system 700 while user 711 is using computer system 700 as a guest user. For example, in some embodiments, computer system 700 uses the guest user information from computer system 1250 to apply one or more user preferences, one or more accessibility features, and/or one or more user account settings while user 711 is using computer system 700 as a guest user.

FIGS. 12AB through 12AG depict example embodiments and/or scenarios in which a guest user is able to access their personal computing devices and/or display their personal content on computer system 700 while operating computer system 700 in the guest mode of operation. At FIG. 12AB, computer system 700 is in the state described above with reference to FIG. 12Z, in which guest user 711 has imported her guest user information from computer system 1250 to computer system 700, and is operating computer system 700 in the guest mode of operation. In the embodiments shown in FIGS. 12AB through 12AG, the guest user information imported from computer system 1250 to computer system 700 includes user input enrollment information, and also includes additional user account information associated with user 711. The user account information associated with user 711 enables computer system 700 to access other computing devices associated with user 711 while user 711 is operating computer system 700 as a guest user. For example, in FIG. 12AB, three-dimensional environment 708 surrounding user 711 also includes computer system 708c-1 and computer system 708c-2. In the depicted scenarios, computer system 708c-1 is a desktop computer that is associated with user 711 (e.g., that is logged into a user account of user 711 and/or that belongs to user 711), and computer system 708c-2 is a laptop computer that is associated with user 711 (e.g., that is logged into a user account of user 711 and/or that belongs to user 711). As will be described in greater detail below, in some embodiments, based on user 711 importing her user-specific guest user information from computer system 1250 to computer system 700, user 711 is able to use computer system 700 to display content from computer system 708c-1 and/or computer system 708c-2 while user 711 is operating computer system 700 in the guest mode of operation (e.g., while user 711 is operating computer system 700 as a guest user). In some embodiments, other users would not be permitted and/or would not be able to access content from computer system 708c-1 and/or computer system 708c-2 while using computer system 70. This may be the case, for example, because those other users are not associated with computer system 708c-1 and/or computer system 708c-2, and/or guest user information for those other users would not permit access to computer system 708c-1 and/or computer system 708c-2.

At FIG. 12AB, computer system 700 detects that user 711 is looking at the palm of her hand 711a. In response to detecting that user 711 is looking at the palm of her hand 711a, computer system 700 displays indication 1265a proximate hand 711a. At FIG. 12AC, computer system 700 detects that user 711 has turned hand 711a over so that the palm of hand 711a is now facing downwards and user 711 is looking at the back of hand 711a. In response to detecting rotation of hand 711a from a palm up position to a palm down position, computer system 700 replaces indication 1265a with indication 1265b. In FIG. 12AC, indication 1265b displays the current time (e.g., 9:41). At FIG. 12AD, while displaying indication 1265b, computer system 700 detects air gesture input 1266a (e.g., a pinch air gesture) and gaze input 1266b directed to indication 1265b (e.g., air gesture input 1266a while user 711 looks at indication 1265b).

At FIG. 12AE, in response to detecting air gesture input 1266a and gaze input 1266b, computer system 700 displays control panel user interface 1268. Control panel user interface 1268 represents another embodiment and/or a variation of control panel user interface 756 discussed above. In some embodiments, control panel user interface 1268 in FIG. 12AE is control panel user interface 756 and/or, in some embodiments, control panel user interface 756 in the scenarios described above can be replaced with control panel user interface 1268. In certain embodiments described previously, a user causes computer system 700 to display control panel user interface 756 by performing an air gesture (e.g., a pinch air gesture) while looking at a region proximate a top edge of display module 702. FIGS. 12AB-12AE depict an example embodiment in which a user invokes control panel user interface 1268 (and/or control panel user interface 756) by performing the inputs shown, e.g., looking at the user's palm, turning the user's palm downwards, and then performing a pinch gesture while looking at indication 1265b. At FIG. 12AE, control panel user interface 1268 displays current time 1268a, current date 1268b, signal strength indication 1268c, and battery level indication 1268d. Control panel user interface 1268 also includes options 1268e, 1268f, 1268g, and 1268h. Option 1268e, when selected, causes computer system 1250 to display one or more settings options that are selectable by the user to modify one or more settings of computer system 1250, such as a brightness setting and/or a volume setting. Option 1268f allows a user to modify the volume setting of computer system 700. Option 1268g, when selected, causes computer system 700 to display one or more options for using computer system 700 to display content from one or more separate computer systems, as will be described in greater detail below. Option 1268h, when selected, causes computer system 700 to display one or more additional options, such as options 760a-760e described above (e.g., with reference to FIG. 7Q and/or 9X). At FIG. 12AE, computer system 700 detects air gesture input 1269a (e.g., a pinch air gesture input) and gaze input 1269b directed to option 1268g (e.g., detects air gesture input 1269a while user 711 looks at option 1268g).

At FIG. 12AF, in response to detecting air gesture input 1269a and gaze input 1269b, computer system 700 displays user interface 1270. User interface 1270 includes options 1270a, 1270b. Option 1270a corresponds to laptop computer system 718c-2, and option 1270b corresponds to desktop computer system 718c-1. In some embodiments, options 1270a-1270b are displayed in user interface 1270 based on the guest user information corresponding to user 711 that was received from computer system 1250, and based on the guest user information indicating that user 711 is associated with computer systems 718c-1, 718c-2. In some embodiments, one or more other devices that are in three-dimensional environment 708 are not represented in user interface 1270 based on a determination that those other devices are not associated with user 711 and/or are not identified by guest user information corresponding to user 711 that was received from computer system 1250. At FIG. 12AF, computer system 700 detects air gesture input 1271a (e.g., a pinch air gesture input) and gaze input 1271b directed to option 1270b (e.g., detects air gesture input 1271a while user 711 is looking at option 1270b).

At FIG. 12AG, in response to detecting air gesture input 1271a and gaze input 1271b, computer system 700 displays window 1272. Window 1272 displays content from desktop computer system 718c-1 (e.g., content stored on and/or generated by desktop computer system 718c-1 and/or that is caused to be displayed on computer system 700 by desktop computer system 718c-1). For example, in FIG. 12AG, window 1272 displays home screen user interface 1272a of desktop computer system 718c-1, as well as folder 1272b and document 1272c, which are open on desktop computer system 718c-1. Accordingly, in FIG. 12AG, computer system 700 is effectively operating as a display for desktop computer system 718c-1, such that user 711 can interact with files and/or content that are stored on desktop computer system 718c-1. In some embodiments, desktop computer system 718c-1 and/or laptop computer system 718c-2 do not need to be within the immediate surrounding environment of user 711 in order for user 711 to display content from those computer systems using computer system 700. For example, in some embodiments, computer system 718c-1 and computer system 700 are in two separate geographic locations (e.g., computer system 718c-1 is not within the field of view of computer system 700 and/or computer system 718c-1 is outside of direct wireless communication range of computer system 700), and computer system 700 accesses and/or communicates with desktop computer system 718c-1 via a network in order to display window 1272.

FIG. 12AH returns to the scenario shown in FIG. 12V. However, in FIG. 12AH, unlike the example scenario described in FIG. 12W, computer system 1250 does not have guest user information stored on computer system 1250 and/or does not have guest user information available to transfer to computer system 700. In the depicted embodiments, when computer system 1250 does not have guest user information and/or does not have guest user input enrollment information, the guest user (e.g., user 711) is led through a process for performing input enrollment on computer system 700 (e.g., such as input enrollment described above with reference to FIGS. 7J-7L), as will be described in greater detail below. At FIG. 12AH, in response to user inputs 1259a-1259c in FIG. 12V and/or in response to authenticating user 711 via passcode-based authentication in FIG. 12V, and based on a determination that computer system 1250 does not have guest user information available to transfer to computer system 700, computer system 1250 displays user interface 1280 (e.g., instead of displaying user interface 1260 from FIG. 12W). User interface 1280 includes options 1280a, 1280b, 1280c. Option 1280c, when selected, causes computer system 1250 to cease display of user interface 1280. Option 1280a, when selected, causes computer system 1250 to proceed with a process for performing user input enrollment of user 711 on computer system 700. Option 1280b, when in a disabled state or off state, is indicative of a user request or instruction to store user input enrollment information on computer system 1250 after the user has completed input enrollment. Option 1280b, when in an enabled state or on state, is indicative of a user request or instruction not to store user input enrollment information on computer system 1250 after the user has completed input enrollment. User 711 can switch option 1280b between the disabled state and the enabled state by selecting option 1280b (e.g., user input 1281b). At FIG. 12AH, computer system 1250 detects user input 1281a (e.g., a selection input, such as a touch input, a button input, and/or a press input) corresponding to selection of option 1280a, while option 1280b is in the off or disabled state.

At FIG. 12AI, in response to detecting user input 1281a, computer system 1250 displays computer-readable code 1282, along with instruction 1282b instructing the user to look at computer-readable code 1282 with computer system 700. At FIG. 12AI, user 711 has moved computer-readable code 1282 within user interface 1254a, and computer system 700 scans and/or reads computer-readable code 1282.

In some embodiments, computer-readable code 1282, when scanned by computer system 700, conveys to computer system 700 that the guest user does not have input enrollment information that can be imported to computer system 700. At FIG. 12AJ, in response to reading computer-readable code 1282, computer system 700 displays user interface 740a, and initiates input enrollment for user 711 (e.g., as described above, for example, with reference to FIGS. 7J-7L). At FIG. 12AK, user 711 has completed input enrollment, and computer system 700 is operating in the guest mode of operation using new guest input enrollment information that has been generated for user 711 based on the input enrollment performed by user 711. Additionally, at FIG. 12AK, after user 711 has completed input enrollment, and based on a determination that option 1280b was in a disabled state in FIG. 12AH (e.g., indicating that user 711 would like to store their input enrollment information on computer system 1250), computer system 700 transmits user 711's input enrollment information to computer system 1250, and computer system 1250 displays user interface 1284 indicating that user 711's input enrollment information has been saved to computer system 1250. Now that user 711's input enrollment information has been saved to computer system 1250, user 711 is able to transmit their input enrollment information to other computer systems (e.g., using the process and/or procedure described above with reference to FIGS. 12U-12Z), and can use those computer systems (e.g., as a guest user and/or as a registered user) without having to perform input enrollment again.

As described above, in some embodiments, user 711 is able to import her guest user information from computer system 1250 to computer system 700. In some embodiments, computer system 700 uses the guest user information from computer system 1250 to set one or more device settings while user 711 is operating computer system 700 in the guest mode of operation (e.g., while user 711 is operating computer system 700 as a guest user). In some embodiments, the guest user information imported from computer system 1250 includes user virtual avatar information. In some embodiments, users are represented by virtual avatars in communication sessions with other users. In some embodiments, a virtual avatar corresponding to a respective user is generated based on biometric information collected from the respective user (e.g., so that the virtual avatar has one or more visual characteristics that correspond to and/or match visual characteristics of the respective user). FIGS. 12AL-12AN depict various example scenarios and/or embodiments in which a guest user is able to import their personal virtual avatar information from their personal device to computer system 700 while operating computer system 700 in the guest mode of operation.

At FIG. 12AL, user 1286 is operating computer system 700 (e.g., in a registered user mode of operation or a guest user mode of operation). Computer system 700 displays home screen user interface 714, as well as side panel 715, various embodiments of which were described above. At FIG. 12AL, computer system 700 detects air gesture input 1286a (e.g., a pinch air gesture input) and gaze input 1286b corresponding to option 715-2 (e.g., a pinch air gesture input while user 1286 looks at option 715-2).

At FIG. 12AM, in response to detecting air gesture input 1286a and gaze input 1286b, computer system 700 replaces display of home screen user interface 714 with contacts user interface 1287. Contacts user interface 1287 displays contact representations 1287-1 through 1287-5 that are representative of different contacts of user 1286 and/or representative of contacts that are stored on computer system 700. In some embodiments, contacts user interface 1287 includes different contacts for different users. For example, in some embodiments, when registered user 710 is using computer system 700, contacts user interface 1287 includes a first set of contacts, and when guest user 711 is using computer system 700, contacts user interface 1287 includes a second set of contacts different from the first set of contacts (e.g., a second set of contacts specified by guest user information imported from computer system 1250). However, in FIG. 12AM, for the sake of explanation, contacts user interface 1287 displays the same set of contacts for both registered user 710 and guest user 711. At FIG. 12AM, computer system 700 detects air gesture input 1288a (e.g., a pinch air gesture input) and gaze input 1288b corresponding to contact representation 1287-1 (e.g., a pinch air gesture input while user 1286 looks at contact representation 1287-1).

In some embodiments, selection of contact representation 1287-1 causes computer system 700 to initiate a video call with the selected contact. In other words, in response to detecting air gesture input 1288a and gaze input 1288b, computer system 700 initiates a video call with the selected contact. However, in some embodiments, the video call with the selected contact will utilize a different virtual avatar to represent user 1286 depending on whether the user of computer system 700 (e.g., user 1286) is registered user 710 or guest user 711 (or a different user). FIG. 12AN depicts various example scenarios in which user 1286 from FIGS. 12AL-12AM is either registered user 710 or guest user 711.

The top row of FIG. 12AN, labeled section (a), depicts a scenario in which user 1286 from FIGS. 12AL-12AM is registered user 710. In section (a) of FIG. 12AN, in response to detecting air gesture input 1288a and gaze input 1288b, computer system 700 initiates a video call with remote user 1292. Remote user 1292 is using their own computer system, computer system 1294, which is an HMD with display module 1294a. In section (a) of FIG. 12AN, remote user 1292 is represented in the video call by virtual avatar 1291a, and computer system 700 displays virtual avatar 1291a within video call user interface 1290-1. Furthermore, in section (a) of FIG. 12AN, registered user 710 is represented in the video call by virtual avatar 1291b, which corresponds to registered user 710. In some embodiments, virtual avatar 1291b is generated based on biometric information collected from registered user 710 and/or is generated to have one or more visual characteristics based on detected visual characteristics of registered user 710. Computer system 1294 of remote user 1292 displays virtual avatar 1291b within video call user interface 1290-2. As such, user 710 and remote user 1292 can have a video call communication session in which user 710 is represented by virtual avatar 1291b, and remote user 1292 is represented by virtual avatar 1291a.

The middle portion of FIG. 12AN, labeled section (b), depicts two example scenarios in which user 1286 from FIGS. 12AL-12AM is guest user 711. The top path of section (b) depicts a scenario in which guest user 711 has imported her guest user information from computer system 1250 to computer system 700, including her virtual avatar information. The bottom path of section (b) depicts a scenario in which guest user 711 has not imported her guest user information from computer system 1250. Additionally, the bottom row of FIG. 12AN, labeled section (c), depicts a separate scenario in which user 711 is using her own computer system 1274 (e.g., her own HMD) to have a video call with remote user 1292.

It can be seen that in section (c), when user 711 is using her own computer system 1274 to have a video call with remote user 1292, user 711 is represented in the video call (e.g., on computer system 1294) by virtual avatar 1291c. In some embodiments, virtual avatar 1291c is generated based on biometric information collected from user 711 and/or is generated to have one or more visual characteristics that are determined based on detected visual characteristics of user 711. Similarly, in the top path of section (b), in which user 711 is operating computer system 700 as a guest user, but has imported her guest user information to computer system 700, user 711 is still represented in the video call by virtual avatar 1291c. However, in the bottom path of section (b), in which user 711 has not imported her guest user information to computer system 700, guest user 711 is represented in the video call by a generic visual representation 1291d. In some embodiments, visual representation 1291d is not specifically associated with user 711, is not generated based on biometric information collected from user 711, and/or is not generated to have visual characteristics based on detected visual characteristics of user 711.

Additional descriptions regarding FIGS. 12A-12AN are provided below in reference to method 1300 described with respect to FIG. 13.

FIG. 13 is a flow diagram of an exemplary method 1300 for initiating a guest mode of operation of a computer system, in some embodiments. In some embodiments, method 1300 is performed at a computer system (e.g., 700) (e.g., computer system 101 in FIG. 1A) (e.g., a smart phone, a smart watch, a tablet, a laptop, a desktop, a wearable device, and/or head-mounted device) that is in communication with one or more display generation components (e.g., 702) (e.g., display generation component 120 in FIGS. 1A, 3A, and 4) (e.g., a heads-up display, a display, a touchscreen, a projector, etc.) (e.g., a visual output device, a 3D display, a display having at least a portion that is transparent or translucent on which images can be projected (e.g., a see-through display), a projector, a heads-up display, and/or a display controller) and one or more input devices (e.g., 703 and/or 704) (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) and/or one or more mechanical input devices (e.g., a depressible input mechanism; a button; a rotatable input mechanism; a crown; and/or a dial)). In some embodiments, method 1300 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1300 are, optionally, combined and/or the order of some operations is, optionally, changed.

The computer system (e.g., 700) detects (1302), via the one or more input devices, a sequence of one or more inputs corresponding to a request to use the computer system in a guest mode of operation (e.g., user 711 placing computer system 700 on her head, user input 1204a, user input 1204b, and/or user input 1248), wherein: the guest mode of operation requires user input enrollment information to calibrate the computer system to be controlled using detected inputs that are interpreted based on the user input enrollment information (e.g., gaze-based input enrollment information, hand-based input enrollment information, and/or air gesture input enrollment information) (e.g., in some embodiments, the user input enrollment information is used to process user inputs from the user of the computer system); and the guest mode of operation is not associated with the user of the computer system (e.g., the guest mode of operation is not uniquely associated with and/or does not correspond with the user of the computer system; and/or the guest mode of operation corresponds to a plurality of different users that are not registered on the computer system). In response to detecting the sequence of one or more inputs (1304), the computer system (e.g., 700) initiates (1306) a process for operating the computer system in a guest mode of operation for a user of the computer system, wherein, the process for operating the computer system in the guest mode of operation includes outputting, via one or more output devices, (e.g., one or more output devices of the computer system and/or one or more output devices of an external computer system) a first prompt (e.g., 1202b, 1206, 1249, 1254a, and/or 1254b) (e.g., displaying a visual prompt and/or outputting an audio prompt) prompting the user of the computer system to use an external computer system (e.g., 1210 and/or 1250) that is separate from the computer system (e.g., 700) (e.g., a mobile device, a mobile phone, a tablet, and/or a watch) and that is associated with the user of the computer system to provide saved user input enrollment information (e.g., gaze-based input enrollment information, hand-based input enrollment information, and/or air gesture input enrollment information) corresponding to the user of the computer system to calibrate the computer system to be controlled using detected inputs that are interpreted based on the user input enrollment information. After the first prompt (e.g., 1202b, 1206, 1249, 1254a, and/or 1254b) has been output (1308) (e.g., by the computer system and/or by the external computer system), the computer system (e.g., 700) receives (1310) first saved user input enrollment information corresponding to the user of the computer system from the external computer system (e.g., FIG. 12E-1 to FIG. 12F and/or FIGS. 12Y-12Z).

After receiving the first saved user input enrollment information corresponding to the user of the computer system from the external computer system (1312), the computer system detects (1314), via the one or more input devices, input (e.g., 1214a, 1214b, 1216a, 1216b, 1218a, and/or 1218b). In response to detecting the input (1316), the computer system performs (1318) an operation based on the input (e.g., displaying control panel 756, displaying options 760a-760e, and/or initiating input enrollment in FIG. 12I), where the operation is performed using the input as interpreted based on the first saved user input enrollment information for the user that was received from the external computer system. In some embodiments, detecting the sequence of one or more inputs corresponding to a request to use the computer system in a guest mode of operation comprises one or more of: detecting that the computer system has been worn on the body of a user; detecting a face of a user (e.g., indicating that the computer system has been worn on the face and/or head of the user); one or more touch inputs; one or more air gesture inputs, one or more gaze inputs; one or more hardware control inputs; and/or one or more user interface navigation inputs. In some embodiments, the computer system (e.g., 700) corresponds to and/or is associated with one or more users (e.g., one or more owners and/or one or more registered users), and is not associated with a user of the computer system (e.g., the user of the computer system is not registered as an owner and/or a registered user of the computer system). In some embodiments, the computer system (e.g., 700) is operable in a guest mode of operation (e.g., FIG. 7N and/or 7R) and a registered user mode of operation (e.g., FIG. 7C) different from the guest mode of operation. In some embodiments, the registered user mode of operation provides access to a first plurality of features of the computer system (e.g., FIG. 7C), and the guest mode of operation provides access to a subset of the first plurality of features and provides access to fewer features than the registered user mode of operation (e.g., FIG. 7R). In some embodiments, the computer system is also operable in a locked mode of operation (e.g., FIG. 7B) that provides access to fewer features than the guest mode of operation (e.g., the guest mode of operation provides access to more features than the locked mode of operation). Allowing a non-registered and/or guest user of the computer system to import, from an external computer system, input enrollment information corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first prompt (e.g., 1202b and/or 1206) further prompts the user of the computer system to bring the external computer system (e.g., 1210) near the computer system (e.g., 700) (e.g., prompts the user of the computer system to bring the external computer system within a viewable area of the computer system; within view of one or more cameras of the computer system; and/or within wireless communication range of the computer system). In some embodiments, the external computer system (e.g., 1210 and/or 1250) is not associated with the owner and/or a registered user (e.g., 710) of the computer system (e.g., 700) (e.g., the external computer system is logged into a user account that is different from a user account that is logged into the computer system; and/or the external computer system is logged into a user account that corresponds to a second user that is different from the owner and/or a registered user the computer system). In some embodiments, the external computer system (e.g., 1210 and/or 1250) has stored enrollment information (e.g., gaze-based input enrollment information, hand-based input enrollment information, and/or air gesture input enrollment information) that is compatible with the computer system. In some embodiments, the external computer system has stored enrollment information that corresponds to a second user (e.g., 711) that is different from the owner (e.g., 700) and/or a registered user of the computer system. Prompting the user to bring the external computer system near the computer system provides the user with instructions on how to import input enrollment information, which enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, after the first prompt (e.g., 1202b and/or 1206) has been output (e.g., by the computer system and/or by the external computer system), the computer system (e.g., 700) detects a second external computer system (e.g., 1210) that is within a threshold distance of the computer system (e.g., within wireless communication range of the computer system; and/or within a threshold distance that is determined based on wireless signal strength). After detecting the second external computer system that is within the threshold distance of the computer system: in accordance with a determination that transfer criteria are satisfied, wherein the transfer criteria includes a first criterion that is satisfied when the second external computer system includes respective saved user input enrollment information (e.g., respective saved user input enrollment information corresponding to the user of the computer system), the computer system initiates a process to receive the respective saved user input enrollment information from the second external computer system (e.g., FIGS. 12E-12F). In some embodiments, the first criterion must be satisfied in order for the transfer criteria to be satisfied. In some embodiments, the computer system (e.g., 700) receives the second saved user input enrollment information from the second external computer system (e.g., 1210); after receiving the second saved user input enrollment information from the second external computer system, the computer system detects, via the one or more input devices, a second input; and in response to detecting the second input, the computer system performs a second operation based on the second input, wherein the second operation is performed using the second input as interpreted based on the second saved user input enrollment information that was received from the second external computer system. Allowing a non-registered and/or guest user of the computer system to import, from an external computer system, input enrollment information corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, after detecting the second external computer system (e.g., 1210) that is within the threshold distance of the computer system (e.g., 700): in accordance with a determination that the transfer criteria are not satisfied, including a determination that the second external computer system does not include respective saved user input enrollment information (e.g., respective saved user input enrollment information corresponding to the user of the computer system), the computer system forgoes initiating the process to receive the respective saved user input enrollment information from the second external computer system (e.g., does not display user interface 1206 and/or does not cause computer system 1200 to display computer-readable code 1212). Forgoing initiating the process to receive the respective saved user input enrollment information from the second external computer system when the second external computer system does not include respective saved user input enrollment information enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the process to receive the respective saved user input enrollment information from the second external computer system (e.g., 1210) includes authentication of the user of the computer system (e.g., biometric authentication and/or passcode-based authentication) at the second external computer system (e.g., 1210) in order to receive the respective saved user input enrollment information from the second external computer system (e.g., in some embodiments, prior to displaying code 1212 and/or prior to transmitting user input enrollment information, computer system 1210 performs authentication of user 711 (e.g., FIG. 12M-2). In some embodiments, the second external computer system (e.g., 1210) requires that the user be authenticated and/or requires receipt of valid authentication information in order for the second external computer system to transmit the respective saved user input enrollment information to the computer system and/or in order for the computer system to receive the respective saved user input enrollment information from the second external computer system. In some embodiments, when user authentication at the second computer system fails, the computer system does not receive the respective saved user input enrollment information from the second external computer system (e.g., the second external computer system does not transmit the saved user input enrollment information to the computer system). Requiring authentication of the user at the second external computer system in order to receive the respective saved user input enrollment information from the second external computer system improves device security by ensuring that an unauthorized user has not requested an unauthorized transfer of the respective saved user input enrollment information.

In some embodiments, the process to receive the respective saved user input enrollment information from the second external computer system (e.g., 1210 and/or 1250) includes one or more user inputs directed to (or detected by) the second external computer system requesting (e.g., approving and/or authorizing) transfer of the respective saved user input enrollment information from the second external computer system to the computer system (e.g., user input 1257, 1259a, 1259b, 1259c, and/or 1261a) (e.g., activation of a displayed user interface object (e.g., pressing of and/or interaction with a software button and/or a displayed objected) that is displayed on the second external computer system; interaction with a hardware control of the second external computer system such as a button, dial/crown; and/or an interaction detected by a sensor of the second external computer system such as a particular movement pattern detected by an accelerometer or an inertial measurement unit). In some embodiments, in response to the one or more user inputs directed to the second external computer system requesting transfer of the respective saved user input enrollment information from the second external computer system to the computer system, the second external computer system (e.g., 1210 and/or 1250) displays a computer-readable code (e.g., 1212 and/or 1262) that is scannable by the computer system (e.g., 700) to initiate transfer of the respective saved user input enrollment information from the second external computer system to the computer system. In some embodiments, in response to the one or more user inputs directed to the second external computer system requesting transfer of the respective saved user input enrollment information from the second external computer system to the computer system, the second external computer system initiates transfer of the respective saved user input enrollment information from the second external computer system to the computer system. Allowing a non-registered and/or guest user of the computer system to import, from an external computer system, input enrollment information corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the process to receive the respective saved user input enrollment information from the second external computer system includes display of computer readable information (e.g., 1212) (e.g., a QR code or other computer readable information) by the second external computer system (e.g., 1210) that enables the respective saved user input enrollment information to be retrieved from the second external computer system. Allowing a non-registered and/or guest user of the computer system to import, from an external computer system, input enrollment information corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the process to receive the respective saved user input enrollment information from the second external computer system includes: instructing the user (e.g., via displayed instructions and/or audio instructions) (e.g., output by the computer system and/or by the second external computer system) to bring the second external computer system to a particular location (e.g., 1206b) (e.g., a particular location relative to the computer system) (e.g., within the field of view of one or more cameras of the computer system) (e.g., in some embodiments, 1206a instructs the user to move computer system 1210 and/or code 1212 within frame 1206b) in order to transmit the respective saved user input enrollment information from the second external computer system to the computer system. In some embodiments, the transfer criteria include a second criterion that is satisfied when the second external computer system (e.g., 1210) is moved to a particular location and/or is positioned at a particular location (e.g., a particular location relative to the computer system) (e.g., within the field of view of one or more cameras of the computer system). In some embodiments, the second criterion must be satisfied in order for the transfer criteria to be satisfied (e.g., the second external computer system must be moved to the particular location in order for the transfer criteria to be satisfied and/or in order for the computer system to initiate the process to receive the respective saved user input enrollment information from the second external computer system). In some embodiments, after detecting the second external computer system that is within the threshold distance of the computer system: in accordance with a determination that the transfer criteria are not satisfied, including a determination that the second external computer system is not positioned at the particular location, the computer system forgoes initiating the process to receive the respective saved user input enrollment information from the second external computer system. In some embodiments, the particular location is an environment-locked location (e.g., a location that is locked to a particular position in the physical environment that surrounds the computer system). In some embodiments, the particular location is a viewpoint-locked location (e.g., a particular location relative to the computer system; a particular location within the view field of the computer system; and/or a particular location that moves as the viewpoint of the computer system moves). Prompting the user to bring the second external computer system to a particular location provides the user with instructions on how to import input enrollment information, which enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the process to receive the respective saved user input enrollment information from the second external computer system includes: instructing the user (e.g., via displayed instructions and/or audio instructions) (e.g., output by the computer system and/or by the second external computer system) to look at the second external computer system (e.g., 1206 and/or 1206a) (e.g., in some embodiments, instructing the user to look at the second external computer system while the user is wearing at least a portion of the computer system on the user's head). In some embodiments, the transfer criteria include a third criterion that is satisfied when the user of the computer system is looking at the second external computer system (e.g., when the second external computer system is within the field of view of one or more cameras of the computer system (e.g., indicating that the user of the computer system is looking at the second external computer system)). In some embodiments, the third criterion must be satisfied in order for the transfer criteria to be satisfied and/or in order for the computer system to initiate the process to receive the respective saved user input enrollment information from the second external computer system. In some embodiments, after detecting the second external computer system that is within the threshold distance of the computer system: in accordance with a determination that the transfer criteria are not satisfied, including a determination that the user of the computer system is not looking at the second external computer system (e.g., the second external computer system is not at a particular location with respect to the computer system and/or the second external computer system is not within the field of view of one or more cameras of the computer system), the computer system forgoes initiating the process to receive the respective saved user input enrollment information from the second external computer system. Prompting the user to look at the second external computer system provides the user with instructions on how to import input enrollment information, which enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first saved user input enrollment information includes first saved hand input enrollment information (e.g., FIG. 7K) corresponding to the user of the computer system, wherein the first saved hand input enrollment information is used to interpret hand-based user inputs (e.g., air gesture user inputs) by the user of the computer system. In some embodiments, the first saved hand input enrollment information includes one or more offset values and/or one or more values that are used in measuring, sensing, and/or responding to hand inputs (e.g., gesture inputs and/or air gesture inputs) and/or air gesture inputs from the user (e.g., one or more offset values and/or other values that are determined based on scanning one or more hands of the user while the user is instructed to perform one or more gestures and/or air gestures). Allowing a non-registered and/or guest user of the computer system to import, from an external computer system, input enrollment information corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first saved user input enrollment information includes first saved eye input enrollment information (e.g., FIG. 7L) corresponding to the user of the computer system, wherein the first saved hand input enrollment information is used to interpret eye-based user inputs (e.g., gaze inputs) by the user of the computer system. In some embodiments, the first saved eye input enrollment information includes one or more offset values and/or one or more values that are used in measuring, sensing, and/or responding to gaze inputs from the user (e.g., one or more offset values and/or other values that are determined based on scanning one or more eyes of the user while the user is instructed to look at one or more gaze targets positioned at one or more different display positions). Allowing a non-registered and/or guest user of the computer system to import, from an external computer system, input enrollment information corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first saved user input enrollment information (e.g., imported from computer system 1210 and/or computer system 1250 to computer system 700 in FIGS. 12D-12F and/or FIGS. 12T-12Z) includes one or more accessibility settings (e.g., one or more accessibility settings that provide alternate options for the user to provide user input). In some embodiments, the one or more accessibility settings include, for example, one or more vision accessibility features (e.g., changing screen colors, text size, and/or display zoom; and/or turning audio descriptions, auto-readers, and/or spoken content on or off); one or more hearing accessibility features (e.g., adjusting volume and/or sound EQ settings; turning sound into text; and/or subtitles and captions); one or more mobility accessibility features (e.g., hands-free device control, voice control, dictation, predictive text, and/or customized gestures); and/or one or more speech-related accessibility features (e.g., typing spoken words, making speech requests in text, and/or allowing more time for speech requests). In some embodiments, the one or more accessibility settings include one or more gaze input alternatives (e.g., switching from gaze input to head or arm-based pointing). In some embodiments, the one or more accessibility settings include one or more hand input alternatives (e.g., using gaze dwell navigation in place of hand input and/or hand-based air gestures). Allowing a non-registered and/or guest user of the computer system to import, from an external computer system, accessibility settings corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first saved user input enrollment information (e.g., imported from computer system 1210 and/or computer system 1250 to computer system 700 in FIGS. 12D-12F and/or FIGS. 12T-12Z) includes first saved spatial audio enrollment information corresponding to the user of the computer system, wherein the first saved spatial audio enrollment information is used to output spatial audio. In some embodiments, spatial audio simulates and/or provides the effect of audio originating from a respective location relative to a user (e.g., from in front of the user, from behind the user, from the left of the user, from the right of the user, from below the user, and/or from above the user). In some embodiments, spatialized audio experiences are produced by manipulating sounds in an audio output device's two audio channels (e.g., left and right) so that they resemble directional sounds arriving in the ear-canal. For example, headphones can reproduce a spatial audio signal that simulates a soundscape around the listener (also referred to as the user). An effective spatial sound reproduction can render sounds such that the listener perceives the sound as coming from a location within the soundscape external to the listener's head, just as the listener would experience the sound if encountered in the real world. In some embodiments, spatialized audio is audio that has been filtered such that a listener of the audio perceives the audio as coming from one or more directions and/or locations in a three-dimensional space (e.g., from above, below, and/or in front of the listener). An example of such a filter is a Head-Related Transfer Function (HRTF) filter. In some embodiments, the first saved spatial audio enrollment information is generated based on biometric information collection from the user such as, for example, one or more scans of the user's head, face, and/or ears. In some embodiments, spatial audio is output for the user based on the one or more scans of the user's head, face, and/or ears (e.g., to provide a personalized audio experience based on the shape, placement, and/or size of the user's head, facial features, and/or ears). Allowing a non-registered and/or guest user of the computer system to import, from an external computer system, input enrollment information corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first saved user input enrollment information (e.g., imported from computer system 1210 and/or computer system 1250 to computer system 700 in FIGS. 12D-12F and/or FIGS. 12T-12Z) includes virtual avatar information corresponding to the user of the computer system (e.g., FIGS. 12AL-12AN), wherein the virtual avatar information (e.g., 1291c) is generated based on biometric information (e.g., biometric information collected by one or more external computer systems and/or external sensors separate from the computer system) that was collected from the user (e.g., 711) of the computer system (e.g., based one or more scans of the user's head and/or face). In some embodiments, the virtual avatar information is generated by an external device (e.g., 1274) different from the computer system (e.g., 700). In some embodiments, the virtual avatar information (e.g., 1291c) is generated based on biometric information that was collected from the user (e.g., 711) of the computer system by an external device (e.g., 1274) different from the computer system (e.g., 700). For example, in some embodiments, the virtual avatar information is generated based on biometric information that is collected by a phone, tablet, and/or headset that is different from the computer system when the user previously performed user enrollment on the phone, tablet, and/or headset that is different from the computer system (e.g., prior to using the computer system). In some embodiments, a guest user is able to import virtual avatar information that they had previously generated on a different device. In some embodiments, the virtual avatar information is used to display and/or generate a virtual avatar corresponding to the user of the computer system. In some embodiments, the virtual avatar is used to represent the user during communication sessions with one or more external users separate from the user of the computer system and/or during communication sessions with one or more external computer systems separate from the computer system. In some embodiments, the virtual avatar has an appearance that is generated based on the biometric information collected from the user of the computer system (e.g., has an appearance that simulates and/or approximates the appearance of the user of the computer system). In some embodiments, within a communication session, the virtual avatar moves based on detected movements by the user of the computer system. Allowing a non-registered and/or guest user of the computer system to import, from an external computer system, virtual avatar information corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, after the first prompt (e.g., 1202b, 1206, 1249, 1254a, and/or 1254b), has been output, the computer system receives, from the external computer system (e.g., 1210 and/or 1250) (e.g., in addition to and/or along with the first saved user input enrollment information), additional user-specific information corresponding to the user (e.g., 711) of the computer system (e.g., user preferences, user account information, and/or content (e.g., visual content, media content, and/or files)) that is different from the first saved user input enrollment information (e.g., additional user-specific information that is not used to calibrate and/or interpret user inputs detected by the computer system). In some embodiments, the additional user-specific information corresponding to the user of the computer system is not available to the computer system prior to receiving it from the external computer system. Allowing a non-registered and/or guest user of the computer system to import, from an external computer system, user-specific information, such as user preferences and/or content, corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, after performing the operation based on the input, the computer system (e.g., 700) displays, via the one or more display generation components, a delete option (e.g., 760d) that, when selected, causes the computer system to initiate a process for deleting the first saved user input enrollment information from the computer system (e.g., without deleting the first saved user input enrollment information from the external computer system). In some embodiments, while displaying the delete option, the computer system receives a selection input corresponding to selection of the delete option (e.g., one or more inputs, one or more touch inputs, one or more tap inputs, one or more hardware control inputs, one or more gaze inputs, one or more gesture inputs, and/or one or more air gesture inputs corresponding to selection of the delete option). Subsequent to receiving the selection input corresponding to selection of the delete option, in accordance with a determination that deletion criteria are satisfied, wherein the deletion criteria include a first criterion that is satisfied when the delete option is in an enabled state, the computer system delete the first saved user input enrollment information from the computer system (e.g., without deleting the first saved user input enrollment information from the external computer system). In some embodiments, the first criterion must be satisfied in order for the deletion criteria to be satisfied. In some embodiments, the deletion criteria includes a second criterion that is satisfied when a determination is made that the user of the computer system has stopped using the computer system and/or has removed the computer system from his or her body. In some embodiments, the second criterion must be satisfied in order for the deletion criteria to be satisfied. Providing a guest user with the option to delete imported and/or saved user input enrollment information from the computer system improves privacy and device security by ensuring that the guest user's private information is not stored on the computer system for longer than the guest user intends and/or desires.

In some embodiments, the process for operating the computer system in the guest mode of operation includes: concurrently displaying, via the one or more display generation components: a first selectable option (e.g., 1202b) that, when selected, causes the computer system to initiate a process for importing saved user input enrollment information from a respective external computer system (e.g., a first selectable option that is an option that is selectable by a user to indicate a user request to import saved user input enrollment information from a respective external computer system); and a second selectable option (e.g., 1202c) that, when selected, causes the computer system to initiate a process for operating the computer system using second saved user input enrollment information that is already stored on the computer system (e.g., without receiving saved user input enrollment information from a respective external computer system) (e.g., a second selectable option that is an option that is selectable by a user to indicate a user request to use locally saved user input enrollment information that is already locally stored on the computer system). In some embodiments, while concurrently displaying the first selectable option (e.g., 1202b) and the second selectable option (e.g., 1202c), the computer system detects, via the one or more input devices, a selection input (e.g., 1204a and/or 1204b) (e.g., one or more inputs, one or more touch inputs, one or more tap inputs, one or more hardware control inputs, one or more gaze inputs, one or more gesture inputs, and/or one or more air gesture inputs corresponding to selection of the delete option). In response to detecting the selection input: in accordance with a determination that the selection input corresponds to selection of the first selectable option (e.g., 1202b) (and, optionally, does not correspond to selection of the second selectable option), the computer system initiates the process for importing saved user input enrollment information from a respective external computer system (e.g., FIGS. 12E-12F); and in accordance with a determination that the selection input corresponds to selection of the second selectable option (e.g., 1202c) (and, optionally, does not correspond to selection of the first selectable option), the computer system (e.g., 700) initiates the process for operating the computer system using second saved user input enrollment information that is already stored on the computer system (e.g., in FIGS. 7W-7X, the user selects option 772b, similar to option 1202c, to operate the computer system using saved user input enrollment information). Providing the user with an option to use locally stored user input enrollment information in the guest mode of operation allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the process for operating the computer system in the guest mode of operation includes: concurrently displaying, via the one or more display generation components: a first option (e.g., 1202b) that, when selected, causes the computer system to initiate a process for importing saved user input enrollment information from a respective external computer system (e.g., a first selectable option that is an option that is selectable by a user to indicate a user request to import saved user input enrollment information from a respective external computer system); and a second option (e.g., 1202a) that, when selected, causes the computer system to initiate a process for performing input enrollment of the user of the computer system (e.g., without receiving saved user input enrollment information from a respective external computer system) (e.g., initiating a process for enrolling and/or calibrating gaze-based user inputs; initiating a process for enrolling and/or calibrating hand-based user inputs; and/or initiating a process for enrolling and/or calibrating air gesture user inputs). In some embodiments, performing input enrollment of the user of the computer system results in a generation of new user input enrollment information corresponding to the user of the computer system. In some embodiments, while concurrently displaying the first option (e.g., 1202b) and the second option (e.g., 1202a), the computer system detects, via the one or more input devices, a selection input (e.g., 1204a and/or 1204b) (e.g., one or more inputs, one or more touch inputs, one or more tap inputs, one or more hardware control inputs, one or more gaze inputs, one or more gesture inputs, and/or one or more air gesture inputs corresponding to selection of the delete option). In response to detecting the selection input: in accordance with a determination that the selection input corresponds to selection of the first option (e.g., 1202b) (and, optionally, does not correspond to selection of the second option), the computer system initiates the process for importing saved user input enrollment information from a respective external computer system (e.g., FIGS. 12E-12F); and in accordance with a determination that the selection input corresponds to selection of the second option (e.g., 1202a) (and, optionally, does not correspond to selection of the first option), the computer system initiates the process for performing input enrollment of the user of the computer system (e.g., FIGS. 7I-7L and/or FIGS. 12I-12K). Providing the user with an option to go through a new input enrollment (e.g., to generate new user input enrollment information for the user) allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, while concurrently displaying, via the one or more display generation components, the first option (e.g., 1202b) and the second option (e.g., 1202a), the computer system detects, via the one or more input devices, a selection input (e.g., 1204a and/or 1204b) corresponding to selection of the second option (e.g., 1202a) (e.g., one or more user inputs corresponding to selection of the second option) (e.g., one or more touch inputs, one or more tap inputs, one or more hardware control inputs, one or more gaze inputs, one or more gesture inputs, and/or one or more air gesture inputs corresponding to selection of the second option). In response to receiving the selection input corresponding to selection of the second option, the computer system performs input enrollment of the user of the computer system to generate first new user input enrollment information for the user of the computer system (e.g., first new user input enrollment information that includes first new gaze-based input enrollment information and/or first new hand-based input enrollment information) (e.g., selection of option 1202a results in user input enrollment, as shown in FIGS. 12I-12K and/or as described with reference to FIGS. 7I-7L). After performing input enrollment of the user of the computer system to generate the first new user input enrollment information for the user of the computer system, the computer system detects, via the one or more input devices, third input (e.g., one or more inputs, one or more touch inputs, one or more tap inputs, one or more hardware control inputs, one or more gaze inputs, one or more gesture inputs, and/or one or more air gesture inputs) (e.g., computer system 700 detects user inputs 1224a, 1224b, 1228a, and/or 1228b after performing input enrollment in FIGS. 12I-12K). In response to detecting the third input, the computer system performs a third operation based on the third input (e.g., in response to user inputs 1224a-1224b, computer system 700 displays user interface 1226; and/or in response to user inputs 1228a-1228b, computer system 700 displays instruction 1229 and/or transmits instructions to computer system 1210), wherein the third operation is performed using the third input as interpreted based on the first new user input enrollment information. In some embodiments, the third input includes one or more gaze inputs, and the third operation is performed using the one or more gaze inputs as interpreted based on the first new user input enrollment information. In some embodiments, the third input includes one or more hand inputs (e.g., one or more hand-based air gestures), and the third operation is performed using the one or more hand inputs as interpreted based on the first new user input enrollment information. Providing the user with an option to go through a new input enrollment (e.g., to generate new user input enrollment information for the user) allows for performance of these operations with fewer user inputs. Additionally, using the new user input enrollment information to interpret user inputs by the user of the computer system enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, after performing input enrollment of the user of the computer system to generate the first new user input enrollment information for the user of the computer system (e.g., FIGS. 12I-12K) (and, in some embodiments, prior to detecting the third input), the computer system outputs a save prompt (e.g., 1226, 1229, and/or 1240a) (e.g., displaying a visual save prompt and/or outputting an audio save prompt) prompting the user of the computer system to save the first new user input enrollment information to a respective external computer system (e.g., the external computer system or a different external computer system) separate from the computer system (e.g., a respective external computer system that is associated with the user of the computer system; and/or a respective external computer system that is logged into a user account belonging to and/or associated with the user of the computer system). In some embodiments, the save prompt (e.g., 1226, 1229, and/or 1240a) is output by the computer system in response to a determination that the input enrollment of the user is completed. In some embodiments, the save prompt (e.g., 1226, 1229, and/or 1240a) is output by the computer system in response to one or more user inputs (e.g., one or more touch inputs, one or more tap inputs, one or more hardware control inputs, one or more gaze inputs, one or more gesture inputs, and/or one or more air gesture inputs) provided by the user while using the computer system (e.g., using the first new user input enrollment information). In some embodiments, the save prompt (e.g., 1226, 1229, and/or 1240a) is output by the computer system in response to one or more user inputs corresponding to a user request to end a usage session of the computer system and/or a user request to end the guest mode of operation. Providing the user with an option to save the new user input enrollment information to their personal device allows for performance of these operations with fewer user inputs, and also allows the user to use the new user input enrollment information on different devices with fewer inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the save prompt (e.g., 1226, 1229, and/or 1240a) includes instructions to bring a respective external computer system (e.g., 1210) associated with the user of the computer system within a threshold distance of the computer system (e.g., 700) (e.g., within wireless communication range of the computer system; and/or a threshold distance that is determined based on wireless communication signal strength). Providing the user with an option to save the new user input enrollment information to their personal device allows for performance of these operations with fewer user inputs, and also allows the user to use the new user input enrollment information on different devices with fewer inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the save prompt (e.g., 1226, 1229, and/or 1240a) includes instructions to bring a respective external computer system (e.g., 1210) associated with the user of the computer system to a particular location (e.g., 1240b) with respect to the computer system (e.g., 700) (e.g., within the field of view of one or more cameras of the computer system; and/or within wireless communication range of the computer system). Providing the user with an option to save the new user input enrollment information to their personal device allows for performance of these operations with fewer user inputs, and also allows the user to use the new user input enrollment information on different devices with fewer inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, after performing input enrollment of the user of the computer system (e.g., FIGS. 12I-12K) to generate the first new user input enrollment information for the user of the computer system (e.g., in some embodiments, while outputting the save prompt and/or after outputting the save prompt), the computer system (e.g., 700) causes the external computer system (e.g., 1210) to display a save option (e.g., 1230b) that, when selected, causes the external computer system to initiate a process for saving the first new user input enrollment information to the external computer system. Providing the user with an option to save the new user input enrollment information to their personal device allows for performance of these operations with fewer user inputs, and also allows the user to use the new user input enrollment information on different devices with fewer inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, after causing the external computer system (e.g., 1210) to display the save option (e.g., 1230b): in accordance with a determination that save criteria are satisfied, the computer system (e.g., 700) causes the first new user input enrollment information to be saved to the external computer system (e.g., 1210) (e.g., FIGS. 12N-120). In some embodiments, after causing the respective external computer system to display the save option: in accordance with a determination that the save criteria are not satisfied, the computer system forgoes causing the first new user input enrollment to be saved to the external computer system. Providing the user with an option to save the new user input enrollment information to their personal device allows for performance of these operations with fewer user inputs, and also allows the user to use the new user input enrollment information on different devices with fewer inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the save criteria includes a first criterion that is satisfied when the computer system (e.g., 700) receives information from the external computer system (e.g., 1210) indicating that the external computer system has received valid user authentication information (e.g., FIG. 12M-2) (e.g., when the external computer system indicates that it has been unlocked; has received valid passcode-based authentication information; and/or has received user biometric information that corresponds to saved biometric information of an authorized user). In some embodiments, the first criterion must be satisfied in order for the save criteria to be satisfied. In some embodiments, in order to save the new user input enrollment information to the external computer system, the external computer system must authenticate the user of the computer system (e.g., to ensure that the user of the computer system is authorized to save user input enrollment information to the external computer system). Saving the new user input enrollment information to the external computer system only when save criteria are satisfied improves privacy and device security by ensuring that the new user input enrollment information is not being saved improperly and/or without the user's permission.

In some embodiments, the save criteria includes a second criterion that is satisfied when the computer system (e.g., 700) receives information from the external computer system (e.g., 1210) indicating that the external computer system has received user input confirming the user request to save the first new user input enrollment information to the external computer system (e.g., user input selecting save option 1230b) (e.g., user input 1232 and/or user inputs 1236a-1236c). In some embodiments, the second criterion must be satisfied in order for the save criteria to be satisfied. In some embodiments, in order to save the new user input enrollment information to the external computer system, the external computer system must receive a user input confirming the user request and/or authorizing the user request to save user input enrollment information to the external computer system (e.g., to ensure that the user of the computer system is authorized to save user input enrollment information to the external computer system and/or to ensure that the user input enrollment information is being saved to the right external computer system). Saving the new user input enrollment information to the external computer system only when save criteria are satisfied improves privacy and device security by ensuring that the new user input enrollment information is not being saved improperly and/or without the user's permission.

In some embodiments, receiving the first saved user input enrollment information corresponding to the user of the computer system is performed in accordance with a determination (e.g., based on a determination) that the external computer system (e.g., 1210 and/or 1250) is in an unlocked state (e.g., is not in a locked state) (e.g., FIGS. 12U-12W, transitioning computer system 1250 from a locked state to an unlocked state). In some embodiments, the external computer system transitions from a locked state to an unlocked state based on authentication of a user, such as passcode-based authentication and/or based on biometric authentication. Transferring user input enrollment information from one device to another only when the transferring device is in an unlocked state improves privacy and device security by ensuring that the new user input enrollment information is not being saved improperly and/or without the user's permission.

In some embodiments, prior to the computer system (e.g., 700) receiving the first saved user input enrollment information and performing the operation based on the input and the first saved user input enrollment information, the first saved user input enrollment information was transferred from the external computer system (e.g., 1210 and/or 1250) to a second external computer system different from the computer system and the external computer system, and used by the second external computer system (e.g., to interpret user inputs by the user of the computer system while the second external computer system was operating in a guest mode of operation of the second external computer system; to import and/or apply accessibility settings corresponding to and/or previously specified by the user of the computer system; to import spatial audio enrollment corresponding to the user of the computer system and/or to provide personalized spatial audio based on biometric information collected from the user of the computer system; to import visual avatar information corresponding to the user of the computer system and/or to display a virtual avatar based on biometric information collected from the user of the computer system; to import and/or apply user preferences corresponding to the user of the computer system; to import and/or apply user account information of the user of the computer system; and/or to import and/or access content corresponding to the user of the computer system). For example, in some embodiments, guest user 711 would also be able to import her guest user information from computer system 1210 and/or computer system 1250 to computer system 1294 in FIG. 12AN to use computer system 1294 as a guest user. In some embodiments, the first saved user input enrollment information can be transferred to multiple different devices and used by the different devices to interpret user inputs by the user of the computer system. Allowing a non-registered and/or guest user of a computer system to import, from an external computer system, input enrollment information corresponding to the non-registered user and/or the guest user, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the user (e.g., 711) of the computer system (e.g., 700) is not a registered user of the computer system (e.g., the user of the computer system is a guest user of the computer system and/or is an unregistered user of the computer system). In some embodiments, the user (e.g., 711) of the computer system (e.g., 700) is a registered user of the external computer system (e.g., 1210 and/or 1250) (e.g., the user of the computer system is associated with an account that is logged into and/or registered on the external computer system). In some embodiments, the user (e.g., 711) of the computer system (e.g., 700) is a registered user of a third external computer system (e.g., 1274) separate from the computer system and the external computer system (e.g., the user of the computer system is associated with an account that is logged into and/or registered on the third external computer system). In some embodiments, the first saved user input enrollment information is synchronized on the external computer system (e.g., 1210 and/or 1250) from the third external computer system (e.g., 1274) (e.g., the first saved user input enrollment information was generated by the third external computer system and transmitted to, saved to, and/or synchronized to the external computer system based on the third external computer system generating the first saved user input enrollment information and, optionally, based on the user of the computer system being a registered user of both the external computer system and the third external computer system). In some embodiments, the first saved user input enrollment information can be transferred to multiple different devices and used by the different devices to interpret user inputs by the user of the computer system. In some embodiments, the computer system (e.g., 700) and the third external computer system (e.g., 1274) are both of the same type (e.g., are both wearable devices and/or are both HMDs). In some embodiments, the external computer system (e.g., 1210 and/or 1250) is of a different type than the computer system (e.g., 700) and the third external computer system (e.g., 1274) (e.g., is not a wearable device and/or is not an HMD). For example, in some embodiments, the computer system (e.g., 700) and the third external computer system (e.g., 1274) are wearable devices and/or head-mounted devices (e.g., HMDs) and the external computer system (e.g., 1210 and/or 1250) is a portable device, such as a phone or a tablet. In some embodiments, the first saved user input enrollment information is generated based on user input enrollment performed on the third external computer system (e.g., 1274) (e.g., an HMD and/or the user's own HMD), and the first saved user input enrollment information is saved to and/or synchronized from the third external computer system (e.g., 1274) (e.g., an HMD) to the external computer system (e.g., 1210 and/or 1250) (e.g., a phone or a tablet (e.g., the user's own phone or tablet)). In some embodiments, the user is able to use the external computer system (e.g., 1210 and/or 1250) (e.g., their phone or tablet) to import the first saved user input enrollment information to the computer system (e.g., 700) (e.g., a different HMD and/or another user's HMD) to apply user settings and/or enrollment information to the computer system. In some embodiments, the computer system (e.g., 700) and the third external computer system (e.g., 1274) are, optionally, of the same type (e.g., the same type of HMD) and/or have the same or similar version of software (e.g., operating system software or other software). Synchronizing enrollment information from the third external computer system to the computer system, and allowing a guest user and/or non-registered user to import that enrollment information to the computer system, allows for performance of these operations with fewer user inputs. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, synchronization of the first saved user input enrollment information between the external computer system (e.g., 1210 and/or 1250) and the third external computer system (e.g., 1274) is controllable via one or more user interfaces (e.g., 1276) of the third external computer system. In some embodiments, the user (e.g., 711) of the computer system can remove the first saved user input enrollment information from the external computer system (e.g., 1210 and/or 1250) using one or more user interfaces (e.g., 1276) of the third external computer system (e.g., 1274). In some embodiments, the third external computer system (e.g., 1274) detects one or more user inputs (e.g., 1278a and/or 1278b) corresponding to a request to remove the first saved user input enrollment information from the external computer system (e.g., 1210 and/or 1250); and in response to detecting the one or more user inputs corresponding to a request to remove the first saved user input enrollment information from the external computer system, the third external computer system (e.g., 1274) causes the external computer system (e.g., 1210 and/or 1250) to delete and/or cease storage of the first saved user input enrollment information. In some embodiments, the user of the computer system can initiate synchronization of and/or saving of the first saved user input enrollment information on the external computer system using one or more user interfaces of the third external computer system. In some embodiments, the third external computer system detects one or more user inputs corresponding to a request to synchronize the first saved user input enrollment information to the external computer system; and in response to detecting the one or more user inputs corresponding to a request to synchronize the first saved user input enrollment information to the external computer system, the third external computer system causes the external computer system to save and/or update the first saved user input enrollment information on the external computer system. Allowing the user of the computer system to manage and/or control the first saved user input enrollment information from the third external computer system improves privacy and device security by ensuring that the user input enrollment information is not being saved improperly and/or without the user's permission.

In some embodiments, after receiving the first saved user input enrollment information corresponding to the user of the computer system from the external computer system (e.g., 1210 and/or 1250), and while using the first saved user input enrollment information to interpret detected inputs from the user of the computer system, the computer system (e.g., 700) detects, via the one or more input devices, a user request (e.g., one or more user inputs) (e.g., one or more touch inputs, one or more gaze inputs, one or more gesture inputs, and/or one or more spoken inputs) (e.g., 1269a, 1269b, 1271a, and/or 1271b) to access a different external computer system (e.g., 708c-1 and/or 708c-2) that is separate from the computer system and the external computer system, wherein the user of the computer system is associated with a first user account, and the external computer system (e.g., 1210 and/or 1250) and the different external computer system (e.g., 708c-1 and/or 708c-2) are associated with the first user account (e.g., are logged into the first user account) (and, optionally, the computer system (e.g., 700) is not associated with the user account and/or is not logged into the user account). In response to detecting the user request to access the different external computer system, the computer system (e.g., 700) displays, via the one or more display generation components (e.g., 702), content from the different external computer system (e.g., one or more user interfaces of the different external computer system; one or more user interfaces generated by the different external computer system; and/or one or more user interfaces generated based on data received from the different external computer system) (e.g., in FIG. 12AG, displaying 1272a, 127b, 1272c from different external computer system 718c-1). In some embodiments, the content from the different external computer system (e.g., 718c-1) is displayed in accordance with a determination that the external computer system (e.g., 1210 and/or 1250) and the different external computer system (e.g., 718c-1) are associated with the same user account. In some embodiments, the content from the different external computer system is displayed in accordance with a determination that the first saved user input enrollment information and the different external computer system are associated with the same user account. In some embodiments, the content from the different external computer system is displayed in accordance with a determination that the computer system is using the first saved user input enrollment information to interpret detected inputs from the user of the computer system (and, optionally, that the first saved user input enrollment information and the different external computer system are associated with the same user account). For example, in some embodiments, the different external computer system (e.g., 718c-1 and/or 718c-2) is a laptop or desktop (or other computing device) of the user (e.g., 711) of the computer system, and the user of the computer system is able to access content and/or data from their own laptop and/or desktop while using the computer system. In some embodiments, the user of the computer system is able to display their own laptop or desktop as a virtual display in the computer system (e.g., a headset and/or HMD). In some embodiments, the user of the computer system is a guest user of the computer system, and is able to access their own laptop or desktop while using the computer system (e.g., is able to display their own laptop or desktop as a virtual display in the computer system). In some embodiments, while the computer system is using the first saved user input enrollment information to interpret detected inputs from the user of the computer system, the computer system is able to access, interact with, and/or display content from other computer systems that are associated with the same user account as the first saved user input enrollment information (e.g., the guest user of the computer system). Allowing a guest user to access and/or display content from a remote computer system that is associated with the guest user enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, after receiving the first saved user input enrollment information corresponding to the user (e.g., 711) of the computer system from the external computer system (e.g., 1210 and/or 1250), and while using the first saved user input enrollment information to interpret detected inputs from the user of the computer system, the computer system (e.g., 700) detects, via the one or more input devices, one or more user inputs (e.g., 1214a, 1214b, 1266a, 1266b, and/or 711a in FIGS. 12AB-12AD) corresponding to a user request to display a control user interface (e.g., 756 and/or 1268) (e.g., a system user interface, a user interface generated by and/or display by an operating system of the computer system, and/or a control center user interface that includes one or more of: a volume control option (e.g., option that a user can interact with to adjust audio output volume of the computer system), a brightness control option (e.g., an option that a user can interact with to adjust the brightness of the one or more display generation components), a wifi option (e.g., an option that is selectable to selectively enable and/or disable wifi), a Bluetooth option (e.g., an option that is selectable to selectively enable and/or disable Bluetooth), and/or an airplane mode option (e.g., an option that is selectable to selectively enable and/or disable an airplane mode (e.g., a mode in which cellular data and/or one or more other types of wireless data are disabled))). In response to detecting the one or more user inputs corresponding to the user request to display the control user interface, the computer system (e.g., 700) displays, via the one or more display generation components (e.g., 702), the control user interface (e.g., 756 and/or 1268), wherein the control user interface includes one or more (or, optionally, a plurality of) selectable options (e.g., 1269b, 760a, 760b, 760c, 760d, and/or 760e) pertaining to the guest mode of operation of the computer system. In some embodiments, the one or more selectable options (e.g., 1269b, 760a, 760b, 760c, 760d, and/or 760e) pertaining to the guest mode of operation are not displayed (e.g., are not all displayed and/or at least some are not displayed) in a first portion (e.g., an initially displayed portion) of the control user interface (e.g., 756 and/or 1268), but are accessible via a sequence of one or more inputs that starts from the first portion of the control user interface. For example, in some embodiments, the control user interface includes a first portion that includes one or more selectable options, and selection of a first option (e.g., 1268h and/or 756f) in the first portion of the control user interface causes the computer system to display a second portion of the control user interface. In some embodiments, the second portion of the control user interface includes at least some of the one or more of the selectable options pertaining to the guest mode of operation. In some embodiments, selection of a second option in the second portion of the control user interface causes the computer system to display a third portion of the control user interface that is different from the second portion of the control user interface and was optionally not displayed prior to detecting selection of the second option in the second portion of the control user interface. In some embodiments, the third portion of the control user interface includes at least some of the one or more selectable options pertaining to the guest mode of operation. In some embodiments, the plurality of selectable options pertaining to the guest mode of operation includes a first selectable option (e.g., 760b and/or 760c) that, when selected, causes the computer system to initiate a process for re-performing user input enrollment for the user of the computer system (e.g., re-performing eye-based input enrollment and/or re-performing hand-based input enrollment). In some embodiments, re-performing user input enrollment for the user of the computer system results in generation of new user input enrollment information that is used to interpret user inputs from the user of the computer system. In some embodiments, the plurality of selectable options pertaining to the guest mode of operation includes a save new enrollment information option that, when selected, causes the computer system to transmit the new user input enrollment information to the external computer system for storage on the external computer system. In some embodiments the plurality of selectable options pertaining to the guest mode of operation includes a save enrollment information option (e.g., 760d, but in a disabled state) that, when selected, causes the computer system to save the first saved user input enrollment information to the computer system (e.g., store the first saved user input enrollment information for a duration of time, even after the user of the computer system has stopped using the computer system). In some embodiments, the plurality of selectable options pertaining to the guest mode of operation includes a delete enrollment information option (e.g., 760d) that, when selected, causes the computer system to delete the first saved user input enrollment information (e.g., delete the first saved user input enrollment information from the computer system after the user of the computer system has stopped using the computer system). In some embodiments, the plurality of selectable options pertaining to the guest mode of operation includes one or more accessibility options (e.g., 760a) that enable a user of the computer system to turn on or turn off one or more accessibility features of the computer system while the computer system is operating in the guest mode of operation. In some embodiments, accessibility features include, for example, vision accessibility features (e.g., changing screen colors, text size, and/or display zoom; and/or turning audio descriptions, auto-readers, and/or spoken content on or off); hearing accessibility features (e.g., adjusting volume and/or sound EQ settings; turning sound into text; and/or subtitles and captions); mobility accessibility features (e.g., hands-free device control, voice control, dictation, predictive text, and/or customized gestures); and/or speech-related accessibility features (e.g., typing spoken words, making speech requests in text, and/or allowing more time for speech requests). In some embodiments, accessibility features include gaze input alternatives (e.g., switching from gaze input to head or arm-based pointing). In some embodiments, accessibility features include hand input alternatives (e.g., using gaze dwell navigation in place of hand input and/or hand-based air gestures). In some embodiments, the plurality of selectable options pertaining to the guest mode of operation includes one or more guest user privacy options and/or one or more options to view guest user privacy information. Providing selectable options pertaining to the guest mode of operation enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, aspects/operations of methods 800, 1000, 1100, 1300, 1500, and/or 1700 may be interchanged, substituted, and/or added between these methods. For example, in some embodiments, the computer systems recited in methods 800, 1200, and/or 1700 are the same computer system, the first computer system recited in method 1000, the wearable device recited in method 1500, and/or the external computer system recited in method 1100. In another example, in some embodiments, the computer system recited in method 1100 is the second computer system recited in method 1000. For brevity, these details are not repeated here.

FIGS. 14A-14R illustrate exemplary techniques for managing a wearable device using a computer system, in accordance with some embodiments. FIG. 15 is a flow diagram of an exemplary method 1500 for managing a wearable device using a computer system, in accordance with some embodiments. The user interfaces in FIGS. 14A-14R are used to illustrate the processes described below, including the processes in FIG. 15.

FIG. 14A depicts computer system 910, which is a smart phone with touch-sensitive display 912. Various embodiments of computer system 910 were described above, for example, with reference to FIGS. 9E-9AA. At FIG. 14A, computer system 910 displays home screen user interface 936, which includes various application icons that are selectable to cause computer system 910 to open different respective applications. In FIG. 14A, home screen user interface 936 includes application icon 1400, which corresponds to a device management application. In some embodiments, the device management application provides various options for managing a wearable device that is separate from computer system 910. In some embodiments, the device management application is automatically installed on computer system 910 and/or corresponding application icon 1400 is automatically displayed within home screen user interface 936 based on computer system 910 being associated with a separate wearable device (e.g., a separate wearable device of a first type and/or of a particular type, such as a head-mounted device). For example, in some embodiments, computer system 910 is associated with a head-mounted device, such as computer system 700 described above. For example, in some embodiments, computer system 910 and computer system 700 belong to the same user, are associated with the same user account, and/or are logged into the same user account. At FIG. 14A, computer system 910 detects user input 1402 (e.g., a tap input selecting application icon 1400).

At FIG. 14B, in response to detecting user input 1402, computer system 910 displays user interface 1404. User interface 1404 is a user interface of the device management application represented by application icon 1400. User interface 1404 includes various sections 1404a-1404i, which will be described in greater detail below. At FIG. 14B, sections 1404a-1404d are displayed via touch-sensitive display 912. Section 1404a displays device information corresponding to a wearable device, e.g., computer system 700. For example, in FIG. 14B, section 1404a displays an image and/or visual representation of computer system 700, and indicates that computer system 700 is 87% charged, and is currently being charged (e.g., as indicated by the lightning bolt icon next to “87%”). Section 1404b displays representations of various contacts (e.g., users and/or people) of the user of computer system 910 and/or computer system 700 that also are associated with (e.g., are registered to and/or own) a head-mounted device (e.g., a head-mounted device of the same type as computer system 700 and/or a head-mounted device of the same make as computer system 700). For example, in some embodiments, section 1404b displays representations of one or more contacts that are stored in a contact list associated with computer system 910 and/or associated with a user of computer system 910 that are also registered as owners and/or users of a head-mounted device. In some embodiments, section 1404b excludes one or more contacts (e.g., one or more contacts that are stored in a contact list associated with computer system 910 and/or a user of computer system 910) that are not associated with (e.g., are not registered to and/or do not own) a head-mounted device (or other wearable device). Section 1404c depicts and/or is representative of immersive audio-visual content entitled “Prehistoric Planet” that is available to be downloaded to computer system 700. In some embodiments, the immersive audio-visual content is an immersive three-dimensional experience that can be played and/or experienced using computer system 700, but cannot be played and/or experienced using computer system 910. Section 1404c includes option 1404c-1 that, when selected, causes computer system 910 to initiate a download of the immersive audio-visual content to computer system 700 and/or to add the immersive audio-visual content to the user's watch list (e.g., in some embodiments, without downloading the immersive audio-visual content to computer system 910). FIG. 14B depicts various example scenarios in which computer system 910 detects various user inputs, including: user input 1406a (e.g., a swipe up input), user input 1408 (e.g., a tap input corresponding to selection of option 1404c-1), user input 1410 (e.g., a tap input corresponding to selection of section 1404b), and user input 1412 (e.g., a tap input corresponding to selection of section 1404a). Each of these user inputs and their respective results will be described in greater detail below.

At FIG. 14C, in response to detecting user input 1406a in FIG. 14B, computer system 910 displays upward scrolling of user interface 1404, such that sections 1404d-1404f of user interface 1404 are now displayed (and sections 1404a-1404c are no longer displayed). Section 1404d includes representations 1404d-1, 1404d-2, 1404d-3 of various three-dimensional content items that are available to be downloaded to and/or played on computer system 700. In some embodiments, at least some of the three-dimensional content items represented in section 1404d are able to be played and/or experienced using computer system 700, but cannot be played and/or experienced using computer system 910. In some embodiments, section 1404d is horizontally scrollable to reveal representations of additional three-dimensional content items that are available to be downloaded to and/or played on computer system 700. In some embodiments, representation 1404d-1, when selected, causes computer system 910 to initiate download of a first three-dimensional content item to computer system 700 (e.g., in some embodiments, without downloading the first three-dimensional content item to computer system 910); representation 1404d-2, when selected, causes computer system 910 to initiate download of a second three-dimensional content item to computer system 700 (e.g., in some embodiments, without downloading the second three-dimensional content item to computer system 910); and representation 1404d-3, when selected, causes computer system 910 to initiate download of a third three-dimensional content item to computer system 700 (e.g., in some embodiments, without downloading the third three-dimensional content item to computer system 910).

Section 1404e includes representations 1404e-1, 1404e-2, 1404e-3 of various immersive content items that are available to be downloaded to and/or played on computer system 700. In some embodiments, immersive content items represented in section 1404e (and/or in section 1404c) are three-dimensional experiences that include one or more interactive elements that the user is able to view and interact with using a head-mounted device such as computer system 700. In some embodiments, immersive content and/or immersive experiences include interactive elements that appear to surround the user such that the user is given the impression of being in an interactive three-dimensional environment that is physical surrounding them. In some embodiments, three-dimensional content items represented in section 1404d include three-dimensional elements such as three-dimensional videos, movies, and/or shows that can be played using a head-mounted device such as computer system 700, but that do not occupy as much of an environment surrounding a viewpoint of a user as the immersive content occupies, and/or include different types of interaction than immersive content. In some embodiments, at least some of the immersive content items represented in section 1404e are able to be played and/or experienced using computer system 700, but cannot be played and/or experienced using computer system 910. In some embodiments, section 1404e is horizontally scrollable to reveal representations of additional immersive content items that are available to be downloaded to and/or played on computer system 700. In some embodiments, representation 1404e-1, when selected, causes computer system 910 to initiate download of a first immersive content item to computer system 700 (e.g., in some embodiments, without downloading the first immersive content item to computer system 910); representation 1404e-2, when selected, causes computer system 910 to initiate download of a second immersive content item to computer system 700 (e.g., in some embodiments, without downloading the second immersive content item to computer system 910); and representation 1404d-3, when selected, causes computer system 910 to initiate download of a third immersive content item to computer system 700 (e.g., in some embodiments, without downloading the third immersive content item to computer system 910).

Section 1404f includes a representation 1404f-1 of a game that is available to be downloaded to and/or played on computer system 700. In some embodiments, the game represented in section 1404f is playable on computer system 700, but is not playable on computer system 910. Representation 1404f-1 includes option 1404f-2 which, when selected, causes computer system 910 to initiate download of the game to computer system 700 (e.g., in some embodiments, without downloading the game to computer system 910). FIG. 14C depicts various example scenarios in which computer system 910 detects various user inputs, including: user input 1406b (e.g., a swipe up input), user input 1414 (e.g., a tap input corresponding to selection of section 1404d), user input 1416 (e.g., a tap input corresponding to selection of representation 1404d-1), user input 1418 (e.g., a tap input corresponding to selection of section 1404e), user input 1420 (e.g., a tap input corresponding to selection of representation 1404e-2), user input 1422 (e.g., a tap input corresponding to selection of section 1404f), and user input 1424 (e.g., a tap input corresponding to selection of option 1404f-2). Each of these user inputs and their respective results will be described in greater detail below.

In some embodiments, in response to detecting user input 1414, computer system 910 displays representations of additional three-dimensional content items that are available to be downloaded to and/or played on computer system 700. In some embodiments, in response to detecting user input 1418, computer system 910 displays representations of additional immersive content items that are available to be downloaded to and/or played on computer system 700. In some embodiments, in response to detecting user input 1422, computer system 910 displays representations of additional games that are available to be downloaded to and/or played on computer system 700.

At FIG. 14D, in response to detecting user input 1406b in FIG. 14C, computer system 910 displays further scrolling of user interface 1404 such that additional sections 1404g-1404h are now displayed (and sections 1404-1404e are no longer displayed). Section 1404g displays a representation of first visual content 1404g-1 (e.g., a digital magazine issue) that is available to be downloaded to and/or displayed on computer system 700. FIG. 14D depicts various example scenarios in which computer system 910 detects various user inputs, including: user input 1406c (e.g., a swipe up input), user input 1426 (e.g., a tap input corresponding to selection of section 1404g), and user input 1428 (e.g., a tap input corresponding to selection of representation 1404g-1. In some embodiments, in response to detecting user input 1426, computer system 910 displays additional visual content that is available to be downloaded to and/or displayed on computer system 700. In some embodiments, in response to detecting user input 1428, computer system 910 causes visual content represented by representation 1404g-1 (e.g., a digital issue of STUN MAGAZINE) to be downloaded to computer system 700.

At FIG. 14E, in response to detecting user input 1406c in FIG. 14D, computer system 910 displays upward scrolling of user interface 1404 such that sections 1404h and 1404i are displayed (and section 1404g is no longer displayed). Section 1404h includes tile 1404h-1, which is selectable (e.g., user input 1430) to cause computer system 910 to play a video that teaches the user about how to adjust the fit of computer system 700 on his or her head. Section 1404i includes tiles 1404-i-1, 1404i-2, 1404i-3. In some embodiments, tile 1404i-1 is selectable (e.g., user input 1432) to cause computer system 910 to display visual instructions and/or play a video (e.g., via touch-sensitive display 912 and/or on computer system 910) providing the user with one or more tips and/or instructions for getting started using computer system 700. In some embodiments, tile 1404i-2 is selectable (e.g., user input 1434) to cause computer system 910 to display visual instructions and/or play a video (e.g., via touch-sensitive display 912 and/or on computer system 910) providing the user with one or more tips and/or instructions for how to adjust the fit of computer system 700 and/or how to care for and/or maintain computer system 700. In some embodiments, tile 1404i-3 is selectable (e.g., user input 1436) to cause computer system 910 to display visual instructions and/or play a video (e.g., via touch-sensitive display 912 and/or on computer system 910) providing the user with one or more tips and/or instructions for using computer system 700.

At FIG. 14F, in response to detecting user input 1408 in FIG. 14B, computer system 910 causes immersive content entitled “PREHISTORIC PLANET” to be downloaded to computer system 700 (e.g., in some embodiments, without downloading the immersive content to computer system 910) and displays status indication 1404c-2, which indicates that the immersive content is being downloaded to computer system 700. At FIG. 14G, computer system 700 receives an indication that the immersive content has finished downloading to computer system 700, and updates status indication 1404c-2 to indicate that download of the immersive content to computer system 700 is completed.

At FIG. 14H, in response to detecting user input 1416 in FIG. 14C, computer system 910 causes the selected content item represented by representation 1404d-1 to be downloaded to computer system 700, and displays representation 1404d-1 with indication 1404d-1a indicating that this content item is being downloaded to computer system 700 (and that the download is 7% completed). In response to detecting user input 1420 in FIG. 14C, computer system 910 causes the selected content item represented by representation 1404e-2 to be downloaded to computer system 700, and displays representation 1404e-2 with indication 1404e-2a indicating that this content item is being downloaded to computer system 700 (and that the download is 9% completed). In response to detecting user input 1424 in FIG. 14C, computer system 910 causes the selected game represented by representation 1404f-1 to be downloaded to computer system 700, and replaces option 1404f-2 with indication 1404f-3 indicating that the game is being downloaded to computer system 700 (and that the download is 5% completed). At FIG. 14I, computer system 910 receives information (e.g., from computer system 700 and/or from a remote server and/or computer system separate from computer system 700 and computer system 910) indicating that the downloads of the selected content items to computer system 700 have been completed, and updates indications 1404d-1a, 1404e-2a, and 1404f-3 to indicate that these content items have been downloaded to computer system 700.

At FIG. 14J, in response to detecting user input 1410 in FIG. 14B, computer system 910 displays contacts user interface 1438. In some embodiments, contacts user interface 1438 is also a user interface of the device management application. Contacts user interface 1438 displays representations of one or more contacts or contactable people or entities (e.g., one or more contacts saved and/or stored in a contacts list associated with computer system 910 and/or a user of computer system 910) that are determined to be associated with a head-mounted device and/or wearable device. For example, in FIG. 14J, representation 1440b represents a contact named Mary Beaton, and indicates that this contact is online (e.g., using her head-mounted device and/or wearable device), and is watching content entitled “EXCEPTION” (e.g., on her head-mounted device and/or wearable device). Representation 1440c represents a contact named Amy Levinson, and indicates that this contact is online (e.g., using her head-mounted device and/or wearable device) and that the contact's head-mounted device and/or wearable device is displaying a home screen user interface. Representation 1440d represents a contact named Ryan Garcia, and indicates that this contact is offline (e.g., is not using his head-mounted device and/or wearable device). Representation 1440e represents a contact named Ellen Hancock, and indicates that this contact is also offline. In some embodiments, contacts user interface 1438 excludes one or more contacts (e.g., does not display representations of one or more contacts) that are determined not to be associated with and/or registered to a head-mounted device and/or wearable device of a particular type. In FIG. 14J, contacts user interface 1438 includes search bar 1440a that can be used to search for contacts. In some embodiments, representations of contacts (e.g., 1440b-1440e) are selectable to cause computer system 910 to initiate a process for contacting the selected contact (e.g., via text message, voice call, and/or video call).

At FIG. 14K, in response to detecting user input 1412 in FIG. 14B, computer system 910 displays device user interface 1442. In some embodiments, device user interface 1442 is also a user interface of the device management application. Device user interface 1442 displays information about computer system 700. For example, in FIG. 14K, device user interface 1442 displays device name information 1442a (e.g., a device name of computer system 700), device storage information 1442b (e.g., total storage and/or available storage on computer system 700), device charge level information 1442c (e.g., indicating how charged the battery of computer system 700 is), and device charge indication 1442d (e.g., indicating that computer system 700 is being charged). Device user interface 1442 also includes head band information 1442e, which identifies a head band type and/or size of a head band (e.g., head band 1-116 in FIGS. 1B-1C and/or head band 1-216 in FIG. 1D) installed on computer system 700 and/or that has been purchased by the user for use with computer system 700; head band information 1442f, which identifies a head band type and/or size of a head band (e.g., head band 1-117 in FIGS. 1B-1C) that is installed on computer system 700 and/or that has been purchased by the user for use with computer system 700; and light seal information 1442g, which indicates a light seal type and/or size of a light seal (e.g., for light seal 1-110 and/or light seal 1-210 described above with reference to FIGS. 1B-1D) installed on computer system 700 and/or that has been purchased by the user for use with computer system 700. At FIG. 14K, computer system 910 detects user input 1444 (e.g., a swipe up input).

At FIG. 14L, in response to detecting user input 1444 in FIG. 14K, computer system 910 displays upward scrolling of device user interface 1442 to reveal additional content, including sections 1442h, 1442i, 1442j, and 1442k. Section 1442h indicates that one or more optical inserts (e.g., prescription optical lenses) are installed on computer system 700 and/or have been purchased by the user for use with computer system 700. In some embodiments, section 1442h includes computer-readable code 1442h-1 (e.g., a QR code, a bar code, or other computer-readable code) that identifies one or more characteristics of the user's optical inserts (e.g., vision prescription information, lens thickness, and/or lens size). In some embodiments, computer system 700 can scan computer-readable code 1442h-1 to adjust one or more visual output settings and/or display settings of computer-readable code 1442h-1 to accommodate the optical inserts of the user (e.g., lenses 1-218 in FIG. 1D). Section 1442i identifies a model name and/or model type of computer system 700. Section 1442j identifies a version number and/or version of computer system 700 (e.g., an operating system version, a software version, and/or a hardware version). Section 1442k identifies a serial number (e.g., a unique serial number) that is associated with and/or identifies computer system 700. At FIG. 14L, computer system 910 detects user input 1446 (e.g., a swipe up input).

At FIG. 14M, in response to detecting user input 1446 in FIG. 14L, computer system 910 displays upward scrolling of device user interface 1442 to reveal additional content, including sections 1442l, 1442m, 1442n, 1442o, 1442p. Section 14421 is selectable (e.g., user input 1448a) to cause computer system 910 to play a video that teaches the user about how to adjust the fit of computer system 700 on his or her head. In some embodiments, section 1442m is selectable (e.g., user input 1448b) to cause computer system 910 to display visual instructions, output audio instructions, and/or play a video (e.g., via touch-sensitive display 912 and/or on computer system 910) providing the user with one or more tips and/or instructions for getting started using computer system 700. In some embodiments, section 1442n is selectable (e.g., user input 1448c) to cause computer system 910 to display visual instructions, output audio instructions, and/or play a video (e.g., via touch-sensitive display 912 and/or on computer system 910) providing the user with one or more tips and/or instructions for how to adjust the fit of computer system 700 and/or how to care for and/or maintain computer system 700. In some embodiments, section 1442o is selectable (e.g., user input 1448d) to cause computer system 910 to display visual instructions, output audio instructions, and/or play a video (e.g., via touch-sensitive display 912 and/or on computer system 910) providing the user with one or more tips and/or instructions for using computer system 700. In some embodiments, section 1442p is selectable (e.g., user input 1448e) to cause computer system 910 to display a user guide for computer system 700. At FIG. 14M, computer system 910 detects user input 1450 (e.g., a swipe up input).

At FIG. 14N, in response to detecting user input 1450 in FIG. 14M, computer system, 910 displays upward scrolling of device user interface 1442 to reveal additional content, including sections 1442q, 1442r, 1442s, 1442t, 1442u, and 1442v. Section 1442q corresponds to a guest mode of operation of computer system 700 (e.g., various embodiments and/or features of which have been described above, for example, with reference to FIGS. 7A-7AB, FIG. 8, FIGS. 9A-9AA, FIG. 10, FIG. 11, FIGS. 12A-12AN, and/or FIG. 13). In some embodiments, section 1442q is selectable to display various options pertaining to the guest mode of operation of computer system 700, as will be described in greater detail below with reference to FIG. 14Q. Section 1442r corresponds to input enrollment information that is used by computer system 700 to detect, sense, and/or interpret user inputs (e.g., gaze input enrollment information and/or hand input enrollment information), as was described above, for example, with reference to FIGS. 7A-7AB, FIG. 8, FIGS. 9A-9AA, FIG. 10, FIG. 11, FIGS. 12A-12AN, and/or FIG. 13. In some embodiments, section 1442r is selectable to cause computer system 910 to display various options pertaining to input enrollment information for computer system 700, as will be described in greater detail below with reference to FIG. 14R. Section 1442v corresponds to one or more accessibility settings of computer system 700. In some embodiments, section 1442v is selectable to cause computer system 910 to displays various accessibility setting options pertaining to the accessibility settings of computer system 700, as will be described in greater detail below with reference to FIG. 14P.

Section 1442s is selectable to switch a device unlock setting to an enabled state and/or to a disabled state. In FIG. 14N, section 1442s indicates that the device unlock setting is in a disabled state (e.g., is off). In some embodiments, when the device unlock setting is in an enabled state (e.g., is on), computer system 910 can be unlocked by computer system 700 while computer system 700 is being used by a user. In other words, in some embodiments, when the device unlock setting is in the enabled state, computer system 700 is permitted and/or authorized to cause computer system 910 transition from a locked state to an unlocked state (e.g., by transmitting a request to unlock computer system 910). This feature can be useful, for example, if computer system 910 uses facial recognition as biometric authentication for unlocking computer system 910, but wearing computer system 700 makes facial recognition difficult and/or impossible. In some embodiments, when the device unlock setting is enabled, and computer system 910 detects a request to transition from a locked state to an unlocked state, and computer system 910 also detects that computer system 700 is being used, computer system 910 requests that computer system 700 perform biometric authentication of the user using computer system 700 (e.g., gaze-based biometric authentication and/or face-based biometric authentication). In some embodiments, if the user of computer system 700 is authenticated by computer system 700, computer system 700 transmits information to computer system 910 that causes computer system 910 to transition to the unlocked state. However, if the user of computer system 700 is not authenticated, computer system 700 does not cause computer system 910 to transition to the unlocked state (e.g., computer system 910 is maintained in a locked state). However, in some embodiments, when the device unlock setting is in the disabled state, computer system 700 is not permitted and/or authorized to unlock computer system 910 (e.g., computer system 700 cannot be used to unlock computer system 910). In some such embodiments, the user can provide passcode-based authentication information via touch-sensitive display 912 to unlock computer system 910.

Section 1442t corresponds to a spatial audio feature of computer system 700. In some embodiments, section 1442t is selectable (e.g., user input 1452d) to cause computer system 910 to initiate a process for generating a personalized spatial audio profile for a user of computer system 910. In some embodiments, computer system 910 generates a personalized spatial audio profile for a user of computer system 910 by capturing one or more images and/or scans of the user's head, face, and/or ears. In some embodiments, the personalized spatial audio profile for the user of computer system 910 is generated based on the one or more images and/or scans of the user's head, face, and/or ears so that sound is optimized for the physical attributes of the user. In some embodiments, the personalized spatial audio profile for the user of computer system 910 is transmitted to and/or provided to computer system 700 so that computer system 700 can output spatial audio using the personalized spatial audio profile for the user and/or according to the personalized spatial audio profile for the user.

Section 1442u corresponds to an audio receiver setting of computer system 910. In some embodiments, when the audio receiver setting of computer system 910 is enabled, computer system 700 is able and/or authorized to use computer system 910 as an audio output device and/or visual output device (e.g., computer system 700 is able to cause computer system 910 to output audio content and/or display visual content). In some embodiments, when the audio receiver setting of computer system 910 is disabled, computer system 700 is not able and/or is not authorized to use computer system, 910 as an audio output device and/or visual output device.

FIG. 14N depicts various example scenarios in which computer system 910 detects various user inputs, including: user input 1452a (e.g., a tap input corresponding to selection of section 1442q); user input 1452b (e.g., a tap input corresponding to selection of section 1442r); user input 1452c (e.g., a tap input corresponding to selection of section 1442s); user input 1452d (e.g., a tap input corresponding to selection of section 1442t); user input 1452e (e.g., a tap input corresponding to selection of section 1442u); and user input 1452f (e.g., a tap input corresponding to selection of section 1442v. Each of these user inputs will be described in greater detail below.

At FIG. 14O, in response to detecting user input 1452c in FIG. 14N, computer system 910 transitions the device unlock setting to the enabled state. At FIG. 14O, in response to detecting user input 1442u in FIG. 14N, computer system 910 transitions the audio receiver setting to the enabled state.

At FIG. 14P, in response to detecting user input 1452f in FIG. 14N, computer system 910 displays accessibility settings user interface 1454. Accessibility settings user interface 1454 includes various options 1454a-1454g to control one or more accessibility settings of computer system 700. For example, in various embodiments, option 1454a is selectable to enable or disable a voice over feature of computer system 700; option 1454b is selectable to enable or disable a display zoom feature of computer system 700; option 1454c is selectable to modify display and/or text size of computer system 700; option 1454d is selectable modify one or more visual motion settings of computer system 700; option 1454e is selectable to modify one or more eye input settings of computer system 700; option 1454f is selectable to modify one or more spoken content settings of computer system 700; and/or option 1454g is selectable enable or disable an audio descriptions feature of computer system 700. In this way, a user is able to use accessibility settings user interface 1454 of computer system 910 to set and/or modify one or more accessibility settings of computer system 700. In some embodiments, computer system 700 includes one or more corresponding user interfaces that allow a user to modify the accessibility settings of computer system 700 using computer system 700.

At FIG. 14Q, in response to detecting user input 1452a in FIG. 14N, computer system 910 displays user interface 1456. User interface 1456 includes one or more options pertaining to a guest user mode of operation of computer system 700 (also referred to herein as a guest mode of operation), various embodiments and features of which have been described above, for example, with reference to FIGS. 7A-7AB, FIG. 8, FIGS. 9A-9AA, FIG. 10, FIG. 11, FIGS. 12A-12AN, and/or FIG. 13. In FIG. 14Q, user interface 1456 includes option 1456a, option 1456b, and option 1456c. In some embodiments, option 1456a is selectable (e.g., user input 1457a) to enable or disable use of computer system 910 to authorize use of computer system 700 in the guest mode of operation. For example, in FIGS. 9A-9AA discussed above, computer system 910 is used to authorize operation of computer system 700 in a guest mode of operation. In some embodiments, when option 1456a is enabled, computer system 910 is permitted to authorize operation of computer system 700 in the guest mode of operation; and when option 1456a is disabled, computer system 910 is not permitted to authorize operation of computer system 700 in the guest mode of operation. In some embodiments, option 1456b is selectable (e.g., user input 1457b) to cause computer system 910 to display a user interface in which the user is able to identify one or more applications that are permitted to be used by a guest user while computer system 700 is operating in the guest mode of operation (e.g., such as user interface 924 in FIG. 9R). In some embodiments, option 1456c is selectable (e.g., user input 1457c) to cause computer system 910 to display an accessibility settings user interface (e.g., such as accessibility settings user interface 1454 in FIG. 14P) to enable and/or disable one or more accessibility features of computer system 700 for when computer system 700 is operating in the guest mode of operation.

At FIG. 14R, in response to detecting user input 1452b in FIG. 14N, computer system 910 displays user interface 1458. User interface 1458 includes one or more options 1458a-1458c pertaining to input enrollment information to be used by computer system 700 to detect, receive, and/or interpret user inputs at computer system 700 (e.g., such as gaze input enrollment information and/or hand input enrollment information). Option 1458a is selectable (e.g., user input 1459a) to enable or disable an input enrollment setting of computer system 910. In some embodiments, when the input enrollment setting of computer system 910 is enabled, a user is able to use computer system 910 to take their personal user input enrollment information to a different wearable device and/or head-mounted device (e.g., as described above, for example, with reference to FIGS. 12A-12AN). In some embodiments, when the input enrollment setting of computer system 910 is disabled, computer system 910 cannot be used to import the user's personal user input enrollment information to a different wearable device and/or head-mounted device. Option 1458b is selectable (e.g., user input 1459b) to cause computer system 910 to initiate a process for deleting the user's user input enrollment information from a cloud storage service. Option 1458c is selectable (e.g., user input 1459c) to cause computer system 910 to disable option 1458a and to delete the user's user input enrollment information (e.g., from computer system 910, from computer system 700, and/or a cloud storage service). Accordingly, in this way, a user is able to use computer system 910 and/or user interface 1458 to manage their user input enrollment information for use with computer system 700 and/or other head-mounted devices and/or wearable devices.

Although various features and options have been described and depicted herein as being presented within particular user interfaces, it will be understood that various user interfaces described herein can be combined, split, and/or remixed such that different features and/or options can be added to and/or removed from one or more of the user interfaces described herein. Additional descriptions regarding FIGS. 14A-14R are provided below with reference to method 1500 described with respect to FIG. 15.

FIG. 15 is a flow diagram of an exemplary method 1500 for managing a wearable device using a computer system, in accordance with some embodiments. In some embodiments, method 1500 is performed at a computer system (e.g., 910) (e.g., computer system 101 in FIG. 1A) (e.g., a smart phone, a smart watch, a tablet, a laptop, a desktop, a wearable device, and/or head-mounted device) that is in communication with one or more display generation components (e.g., 912) (e.g., display generation component 120 in FIGS. 1A, 3A, and 4) (e.g., a heads-up display, a display, a touchscreen, a projector, etc.) (e.g., a visual output device, a 3D display, a display having at least a portion that is transparent or translucent on which images can be projected (e.g., a see-through display), a projector, a heads-up display, and/or a display controller) and one or more input devices (e.g., 912) (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) and/or one or more mechanical input devices (e.g., a depressible input mechanism; a button; a rotatable input mechanism; a crown; and/or a dial)). In some embodiments, method 1500 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1500 are, optionally, combined and/or the order of some operations is, optionally, changed.

The computer system (e.g., 910) displays (1502), via the one or more display generation components (e.g., 912), a first user interface (e.g., 1404, 1442, 1456, and/or 1458) (e.g., a first user interface that is part of a first application; and/or a first user interface that is part of a first application that corresponds to managing a wearable device) that is part of a first application (e.g., 1400) (e.g., a first user interface that is generated by the first application and/or caused to be displayed by the first application), wherein: the first application (e.g., 1400) includes one or more options (e.g., 140a, 1404b, 1404c, 1404c-1, 1404d, 1404d-1, 1404d-2, 1404d-3, 1404e, 1404e-1, 1404e-2, 1404e-3, 1404f, 1404f-1, 1404f-2, 1442q, 1442r, 1442s, 1442t, 1442u, 1442v, 1454a-1454g, 1456a-1456c, and/or 1458a-1458c) for managing a wearable device (e.g., 700) (e.g., a companion wearable device; an external wearable device that is associated with the computer system; an external wearable device that corresponds to a first user account that is also associated with the computer system; and/or an external wearable device that is registered to a first user account that is also associated with, registered to, and/or logged into the computer system) that is separate from the computer system (e.g., 910), and displaying the first user interface (e.g., 1404, 1442, 1456, and/or 1458) includes displaying a first set of one or more options for managing input enrollment information (e.g., 1442q, 1442r, 1458a, 1458b, and/or 1458c) (e.g., gaze-based input enrollment information, hand-based input enrollment information, and/or air gesture input enrollment information) corresponding to the wearable device (e.g., one or more options for saving input enrollment information on the computer system; one or more options for saving input enrollment information to a cloud service; one or more options for making the input enrollment information accessible on one or more other wearable devices separate from the wearable device; and/or one or more options for deleting the input enrollment information (e.g., from the wearable device, from the computer system, and/or from a cloud service)), wherein the input enrollment information is used by the wearable device (e.g., 700) to process user inputs received by the wearable device. While displaying the first user interface (e.g., 1404, 1442, 1456, and/or 1458) (1504), including displaying the first set of options (e.g., 1442q, 1442r, 1458a, 1458b, and/or 1458c), the computer system (e.g., 910) detects (1506), via the one or more input devices (e.g., 912), a first set of one or more user inputs (e.g., 1459a, 1459b, and/or 1459c) (e.g., one or more touch inputs, one or more spoken inputs, one or more hardware control inputs, and/or one or more gesture inputs) directed to one or more of the first set of options. In response to detecting the first set of one or more user inputs directed to one or more of the first set of options (1508), the computer system performs (1510) one or more actions with respect to the input enrollment information for the wearable device. In some embodiments, performing the one or more actions with respect to the input enrollment information includes one or more of: saving the input enrollment information on the computer system; causing the input enrollment information to be saved and/or transmitted to a cloud service; causing the input enrollment information to be saved and/or transmitted to an external computer system; causing the input enrollment information to be accessible on one or more other wearable devices separate from the wearable device; and/or causing the input enrollment information to be deleted or marked for deletion (e.g., from the wearable device, from the computer system, and/or from a cloud service). In some embodiments, input enrollment information is stored as part of a user input calibration profile generated for a first user that, in some embodiments, includes a gaze-based input calibration profile and/or an air gesture input calibration profile for the first user. In some embodiments, input enrollment information includes one or more offset values and/or one or more values that are used in measuring, sensing, and/or responding to user inputs. In some embodiments, gaze-based input calibration information and/or a gaze-based input calibration profile includes one or more offset values and/or one or more values that are used in measuring, sensing, and/or responding to gaze inputs from a user (e.g., one or more offset values and/or other values that are determined based on scanning one or more eyes of the user while the user is instructed to look at one or more gaze targets positioned at one or more different display positions). In some embodiments, hand-based input calibration information, a hand-based input calibration profile, air gesture input calibration information, and/or an air gesture input calibration profile includes one or more offset values and/or one or more values that are used in measuring, sensing, and/or responding to hand inputs (e.g., gesture inputs and/or air gesture inputs) and/or air gesture input from a user (e.g., one or more offset values and/or other values that are determined based on scanning one or more hands of the user while the user is instructed to perform one or more gestures and/or air gestures). Providing options on a computer system for managing input enrollment information for a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the input enrollment information for the wearable device (e.g., 700) includes gaze input enrollment information that is used by the wearable device to process gaze inputs received by the wearable device. In some embodiments, input enrollment information is stored as part of a user input calibration profile generated for a first user that, in some embodiments, includes a gaze-based input calibration profile. In some embodiments, input enrollment information includes one or more offset values and/or one or more values that are used in measuring, sensing, and/or responding to user inputs. In some embodiments, gaze-based input calibration information and/or a gaze-based input calibration profile includes one or more machine learning model weight values, one or more offset values and/or one or more values that are used in interpreting, measuring, sensing, and/or responding to gaze inputs from a user (e.g., one or more offset values and/or other values that are determined based on scanning one or more eyes of the user while the user is instructed to look at one or more gaze targets positioned at one or more different display positions). In some embodiments, performing the one or more actions with respect to the input enrollment information for the wearable device includes performing one or more actions with respect to the gaze input enrollment information. Providing options on a computer system for managing input enrollment information for a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the input enrollment information for the wearable device (e.g., 700) includes hand input enrollment information that is used by the wearable device to process hand inputs received by the wearable device (e.g., gesture inputs and/or air gesture inputs). In some embodiments, input enrollment information is stored as part of a user input calibration profile generated for a first user that, in some embodiments, includes an air gesture input calibration profile for the first user. In some embodiments, hand-based input calibration information, a hand-based input calibration profile, air gesture input calibration information, and/or an air gesture input calibration profile includes one or more machine learning model weight values, one or more offset values and/or one or more values that are used in interpreting, measuring, sensing, and/or responding to hand inputs (e.g., gesture inputs and/or air gesture inputs) and/or air gesture input from a user (e.g., one or more offset values and/or other values that are determined based on scanning one or more hands of the user while the user is instructed to perform one or more gestures and/or air gestures). In some embodiments, performing the one or more actions with respect to the input enrollment information for the wearable device includes performing one or more actions with respect to the hand input enrollment information. Providing options on a computer system for managing input enrollment information for a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a second user interface (e.g., 1442) that is part of the first application (e.g., 1400) (e.g., a second user interface that is different from the first user interface; or a second user interface that is the first user interface), wherein: the second user interface includes a companion device unlock option (e.g., 1442s); the companion device unlock option being set to a first state (e.g., an enabled state or a disabled state) enables the computer system (e.g., 910) to be unlocked (e.g., transitioned from a locked state to an unlocked state) by the wearable device (e.g., 700) (e.g., in response to a communication and/or a command from the wearable device) based on a determination by the wearable device that first criteria are satisfied (e.g., based on a determination by the wearable device that biometric authentication of a user wearing the wearable device is successful and/or corresponds to an owner and/or a registered user of the computer system); and the companion device unlock option (e.g., 1442s) being set to a second state (e.g., a disabled state or an enabled state) different from the first state prevents the computer system (e.g., 910) from being unlocked by the wearable device (e.g., 700) (e.g., regardless of whether the first criteria are satisfied); while displaying the second user interface (e.g., 1442), the computer system (e.g., 910) detects, via the one or more input devices, a second set of one or more user inputs (e.g., 1452c) (e.g., one or more touch inputs, one or more spoken inputs, one or more hardware control inputs, and/or one or more gesture inputs) that includes selection of the companion device unlock option; and in response to detecting the second set of one or more user inputs: in accordance with a determination that the second set of one or more user inputs cause the companion device unlock option to be set to the first state, the computer system (e.g., 910) enables the computer system to be unlocked by the wearable device (e.g., 700) (e.g., FIG. 14O); and in accordance with a determination that the second set of one or more user inputs cause the companion device unlock option to be set to the second state, the computer system forgoes enabling (e.g., preventing and/or not enabling) the computer system to be unlocked by the wearable device (e.g., FIG. 14N). Allowing a user to control whether or not the computer system can be unlocked by the wearable device improves privacy and device security by ensuring that the computer system is not unlocked by an unauthorized user and/or allowing the user to define how the computer system can be unlocked.

In some embodiments, the computer system (e.g., 910) displays, via the one or more display generation components (e.g., 912), a third user interface that is part of the first application (e.g., 1400) (e.g., a third user interface that is different from the first user interface; or a third user interface that is the first user interface), wherein: the third user interface includes one or more avatar management options; and the one or more avatar management options pertain to virtual avatar information associated with (e.g., stored on and/or accessible to) the wearable device (e.g., virtual avatar information that is used to generate one or more virtual avatars that are used to represent a user of the wearable device within one or more applications and/or within communications sessions) (e.g., in some embodiments, user interface 1458 includes one or more options for managing, saving and/or storing a virtual avatar representative of a user of computer system 910 on computer system 910 and/or a cloud storage service, similar to options 1458a-1458c in FIG. 14R for managing user input enrollment information, such that the virtual avatar can be imported to and/or used on a different head-mounted device); while displaying the third user interface, the computer system detects, via the one or more input devices, a third set of one or more user inputs (e.g., one or more touch inputs, one or more spoken inputs, one or more hardware control inputs, and/or one or more gesture inputs) directed to the one or more avatar management options (e.g., user input 1459a, 1459b, and/or 1459c); and in response to detecting the third set of one or more user inputs, the computer system performs one or more actions with respect to the virtual avatar information. In some embodiments, performing the one or more actions with respect to the virtual avatar information includes one or more of: saving the virtual avatar information on the computer system; causing the virtual avatar information to be saved and/or transmitted to a cloud service; causing the virtual avatar information to be saved and/or transmitted to an external computer system; causing the virtual avatar information to be accessible on one or more other wearable devices separate from the wearable device; and/or causing virtual avatar information to be deleted or marked for deletion (e.g., from the wearable device, from the computer system, and/or from a cloud service). Providing options on a computer system for managing virtual avatar information for a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a fourth user interface (e.g., 1454) that is part of the first application (e.g., 1400) (e.g., a fourth user interface that is different from the first user interface; or a fourth user interface that is the first user interface), wherein: the fourth user interface includes one or more accessibility options (e.g., 1454a-1454g); and the one or more accessibility options pertain to accessibility features of the wearable device (e.g., 700) (e.g., one or more accessibility features that provide alternate options for a user of the wearable device to provide user input to the wearable device). In some embodiments, the one or more accessibility features include, for example, one or more vision accessibility features (e.g., changing screen colors, text size, and/or display zoom; and/or turning audio descriptions, auto-readers, and/or spoken content on or off); one or more hearing accessibility features (e.g., adjusting volume and/or sound EQ settings; turning sound into text; and/or subtitles and captions); one or more mobility accessibility features (e.g., eyes-free device control, hands-free device control, voice control, dictation, predictive text, and/or customized gestures); and/or one or more speech-related accessibility features (e.g., typing spoken words, making speech requests in text, and/or allowing more time for speech requests). In some embodiments, the one or more accessibility features include one or more gaze input alternatives (e.g., switching from gaze input to head or arm-based pointing). In some embodiments, the one or more accessibility features include one or more hand input alternatives (e.g., using gaze dwell navigation in place of hand input and/or hand-based air gestures). While displaying the fourth user interface (e.g., 1454), the computer system (e.g., 910) detects, via the one or more input devices, a fourth set of one or more user inputs (e.g., one or more touch inputs, one or more spoken inputs, one or more hardware control inputs, and/or one or more gesture inputs) directed to the one or more accessibility options (e.g., one or more user inputs interacting with user interface 1454 and/or options 1454a, 1454b, 1454c, 1454d, 1454e, 1454f, and/or 1454g). In response to detecting the fourth set of one or more user inputs, the computer system (e.g., 910) performs one or more actions with respect to the accessibility features of the wearable device (e.g., 700). In some embodiments, performing the one or more actions with respect to the accessibility features of the wearable device includes one or more of: enabling and/or disabling a first accessibility feature of the wearable device; enabling and/or disabling a second accessibility feature of the wearable device different from the first accessibility feature; saving accessibility settings of the wearable device (e.g., to the computer system and/or to a cloud storage system); and/or causing accessibility settings to be imported to the wearable device. Providing options on a computer system for managing accessibility settings of a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a fifth user interface (e.g., 1456) that is part of the first application (e.g., 1400) (e.g., a fifth user interface that is different from the first user interface; or a fifth user interface that is the first user interface), wherein: the fifth user interface includes one or more guest mode options (e.g., 1456a, 1456b, and/or 1456c); and the one or more guest mode options pertain to a guest user mode of operation of the wearable device (e.g., 700), wherein the guest user mode of operation of the wearable device has access to fewer features of the wearable device than a registered user mode of operation of the wearable device. While displaying the fifth user interface (e.g., 1456), the computer system (e.g., 910) detects, via the one or more input devices, a fifth set of one or more user inputs (e.g., 1457a, 1457b, and/or 1457c) (e.g., one or more touch inputs, one or more spoken inputs, one or more hardware control inputs, and/or one or more gesture inputs) directed to the one or more guest mode options. In response to detecting the fifth set of one or more user inputs, the computer system (e.g., 910) performs one or more actions with respect to the guest user mode of operation of the wearable device (e.g., 700). In some embodiments, performing the one or more actions with respect to the guest user mode of operation of the wearable device includes one or more of: changing default settings for the guest user mode of operation; enabling the guest user mode of operation; and/or disabling the guest user mode of operation. In some embodiments, a guest mode of operations is a mode in which a person other than a registered user of the device uses the wearable device. In some embodiments, a guest mode uses a generic or limited biometric enrollment for controlling the wearable device and/or provides limited access to functions of the wearable device such as restricting access to health information, password protected information, passwords, device system preferences, applications identified as not being accessible in guest mode, functionalities identified as not being accessible in guest mode, and/or resetting functionality of the wearable device. Providing options on a computer system for managing a guest user mode of operation of a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, performing one or more actions with respect to the guest user mode of operation of the wearable device (e.g., 700) includes modifying one or more default settings of the guest user mode of operation (e.g., modifying one or more default apps that are accessible in the guest user mode of operation and/or modifying one or more default accessibility settings for the guest user mode of operation). Providing options on a computer system for managing a guest user mode of operation of a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, at least some of the one or more default settings of the guest user mode of operation are modifiable by a guest user of the wearable device (e.g., 700) while the wearable device is operating in the guest user mode of operation (e.g., accessibility options 760a in FIG. 7T to modify the default accessibility settings and/or features). In some embodiments, a subset of the one or more default settings of the guest user mode of operation are not modifiable and/or cannot be changed by a guest user of the wearable device while the wearable device is operating in the guest user mode of operation (e.g., in some embodiments, a guest user cannot modify the applications that are accessible in the guest user mode of operation). Providing options on a computer system for managing a guest user mode of operation of a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a sixth user interface (e.g., 1404 and/or 1442) that is part of the first application (e.g., 1400) (e.g., a sixth user interface that is different from the first user interface; or a sixth user interface that is the first user interface), wherein the sixth user interface includes device information (e.g., 1404a, 1442a, 1442b, 1442c, 1442d, 1442e, 1442f, 1442g, 1442h, 1442i, 1442j, and/or 1442k) corresponding to the wearable device (e.g., 700) (e.g., device name information, device model number information, device version information, head band size information, light seal (e.g., 1-110 and/or 1-210) information, light seal size information, light seal model information, optical insert information, one or more computer-readable codes associated with the wearable device, software version information, and/or device serial number information). Displaying device information within the first application enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a seventh user interface (e.g., 1442) that is part of the first application (e.g., 1400) (e.g., a seventh user interface that is different from the first user interface; or a seventh user interface that is the first user interface), wherein the seventh user interface includes software update information (e.g., 1442j) corresponding to the wearable device (e.g., 700) (e.g., software update information that indicates a software version of software and/or an operating system installed on the wearable device; and/or software update information that indicates whether a software update is available for the wearable device). In some embodiments, while displaying the software update information within the seventh user interface, the computer system detects, via the one or more input devices, one or more user inputs directed to the software update information (or, in some embodiments, a selection option corresponding to the software update information); and in response to detecting the one or more user inputs directed to the software update information, the computer system causes the wearable device to initiate a software update (e.g., causes the wearable device to initiate download of a software update and/or initiate installation of a software update) (e.g., in some embodiments, section 1442j in FIG. 14L includes an indication of whether a software update is available for computer system 700, and/or an option that is selectable to cause a software update to be downloaded and/or installed on computer system 700). Displaying software update information within the first application allows the user to manage the wearable device even when the user not wearing and/or using the wearable device, and also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), an eighth user interface (e.g., 1404) that is part of the first application (e.g., 1400) (e.g., an eighth user interface that is different from the first user interface; or an eighth user interface that is the first user interface), wherein the eighth user interface includes a representation of first content (e.g., 1404c, 1404d-1, 1404d-2, 1404d-3, 1404e-1, 1404e-2, 1404e-3, and/or 1404f) (e.g., first visual content, first audio content, and/or a first application) that is available for the wearable device (e.g., 700) (e.g., available to be downloaded to the wearable device, available to the installed on the wearable device, and/or available to be played on the wearable device). Displaying a representation of first content that is available for the wearable device allows the user to see what content is available on the wearable device even when the user is not wearing and/or using the wearable device. This also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a ninth user interface (e.g., 1404) that is part of the first application (e.g., 1400) (e.g., a ninth user interface that is different from the first user interface; or a ninth user interface that is the first user interface), wherein the ninth user interface further includes a first download option (e.g., 1404c, 1404d-1, 1404d-2, 1404d-3, 1404e-1, 1404e-2, 1404e-3, and/or 1404f) that corresponds to first downloadable content (e.g., first visual content, first audio content, and/or a first application) available to be downloaded to the wearable device (e.g., 700) (e.g., first downloadable content that is not yet downloaded on the wearable device). While displaying the first download option within the ninth user interface, the computer system detects, via the one or more input devices, a selection input (e.g., 1408, 1416, 1420, and/or 1424) (e.g., a touch input, a hardware input, a button input, a gaze input, a spoken input, a gesture input, and/or an air gesture input) corresponding to selection of the first download option. In response to detecting the selection input corresponding to selection of the first download option, the computer system (e.g., 910) causes the first downloadable content to be downloaded to the wearable device (e.g., 700) (and, in some embodiments, without causing the first downloadable content to be downloaded to the computer system) (e.g., FIGS. 14F-14I). Providing options on a computer system for managing downloads and/or download content for a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first downloadable content corresponds to a first application (e.g., the first downloadable content is a first application and/or is playable by a first application). In some embodiments, the computer system (e.g., 910) concurrently displays, via the one or more display generation components: the first download option (e.g., 1404c, 1404d-1, 1404d-2, 1404d-3, 1404e-1, 1404e-2, 1404e-3, and/or 1404f) that corresponds to the first downloadable content; and a second download option (e.g., 1404c, 1404d-1, 1404d-2, 1404d-3, 1404e-1, 1404e-2, 1404e-3, and/or 1404f) that corresponds to second downloadable content (e.g., second visual content, second audio content, and/or a second application) different from the first downloadable content, wherein the second downloadable content corresponds to a second application (e.g., the second downloadable content is the second application and/or is playable by the second application) different from the first application (and, optionally, does not correspond to the first application and/or is not playable by the first application) (e.g., in some embodiments, three-dimensional content in section 1404d is played using a different application than the immersive content in section 1404e, and/or the games in section 1404f are played using different applications than the three-dimensional content in section 1404d and/or the immersive content in section 1404e). Providing options on a computer system for managing downloads and/or download content for a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, in response to detecting the selection input (e.g., 1408, 1416, 1420, and/or 1424) corresponding to selection of the first download option, the computer system (e.g., 910) displays, via the one or more display generation components (and, optionally, within the first user interface), a first download status representation (e.g., 1404c-2, 1404d-1a, 1404e-2a, and/or 1404f-3) that is representative of a download status of the first downloadable content being downloaded to the wearable device (e.g., 700) (e.g., a first download status representation that indicates a percentage of completion of downloading the first downloadable content to the wearable device and/or an estimated time remaining for downloading the first downloadable content to the wearable device). Providing options on a computer system for managing downloads and/or download content for a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently. Furthermore, displaying download status information for content being downloaded to the wearable device provides the user with improved visual feedback about the state of the wearable device.

In some embodiments, the computer system (e.g., 910) displays, via the one or more display generation components (e.g., 912), concurrently with the first download option (e.g., 1404c, 1404d-1, 1404d-2, 1404d-3, 1404e-1, 1404e-2, 1404e-3, and/or 1404f), a first watch list option (e.g., 1404c-1) that corresponds to the first downloadable content (e.g., in some embodiments, section 1404c includes option 1404c-1 to add the content to a watch list, and a separate option to download the content to computer system 700). While displaying the first watch list option (e.g., 1404c-1) that corresponds to the first downloadable content, the computer system (e.g., 910) detects, via the one or more input devices, a selection input (e.g., 1408) (e.g., a touch input, a hardware input, a button input, a gaze input, a spoken input, a gesture input, and/or an air gesture input) corresponding to selection of the first watch list option. In response to detecting the selection input corresponding to selection of the first watch list option, the computer system (e.g., 910) causes the first downloadable content to be added to a watch list of the wearable device (e.g., 700) (and, in some embodiments, without causing the first downloadable content to be added to a watch list of the computer system). Providing options on a computer system for managing downloads and/or download content for a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a tenth user interface (e.g., 1404 and/or 1438) that is part of the first application (e.g., 1400) (e.g., a tenth user interface that is different from the first user interface; or a tenth user interface that is the first user interface), wherein the tenth user interface includes: a representation of a first contact (e.g., contacts in section 1404b, 1440b, 1440c, 1440d, and/or 1440e) (e.g., a first contactable person, a first person, a first contact stored in a contacts list of the computer system, and/or a first remote user different from a user of the computer system) that is associated with a second wearable device different from the wearable device (e.g., 700) (e.g., a second wearable device that is different from the wearable device but is of the same type as the wearable device and/or the same model as the wearable device). In some embodiments, the first contact is represented in the tenth user interface (e.g., 1404 and/or 1438) and/or the representation of the first contact is displayed within the tenth user interface based on and/or in accordance with a determination that the first contact is associated with the second wearable device and/or that the first contact is associated with a respective wearable device that is of a same type as the wearable device (e.g., a head-mounted device). In some embodiments, the tenth user interface further includes a representation of a second contact (e.g., contacts in section 1404b, 1440b, 1440c, 1440d, and/or 1440e) different from the first contact and that is associated with a third wearable device different from the wearable device. In some embodiments, the second contact is represented in the tenth user interface and/or the representation of the second contact is displayed within the tenth user interface based on and/or in accordance with a determination that the second contact is associated with the third wearable device and/or that the second contact is associated with a respective wearable device that is of a same type as the wearable device (e.g., a head-mounted device). Displaying representations of users that have the same type of device as the wearable device provides the user with useful information about his or her contacts. This also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, displaying the tenth user interface (e.g., 1404 and/or 1438) further comprises: in accordance with a determination that the second wearable device is being used (e.g., by the first contact and/or by a guest user of the first contact), displaying, via the one or more display generation components, the representation of the first contact in a first manner (e.g., a first visual manner and/or with a first set of visual characteristics) (e.g., representations 1440b-1440c in FIG. 14J indicating that these contacts are “online”); and in accordance with a determination that the second wearable device is not being used (e.g., the second wearable device is off, is in a rest state, is in a locked state, and/or is not being worn by a user), displaying, via the one or more display generation components, the representation of the first contact in a second manner different from the first manner (e.g., a second visual manner and/or with a second set of visual characteristics) (e.g., representations 1440d-1440e in FIG. 14J indicating that these contacts are “offline”). Displaying representations of users that have the same type of device as the wearable device provides the user with useful information about his or her contacts. This also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first application (e.g., 1400) is automatically installed on the computer system (e.g., 910) (e.g., without user input and/or without a user request to download and/or install the first application). In some embodiments, the first application is automatically installed on the computer system based on a determination that a user of the computer system (e.g., 910) is associated with the wearable device (e.g., 700) and/or based on a determination that a user account that is logged into the computer system is also logged into the wearable device. The first application is optionally automatically installed when an operating system of the computer system is updated and/or when the first application becomes available. Automatically downloading the first application allows for this operation to be performed with fewer user inputs. Furthermore, this also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), an eleventh user interface (e.g., 1404 and/or 1442) that is part of the first application (e.g., 1400) (e.g., an eleventh user interface that is different from the first user interface; or an eleventh user interface that is the first user interface), wherein the eleventh user interface includes battery information (e.g., 1404a, 1442c, and/or 1442d) for the wearable device (e.g., 700) (e.g., battery charge level and/or an indication of whether the wearable device is being charged or is not being charged). Displaying battery charge information for the wearable device provides the user with improved visual feedback about a state of the wearable device.

In some embodiments, the computer system (e.g., 910) displays, via the one or more display generation components (e.g., 912), a twelfth user interface (e.g., 1404 and/or 1442) that is part of the first application (e.g., 1400) (e.g., a twelfth user interface that is different from the first user interface; or a twelfth user interface that is the first user interface), wherein the twelfth user interface includes: a first selectable user guide option (e.g., 1404h-1, 1404i-1, 1404i-2, 1404i-3, 1442l, 1442m, 1442n, 1442o, and/or 1442p) that, when selected, causes the computer system (e.g., 910) to display instructions (e.g., visual instructions, suggestions, and/or tips) for using the wearable device (e.g., 700) (e.g., displaying one or more images, text, and/or one or more videos including the instructions). Displaying user guides for the wearable device on the computer system allows a user of the computer system to learn how to use the wearable device prior to actually using the wearable device. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, in accordance with a determination that first notification criteria have been satisfied (e.g., in accordance with a determination that a pre-determined duration of time has passed since displaying a last device status notification, and/or in accordance with a determination that a pre-determined day and/or time has been reached), the computer system (e.g., 910) displays, via the one or more display generation components (e.g., 912), a wearable device status notification that provides device status information pertaining to the wearable device (e.g., in some embodiments, computer system 910 displays a notification (e.g., overlaid on a lock screen user interface, home screen user interface 936, and/or a user interface for an application different from the device management application) that displays at least a subset of the information shown in user interface 1404, 1438, and/or 1442). In some embodiments, in accordance with a determination that the first notification criteria have not been satisfied, the computer system (e.g., 910) forgoes displaying a wearable device status notification. In some embodiments, the notification indicates new features that are available for the wearable device (e.g., 700) (e.g., due to a software update for the wearable device and/or an application of the wearable device). In some embodiments, the notification indicates new content that is available for the wearable device (e.g., due to new content being available via a subscription service, a new subscription service being associated with the user's account, or new applications and/or content being available for purchase and or download) (e.g., similar to content being shown in user interface 1404, such as sections 1404c, 1404d, 1404e, 1404f, and/or 1404g). In some embodiments, the notification indicates activity and/or availability of one or more other users of wearable devices that can communicate with the wearable device (e.g., indicating that people who the user knows or has associated contact information are available for shared communication using compatible wearable devices) (e.g., similar to information shown in user interface 1438). Providing the user with periodic device status information for the wearable device provides the user with improved visual feedback about a state of the wearable device.

In some embodiments, the computer system (e.g., 910) displays, via the one or more display generation components (e.g., 912), a thirteenth user interface (e.g., 1442) that is part of the first application (e.g., 1400) (e.g., a thirteenth user interface that is different from the first user interface; or a thirteenth user interface that is the first user interface), wherein the thirteenth user interface includes one or more personalized spatial audio options (e.g., 1442t) that correspond to personalized spatial audio information associated with a first user (e.g., a user of the computer system and/or the wearable device). While displaying the one or more personalized spatial audio options, the computer system detects, via the one or more input devices, one or more user inputs (e.g., 1452d) directed to the one or more personalized spatial audio options; and in response to detecting the one or more user inputs directed to the one or more personalized spatial audio options, the computer system performs one or more actions with respect to the personalized spatial audio information (e.g., initiates set up of personalized spatial audio and/or initiates generation of a personalized spatial audio profile for the user). In some embodiments, performing one or more actions with respect to the personalized spatial audio information includes one or more of: initiating a process for collecting biometric information from a user of the computer system (e.g., 910) to generate personalized spatial audio information for the user of the computer system; causing stored personalized spatial audio information for the user of the computer system to be downloaded to and/or transmitted to the wearable device (e.g., 700); and/or causing stored personalized spatial audio information for the user of the computer system to be deleted (e.g., from the computer system, from the wearable device, and/or from a cloud storage system). In some embodiments, spatialized audio experiences are produced by manipulating sounds in an audio output device's two audio channels (e.g., left and right) so that they resemble directional sounds arriving in the ear-canal. For example, headphones can reproduce a spatial audio signal that simulates a soundscape around the listener (also referred to as the user). An effective spatial sound reproduction can render sounds such that the listener perceives the sound as coming from a location within the soundscape external to the listener's head, just as the listener would experience the sound if encountered in the real world. In some embodiments, spatialized audio is audio that has been filtered such that a listener of the audio perceives the audio as coming from one or more directions and/or locations in a three-dimensional space (e.g., from above, below, and/or in front of the listener). An example of such a filter is a Head-Related Transfer Function (HRTF) filter. In some embodiments, personalized spatial audio information is generated based on biometric information collected from the user such as, for example, one or more scans of the user's head, face, and/or ears. In some embodiments, spatial audio is output for the user based on the one or more scans of the user's head, face, and/or ears (e.g., to provide a personalized audio experience based on the shape, placement, and/or size of the user's head, facial features, and/or ears). Providing options on a computer system for managing spatial audio for a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a fourteenth user interface (e.g., 1404 and/or 1442) that is part of the first application (e.g., 1400) (e.g., a fourteenth user interface that is different from the first user interface; or a fourteenth user interface that is the first user interface), wherein the fourteenth user interface includes wearable device adjustment instructions (e.g., 14421, 1442n, 1404h-1, and/or 1404i-2) for adjusting one or more physical dimensions of the wearable device (e.g., 700) (e.g., adjusting and/or modifying IPD, adjusting and/or modifying a light seal (e.g., 1-110 and/or 1-210) of the wearable device (e.g., 700), and/or adjusting and/or modifying head band fit of the wearable device). Providing the user with instructions for how to adjust the fit of the wearable device enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a fifteenth user interface (e.g., 1442) that is part of the first application (e.g., a fifteenth user interface that is different from the first user interface; or a fifteenth user interface that is the first user interface), wherein the fifteenth user interface includes a receiver option (e.g., 1442u) for using the computer system (e.g., 910) as an output device (e.g., visual output device and/or audio output device) of the wearable device (e.g., 700). While displaying the receiver option, the computer system detects, via the one or more input devices, one or more user inputs (e.g., 1452e) directed to the receiver option; and in response to detecting the one or more user inputs directed to the receiver option: in accordance with a determination that the receiver option is in a first state (e.g., an enabled state) (e.g., FIG. 14O), the computer system (e.g., 910) enables the computer system to be used as an output device (e.g., a visual output device and/or an audio output device) of the wearable device (e.g., 700) (e.g., outputting visual content and/or audio content that is provided by the wearable device); and in accordance with a determination that the receiver option is in a second state (e.g., a disabled state) different from the first state (e.g., 1442u in FIG. 14N), the computer system (e.g., 910) forgoes enabling the computer system to be used (e.g., preventing the computer system from being used) as an output device of the wearable device (e.g., 700). Providing options on a computer system for managing a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) displays, via the one or more display generation components (e.g., 912), a sixteenth user interface (e.g., 1442, 1456, and/or 1458) that is part of the first application (e.g., 1400) (e.g., a sixteenth user interface that is different from the first user interface; or a sixteenth user interface that is the first user interface), wherein the sixteenth user interface includes a cloud synchronization option for the wearable device (e.g., 700) (e.g., in some embodiments, user interface 1442 and/or user interface 1458 includes an option to enable or disable cloud synchronization for computer system 700). While displaying the cloud synchronization option, the computer system detects, via the one or more input devices, one or more user inputs directed to the cloud synchronization option. In response to detecting the one or more user inputs directed to the cloud synchronization option: in accordance with a determination that the cloud synchronization option is in a first state (e.g., an enabled state in which information, settings and/or data is synchronized between the wearable device and one or more other devices associated with a same user account), the computer system enables a cloud synchronization feature of the wearable device; and in accordance with a determination that the cloud synchronization option is in a second state (e.g., a disabled state in which information, settings and/or data is not synchronized between the wearable device and one or more other devices associated with a same user account) different from the first state, the computer system disables the cloud synchronization feature of the wearable device. Providing options on a computer system for managing a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 910) detects, via the one or more input devices, a first user request (e.g., one or more user inputs) to modify a first setting of the computer system (e.g., 910). In response to detecting the first user request to modify the first setting of the computer system: the computer system modifies the first setting of the computer system; and causes a first respective setting of the wearable device that corresponds to the first setting of the computer system to be modified based on the modification to the first setting of the computer system (e.g., in some embodiments, modifying an accessibility setting of computer system 910 in a user interface similar to user interface 1454 and/or in user interface 1454 causes a corresponding accessibility setting to be modified for computer system 700). Providing options on a computer system for managing a separate wearable device allows the user to manage the wearable device even when the user not wearing and/or using the wearable device. This enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, aspects/operations of methods 800, 1000, 1100, 1300, 1500, and/or 1700 may be interchanged, substituted, and/or added between these methods. For example, in some embodiments, the computer systems recited in methods 800, 1200, and/or 1700 are the same computer system, the first computer system recited in method 1000, the wearable device recited in method 1500, and/or the external computer system recited in method 1100. In another example, in some embodiments, the computer system recited in method 1100 is the second computer system recited in method 1000. For brevity, these details are not repeated here.

FIGS. 16A-16W illustrate examples of managing a computer system, in accordance with some embodiments. FIG. 17 is a flow diagram of an exemplary method 1700 for managing a computer system, in accordance with some embodiments. The user interfaces in FIGS. 16A-16W are used to illustrate the processes described below, including the processes in FIG. 17.

FIG. 16A depicts user 1600 placing computer system 700 on their head. As is more clearly seen in FIG. 16B, in the depicted examples, computer system 700 is a head-mounted device that includes input sensors 703, hardware control 704, and display module 702. Various embodiments of computer system 700 were described above, for example, with reference to FIGS. 7A-7AB, FIGS. 9A-9AA, and/or FIGS. 12A-12AN. At FIG. 16B, based on a determination that computer system 700 has been worn on the head of a user, computer system 700 displays, via display module 702, gaze target 706 and attempts biometric authentication of user 1600 (e.g., face-based, eye-based, and/or iris-based biometric authentication) by collecting biometric information from user 1600 (e.g., one or more scans of user 1600's eyes to perform eye-based biometric authentication). Gaze target 706 is displayed overlaid on three-dimensional environment 708. In the depicted scenario, three-dimensional environment 708 includes objects 708d-708g (e.g., wall 708d, wall 708e, sofa 708f, and wall 708g). In some embodiments, three-dimensional environment 708 is displayed by a display (e.g., display module 702) (e.g., a virtual passthrough environment displayed by display module 702). In some embodiments, three-dimensional environment 708 includes a virtual environment and/or an image or video of a physical environment captured by one or more cameras (e.g., one or more cameras that are part of input sensors 703 and/or one or more external cameras). For example, in some embodiments, objects 708d-708g are virtual objects that are representative of physical objects that have been captured by one or more cameras and/or detected by one or more sensors. In some embodiments, three-dimensional environment 708 is visible to a user, but is not displayed by a display. For example, in some embodiments, three-dimensional environment 708 is a physical environment (and, for example, objects 708d-708g are physical objects) that is visible to a user (e.g., through a transparent display module 702) without being displayed by display module 702 (e.g., a physical passthrough and/or an optical passthrough environment that is visible through display module 702 but is not displayed by display module 702). At FIG. 16B, computer system 700 is in a locked state in which features of computer system 700 other than user authentication are not accessible by user 1600.

In some embodiments, if user 1600 is identified and/or authenticated as a known and/or registered user of computer system 700 based on biometric authentication of user 1600, computer system 700 transitions to an unlocked state and/or a registered user mode of operation, and applies one or more device settings corresponding to the registered user, such as applying input enrollment information that corresponds to the identified user. Examples of the unlocked state corresponding to identification of a registered user and/or a registered user mode of operation are described above, for example, with reference to FIG. 7C, FIG. 9C, and/or FIG. 12C.

At FIG. 16C, the attempted biometric authentication of user 1600 fails to identify user 1600 as a known and/or registered user (e.g., biometric authentication of user 1600 is unsuccessful). At FIG. 16C, based on a determination that biometric authentication of user 1600 is unsuccessful, computer system 700 displays user interface 1602. User interface 1602 includes keyboard 1602a, which allows the user to enter a passcode to attempt passcode-based authentication of the user. User interface 1602 also includes button 1602b which, when selected, causes computer system 700 to re-attempt biometric authentication of user 1600. User interface 1602 also includes instructions 1602d which instruct and/or inform the user to press hardware control 704 for more options. At FIG. 16C, computer system 700 detects user input 1603 (e.g., a press of hardware control 704).

At FIG. 16D, in response to detecting user input 1603, computer system 700 displays user interface 1604. User interface 1604 includes options 1604a-1604c. Option 1604a, when selected, causes computer system 700 to initiate a process for requesting guest access to computer system 700 (e.g., requesting to operate computer system 700 in a guest mode of operation), as was described above, for example, with reference to FIGS. 9D-9AA. Option 1604b, when selected, causes computer system 700 to initiate a process for resetting computer system 700 for use by a new user, as will be described in greater detail below. Option 1604c, when selected, causes computer system 700 to initiate a process for re-performing biometric authentication of user 1600 and/or authenticating user 1600 (e.g., via biometric authentication and/or passcode-based authentication) as a known and/or registered user. User interface 1604 also includes instruction 1604d, which instructs the user to press hardware control 704 to select a currently highlighted option (which, in FIG. 16D, is option 1604a, as indicated by the bold outline around option 1604a) and to turn hardware control 704 to scroll between options 1604a-1604c. FIG. 16D depicts two example scenarios in which computer system 700 detects two different inputs: user input 1605a (e.g., a press of hardware control 704); and user input 1605b (e.g., a turn and/or rotation of hardware control 704 in a first direction (e.g., counter-clockwise)). In response to detecting user input 1605a, computer system 700 initiates a process for requesting to operate computer system 700 in a guest mode of operation. In some embodiments, in response to detecting user input 1605a, computer system 700 transitions to the state shown and described above with reference to FIG. 9E.

At FIG. 16E, in response to detecting user input 1605b, computer system 700 updates user interface 1604 to display option 1604b as a currently highlighted option (e.g., as indicated by the bold outline around option 1604b). FIG. 16E depicts three example scenarios in which computer system 700 detects three different inputs: user input 1606a (e.g., a rotation of hardware control 704 in a first direction (e.g., counter-clockwise)); user input 1606b (e.g., a rotation of hardware control 704 in a second direction (e.g., clockwise)); and user input 1606c (e.g., a press of hardware control 704). In response to detecting user input 1606a, computer system 700 updates user interface 1604 to show option 1604c as a currently highlighted option. In response to detecting user input 1606b, computer system 700 updates user interface 1604 to show option 1604a as a currently highlighted option (e.g., as shown in FIG. 16D).

At FIG. 16F, in response to detecting user input 1606c, computer system 700 displays user interface 1608. User interface 1608 includes option 1608a and option 1608b. Option 1608a, when selected, causes computer system 700 to initiate a process for resetting computer system 700 for use by a new user, various features and/or embodiments of which will be described in greater detail below. In some embodiments, computer system 700 is configured such that computer system 700 is able to perform two different types of resets: a new user reset (e.g., resetting computer system 700 for use by a new user) and a full system reset (e.g., a full device reset and/or a factory reset). In some embodiments, the new user reset (e.g., resetting computer system 700 for use by a new user) differs from performing a full system reset of computer system 700. In some embodiments, when computer system 700 performs a new user reset, computer system 700 maintains (e.g., does not delete and/or makes accessible) a first set of applications, features, and/or content for use by a new user, as will be described in greater detail below. In some embodiments, certain applications, features, and/or content that are maintained and/or accessible after a new user reset are not accessible and/or are deleted when computer system 700 performs a full system reset. In some embodiments, the new user reset feature enables multiple users (e.g., multiple users in a company, multiple users in a school, and/or multiple users in an organization) to share a single device with a default set of applications, content, and/or features applied to computer system 700 when a new user starts using computer system 700. In some embodiments, a full system reset of computer system 700 places computer system 700 back into an “out of box” state and/or a factory reset state that includes fewer applications, content, and/or features compared to the new user reset. In some embodiments, the option to reset computer system 700 for use by a new user (e.g., the new user reset feature) is only available and/or is only accessible when a shared use setting (e.g., an enterprise setting) of computer system 700 is enabled. In this way, computer systems that have only a single user and/or that are not intended to be shared with multiple users can have the shared use setting disabled. In some embodiments, when the shared use setting is enabled, the option to perform a new user reset is accessible (e.g., option 1604b is accessible in user interface 1604 of FIG. 16E), and when the shared use setting is disabled, the option to perform a new user reset (e.g., option 1604 in FIG. 16E) is not accessible (e.g., is not displayed in user interface 1604 in FIG. 16E).

Option 1608b, when selected, causes computer system 700 to cease display of user interface 1608 without performing a new user rest and, optionally, return to the state shown in FIG. 16E. User interface 1608 also includes notification 1610, which notifies the user that selection of option 1608a will cause computer system 700 to reset computer system 700 for use by a new user. User interface 1608 also includes instruction 1608c, which instructs the user to press hardware control 704 to select a currently highlighted option (e.g., option 1608a in FIG. 16F) or to turn hardware control 704 to scroll through options 1608a-1608b. FIG. 16F depicts two example scenarios in which computer system 700 detects two different inputs: user input 1609a (e.g., a rotation of hardware control 704 in a first direction (e.g., counter-clockwise)); and user input 1609b (e.g., a press of hardware control 704). In response to detecting user input 1609a, computer system 700 updates user interface 1609 to show option 1608b as a currently highlighted option.

At FIG. 16G, in response to detecting user input 1609b, computer system 700 displays user interface 1610. User interface 1610 includes notification 1610a, which instructs the user to remove computer system 700 from his or her head, and notifies the user that computer system 700 will shut down. At FIG. 16H, user 1600 removes computer system 700 from their head and places computer system 700 down on a table.

In some embodiments, computer system 700 includes one or more external display generation components 702x that are positioned on an external portion of computer system 700. In some embodiments, external generation component(s) 702x are not directed toward the head and/or the eyes of the user when computer system 700 is worn on the head of the user (e.g., are directed away from the eyes of the user when computer system 700 is worn on the head of the user and/or display content in a direction directed away from the head of the user), while one or more internal display generation components, including display module 702, are directed toward the head and/or eyes of the user when computer system 700 is worn on the head of the user (e.g., display content in a direction directed toward the head of the user). At FIG. 16I, while computer system 700 is performing a new user reset of computer system 700, computer system 700 displays visual indication 1612 via one or more external display generation components 702x to indicate that computer system 700 is performing a new user reset of computer system 700. At FIG. 16J, computer system 700 has completed performing the new user reset of computer system 700. Based on a determination that computer system 700 has completed performing the new user reset of computer system 700, computer system 700 ceases display of visual indication 1612 and outputs audio output 1614 to indicate that computer system 700 has completed performing the new user reset.

At FIG. 16K, user 1600 puts computer system 700 back on their head. At FIG. 16L, based on a determination that a user has worn computer system 700 on their head, and based on computer system 700 having performed the new user reset of computer system 700, computer system 700 displays, via display module 702, user interface 1616. User interface 1616 includes instruction 1616a, which instructs the user to press hardware control 704. At FIG. 16L, computer system 700 detects user input 1617 (e.g., a press of hardware control 704).

At FIG. 16M, in response to detecting user input 1617, computer system 700 displays user interface 1618. User interface 1618 instructs the new user to bring their phone or tablet nearby to import user input enrollment information and/or other device settings for the new user, as was described above, for example, with reference to FIGS. 12D-12F and/or FIGS. 12U-12AN. User interface 1618 also includes instruction 1618b, which instructs the user to double press hardware control 704 to perform a new input enrollment, as was described above, for example, with reference to FIGS. 7I-7N.

At FIG. 16N, computer system 700 has completed importing user input enrollment information corresponding to user 1600 from the user's personal device (e.g., phone and/or tablet) and/or has completed performing a new input enrollment of user 1600, and now displays, via display module 702, user interface 1620. User interface 1620 is a home screen user interface, like home screen user interface 714 described above, and includes application icons 1620-1 through 1620-13 representative of various applications that are accessible by the user. In some embodiments, application icons 1620-1 through 1620-13 represent a set of default applications that are accessible to the user after a new user reset. In some embodiments, the applications corresponding to application icons 1620-1 through 1620-13 were selected to be included in the set of default applications that are accessible to a user after a new user reset, and computer system 700 excludes application icons corresponding to one or more applications that have not been selected for inclusion in the set of default applications. In some embodiments, applications that are not part of the set of default applications but that were downloaded, installed, and/or otherwise made accessible for a previous user are deleted and/or otherwise made inaccessible by the new user reset.

FIGS. 16A-16N described an example scenario in which a user is able to request a new user reset when authentication of the user fails. FIGS. 16N-16S depict example scenarios and/or embodiments in which the option to perform a new user reset is displayed in response to other user inputs and/or in other contexts. At FIG. 16N, computer system 700 detects user inputs 1621a-1621b (e.g., simultaneous and/or concurrent presses of hardware control 704 and button 704a and/or one or more presses of hardware control 704 and/or button 704a). At FIG. 16O, in response to detecting user input 1621a and/or user input 1621b, computer system 700 displays user interface 1622. User interface 1622 includes options 1622a-1622b. Option 1622a, when selected, causes computer system 700 to initiate a process for re-performing user input enrollment of the user (for example, as was described above with reference to FIGS. 7J-7N and/or FIGS. 12H-12P). Option 1622b, when selected, causes computer system 700 to initiate a new user reset. User interface 1622 also includes instruction 1622c, which instructs the user to press hardware control 704 to select a currently highlighted option (e.g., option 1622a in FIG. 16O) or to rotate hardware control 704 to scroll between options 1622a-1622b. By allowing a user to access user interface 1622 via one or more hardware control inputs, computer system 700 allows a user to access options to re-do input enrollment and/or to perform a new user reset without using gaze and/or hand inputs that rely on user-specific and/or user-calibrated user input enrollment information. This may be useful, for example, if user input enrollment information is not correctly calibrated to a user and/or user input enrollment information for the wrong user and/or a different user has been applied. FIG. 16O depicts two example scenarios in which computer system 700 detects two different user inputs: user input 1623a (e.g., a press of hardware control 704) and user input 1623b (e.g., rotation of hardware control 704 in a first direction (e.g., counter-clockwise)). In response to detecting user input 1623a, computer system 700 initiates a process for re-performing user input enrollment of the user (e.g., as shown in FIGS. 7J-7N and/or FIGS. 12H-12P).

At FIG. 16P, in response to detecting user input 1623b, computer system 700 updates display of user interface 1622 to display option 1622b as a currently highlighted option. FIG. 16P depicts two example scenarios in which computer system 700 detects two different user inputs: user input 1624a (e.g., a press of hardware control 704) and user input 1624b (e.g., rotation of hardware control 704 in a first direction (e.g., counter-clockwise)). In response to detecting user input 1624b, computer system 700 returns to the state shown in FIG. 16O (with option 1622a as the currently highlighted option). In response to detecting user input 1624a, computer system 700 initiates a new user reset (e.g., the state shown in FIG. 16G and/or the state shown in FIG. 16T described below).

At FIG. 16Q, computer system 700 is in the same state as was described above with reference to FIG. 16N (e.g., displaying home screen user interface 1620). At FIG. 16Q, computer system 700 detects that user 1600 is looking at the palm of their hand 1626. In response to detecting that user 1600 is looking at the palm of their hand 1626, computer system 700 displays indication 1628 proximate hand 1626. At FIG. 16R, computer system 700 detects that user 1600 has turned hand 1626 over so that the palm of hand 1626 is now facing downwards and user 1600 is looking at the back of hand 1626. In response to detecting rotation of hand 1626 from a palm up position to a palm down position, computer system 700 replaces indication 1628 with indication 1632. In FIG. 16R, indication 1632 displays a current time (e.g., 10:09), battery level information 1632a, wireless signal strength information 1632b, and device volume information 1632c. At FIG. 16R, while displaying indication 1632, computer system 700 detects air gesture input 1634a (e.g., a pinch air gesture) and gaze input 1634b directed to indication 1632 (e.g., air gesture input 1634a while user 1600 looks at indication 1632).

At FIG. 16S, in response to detecting air gesture input 1634a and gaze input 1634b, computer system 700 displays control panel user interface 1636. Control panel user interface 1636 represents another embodiment and/or a variation of control panel user interface 756 and/or control panel user interface 1268 discussed above. In some embodiments, control panel user interface 1636 in FIG. 16S is control panel user interface 756 and/or control panel user interface 1268, and/or, in some embodiments, control panel user interface 756 and/or control panel user interface 1268 in the scenarios described above can be replaced with control panel user interface 1636. At FIG. 16S, control panel user interface 1636 displays current date 1636a, current time 1636b, battery level indication 1636c, and wireless signal strength indication 1636d. Control panel user interface 1636 also includes options 1636f through 1636o. Option 1636f, when selected, causes computer system 700 to turn WiFi on or off. Option 1636g, when selected, causes computer system 700 to turn Bluetooth on or off. Option 1636h, when selected, causes computer system 700 to turn airplane mode on or off. Option 1636i causes computer system 700 to increase or decrease system volume in response to user input (e.g., an air gesture input with movement to the left to decrease volume or an air gesture input with movement to the right to increase volume). Option 1636j displays music track information for a currently playing music track. Option 1636k, when selected, causes computer system 700 to request and/or initiate a guest mode of operation (e.g., as described above, for example, with reference to FIGS. 7A-7AB; similar to operation and/or selection of option 722d in FIG. 7D and/or FIG. 7Y; and/or similar to requesting operation of computer system 700 in the guest mode of operation in FIG. 9D). Option 1636l, when selected, causes computer system 700 to enable or disable a focus mode (e.g., a focus mode in which one or more notifications that would be output and/or displayed when the focus mode is disabled are muted when the focus mode is enabled). Option 1636m, when selected, causes computer system 700 to enable or disable a travel mode (e.g., a travel mode that is indicative of computer system 700 and/or user 1600 traveling in a vehicle when the travel mode is enabled; a travel mode in which computer system 700 uses certain device movement information indicative of movement of computer system 700 when the travel mode is disabled and ignores the device movement information when the travel mode is enabled). Option 1636n, when selected, causes computer system 700 to initiate recording of one or more cameras of computer system 700. Option 1636o, when selected, causes computer system 700 to initiate a new user reset of computer system 700. At FIG. 16S, computer system 700 detects user input 1638a (e.g., a pinch air gesture input) and gaze input 1638b corresponding to selection of option 1636o (e.g., pinch air gesture input 1638a while user 1600 looks at option 1636o).

In some embodiments, in response to detecting user input 1638a and gaze input 1638b, computer system 700 initiates a new user reset of computer system 700 and/or transitions to the state shown in FIG. 16G. In some embodiments, in response to detecting user 1638a and gaze input 1638b, computer system 700 initiates a new user reset of computer system 700 and transitions to the state shown in FIG. 16T. In some embodiments, FIGS. 16T-16V represent an alternative embodiment of the new user reset described above with reference to FIG. 16G. In FIG. 16T, rather than displaying user interface 1610 of FIG. 16G, computer system 700 displays user interface 1640. User interface 1640 includes notification 1640a, which informs the user that computer system 700 is performing a new user reset, and that computer system 700 will output an audio output when the new user reset is completed. User interface 1640 also includes status information 1640b, which indicates the status and/or progress of the new user reset. At FIG. 16U, computer system 700 updates status information 1640b to indicate that the new user reset is progressing. At FIG. 16V, computer system 700 updates status information 1640b to include a progress bar that indicates a percentage of completion of the new user reset. In some embodiments, after completion of the new user reset, computer system 700 transitions to the state shown in FIG. 16J and/or the state shown in FIG. 16L.

At FIG. 16W, computer system 700 is not being worn by a user. In some embodiments, computer system 700 automatically performs a new user reset when a threshold duration of time has elapsed since computer system 700 was used by a user, since computer system 700 was worn by a user, and/or since computer system 700 last detected user input (e.g., as indicated by timer indication 1648). In some embodiments, computer system 700 automatically performs a new user reset at a predetermined and/or prespecified time each day. In some embodiments, computer system 700 performs a new user reset in response to instructions received from a remote device, such as remote device 1642. At FIG. 16W, remote device 1642 detects user input 1646 (e.g., a mouse click input) corresponding to selection of option 1644. In response to detecting user input 1646, remote device 1642 transmits a communication and/or an instruction to computer system 700 to perform a new user reset. In response to detecting and/or receiving the communication and/or instruction from remote device 1642, computer system 700 performs a new user reset.

Additional descriptions regarding FIGS. 16A-16W are provided below with reference to method 1700 described with respect to FIG. 17.

FIG. 17 is a flow diagram of an exemplary method 1700 for managing a computer system, in accordance with some embodiments. In some embodiments, method 1700 is performed at a computer system (e.g., 700) (e.g., a smart phone, a smart watch, a tablet, a laptop, a desktop, a wearable device, and/or head-mounted device) that is in communication with one or more display generation components (e.g., a visual output device, a 3D display, a display having at least a portion that is transparent or translucent on which images can be projected (e.g., a see-through display), a projector, a heads-up display, and/or a display controller) (e.g., 702 and/or 702X) and one or more input devices (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) and/or one or more mechanical input devices (e.g., a depressible input mechanism; a button; a rotatable input mechanism; a crown; and/or a dial)) (e.g., 702, 703, 704, and/or 704a). In some embodiments, method 1700 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1700 are, optionally, combined and/or the order of some operations is, optionally, changed.

The computer system (e.g., 700) displays (1702), via the one or more display generation components (e.g., 702), a first user interface (e.g., 1602, 1604, 1622, and/or 1636) (e.g., a first user interface that is part of a first application; and/or a first user interface that is part of a first application that corresponds to managing a wearable device), wherein displaying the first user interface includes concurrently displaying: a first set of one or more options that correspond to logging into a first user account of the computer system (e.g., 1602b, 1604c, and/or 1622a) (e.g., using the computer system using one or more device settings, using one or more device configurations, and/or using user input enrollment information that correspond to the first user account; and/or entering login credentials and/or biometric authentication information corresponding to the first user account), wherein the first user account corresponds to a first respective user; and instructions for initiating a process for resetting the computer system for use by a new user different from the first respective user (e.g., 1602d, 1604b, 1604d, 1622b and/or 1636o) (e.g., for using the computer system using a different user account and/or a new user account that is different from the first user account; for using the computer system using one or more device settings, one or more device configurations, and/or user input enrollment information that corresponds to a different user account and/or a new user account that is different from the first user account). In some embodiments, displaying instructions for resetting the computer system for use by a new user different from the first respective user includes one or more of the following: displaying instructions specifying one or more user inputs to initiate the process for resetting the computer system for use by a new user (e.g., 1602d, 1604d, and/or 1604b); displaying instructions for how to display additional options that include an option to reset the computer system for use by a new user (e.g., an option that, when selected, causes the computer system to initiate a process for resetting the computer system for use by a new user) (e.g., 1602d); and/or displaying an option that, when selected, causes the computer system to initiate a process for resetting the computer system for use by a new user (e.g., 1604b, 1622b, and/or 1636o). While displaying the first user interface (1704), the computer system detects (1706), via the one or more input devices (e.g., 703, 704, 704a, and/or 704b), a first set of one or more user inputs (e.g., 1603, 1605a, 1605b, 1606a, 1606b, 1606c, 1609a, 1609b, 1623a, 1623b, 1624a, and/or 1624b) associated with the first user interface (e.g., one or more touch inputs, one or more hardware control inputs, one or more gaze inputs, one or more gesture inputs, one or more air gesture inputs, and/or one or more spoken inputs). In some embodiments, the first set of one or more user inputs are directed to the first user interface (e.g., 1602 and/or 1604) (e.g., inputs detected while attention is directed to the first user interface or a portion of the first user interface). In some embodiments, the first set of one or more user inputs are based on instructions provided in the first user interface (e.g., 1602d and/or 1604d) (e.g., instructions for providing an input such as a sequence of one or more button presses or other physical manipulations of one or more controls). In response to detecting the first set of one or more user inputs (1708): in accordance with a determination that the first set of one or more user inputs correspond to the instructions for initiating a process for resetting the computer system for use by a new user different from the first respective user (1710) (and, optionally, do not correspond to selection of the first set of one or more options) (e.g., user input 1603, user input 1605b, user input 1606c, user input 1609b, user input 1623b, user input 1624, user input 1638a, and/or user input 1638b), the computer system initiates (1712) a process for resetting the computer system for use by a new user (e.g., FIG. 16E, FIG. 16F, FIG. 16G, and/or FIG. 16T) (e.g., a user that is different from the first respective user; a user that has previously used the computer system but is different from the first respective user and/or is not associated with the first user account; and/or a user that is new to using the computer system and/or has not used the computer system before). In some embodiments, in response to detecting the first set of one or more user inputs: in accordance with a determination that the first set of one or more user inputs correspond to selection of the first set of one or more options (e.g., selection of option 1602b, user input 1605a, and/or selection of option 1604c), the computer system initiates a process for using the computer system using the first user account (e.g., with one or more settings, device configurations, and/or user input enrollment information corresponding to the first user account) (e.g., performing biometric authentication of the user in FIG. 16B and/or operating in the registered user mode of operation shown in FIG. 7C).

In some embodiments, the process for resetting the computer system (e.g., 700) for use by a new user includes revoking access to (e.g., deleting, erasing, and/or revoking permission to access) a first set of data (e.g., one or more applications, one or more functions, and/or one or more data files) of the computer system (e.g., in FIG. 16G and/or in FIGS. 16T-16V, computer system 700 deletes and/or erases data that was stored on and/or accessible on computer system 700 in FIG. 16B (e.g., had authentication of user 1600 been successful)). In some embodiments, the process for resetting the computer system includes removing and/or revoking access to a first set of user input enrollment information (e.g., a first set of user input enrollment information that corresponds to the first user account) (e.g., in FIG. 16G and/or in FIGS. 16T-16V, computer system 700 deletes and/or erases user input enrollment information that was stored on and/or accessible on computer system 700 in FIG. 16B (e.g., had authentication of user 1600 been successful)). In some embodiments, the process for resetting the computer system includes applying a second set of user input enrollment information different from the first set of user input enrollment information (e.g., in FIG. 16N, computer system 700 applies a new set of user input enrollment information corresponding to user 1600 and/or applies different user input enrollment information than had user authentication been successful in FIG. 16B). In some embodiments, input enrollment information is stored as part of a user input calibration profile generated for a first user that, in some embodiments, includes a gaze-based input calibration profile and/or an air gesture input calibration profile for the first user. In some embodiments, input enrollment information includes one or more offset values and/or one or more values that are used in measuring, sensing, and/or responding to user inputs. In some embodiments, gaze-based input calibration information and/or a gaze-based input calibration profile includes one or more offset values and/or one or more values that are used in measuring, sensing, and/or responding to gaze inputs from a user (e.g., one or more offset values and/or other values that are determined based on scanning one or more eyes of the user while the user is instructed to look at one or more gaze targets positioned at one or more different display positions). In some embodiments, hand-based input calibration information, a hand-based input calibration profile, air gesture input calibration information, and/or an air gesture input calibration profile includes one or more offset values and/or one or more values that are used in measuring, sensing, and/or responding to hand inputs (e.g., gesture inputs and/or air gesture inputs) and/or air gesture input from a user (e.g., one or more offset values and/or other values that are determined based on scanning one or more hands of the user while the user is instructed to perform one or more gestures and/or air gestures). Displaying instructions for initiating a process for resetting the computer system for use by a new user enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 700) detects, via the one or more input devices, an attempt to authenticate a first respective user at the computer system (e.g., via passcode-based authentication and/or biometric authentication (e.g., eye-based authentication, face-based authentication, and/or fingerprint-based authentication)) (e.g., FIGS. 16A-16B). In response to detecting the attempt to authenticate the first user: in accordance with a determination that the attempt to authenticate the first user has failed (e.g., FIG. 16C) (e.g., the attempt to authenticate the first user does not identify the first user as a registered user; and/or the attempt to authenticate the first user fails to authenticate the first user as a registered user using biometric authentication and/or password/passcode authentication), the computer system (e.g., 700) displays, via the one or more display generation components, the first user interface (e.g., 1602 and/or 1604). In some embodiments, the first user interface is displayed based on and/or in response to a determination that authentication of the user has failed and/or is not successful. In some embodiments, in response to detecting the attempt to authenticate the first user: in accordance with a determination that the attempt to authenticate the first user is successful (e.g., the attempt to authenticate the first user identifies the first user as a registered user and/or the attempt to authenticate the first user authenticates the first user as a registered user using biometric authentication and/or password/passcode authentication), the computer system forgoes displaying the first user interface (e.g., in some embodiments, from FIG. 16B, is authentication of the user is successful, computer system 700 transitions to the state shown in FIG. 7C). In some embodiments, the computer system displays a second user interface (e.g., 714 in FIG. 7C) different from the first user interface (e.g., a second user interface that is indicative of the first respective user being identified as a registered user of the computer system). Displaying instructions for initiating a process for resetting the computer system for use by a new user enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the first user interface is an authentication user interface (e.g., 1602) (e.g., a passcode, password, and/or pattern entry user interface to authenticate a user and/or to unlock the computer system). In some embodiments, the first user interface (e.g., the authentication user interface) displays one or more options (e.g., keyboard 1602a and/or option 1602b) that are selectable to authenticate a user of the computer system as a registered user and/or one or more options that are selectable to authenticate a user of the computer system as the first respective user that is associated with the first user account of the computer system. In some embodiments, the instructions for initiating a process for resetting the computer system for use by a new user different from the first respective user comprises instructions for displaying additional options for using the computer system (e.g., additional options that include an option to initiate a process for resetting the computer system for use by a new user) (e.g., 1602d). Displaying instructions for initiating a process for resetting the computer system for use by a new user enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, displaying the first user interface (e.g., 1602, 1604, 1622, and/or 1636) further includes: displaying, via the one or more display generation components and concurrently with the first set of one or more options that correspond to logging into the first user account (e.g., 1604c) and the instructions for initiating a process for resetting the computer system for use by a new user (e.g., 1604b and/or 1604d), a guest mode option (e.g., 1604a) that, when selected, causes the computer system to initiate a process for operating the computer system in a guest mode of operation that has restricted access to one or more of a plurality of features of the computer system (e.g., as described above, for example, with reference to FIGS. 7A-7AB and/or FIGS. 9A-9AA) (e.g., a guest mode of operation that has access to a subset of a plurality of features that are accessible in an unlocked mode of operation and/or a registered user mode of operation, and/or a guest mode of operation that has access to fewer features than are available in the unlocked mode of operation and/or the registered user mode of operation). In some embodiments, in response to detecting the first set of one or more user inputs: in accordance with a determination that the first set of one or more user inputs correspond to the guest mode option (e.g., correspond to selection of the guest mode option), the computer system initiates a process for operating the computer system in the guest mode of operation (e.g., as described above, for example, with reference to FIGS. 7A-7AB and/or FIGS. 9A-9AA) (e.g., in some embodiments, without logging into the first user account of the computer system and/or without resetting the computer system for use by a new user different from the first respective user). Displaying instructions for initiating a process for resetting the computer system for use by a new user and displaying an option to initiate a guest mode of operation enhances the operability of the system and makes the user-system interface more efficient (e.g., by helping the user to provide proper inputs and reducing errors) which, additionally, reduces power usage and improves battery life of the device by enabling the user to use the system more quickly and efficiently. Additionally, operating the computer system in a guest mode of operation that has access to a restricted set of features improves device security and privacy by ensuring that unauthorized users do not have access to private and/or confidential information.

In some embodiments, the process for resetting the computer system for use by a new user comprises restarting the computer system (e.g., FIG. 16G) (e.g., rebooting the computer system; and/or powering off the computer system and powering on the computer system). In some embodiments, in response to detecting the first set of one or more user inputs: in accordance with a determination that the first set of one or more user inputs correspond to the instructions for initiating a process for resetting the computer system for use by a new user different from the first respective user, the computer system restarts the computer system and/or initiates a process for restarting the computer system (e.g., FIG. 16G) (e.g., reboots the computer system and/or initiates a process for rebooting the computer system). Displaying instructions for initiating a process for resetting the computer system for use by a new user enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the process for resetting the computer system for use by a new user comprises, displaying, via the one or more display generation components, a visual indication indicating that resetting the computer system for use by a new user will cause the computer system to reboot (e.g., 1610 and/or 1610a). In some embodiments, in response to detecting the first set of one or more user inputs: in accordance with a determination that the first set of one or more user inputs correspond to the instructions for initiating a process for resetting the computer system for use by a new user different from the first respective user, the computer system displays the visual indication indicating that resetting the computer system for use by a new user will cause the computer system to reboot. Displaying a visual indication that resetting the computer system for use by a new user will cause the computer system to reboot provides the user with improved visual feedback about a state of the computer system (e.g., that the computer system is about to reboot and/or that the computer system is about to be reset for use by a new user). Furthermore, doing so also makes the user-system interface more efficient (e.g., by helping the user to provide proper inputs and reducing errors) which, additionally, reduces power usage and improves battery life of the device by enabling the user to use the system more quickly and efficiently. Additionally, doing so also improves user and device safety by allowing a user to remove the computer system before passthrough ends (e.g., to avoid a scenario in which the user is not able to see his or her surroundings while wearing the computer system).

In some embodiments, the computer system (e.g., 700) concurrently displays, via the one or more display generation components: the visual indication indicating that resetting the computer system for use by a new user will cause the computer system reboot (e.g., 1610); and a cancel option (e.g., 1608b) that, when selected, causes the computer system to display the first user interface without rebooting the computer system (e.g., a cancel option that, when selected, cancels the process for resetting the computer system for use by a new user and/or returns to a user interface for authenticating the user of the computer system). In some embodiments, while concurrently displaying the visual indication that resetting the computer system for use by a new user will cause the computer system to reboot (e.g., 1610) and the cancel option (e.g., 1608b), the computer system detects a set of one or more user inputs (e.g., 1609a and/or 1609b). In some embodiments, in response to detecting the set of one or more user inputs: in accordance with a determination that the set of one or more user inputs correspond to selection of the cancel option (e.g., 1608b), the computer system displays, via the one or more display generation components, the first user interface without rebooting the computer system (e.g., from FIG. 16F, returns to the state shown in FIG. 16E). In some embodiments, in response to detecting the set of one or more user inputs: in accordance with a determination that the set of one or more user inputs correspond to a user request to proceed with the process for resetting the computer system for use by a new user (e.g., user input 1609b), the computer system reboots the computer system; initiates a process for rebooting the computer system; and/or proceeds with the process for resetting the computer system for use by a new user (e.g., FIG. 16G). Displaying a cancel option that is selectable to cancel the process for resetting the computer system makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system concurrently displays, via the one or more display generation components (e.g., 702): the visual indication indicating that resetting the computer system for use by a new user will cause the computer system reboot (e.g., 1610); and a request access option that, when selected, causes the computer system to transmit an access request to a second computer system different from the computer system (e.g., in some embodiments, user interface 1608 includes option 1604a to “request guest access” and/or, in some embodiments, user interface 1604 includes a visual indication that resetting the computer system for use by a new user will cause the computer system to reboot), wherein the access request causes the second computer system to output a request requesting access to one or more features of the computer system (e.g., in FIG. 9E, a guest access request causes second computer system 910 to display user interface 916 requesting access to computer system 700) (e.g., a request requesting to operate the computer system in a guest mode of operation that has restricted access to a set of features of the computer system and/or that has access to a subset of a plurality of features that are accessible in an unlocked mode of operation and/or a registered user mode of operation, and/or a guest mode of operation that has access to fewer features than are available in the unlocked mode of operation and/or the registered user mode of operation). In some embodiments, while concurrently displaying the visual indication that resetting the computer system for use by a new user will cause the computer system to reboot (e.g., 1610) and the request access option (e.g., 1604a), the computer system detects a set of one or more user inputs. In some embodiments, in response to detecting the set of one or more user inputs: in accordance with a determination that the set of one or more user inputs correspond to selection of the request access option (e.g., 1604a), the computer system transmits the access request to the second computer system (e.g., 910 in FIG. 9E), wherein the access request causes the second computer system to output a request (e.g., 916) requesting access to one or more features of the computer system (e.g., 700). In some embodiments, in response to detecting the set of one or more user inputs: in accordance with a determination that the set of one or more user inputs correspond to a user request to proceed with the process for resetting the computer system for use by a new user (e.g., user input 1609b), the computer system reboots the computer system; initiates a process for rebooting the computer system; and/or proceeds with the process for resetting the computer system for use by a new user (e.g., FIG. 16G). Displaying a cancel option that is selectable to cancel the process for resetting the computer system makes the user-system interface more efficient (e.g., by helping the user to provide proper inputs and reducing errors) which, additionally, reduces power usage and improves battery life of the device by enabling the user to use the system more quickly and efficiently. Additionally, causing a second computer system to display a request and/or an indication that a guest user has requested guest access to the computer system improves device security and privacy by ensuring that unauthorized users do not have access to private and/or confidential information.

In some embodiments, the computer system (e.g., 700) detects, via the one or more input devices, a second set of one or more user inputs (e.g., 1621a and/or 1621b) (e.g., one or more touch inputs, one or more hardware control inputs, one or more gaze inputs, one or more gesture inputs, one or more air gesture inputs, and/or one or more spoken inputs). In response to detecting the second set of one or more user inputs, the computer system: displays, via the one or more display generation components, an input enrollment reset user interface (e.g., 1622), wherein displaying the input enrollment reset user interface includes concurrently displaying: an input enrollment reset option (e.g., 1622a) which, when selected, causes the computer system to initiate a process for input enrollment of a user of the computer system (e.g., to initiate collection of new input enrollment information, optionally, without resetting the computer system for use by a new user different from the first respective user); and a device reset option (e.g., 1622b) which, when selected, causes the computer system to initiate the process for resetting the computer system for use by a new user different from the first respective user. In some embodiments, initiating the process for performing input enrollment of a user of the computer system includes initiating a process for enrolling and/or calibrating gaze-based user inputs; initiating a process for enrolling and/or calibrating hand-based user inputs; and/or initiating a process for enrolling and/or calibrating air gesture user inputs (e.g., FIGS. 7K-7N). In some embodiments, performing input enrollment of the first user results in a user input calibration profile being generated for the first user that includes a gaze-based input calibration profile and/or an air gesture input calibration profile for the user. In some embodiments, guest enrollment information includes gaze-based input calibration information; hand-based input calibration information; and/or air gesture input calibration information. In some embodiments, gaze-based input calibration information includes one or more offset values and/or one or more values that are used in measuring, sensing, and/or responding to gaze inputs from the user (e.g., one or more offset values and/or other values that are determined based on scanning one or more eyes of the user while the user is instructed to look at one or more gaze targets positioned at one or more different display positions). In some embodiments, hand-based input calibration information and/or air gesture input calibration information includes one or more offset values and/or one or more values that are used in measuring, sensing, and/or responding to hand inputs (e.g., gesture inputs and/or air gesture inputs) and/or air gesture input from the user (e.g., one or more offset values and/or other values that are determined based on scanning one or more hands of the user while the user is instructed to perform one or more gestures and/or air gestures). Providing an option to re-perform and/or re-do input enrollment enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 700) detects, via the one or more input devices, one or more user inputs (e.g., 1630, 1634a, and/or 1634b) corresponding to a user request to display a control user interface (e.g., 1636) (e.g., a system user interface, a user interface generated by and/or display by an operating system of the computer system, and/or a control center user interface that includes one or more of: a volume control option (e.g., 1636i) (e.g., option that a user can interact with to adjust audio output volume of the computer system), a brightness control option (e.g., an option that a user can interact with to adjust the brightness of the one or more display generation components), a wifi option (e.g., 1636f) (e.g., an option that is selectable to selectively enable and/or disable wifi), a Bluetooth option (e.g., 1636g) (e.g., an option that is selectable to selectively enable and/or disable Bluetooth), and/or an airplane mode option (e.g., 1636h) (e.g., an option that is selectable to selectively enable and/or disable an airplane mode (e.g., a mode in which cellular data and/or one or more other types of wireless data are disabled))). In response to detecting the one or more user inputs corresponding to the user request to display the control user interface, the computer system displays, via the one or more display generation components, the control user interface (e.g., 1636), wherein the control user interface includes: one or more system options (e.g., one or more of options 1636f-1636n) pertaining to one or more settings of the computer system; and a device reset option (e.g., 1636o) separate from the one or more system options which, when selected, causes the computer system to initiate the process for resetting the computer system for use by a new user different from the first respective user. In some embodiments, the device reset option (e.g., 1636o) is not displayed in a first portion (e.g., an initially displayed portion) of the control user interface (e.g., 1636), but is accessible via a sequence of one or more inputs that starts from the first portion of the control user interface. For example, in some embodiments, the control user interface includes a first portion that includes one or more selectable options, and selection of a first option in the first portion of the control user interface causes the computer system to display a second portion of the control user interface. In some embodiments, the second portion of the control user interface includes the device reset option. In some embodiments, selection of a second option in the second portion of the control user interface causes the computer system to display a third portion of the control user interface that is different from the second portion of the control user interface and was optionally not displayed prior to detecting selection of the second option in the second portion of the control user interface. In some embodiments, the third portion of the control user interface includes the device reset option. Providing a device reset option within a control center user interface enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 700) detects that a set of one or more criteria for displaying a second user interface (e.g., 1604, 1622, and/or 1636) (e.g., a second user interface that is the same as the first user interface or a second user interface that is different from the first user interface) are satisfied (e.g., in some embodiments, detecting one or more user inputs corresponding to a user request to display the second user interface; detecting that authentication of a user has failed; and/or detecting that a user has put on and/or worn the computer system). In response to detecting that the set of one or more criteria for displaying the second user interface are satisfied, the computer system displays, via the one or more display generation components, the second user interface (e.g., 1604, 1622, and/or 1636), wherein displaying the second user interface comprises: in accordance with a determination that a device reset setting is enabled, displaying, within the second user interface via the one or more display generation components, a device reset option (e.g., 1604b, 1622b, and/or 1636o) that, when selected, causes the computer system to initiate the process for resetting the computer system for use by a new user different from the first respective user; and in accordance with a determination that the device reset setting is disabled, displaying, via the one or more display generation components, the second user interface without the device reset option (e.g., in some embodiments, when the device reset setting is disabled, user interface 1604 does not include option 1604b; user interface 1622 does not include option 1622b; and/or user interface 1636 does not include option 1636c). In some embodiments, the second user interface is the first user interface, and displaying the second user interface comprises: in accordance with a determination that the device reset setting is enabled, displaying, within the second user interface (e.g., the first user interface), the first set of one or more options that correspond to logging into the first user account of the computer system and the instructions for initiating the process or resetting the computer system for use by a new user different from the first respective user; and in accordance with a determination that the device reset setting is disabled, displaying, within the second user interface, the first set of one or more options that correspond to logging into the first user account of the computer system without displaying the instructions for initiating the process for resetting the computer system for use by a new user different from the first respective user. In some embodiments, the option to reset the computer system for use by a new user is accessible only when a device reset setting is enabled. Displaying the device reset option only when the device reset setting is enabled, and forgoing display of the device reset option when the device reset setting is disabled, enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, the computer system (e.g., 700) determines that the computer system has not been used (e.g., has not been worn by a user and/or has not detected user input from a user) for a first threshold duration of time (e.g., fifteen minutes, thirty minutes, one hour, or two hours). In response to determining that the computer system has not been used for the first threshold duration of time: in accordance with a determination that the device reset setting is enabled, resetting the computer system for use by a new user different from the first respective user (e.g., in FIG. 16W, when a threshold duration of time has elapsed since computer system 700 was used (e.g., as indicated by timer 1648), computer system 700 automatically performs a new user reset if the device reset setting is enabled); and in accordance with a determination that the device reset setting is disabled (e.g., is not enabled), the computer system forgoes resetting the computer system for use by a new user different from the first respective user (e.g., in FIG. 16W, if the device reset setting is disabled, computer system 700 does not automatically perform a new user reset). Automatically resetting the computer system when a threshold duration of time has passed without the computer system being used improves device security and privacy. Furthermore, doing so also allows for these operations to be performed automatically without user input, which reduces power usage and improves battery life of the device.

In some embodiments, the computer system (e.g., 700) receives, from a first remote computer system (e.g., 1642) separate from the computer system (e.g., 700), a first set of instructions to reset the computer system for use by a new user different from the first respective user (e.g., instructions transmitted in response to user input 1646 in FIG. 16W). In response to receiving the first set of instructions from the first remote computer system (e.g., 1642), the computer system (e.g., 700) resets the computer system (e.g., 700) for use by a new user different from the first respective user (e.g., FIG. 16G-16L and/or FIGS. 16T-16V). In some embodiments, the first set of instructions are transmitted from the first remote computer system to the computer system in response to one or more user inputs (e.g., 1646) received at the first remote computer system (e.g., 1642). Resetting the computer system based on instructions from a remote system improves device security and privacy by allowing system administrators and/or system owners to perform a remote reset of the computer system using a remote device.

In some embodiments, the computer system (e.g., 700) detects, via the one or more input devices, a second set of one or more user inputs (e.g., one or more touch inputs, one or more hardware control inputs, one or more gaze inputs, one or more gesture inputs, one or more air gesture inputs, and/or one or more spoken inputs). In response to detecting the second set of one or more user inputs: in accordance with a determination that the second set of one or more user inputs correspond to a user request to perform a full system reset of the computer system, the computer system (e.g., 700) performs a full system reset of the computer system including deleting a first set of content (e.g., files, features, and/or applications) from the computer system (e.g., permanently deleting the first set of content from the computer system and/or removing the first set of content from the computer system); and in accordance with a determination that the second set of one or more user inputs correspond to a user request to reset the computer system for use by a new user (e.g., 1609b, 1624a, 1638a, and/or 1638b) (e.g., a new user different from the first respective user) without performing the first system reset of the computer system, the computer system resets the computer system for use by a new user (e.g., FIGS. 16G-16L), wherein resetting the computer system for use by a new user includes maintaining at least some of the first set of content that is deleted in a full system reset of the computer system (e.g., in some embodiments, a new user reset maintains access to applications 1620-1 through 1620-13 in FIG. 16N, while a full system reset of computer system 700 does not include and/or does not maintain access to at least some of applications 1620-1 through 1620-13 in FIG. 16N). In some embodiments, the computer system is configured to perform a first type of reset to reset the computer system for use by a new user, and the computer system is configured to perform a second type of reset that is a full system reset. In some embodiments, the first type of reset is different from the second type of reset. For example, in some embodiments, resetting the computer system for use by a new user maintains (e.g., does not delete and/or does not remove) at least some content that is deleted and/or removed in a full system reset. Providing the option to reset the computer system for use by a new user without performing a full system reset enhances the operability of the system and makes the user-system interface more efficient (e.g., by eliminating the need to re-install and/or re-add content that is maintained when resetting the device for use by a new user) which, additionally, reduces power usage and improves battery life of the device by enabling the user to use the system more quickly and efficiently.

In some embodiments, the computer system (e.g., 700) is configured to be worn on the head of a user (e.g., FIG. 16A). In some embodiments, the one or more display generation components include: one or more internal display generation components (e.g., 702, 1-120a, 1-120b, 11.1.1-104a, and/or 11.1.1-104b) that are directed toward the head the user while the computer system is being worn on the head of the user (e.g., one or more internal display generation components that are configured to be positioned in front of the eyes of a user while the user is wearing the computer system and/or are configured to display content toward the eyes of the user while the user is wearing the computer system on his or her head); and one or more external display generation components (e.g., 702X and/or 1-108) that are different from the one or more internal display generation components, and are positioned on an external surface of the computer system that faces away from the head of the user while the computer system is worn on the head of the user. In some embodiments, the computer system detects, via the one or more input devices, one or more user inputs (e.g., one or more touch inputs, one or more hardware control inputs, one or more gaze inputs, one or more gesture inputs, one or more air gesture inputs, and/or one or more spoken inputs) corresponding to a user request to reset the computer system for use by a new user different from the first respective user (e.g., 1609b, 1624a, 1638a, and/or 1638b). In some embodiments, in response to detecting the one or more user inputs corresponding to the user request to reset the computer system for use by a new user different from the respective user, the computer system: initiates the process for resetting the computer system for use by a new user different from the first respective user (e.g., FIG. 16G); and displays, via the one or more external display generation components (e.g., 702X and/or 1-108), a first visual indication (e.g., 1612) that the computer system is being reset for use by a new user. Displaying an external indication that the computer system is being reset improves visual feedback about the state of the computer system. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, in response to detecting the one or more user inputs corresponding to the user request to reset the computer system for use by a new user different from the respective user (e.g., 1609b, 1624a, 1638a, and/or 1638b): in accordance with a determination that the computer system is being worn by a user (e.g., is being worn on the head of a user), the computer system displays, via the one or more internal display generation components (e.g., 702, 1-120a, 1-120b, 11.1.1-104a, and/or 11.1.1-104b), a second visual indication (e.g., 1640) indicating that the computer system is being reset for use by a new user. In some embodiments, the second visual indication indicating that the computer system is being reset for use by a new user indicates a degree of progress (e.g., a percentage of completion) of resetting the computer system for use by a new user (e.g., 1640b in FIG. 16V). In some embodiments, in response to detecting the one or more user inputs corresponding to the user request to reset the computer system for use by a new user different from the respective user: in accordance with a determination that the computer system (e.g., 700) is not being worn by a user (e.g., is not being worn on the head of a user) (e.g., FIGS. 16H-16I), the computer system forgoes displaying the second visual indication (e.g., 1640) via the one or more internal display generation components (e.g., 702, 1-120a, 1-120b, 11.1.1-104a, and/or 11.1.1-104b) (and, optionally, displays the first visual indication via the one or more external display generation components). In some embodiments, in response to detecting the one or more user inputs corresponding to the user request to reset the computer system for use by a new user different from the respective user: in accordance with a determination that the computer system is being worn by a user (e.g., FIGS. 16S-16V), the computer system displays the second visual indication (e.g., 1640) via the one or more internal display generation components (e.g., 702, 1-120a, 1-120b, 11.1.1-104a, and/or 11.1.1-104b) and displays the first visual indication (e.g., 1612) via the one or more external display generation components (e.g., 702X and/or 1-108). In some embodiments, in response to detecting the one or more user inputs corresponding to the user request to reset the computer system for use by a new user different from the respective user: in accordance with a determination that the computer system is being worn by a user, the computer system displays the second visual indication (e.g., 1640) via the one or more internal display generation components (e.g., 702, 1-120a, 1-120b, 11.1.1-104a, and/or 11.1.1-104b) and forgoes displaying the first visual indication (e.g., 1612) via the one or more external display generation components (e.g., 702X and/or 1-108). Displaying an indication that the computer system is being reset improves visual feedback about the state of the computer system. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, after completion of the process for resetting the computer system (e.g., 700) for use by a new user (e.g., in some embodiments, in response to determining that the process for resetting the computer system for use by a new user has completed and/or in accordance with a determination that the process for resetting the computer system for use by a new user has completed), the computer system outputs a first completion indication (e.g., 1614) indicating that the process for resetting the computer system for use by a new user has completed. In some embodiments, the first completion indication includes a non-visual output such as a first haptic output and/or a first sound that is indicative of the process for resetting the computer system for use by a new user being completed. Outputting an indication that the computer system has completed resetting the computer system for use by a new user improves feedback about the state of the computer system. Furthermore, doing so also enhances the operability of the system and makes the user-system interface more efficient (e.g., by helping the user to provide proper inputs and reducing errors) which, additionally, reduces power usage and improves battery life of the device by enabling the user to use the system more quickly and efficiently.

In some embodiments, aspects/operations of methods 800, 1000, 1100, 1300, 1500, and/or 1700 may be interchanged, substituted, and/or added between these methods. For example, in some embodiments, the computer systems recited in methods 800, 1200, and/or 1700 are the same computer system, the first computer system recited in method 1000, the wearable device recited in method 1500, and/or the external computer system recited in method 1100. In another example, in some embodiments, the computer system recited in method 1100 is the second computer system recited in method 1000. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

What is claimed is:

1. A computer system configured to communicate with one or more display generation components and one or more input devices, the computer system comprising:
one or more processors; and
memory storing one or more programs configured to be executed by the one or more processors, the one or more programs including instructions for:
detecting, via the one or more input devices, a first user using the computer system; and
in response to detecting the first user using the computer system:
in accordance with a determination that one or more guest user criteria are satisfied and there is saved guest enrollment information available to the computer system, initiating a processing for using the saved guest enrollment information to process user inputs by the first user; and
in accordance with a determination that the one or more guest user criteria are satisfied and there is not saved guest enrollment information available to the computer system, initiating a process for performing input enrollment of the first user.

2. The computer system of claim 1, wherein the one or more programs further include instructions for:
in response to detecting the first user using the computer system:
in accordance with a determination that the one or more guest user criteria are not satisfied, operating the computer system using registered user enrollment information to process user inputs by the first user.

3. The computer system of claim 1, wherein the saved guest enrollment information includes one or more of: hand enrollment information, eye enrollment information, or prescription information.

4. The computer system of claim 1, wherein:
initiating the process for using the saved guest enrollment information to process user inputs by the first user comprises concurrently displaying, via the one or more display generation components:
a first selectable option that, when selected, causes the computer system to operate the computer system using the saved guest enrollment information; and
a second selectable option that, when selected, causes the computer system to initiate the process for performing input enrollment of the first user; and
the one or more programs further include instructions for:
while concurrently displaying the first selectable option and the second selectable option, receiving, via a first hardware control of the computer system, one or more hardware inputs; and
in response to receiving the one or more hardware inputs:
in accordance with a determination that the one or more hardware inputs correspond to selection of the first selectable option, operating the computer system using the saved guest enrollment information to process user inputs by the first user; and
in accordance with a determination that the one or more hardware inputs correspond to selection of the second selectable option, initiating the process for performing input enrollment of the first user.

5. The computer system of claim 1, wherein the one or more programs further include instructions for:
in response to detecting the first user using the computer system:
in accordance with a determination that the one or more guest user criteria are satisfied, and there is second saved guest enrollment information different from the guest enrollment information available to the computer system, and that biometric information received from the first user corresponds to the second saved guest enrollment information, initiating a process for using the second saved guest enrollment information to process user inputs by the first user.

6. The computer system of claim 1, wherein:
initiating the process for using the saved guest enrollment information to process user inputs by the first user comprises displaying, via the one or more display generation components, an enrollment management user interface, wherein the enrollment management user interface includes:
a first option that, when selected, causes the computer system to operate the computer system using the saved guest enrollment information to process user inputs by the first user; and
a second option that, when selected, causes the computer system to initiate the process for performing input enrollment of the first user.

7. The computer system of claim 6, wherein the one or more programs further include instructions for:
while concurrently displaying the first option and the second option, receiving, via the one or more input devices, a selection input; and
in response to receiving the selection input:
in accordance with a determination that the selection input corresponds to selection of the first option, operating the computer system using the saved guest enrollment information to process user inputs by the first user; and
in accordance with a determination that the selection input corresponds to selection of the second option, initiating the process for performing input enrollment of the first user.

8. The computer system of claim 6, wherein the one or more programs further include instructions for:
while displaying the enrollment management user interface, receiving, via the one or more input devices, a selection input corresponding to selection of the second option;
in response to receiving the selection input corresponding to selection of the second option, initiating the process for performing input enrollment of the first user; and
subsequent to performing input enrollment of the first user, displaying, via the one or more display generation components, a save option that, when selected, causes the computer system to save new guest enrollment information, wherein the new guest enrollment information is generated based on the input enrollment of the first user.

9. The computer system of claim 8, wherein the one or more programs further include instructions for:
while displaying the save option, receiving, via the one or more input devices, a first set of one or more user inputs; and
in response to receiving the first set of one or more user inputs:
in accordance with a determination that the first set of one or more user inputs corresponds to selection of the save option:
saving the new guest enrollment information; and
operating the computer system using the new guest enrollment information to process user inputs by the first user; and
in accordance with a determination that the first respective user input corresponds to a user request not to save the new guest enrollment information:
operating the computer system using the new guest enrollment information to process user inputs by the first user without saving the new guest enrollment information.

10. The computer system of claim 8, wherein the one or more programs further include instructions for:
while displaying the save option, receiving, via the one or more input devices, a selection input corresponding to selection of the save option;
in response to receiving the selection input corresponding to selection of the save option:
saving the new guest enrollment information; and
operating the computer system using the new guest enrollment information to process user inputs by the first user;
subsequent to saving the new guest enrollment information and operating the computer system using the new guest enrollment information to process user inputs by the first user, detecting, via the one or more input devices, a second user using the computer system; and
in response to detecting the second user using the computer system:
in accordance with a determination that the one or more guest user criteria are satisfied and that the new guest enrollment information is available to the computer system, initiating a processing for using the new guest enrollment information to process user inputs by the second user; and
in accordance with a determination that the one or more guest user criteria are satisfied and there is not saved guest enrollment information available to the computer system, initiating a process for performing input enrollment of the second user.

11. The computer system of claim 8, wherein the one or more programs further include instructions for:
subsequent to performing input enrollment of the first user, displaying, via the one or more display generation components, one or more selectable options that, when selected, cause the computer system to save the new guest enrollment information with user-entered identification information.

12. The computer system of claim 6, wherein displaying the enrollment management user interface comprises displaying, within the enrollment management user interface, first identifying information corresponding to the saved guest enrollment information and the first option.

13. The computer system of claim 12, wherein the first identifying information includes date and/or time information of the last time the saved guest enrollment information was used by a guest user of the computer system.

14. The computer system of claim 12, wherein the first identifying information includes a text identifier corresponding to the saved guest enrollment information.

15. The computer system of claim 12, wherein:
the enrollment management user interface further includes a third option that, when selected, causes the computer system to operate the computer system using second saved guest enrollment information different from the saved guest enrollment information to process user inputs by the first user;
displaying the enrollment management user interface further comprises displaying, within the enrollment management user interface, second identifying information corresponding to the second saved guest enrollment information and the third option;
the first identifying information includes a first user name corresponding to the saved guest enrollment information; and
the second identifying information includes a second user name different from the first user name and that corresponds to the second saved guest enrollment information.

16. The computer system of claim 1, wherein the one or more programs further include instructions for:
subsequent to detecting the first user using the computer system:
in accordance with a determination that a first time threshold with respect to the saved guest enrollment information has elapsed, deleting the saved guest enrollment information.

17. The computer system of claim 16, wherein the determination that the first time threshold with respect to the saved guest enrollment information has elapsed comprises a determination that a threshold amount of time has elapsed since the saved guest enrollment information was last used by the computer system to process user inputs by a guest user.

18. The computer system of claim 1, wherein the one or more programs further include instructions for:
while operating the computer system using the saved guest enrollment information to process user inputs by the first user, displaying, via the one or more display generation components, a delete option that, when selected, causes the computer system to initiate a process for deleting the saved guest enrollment information.

19. The computer system of claim 18, wherein the one or more programs further include instructions for:
while displaying the delete option, receiving, via the one or more input devices, a selection input corresponding to selection of the delete option;
in response to receiving the selection input corresponding to selection of the delete option, transitioning a deletion setting corresponding to the delete option into an enabled state without deleting the saved guest enrollment information;
detecting that the first user has stopped using the computer system; and
in response to detecting that the first user has stopped using the computer system:
in accordance with a determination that the deletion setting is in the enabled state, deleting the saved guest enrollment information.

20. The computer system of claim 19, wherein the one or more programs further include instructions for:
subsequent to detecting the selection input corresponding to selection of the delete option and prior to detecting that the first user has stopped using the computer system, operating the computer system using the saved guest enrollment information to process user inputs by the first user while the deletion setting is in the enabled state.

21. The computer system of claim 19, wherein the one or more programs further include instructions for:
in response to receiving the selection input corresponding to selection of the delete option, replacing the delete option with a save enrollment option that, when selected, causes the computer system to transition the deletion setting to a disabled state that is different from the enabled state;
while displaying the save enrollment option, receiving, via the one or more input devices, a selection input corresponding to selection of the saved enrollment option; and
in response to receiving the selection input corresponding to selection of the save enrollment option, cancelling the process for deleting the saved guest enrollment information.

22. The computer system of claim 19, wherein the one or more programs further include instructions for:
while operating the computer system using the saved guest enrollment information to process user inputs by the first user, displaying, via the one or more display generation components, a first accessibility feature option that, when selected, causes the computer system to initiate a process for enabling a first accessibility feature of the computer system.

23. The computer system of claim 1, wherein the one or more programs further include instructions for:
performing input enrollment of the first user to generate first new guest enrollment information; and
subsequent to performing input enrollment of the first user, operating the computer system using the first new guest enrollment information to process user inputs by the first user.

24. The computer system of claim 23, wherein the one or more programs further include instructions for:
subsequent to performing input enrollment of the first user, displaying, via the one or more display generation components, first visual content, wherein the first visual content is automatically centered based on a viewpoint of the first user.

25. The computer system of claim 23, wherein the one or more programs further include instructions for:
subsequent to operating the computer system using the first new guest enrollment information to process user inputs by the first user, detecting, via the one or more input devices, a registered user of the computer system using the computer system; and
while the registered user of the computer system is using the computer system:
operating the computer system with registered user enrollment information to process user inputs by the registered user; and
displaying, via the one or more display generation components, one or more guest enrollment management options for managing the new guest enrollment information.

26. The computer system of claim 25, wherein the one or more guest enrollment management options includes a guest enrollment save option that, when selected, causes the computer system to increase a duration for which the new guest enrollment information will be saved.

27. The computer system of claim 25, wherein the one or more guest enrollment management options includes a guest enrollment deletion option that, when selected, causes the computer system to delete the new guest enrollment information.

28. The computer system of claim 1, wherein the one or more programs further include instructions for:
receiving, via the one or more input devices, a user request to enable a guest mode setting of the computer system, wherein the guest mode setting permits a guest user to use the computer system in a guest mode; and
in response to receiving the user request to enable the guest mode setting of the computer system:
enabling the guest mode setting of the computer system; and
enabling a view sharing setting of the computer system, wherein the view sharing setting of the computer system, when enabled, causes the computer system to transmit at least a portion of visual content being displayed by the computer system to an external computer system.

29. The computer system of claim 1, wherein the one or more programs further include instructions for:
receiving, via the one or more input devices, a user request to enable a guest mode setting of the computer system, wherein the guest mode setting permits a guest user to use the computer system in a guest mode; and
in response to receiving the user request to enable the guest mode setting of the computer system:
displaying, via the one or more display generation components, representations of two or more applications of the computer system that are available to be accessed while the guest mode setting is enabled, including:
a representation of a first application that, when selected, causes the computer system to enable or disable the first application while the guest mode setting is enabled; and
a representation of a second application different from the first application that, when selected, causes the computer system to enable or disable the first application while the guest mode setting is enabled.

30. The computer system of claim 1, wherein the one or more programs further include instructions for:
receiving, via the one or more input devices, a user request to enable a guest mode setting of the computer system, wherein the guest mode setting permits a guest user to use the computer system in a guest mode; and
in response to receiving the user request to enable the guest mode setting of the computer system:
concurrently displaying, via the one or more display generation components:
a first saved guest enrollment option that, when selected, causes the computer system to initiate a process for using the saved guest enrollment information to process user inputs by a guest user; and
a new guest user option that, when selected, causes the computer system to initiate a process for performing input enrollment of a guest user.

31. The computer system of claim 1, wherein the one or more programs further include instructions for:
receiving, via the one or more input devices, a user request to enable a guest mode setting of the computer system, wherein the guest mode setting permits a guest user to use the computer system in a guest mode;
subsequent to receiving the user request to enable the guest mode setting of the computer system, detecting that the computer system has been removed from the body of a first respective user and has been placed on the body of a second respective user; and
in response to detecting that the computer system has been removed from the body of the first respective user and has been placed on the body of the second respective user:
in accordance with a determination that the second respective user is different from the first respective user, initiating the guest mode of the computer system.

32. The computer system of claim 1, wherein the one or more programs further include instructions for:
receiving, via the one or more input devices, a user request to enable a guest mode setting of the computer system, wherein the guest mode setting permits a guest user to use the computer system in a guest mode;
subsequent to receiving the user request to enable the guest mode setting of the computer system, detecting that the computer system has been removed from the body of a first respective user and has been placed on the body of a second respective user; and
in response to detecting that the computer system has been removed from the body of the first respective user and has been placed on the body of the second respective user, initiating the guest mode of the computer system.

33. A non-transitory computer-readable storage medium storing one or more programs configured to be executed by one or more processors of a computer system that is in communication with one or more display generation components and one or more input devices, the one or more programs including instructions for:
detecting, via the one or more input devices, a first user using the computer system; and
in response to detecting the first user using the computer system:
in accordance with a determination that one or more guest user criteria are satisfied and there is saved guest enrollment information available to the computer system, initiating a processing for using the saved guest enrollment information to process user inputs by the first user; and
in accordance with a determination that the one or more guest user criteria are satisfied and there is not saved guest enrollment information available to the computer system, initiating a process for performing input enrollment of the first user.

34. A method, comprising:
at a computer system that is in communication with one or more display generation components and one or more input devices:
detecting, via the one or more input devices, a first user using the computer system; and
in response to detecting the first user using the computer system:
in accordance with a determination that one or more guest user criteria are satisfied and there is saved guest enrollment information available to the computer system, initiating a processing for using the saved guest enrollment information to process user inputs by the first user; and
in accordance with a determination that the one or more guest user criteria are satisfied and there is not saved guest enrollment information available to the computer system, initiating a process for performing input enrollment of the first user.
